(19) United States
(12) Patent Application Publication
(10) Pub. No.: US 2007/0158335 A1
(43) Pub. Date: Jul. 12, 2007

(54) Method and control interface for food preparation on a cooking appliance

(76) Inventor: David I. Mansbery, Brecksville, OH (US)

Correspondence Address: TUCKER, ELLIS & WEST LLP, 1150 HUNTINGTON BUILDING, 925 EUCLID AVENUE, CLEVELAND, OH, 44115-1414, US

(21) Appl. No.: 11/435,226

(22) Filed: May 16, 2006

Related U.S. Application Data
(63) Continuation-in-part of application No. PCT/US05/00443, filed on Jan. 7, 2005.
(60) Provisional application No. 60/634,826, filed on Dec. 10, 2004.

(51) Int. Cl. H05B 1/02

(52) U.S. Cl. 219/505

(57) ABSTRACT

A graphical user interface adapted to enable a user to direct and control a cooking appliance. The graphical user interface generally enables a plurality of cooking appliance operations through associated layers of screens, such as a refrigerate operation, a cook now operation, a cook later operation, etc., and a plurality of cook settings, such as a bake setting, a roast setting, a broil setting, a warm setting, a convection bake setting, a convection roast setting, a convection broil setting, a convection defrost setting, etc. The graphical user interface is adapted to be integrated with and accessible through one or more of the cooking appliance, a handheld device, an Internet-accessible computer, etc.

### CROSS-REFERENCE TO RELATED APPLICATIONS

This application is a continuation-in-part of PCT/US05/00443, filed Jan. 7, 2005, entitled, GRAPHICAL USER INTERFACE FOR A COOKING APPLIANCE, which claims priority to U.S. patent application Ser. No. 11/030,797, filed Jan. 7, 2005 entitled, GRAPHICAL USER INTERFACE FOR A COOKING APPLIANCE, which claims priority to U.S. Provisional Patent Application No. 60/634,826 filed Jan. 7, 2004 entitled, GRAPHICAL USER INTERFACE FOR A COOKING APPLIANCE, the entirety of which is incorporated herein.

### BACKGROUND OF THE INVENTION

The present invention relates to a graphical user interface, and more particularly, the present invention relates to a graphical user interface for directing and controlling a cooking appliance.

A cooking appliance is a device adapted to heat food to a desired temperature for consumption. A user typically directs operation of a conventional cooking appliance through a simple fixed control panel that usually includes such components as rotary dials, analog controls, electromechanical controls, membrane switches, etc. These components often suffer from poor construction, a tendency to break, and a tendency to become detached from the appliance. Thus, there is a need for a cooking appliance control panel that is more durable and able to withstand repetitious use.

Conventional cooking appliances typically offer a limited number of cooking operations. An example user-controllable operation is a cook setting parameter, adapted for enabling the user to specify such settings as a bake setting, a roast setting, a broil setting, etc. Another example user-controllable operation is a cooking temperature setting adapted for enabling the user to specify a temperature for the cooking operation, which temperature settings are usually provided in twenty-five degree increments. However, these operational parameters are often inadequate to provide a fully functional cooking apparatus. Thus, there is a need for a cooking apparatus having a greater range of operations.

### SUMMARY OF THE INVENTION

Disclosed according to the subject application is a graphical user interface for a cooking appliance adapted to enable a user to direct and control the cooking appliance. The graphical user interface generally includes a plurality of user selectable and controllable cooking operations, each of which operation is accessible through one of a plurality of layers of screens provided by the graphical user interface. The operations generally include such example operations as a refrigerate operation, a cook now operation, a cook later operation, etc. The refrigerate operation is suitably adapted to cause the cooking appliance to maintain an internal temperature adequate for refrigerating a food item placed therein. The cook now operation is adapted to enable the user to direct the cooking appliance to immediately cook a food item. The cook later operation is adapted to enable the user to direct the cooking appliance to cook a food item at a specified time and date.

The graphical user interface is adapted to be integrated with and accessible through the cooking appliance. The graphical user interface is also adapted to be integrated with and accessible through a plurality of devices, such as a handheld device (e.g., personal digital assistant, cellular phone, etc.), an Internet-accessible computer, etc.

In accordance with the subject application, there is provided a control interface for food preparation. The control interface includes generating means adapted to generate a display representing date and time data. The date and time data represents available options for future food preparation. The control interface also includes timing data receiving means adapted to receive timing data. The timing data is suitably selected from the time and date data, representing a user-selected time for which a prepared food event is desired. The control interface further includes generating means adapted to selectively generate a display. The display represents available, pre-stored food preparation characteristics or user-specified food preparation characteristics. The control interface includes receiving means adapted to receive food preparation instruction data. The food preparation instruction data is selected from the available, pre-stored food preparation characteristics or user-specified food preparation characteristics. In addition, the control interface also includes communication means adapted for communicating the timing data and the food preparation instruction data to an associated food preparation controller unit. The food preparation controller unit is suitably adapted to complete a food preparation operation according to the food preparation instruction data.

In one embodiment of the subject application, the food preparation controller unit further comprises a refrigeration controller and a heating unit controller. The refrigeration controller includes means adapted for selectively controlling an associated refrigeration unit, which refrigeration unit functions to keep associated food at a safe storage temperature until commencement of the food preparation operation in accordance with the timing data. The heating unit controller includes means adapted for selectively controlling an associated heating unit, which heating unit functions to cook the associated food in accordance with the food preparation instruction data.

In another embodiment of the subject application, the control interface for food preparation further includes means adapted for generating a display representative of a solicited input of at least one of weight and mass of the associated food and means adapted for receiving quantity data, which quantity data is associated with a user input of at least one of weight and mass of the associated food. In addition, the heating unit controller further includes means adapted for selectively controlling the associated heating unit in accordance with the quantity data.

Further, in accordance with the subject application, there is provided a method for food preparation using a control interface. The method comprises the steps of generating a display representative of at least one of date and time data, which date and time data is representative of available options for future food preparation options, receiving timing data, which timing data is selected from the at least one of time and date data, representative of a user-selected time for which a prepared food event is desired, and generating a display representative of at least one of available, pre-stored food preparation characteristics and user-specified food preparation characteristics. The method further comprises receiving food preparation instruction data, which food preparation instruction data is selected from the at least one of available, pre-stored food preparation characteristics and user-specified food preparation characteristics and communicating the timing data and the food preparation instruction data to an associated food preparation controller unit adapted to complete a food preparation operation in accordance therewith.

In another embodiment, the method further comprises the step of selectively controlling, via a refrigeration controller, an associated refrigeration unit, which refrigeration unit functions to keep associated food at a safe storage temperature until commencement of the food preparation operation in accordance with the timing data. The method also includes the step of selectively controlling, via a heating unit controller, an associated heating unit, which heating unit functions to cook the associated food in accordance with the food preparation instruction data.

In yet another embodiment, the method also comprises the steps of generating a display representative of a solicited input of at least one of weight and mass of the associated food and receiving quantity data, which quantity data is associated with the user input of at least one of weight and mass of the associated food. The method also includes the step of selectively controlling, via the heating unit controller, the associated heating unit in accordance with the quantity data.

Still other advantages, aspects and features of the subject application will become readily apparent to those skilled in the art from the following description wherein there is shown and described a preferred embodiment of this invention, simply by way of illustration of one of the best modes best suited for to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

The accompanying drawings incorporated into and forming a part of the specification, illustrate several example aspects of the present invention, and together with the description, serve to explain the principles of the invention. In the drawings:

FIG. 1 is an illustration of a system in accordance with the present invention;

FIG. 2 is an illustration of a block diagram of a cooking appliance in accordance with the present invention;

FIG. 3 is a flowchart illustrating the main screen architecture in accordance with the present invention;

FIGS. 4-5 generally illustrate an embodiment of the main screen architecture according to FIG. 3;

FIG. 4 is a view of the main screen with a probe in the top oven in accordance with the present invention;

FIG. 5 is a view of a calendar pop-up window from the main screen in accordance with the present invention;

FIG. 6 is a flowchart illustrating the my oven screen architecture in accordance with the present invention;

FIGS. 7-12 generally illustrate an embodiment of the my oven screen architecture according to FIG. 6;

FIG. 7 is a view of the my oven screen in accordance with the present invention;

FIG. 8 is a view of a preferences screen from the my oven screen in accordance with the present invention;

FIG. 9 is a view of a units selection screen from the preferences screen of the my oven screen in accordance with the present invention;

FIG. 10 is a view of a sleep mode selection screen from the preferences screen of the my oven screen in accordance with the present invention;

FIG. 11 is a view of an offset selection screen from the preferences screen of the my oven screen in accordance with the present invention;

FIG. 12 is a flowchart illustrating the my contact information screen architecture in accordance with the present invention;

FIGS. 13-15 generally illustrate an embodiment of the my contact information screen architecture according to FIG. 12;

FIG. 13 is a view of a my contact information screen in accordance with the present invention;

FIG. 14 is a view of a QWERTY keyboard screen selection from the my contact information screen in accordance with the present invention;

FIG. 15 is a view of an ABC keyboard screen selection from the my contact information screen in accordance with the present invention;

FIG. 16 is a flowchart illustrating the cooking guide screen architecture in accordance with the present invention;

FIGS. 17-19 generally illustrate an embodiment of the cooking guide screen architecture according to FIG. 16;

FIG. 17 is a view of a cooking guide screen in accordance with the present invention;

FIG. 18 is a view of a temperature definitions selection screen from the cooking guide screen in accordance with present invention;

FIG. 19 is a view of a safe meat temperature selection screen from the cooking guide screen in accordance with present invention;

FIG. 20 is a flowchart illustrating the self clean screen architecture in accordance with the present invention;

FIG. 21 is a flowchart illustrating the self clean screen architecture in accordance with the present invention;

FIGS. 22-24 generally illustrate an embodiment of the self clean screen architecture according to FIGS. 20-21;

FIG. 22 is a view of a probe alert screen from the self clean select an oven screen in accordance with the present invention;

FIG. 23 is a view of a self clean top oven set start time screen in accordance with the present invention;

FIG. 24 is a view of a self clean status door locked cooling screen in accordance with the present invention;

FIG. 25 is a flowchart illustrating the sleep mode screen architecture in accordance with the present invention;

FIGS. 26-29 generally illustrate an embodiment of the sleep mode screen architecture according to FIG. 25;

FIG. 26 is a view of the main screen in accordance with the present invention;

FIG. 27 is a view of a logo screensaver screen from the main screen in sleep mode according to the present invention;

FIG. 28 is a view of a weather/time screen of the sleep mode in accordance with present invention;

FIG. 29 is a view of a blank screen of the sleep mode in accordance with present invention;

FIG. 30 is a flowchart illustrating the network settings screen architecture in accordance with the present invention;

FIGS. 31-32 generally illustrate an embodiment of the cooking guide screen architecture according to FIG. 30;

FIG. 31 is a view of a local network settings screen from the network settings screen in accordance with the present invention;

FIG. 32 is a view of a remote access screen from the network settings screen in accordance with present invention;

FIG. 33 is a flowchart illustrating the set alerts screen architecture in accordance with the present invention;

FIG. 34 is a view of a set alerts screen illustrating an embodiment of the set alerts screen architecture according to FIG. 46;

FIG. 35 is a flowchart illustrating the oven service screen architecture in accordance with the present invention;

FIGS. 36-38 generally illustrate an embodiment of the oven service screen architecture according to FIG. 35;

FIG. 36 is a view of an oven service screen in accordance with the present invention;

FIG. 37 is a view of a diagnostics screen from the oven service screen in accordance with present invention;

FIG. 38 is a flowchart illustrating the set date/time screen architecture in accordance with the present invention;

FIGS. 39-41 generally illustrate an embodiment of the set date/time screen architecture according to FIG. 38;

FIG. 39 is a view of a set date/time screen in accordance with the present invention;

FIG. 40 is a view of a date setting screen from the set date/time screen in accordance with present invention;

FIG. 41 is a view of a time zone setting screen from the set date/time screen in accordance with the present invention;

FIGS. 42-54 generally illustrate flowcharts for the Sabbath/holiday screen architecture in accordance with the present invention;

FIG. 42 is a flowchart illustrating the basic Sabbath screen architecture in accordance with the present invention;

FIG. 43 is a flowchart illustrating the Sabbath Plus screen architecture in accordance with the present invention;

FIG. 44 is a flowchart illustrating the basic Sabbath screen architecture in accordance with the present invention;

FIG. 45 is a flowchart illustrating the basic Sabbath screen architecture in accordance with the present invention;

FIG. 46 is a flowchart illustrating the Sabbath Plus screen architecture in accordance with the present invention;

FIG. 47 is a flowchart illustrating the Sabbath Plus screen architecture in accordance with the present invention;

FIG. 48 is a flowchart illustrating the Sabbath Plus screen architecture in accordance with the present invention;

FIG. 49 is a flowchart illustrating the Sabbath Plus screen architecture in accordance with the present invention;

FIG. 50 is a flowchart illustrating the Sabbath Plus Holiday screen architecture in accordance with the present invention;

FIG. 51 is a flowchart illustrating the Sabbath Plus Holiday screen architecture in accordance with the present invention;

FIG. 52 is a flowchart illustrating the Sabbath Plus Holiday screen architecture in accordance with the present invention;

FIG. 53 is a flowchart illustrating the Sabbath Plus Holiday screen architecture in accordance with the present invention;

FIG. 54 is a flowchart illustrating the Sabbath Plus Holiday screen architecture in accordance with the present invention;

FIGS. 55-84 generally illustrate an embodiment of the Sabbath/Holiday screen architecture according to FIGS. 42-54.

FIG. 55 is a view of a Sabbath/holiday selection screen in accordance with the present invention;

FIG. 56 is a view of a select an oven screen in accordance with the present invention;

FIG. 57 is a view of a select a Sabbath cook method screen in accordance with the present invention;

FIG. 58 is a view of a set oven temperature selection screen in accordance with the present invention;

FIG. 59 is a view of a set start/stop time selection screen in accordance with the present invention;

FIG. 60 is a view of a confirmation and start screen in accordance with the present invention;

FIG. 61 is a view of a set Sabbath/holiday on a bottom oven selection screen in accordance with the present invention;

FIG. 62 is a view of a Sabbath basic mode screen in accordance with the present invention;

FIG. 63 is a view of a set Sabbath Plus selection screen in accordance with the present invention;

FIG. 64 is a view of a first Holiday selection screen in accordance with the present invention;

FIG. 65 is a view of a Sabbath Plus cook method selection screen in accordance with the present invention;

FIG. 66 is a view of a Sabbath Plus set oven temperature selection screen in accordance with the present invention;

FIG. 67 is a view of a Sabbath Plus set start/stop time selection screen in accordance with the present invention;

FIG. 68 is a view of a Sabbath Plus confirmation screen in accordance with the present invention;

FIG. 69 is a view of a Sabbath Plus stage two fill-in screen in accordance with the present invention;

FIG. 70 is a view of a Sabbath Plus confirmation of days screen in accordance with the present invention;

FIG. 71 is a view of a Sabbath Plus status screen in accordance with the present invention;

FIG. 72 is a view of a Sabbath Plus Holiday cook method selection screen in accordance with the present invention;

FIG. 73 is a view of a Sabbath Plus Holiday set oven temperature selection screen in accordance with the present invention;

FIG. 74 is a view of a Sabbath Plus set holiday start/stop time selection screen in accordance with the present invention;

FIG. 75 is a view of a Sabbath Plus first Holiday confirmation screen in accordance with the present invention;

FIG. 76 is a view of a Sabbath Plus first Holiday stage two fill-in screen in accordance with the present invention;

FIGS. 77-78 generally illustrate a flowchart and screen embodiment illustrating an embodiment of the refrigeration screen architecture in accordance with the present invention;

FIG. 77 is a flowchart illustrating the refrigerate screen architecture in accordance with the present invention;

FIG. 78 is a view of a refrigeration status screen illustrating an embodiment of the refrigerate screen architecture according to FIG. 77;

FIGS. 79-88 generally illustrate flowcharts for the cook now screen architecture in accordance with the present invention;

FIG. 79 is a flowchart illustrating the cook now screen architecture in accordance with the present invention;

FIG. 80 is a flowchart illustrating the cook now screen architecture in accordance with the present invention;

FIG. 81 is a flowchart illustrating the cook now add stage one screen architecture in accordance with the present invention;

FIG. 82 is a flowchart illustrating the cook now screen architecture in accordance with the present invention;

FIG. 83 is a flowchart illustrating the cook now add stage one screen architecture in accordance with the present invention;

FIG. 84 is a flowchart illustrating the cook now screen architecture in accordance with the present invention;

FIG. 85 is a flowchart illustrating the cook now favorites screen architecture in accordance with the present invention;

FIG. 86 is a flowchart illustrating the cook now favorites screen architecture in accordance with the present invention;

FIG. 87 is a flowchart illustrating the cook now favorites screen architecture in accordance with the present invention;

FIG. 88 is a flowchart illustrating the cook now favorites screen architecture in accordance with the present invention;

FIGS. 89-98 generally illustrate an embodiment of the cook now screen architecture according to FIGS. 79-88;

FIG. 89 is a view of a cook now cook method selection screen in accordance with the present invention;

FIG. 90 is a view of a cook now set oven temperature selection screen in accordance with the present invention;

FIG. 91 is a view of a cook now set cooking time selection screen in accordance with the present invention;

FIG. 92 is a view of a cook now confirmation adjust add stage screen in accordance with the present invention;

FIG. 93 is a view of a cook now preheat selection screen in accordance with the present invention;

FIG. 94 is a view of a cook now cooking cycle screen in accordance with the present invention;

FIG. 95 is a view of a cook now favorites selection screen in accordance with the present invention;

FIG. 96 is a view of a cook now favorites confirmation screen in accordance with the present invention;

FIG. 97 is a view of a cook now favorites name entry screen in accordance with the present invention;

FIG. 98 is a view of a cook now delete favorites confirmation screen in accordance with the present invention;

FIGS. 98-109 generally illustrate flowcharts for the cook later screen architecture in accordance with the present invention;

FIG. 99 is a flowchart illustrating the cook later screen architecture in accordance with the present invention;

FIG. 100 is a flowchart illustrating the cook later screen architecture in accordance with the present invention;

FIG. 101 is a flowchart illustrating the cook later screen architecture in accordance with the present invention;

FIG. 102 is a flowchart illustrating the cook later add stage screen architecture in accordance with the present invention;

FIG. 103 is a flowchart illustrating the cook later add stage screen architecture in accordance with the present invention;

FIG. 104 is a flowchart illustrating the cook later add stage screen architecture in accordance with the present invention;

FIG. 105 is a flowchart illustrating the cook later favorites screen architecture in accordance with the present invention;

FIG. 106 is a flowchart illustrating the cook later favorites screen architecture in accordance with the present invention;

FIG. 107 is a flowchart illustrating the cook later favorites screen architecture in accordance with the present invention;

FIG. 108 is a flowchart illustrating the cook later favorites add dish screen architecture in accordance with the present invention;

FIG. 109 is a flowchart illustrating the cook later favorites edit dish screen architecture in accordance with the present invention;

FIG. 110 is a flowchart illustrating the cook later favorites add dish screen architecture in accordance with the present invention;

FIGS. 111-115 generally illustrate an embodiment of the cook later screen architecture according to FIGS. 99-110;

FIG. 111 is a view of a cook later cook method selection screen in accordance with the present invention;

FIG. 112 is a view of a cook later set eating time selection screen in accordance with the present invention;

FIG. 113 is a view of a cook later confirmation screen in accordance with the present invention;

FIG. 114 is a view of a cook later refrigerate before cooking selection screen in accordance with the present invention;

FIG. 115 is a view of a cook later preheat and cook adjust screen in accordance with the present invention;

FIGS. 116-118 generally illustrate flowcharts for the cook now probe cooking screen architecture in accordance with the present invention;

FIG. 116 is a flowchart illustrating the cook now probe cooking screen architecture in accordance with the present invention;

FIG. 117 is a flowchart illustrating the cook now screen architecture in accordance with the present invention;

FIG. 118 is a flowchart illustrating the cook now probe cooking architecture in accordance with the present invention;

FIGS. 119-122 generally illustrate an embodiment of the cook now probe cooking screen architecture according to FIGS. 116-118;

FIG. 119 is a view of a cook now probe cooking cook method selection screen in accordance with the present invention;

FIG. 120 is a view of a cook now probe cooking set meat weight and time adjust screen in accordance with the present invention;

FIG. 121 is a view of a cook now probe cooking confirmation screen in accordance with the present invention;

FIG. 122 is a view of a cook now probe cooking status screen in accordance with the present invention;

FIGS. 123-125 generally illustrate flowcharts for the cook later probe cooking screen architecture in accordance with the present invention;

FIG. 123 is a flowchart illustrating the cook later probe cooking screen architecture in accordance with the present invention;

FIG. 124 is a flowchart illustrating the cook later probe cooking screen architecture in accordance with the present invention;

FIG. 125 is a flowchart illustrating the cook later probe cooking screen architecture in accordance with the present invention;

FIGS. 126-131 generally illustrate an embodiment of the cook later probe cooking screen architecture according to FIGS. 123-125;

FIG. 126 is a view of a cook later probe cooking cook method selection screen in accordance with the present invention;

FIG. 127 is a view of a cook later probe cooking set eating time selection screen in accordance with the present invention;

FIG. 128 is a view of a cook later probe cooking confirmation screen in accordance with the present invention;

FIG. 129 is a view of a cook later probe cooking meat guide screen in accordance with the present invention;

FIG. 130 is a view of a cook later probe cooking set oven temperature selection screen in accordance with the present invention; and

FIG. 131 is a view of a cook later probe cooking set probe temperature adjust screen in accordance with the present invention.

### DETAILED DESCRIPTION OF PREFERRED EXAMPLE EMBODIMENTS

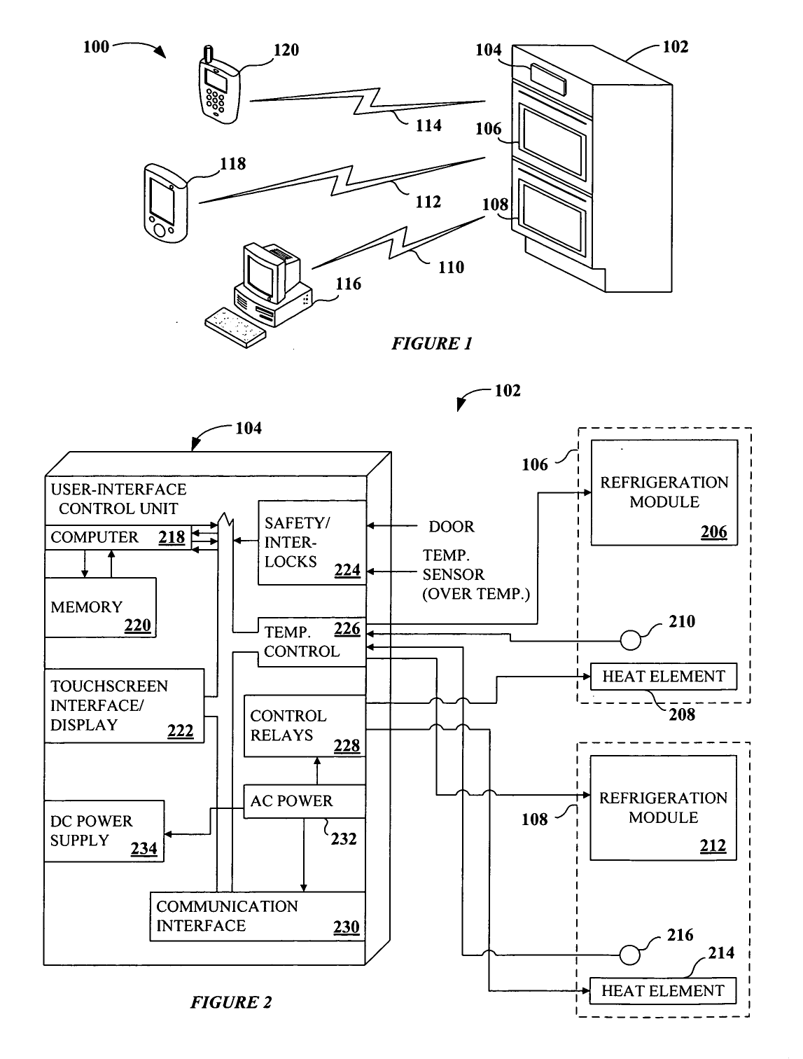

The subject application is directed to control systems for cooking appliances. More particularly, the subject application is directed to a control interface for food preparation and a method for food preparation using the control interface. FIG. 1 illustrates an exemplary system 100 employing the present invention. In the preferred embodiment of the present invention, the control interface is implemented as a graphical user-interface (“GUI”).

As shown in FIG. 1, the system 100 includes one or more remote devices, illustrated as a desktop computer 116, a personal data assistant (PDA) 118, and a web-enabled cellular telephone 120. The system also includes a cooking appliance 102. In the preferred embodiment, the cooking appliance 102 suitably comprises a refrigerator/oven, capable of both refrigerating and cooking food items. The cooking appliance 102 further comprises a top compartment 106, suitably equipped for both heating and cooling a food item, a bottom compartment 108, suitably equipped for both heating and cooling a food item, independent of the top compartment 106, and a user-interface control unit 104, suitably adapted to control both the top and bottom compartments 106, 108, accept locally input commands, and communicate with the remote devices 116-120. As will be appreciated by those skilled in the art, the cooking appliance 102 is capable of being a microwave/refrigerator combo, a microwave oven, conventional oven, and any other suitable cooking appliance known in the art.

The user-interface control unit 104 suitably includes the GUI to facilitate control of the cooking appliance 102. As will be understood by those skilled in the art, the GUI suitably enables the user to direct and control a plurality of cooking appliance operations, such as a refrigeration operation, a cook now operation, a cook later operation, and the like, by interacting with at least one of a plurality of GUI-accessible layers of screens. Each layer suitably corresponds to a different cooking appliance operation and suitably includes a plurality of user selectable and manipulatable cooking settings and operational parameters. Various example cooking operations and example cooking settings will be more fully discussed below with reference to the example drawing and figures included herewith.

In the preferred embodiment, the GUI is suitably adapted to be integrated with and accessible through the cooking appliance 102, the remote devices 116-120, a network connection, through one or more of the foregoing, or through any suitable means as known to one of ordinary skill in the art. As shown in FIG. 1, the remote devices 116-120 are suitably adapted to communicate with the cooking appliance 102 via a variety of communications means. As illustrated in FIG. 1, for example and without limitation, the web-enabled cellular telephone 120 suitably communicates with the cooking appliance 102 via communications link 114. As will be understood by the skilled artisan, the communications link 114 is capable of being a direct wireless connection, such as IEEE802.11x, 802.16x, 802.20x, Bluetooth, and other like protocols, a direct modem connection to the cooking appliance 102, via TDMA, CDMA, GSM protocols, the Internet, e.g., IP, TCIP protocols, and the like. The skilled artisan will further appreciate that the present invention is capable of employing a third-party server to facilitate communication between the cooking appliance 102 and the cellular telephone 120, particularly when the cellular telephone 120 is not capable of directly connecting to the Internet. In such circumstances, the cellular telephone 120 would establish a call to the third-party server (not shown) and via touch-tone menu options, interact with the GUI of the user-interface control unit 104 of the cooking appliance 102. Thus, the user is able to access the cooking appliance 102 using an ordinary telephone, a cellular telephone and a web-enabled cellular telephone.

It will also be appreciated by those skilled in the art that the PDA 118 is suitably adapted to communicate with the cooking appliance 102 via communications link 112. As the skilled artisan will understand, the communications link 112 is any suitable communications channel known in the art capable of facilitating the transmission and receipt of digital signals as is known in the art. In the preferred embodiment, the communications link 112 is one of infrared, radio-frequency, IEEE802.11x, 802.16x, 802.20x, Bluetooth, the Internet, and the like. In an alternate embodiment, the PDA 118 is suitably adapted to include a cellular telephone feature, wherein the PDA 118 communicates with the cooking appliance 102 via the means described above with respect to cellular communications.

The skilled art artisan will appreciate that the personal computer 116 is suitably adapted to communicate with the cooking appliance 102 via communications link 110. As will be understood by those of ordinary skill in the art, the personal computer 116 is suitably equipped with an appropriate network interface card or modem to enable connection between the computer 116 and the cooking appliance 102 via the communications link 110. In the preferred embodiment, both the cooking appliance 102 and the personal computer 116, communicate via the Internet. As will be understood by those skilled in the art, the communications link 110 is suitably one of an Ethernet connection, IEEE802.11x, 802.16x, 802.20x, or other communications channel known in the art and capable of connecting the personal computer 116 to the Internet.

According to an example embodiment, the cooking appliance 102 suitably includes or is associated with a monitor, an LCD screen or other suitable display means, as known to one of ordinary skill in the art, adapted to display the GUI of the present invention, as shown in FIG. 1. According to another example embodiment, the GUI is accessible through network connections 110-114 via remote devices 116-120, respectively. As previously explained, the cooking appliance 102 suitably is interconnected to a network, such as a local area network, a wide area network, an Internet-connected network, and the like, through any suitably means. The GUI is employed in any suitable manner, such as through a locally or remotely connected computer 116, to direct and control the cooking appliance. Additionally, the computer readable medium of instructions that correspond to and encode the GUI are stored in any suitable storage device, such as in a server (not shown) connected to the cooking appliance 102, a user-interface controller 104 integrated with the cooking appliance 102, a storage device (not shown) integrated with the cooking appliance 102.

In accordance with the implementation of the GUI as integrated with the cooking appliance 102, the GUI suitably is a touch screen activated GUI, illustrated in FIG. 1 as being comprised in the user-interface controller unit 104. Turning now to FIG. 2, there is shown a block diagram illustration of the cooking appliance 102 including the user-interface control unit 104. As shown in FIG. 2, the cooking appliance 102 includes a top cooling/cooking chamber 106, a bottom cooling/cooking chamber 108 and the user-interface control unit 104. The skilled artisan will appreciate that the use of dual cooling/cooking chambers 106, 108 is for illustration purposes only and the present invention is equally adaptable to a single chamber, as well as a number of chambers greater than two, without departing from the scope of the invention.

As shown in FIG. 2, the top cooling/cooking chamber 106 suitably includes a refrigeration module 206, one or more heating elements 208, and one or more probes 210. The refrigeration module 206 suitably comprises a closed-loop system that uses a fluid, or refrigerant, to move heat from one place to another. The skilled artisan will appreciate that any refrigeration module known in the art is suitably capable of being implemented in accordance with the present invention. The one or more heating elements 208 is suitably in communication with the user-interface control unit 104, which functions to control operations of the cooking appliance 102, as well as communicate with an associated user through a remote device, as discussed above. The heating elements are connected to control relays 228, which are capable of being activated and deactivated according to the temperature control 226. The skilled artisan will appreciate that any heating element known in the art, including and without limitation, electric resistive elements, gas burners, microwave, radiated heat elements, infra red, and the like, are capable of being used to cook food in the cooking appliance 102. The one or more probes 210 are suitably used to gauge the internal temperature of food items during cooking and/or cooling, as well as to ascertain the ambient temperature at a given time within the top chamber 106.

Similar to the top chamber 106 of the cooking appliance 102, the bottom chamber 108 also includes a refrigeration module 212, one or more heating elements 214 and one or more probes 216. In the preferred embodiment, the refrigeration modules 206 and 212 are independent modules, enabling the top chamber 106 and the bottom chamber 108 to maintain different temperatures. As set forth above with respect to the top chamber 106, the refrigeration module 212 of the bottom chamber 108 is also a closed-loop system using a fluid-based refrigerant. The one or more heating elements 214 of the bottom chamber 108, which are suitably electric resistive elements, gas burners, microwave, radiated heat elements, infra red, and the like, are connected to the control relays 228, which are activated or deactivated according to the temperature control 226. The one or more probes 216 are suitably disposed within the bottom chamber 108 and are suitably used to gauge the internal temperature of food items during cooking and/or cooling, as well as to determine the ambient temperature within the bottom chamber 108.

As previously mentioned, the user-interface control unit 104 suitably functions to control communications with remote devices 116-120 and an associated user, as well as to control heating and cooling operations within the top chamber 106 and bottom chamber 108 of the cooking appliance 102. FIG. 2 provides an illustrative block diagram of the various components of the user-interface control unit 104. As will be understood by those skilled in the art, the components described herein are capable of being contained on a single-board computer, a personal computer, an application specific integrated circuit as known in the art. The user-interface control unit 104 includes an AC power supply 232, drawn from the electric power supplied to the cooking appliance 102. The skilled artisan will appreciate that the voltage of the user-interface control unit 104 will differ from the voltage required for the heating elements 210 and 214, as well as the refrigeration modules 206 and 212, and therefore a suitable transformer (not shown) or the like is used to step-down the voltage as needed. The AC power supply 232 is connected to the control relays 228, the communication interface 230 and the DC power supply 234.

The skilled artisan will appreciate that control relays 228 are suitably supplied with power from the AC power supply 232. The DC power supply 234 receives input voltage from the AC power supply 232 and suitably converts to DC and steps up/steps down the output DC voltage as needed to supply power to the various electrical control components contained within the user-interface control unit 104. In one embodiment of the present invention, the user-interface control unit 104 receives data and instructions via a Powerline network. Thus, data and instructions are transmitted via the electrical supply line to the cooking appliance 102 and received by the communication interface 230. In the preferred embodiment, the communication interface 230 suitably comprises a network interface card, or the like, to connect the user-interface control unit 104 to a home computer network, a local area computer network, a wide area computer network, the Internet, and the like.

The user-interface control unit 104 of FIG. 2 also includes a computer 218 and associated memory 220. The skilled artisan will appreciate that the computer 218 is any suitable microprocessor based computing device known in the art. The associated memory 220 is any suitable data storage known in the art, including without limitation, flash memory, magnetic storage, optical storage, and the like. The skilled artisan will further appreciate that the computer 218 and associated memory 220 suitably act in concert to control the cooking appliance 102. In addition, the computer 218 and the associated memory 220 further control the touch screen interface display 222, including the presentation of the GUI of the present invention. As shown in FIG. 2, the computer 218 advantageously interacts with the other components of the user-interface control unit 104 via any suitably data interconnect known in the art. In addition to the other components of the user-interface control unit 104, a safety/interlock 224 component is included in the cooking appliance 102 to access to the top chamber 106 and the bottom chamber 108 during heating/cooling operations. Various inputs, such as door sensors and temperature sensors, are included to control, for example, when an oven is able to be opened following a cleaning cycle and the like. It will be apparent to those skilled in the art that other controls not shown are equally capable of being implemented in accordance with the present invention, without departing from the scope of the present invention.

In accordance with one aspect of the present invention, the touchscreen interface 222 further includes a notepad, such as an electronic message center, suitably adapted to receive, store, and display messages written from one household member to another. In addition, the message center is further accessible from a remote location, such as, for example and without limitation, a remote desktop computer, a portable handheld device, a cellular telephone, a smart phone, an Internet kiosk, or the like. It will be understood by those skilled in the art that the following screen architecture is capable of being viewed from any of the above-identified devices remotely, with data relayed via a suitable communications network, such as for example and without limitation, the Internet, the public switched telephone network, a local area network, a wide area network, a personal area network, and the like.

Further in accordance with the present invention, the cooking appliance 102 is suitably adapted, via any means known in the art, to receive software updates, patches, upgrades, and the like, via a connection to backend servers (not shown) operated by a service provider. In accordance with this embodiment, the backend servers “push” updates, patches, and the like, to the cooking appliance 102 via the Internet, public switched telephone network, or other suitable communications network. Preferably, the cooking appliance 102 is further capable of requesting, on a predetermined basis, such as daily, updates, patches, or other software upgrades from the service provider.

Alternate embodiments of the instant invention include a “panic” icon, accessible from the main screen of the graphical user interface, as described below, which allows the user to request take-out, delivery, or other food services from a variety of local food service providers. Preferably, the location of the cooking appliance 102 is programmed, as explained in further detail below, which enables the appliance 102 to locate nearby restaurants using the communications network to which it is connected. Further adaptations of the instant invention will become readily apparent to the skilled artisan upon analysis of the detailed description of the graphical user interface of the present invention.

Main Screen Architecture

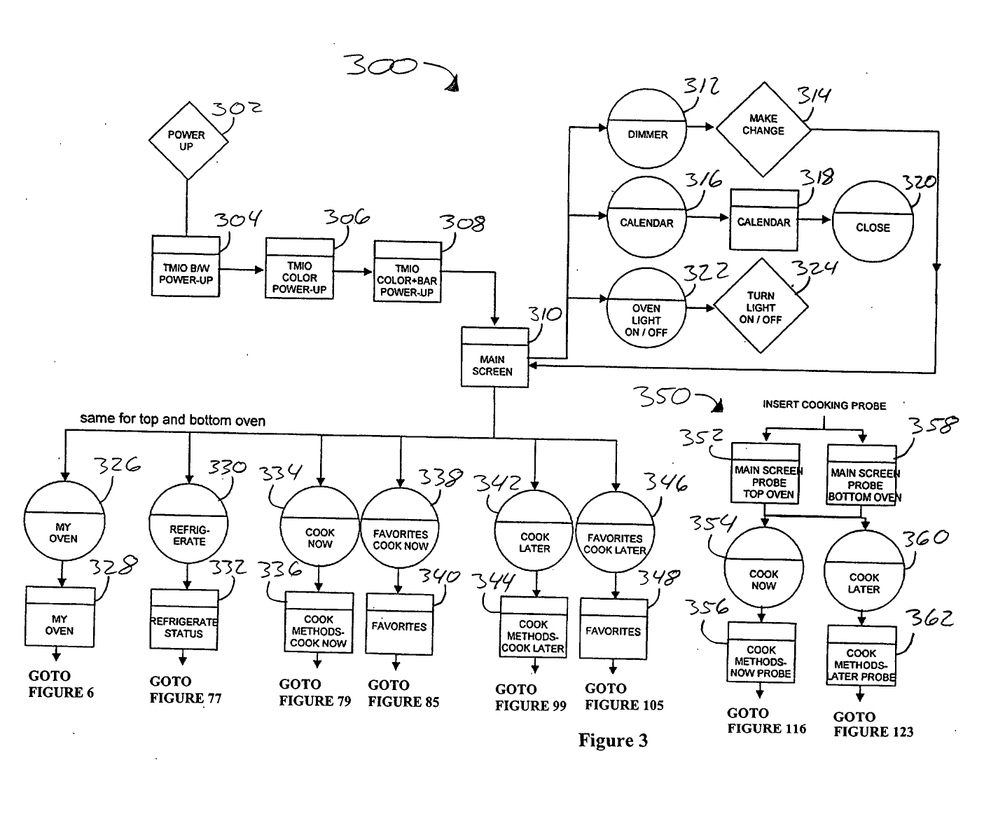

Turning now to FIG. 3 there is shown a flowchart illustrating the main screen architecture used in accordance with the present invention. Operations of the cooking appliance 102 begin at step 302 wherein the cooking appliance 102, and particularly the user-interface control unit 104, begin power-up/activation. During the power-up of step 302, the computer 218 boots using any suitable BIOS as is known in the art and accesses the associated memory 220. The GUI software is retrieved from the associated memory 220 and the GUI is initiated on the touchscreen 222 of the cooking appliance 102. During power-up of the cooking appliance 102, a black-and-white logo screen is displayed to the user at step 304, followed by a color logo screen at step 306 and a color bar power-up screen at step 308. Following power-up, a main screen of the GUI is displayed at step 310. As will be understood by those skilled in the art, the main screen of the GUI facilitates interaction between the cooking appliance 102 and the user.

It will be appreciated by those skilled in the art that a plurality of configurations are contemplated for interacting with the GUI in addition to the touchscreen 222 embodiment. For example, the GUI is suitably adapted to be implemented in a monitor and an associated input peripheral (e.g., mouse, rollerball, keyboard, etc.) configuration such that each graphical icon is selectable through the associated input peripheral. Although various input configurations are contemplated, reference will be made throughout to the touch screen example embodiment.

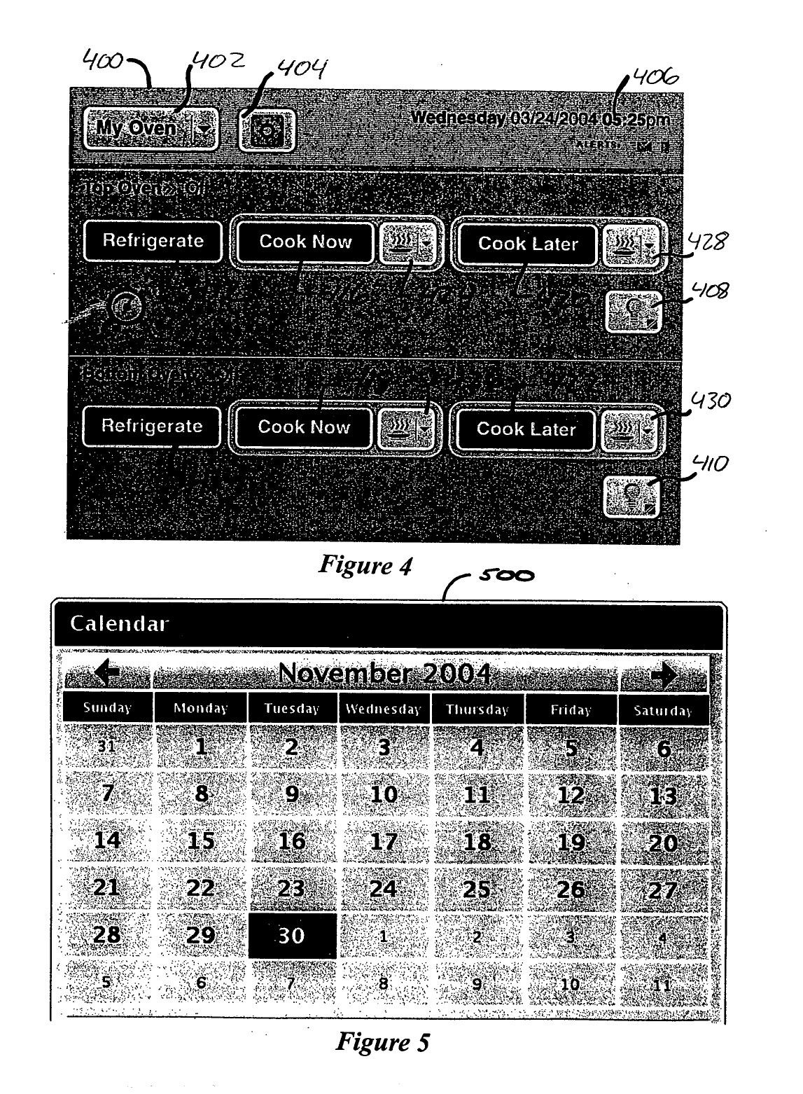

FIG. 4 illustrates a main screen 400 corresponding to the screen architecture of FIG. 3. The main screen 400 of the GUI suitably includes a plurality of user-selectable buttons, corresponding to various actions and menus in accordance with the screen architecture shown in the flowchart 300 of FIG. 3. Main screen 400 suitably operates as a high level portal screen through which all layers of the GUI are accessible. The GUI is advantageously composed in a format such that the user first selects a desired cooking operation and then, upon so selecting, specifies settings for controlling and directing the cooking operation. Accordingly, the control screen 400 suitably includes a plurality of graphical icons corresponding to a various cooking operations. According to an example embodiment, at least three cooking operations are contemplated, a refrigeration operation, a cook now operation, and a cook later operation.

As will be more fully described herein, each screen of the GUI includes at least one user selectable feature corresponding to an action to be taken by the GUI and/or the cooking appliance 102. Preferably, a graphical icon, such as a button-like icon, suitably embodies each user selectable feature. Accordingly, each feature is activated by the user touching or depressing an area of the displayed screen corresponding to a location of the desired graphical icon. Thus, the main screen 400 includes a my oven icon 402, a dimmer icon 404, date/time/calendar icon 406, a top oven light icon 408, a bottom light icon 410, a top oven refrigerate icon 412, a bottom oven refrigerate icon 414, a top oven cook now icon 416, a bottom oven cook now icon 418, a top oven cook later icon 420, a bottom oven cook later icon 422, a top oven cook now favorites icon 424, a bottom oven cook now favorites icon 426, a top oven cook later favorites icon 428, a bottom oven cook later favorites icon 430, and a probe icon 432. Each of the aforementioned icons 402-432 correspond to a feature or operation of the cooking appliance 102, the selection of which results in the display of a layer of screens associated with the corresponding cooking operation.

In one embodiment of the present invention, the cooking appliance 102 includes one or more probes 210, 216, which when inserted into a food item, automatically generates a graphical representation of the temperature for the corresponding chamber 106, 108, illustrated in FIG. 4 as the probe icon 432. Similarly, a graphical representation of a temperature probe is capable of being displayed for the bottom chamber 108 as well. The skilled artisan will appreciate that FIG. 3 includes additional steps when the user inserts the probes 210, 216, shown at 350. To maintain appropriate flow in the description of the present invention, discussion of the steps contained in 350 will follow the description of the preceding steps of the flowchart 300 of FIG. 3.

Following the display of the main screen 400 at step 310, the GUI awaits user selection of one or more features capable of being performed by the cooking appliance 102. The user is presented with a variety of options from the main screen 400 at step 310, as shown in FIG. 4. When the user selects the dimmer icon 404 at step 312, the amount of backlighting, i.e., the brightness, of the touchscreen 222 is reduced at step 314 and the GUI returns to the main screen 400 at step 310. When the user selects the calendar icon 406 at step 316, a separate calendar screen, shown in FIG. 5 as 500, is displayed at step 318. The skilled artisan will appreciate that screen 500 is shown in FIG. 5 as a popup window, however, other graphical transitions, such as folders and the like, are equally capable of being used in the present invention to facilitate the transition from one screen to the next. The skilled artisan will also appreciate that the calendar screen 500 enables the user to set the correct date for the cooking appliance. In one particular embodiment, the user selects the calendar icon 406 to select a day on which a cooking operation is to occur. Once the user is satisfied with the date selected, or wishes to exit the calendar screen 500, the user closes the calendar screen at step 320 via any suitable means known in the art. Flow then returns from step 320 to step 310, wherein the main screen 400 is suitably displayed.

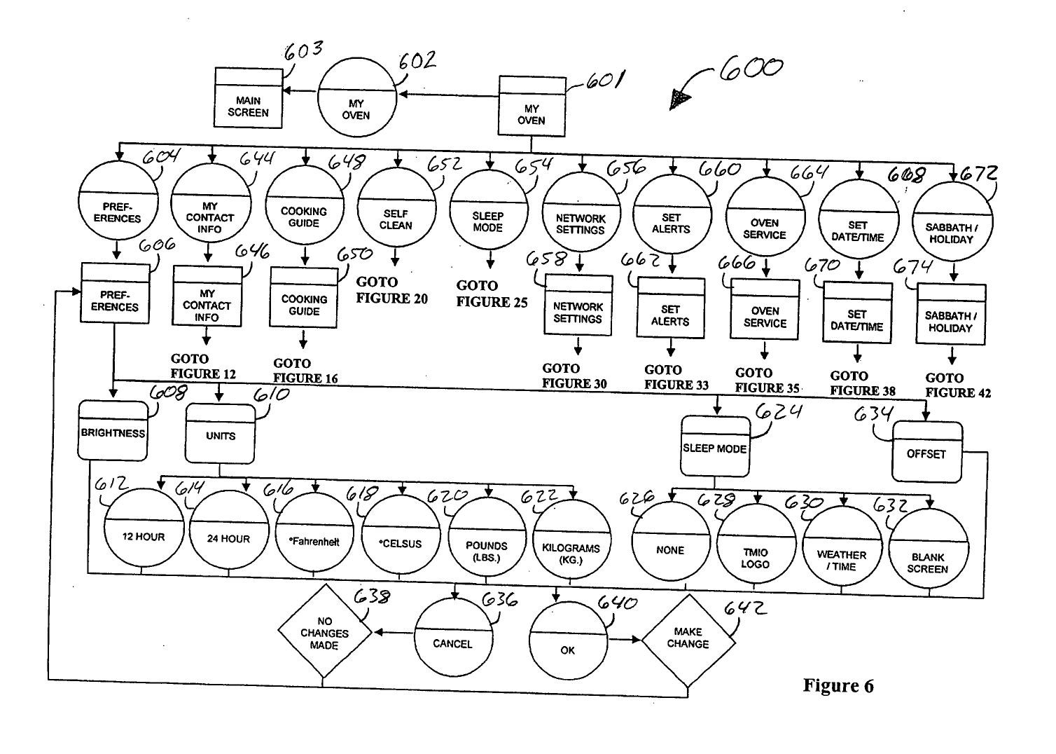

The user is able to select, from the main screen 400, the my oven icon 402 at step 326. When the user selects the my oven icon 402 at step 326, flow proceeds to step 328, where a my oven popup window is displayed. The skilled artisan will appreciate that the nature of the screen architecture of the subject invention uses a multi-layered approach in displaying various screens. It will be understood that other approaches, as known in the art, are equally capable of being employed by the subject invention. The my oven icon 402 of the main screen 400 suitably links the main screen 400 with a my oven screen, which is displayed at step 328 to the user on the touchscreen 222. The my oven screen architecture and related screen display templates will be more fully explained below with respect to FIG. 6.

From the main screen 400, the user is able to select, at step 330, either the refrigerate icon 412 or the refrigerate icon 414. For purposes of brevity, operation of the appliance 102 will now be described with reference to both chambers 106, 108, unless expressly stated otherwise. Thus, when discussing the operation of the refrigerate icon 412 hereinafter, it is to be inferred that similar operations, screen architectures, and screens apply to the selection of the refrigerate icon 414 corresponding to the bottom chamber 108. Upon user selection of the refrigerate icon 412, a refrigerate status popup window is displayed at step 332. The skilled artisan will appreciate that methods other than popup windows are capable of being employed by the present invention to indicate the transition among the several screens and the present invention need not be limited to the popup implementation. The refrigerate status screen architecture will be more readily understood by those skilled in the art with respect to FIG. 77, more fully explained below.

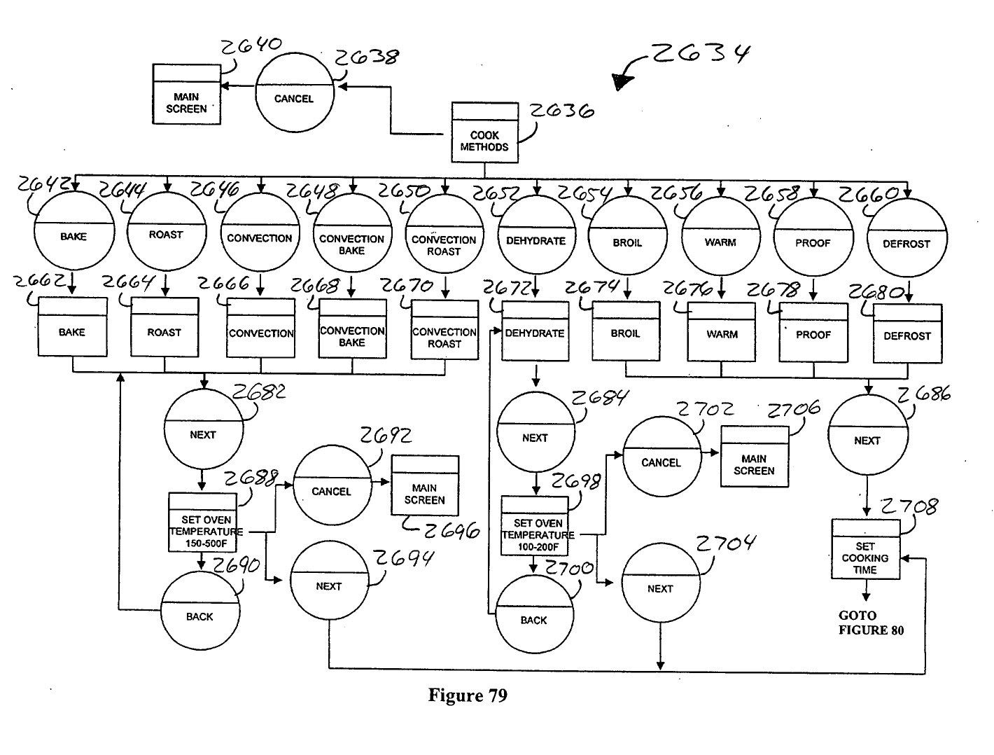

Returning to the main screen 400 of the present invention, when the user selects, at step 334, the cook now icon 416 for the top chamber 106 or the cook now icon 418 for the bottom chamber 108, a cook methods—cook now screen is advantageously displayed at step 336 to the user on the touchscreen 222. The cook methods—cook now screen architecture and related screen display templates will be more fully explained below with respect to FIGS. 79-84. As previously stated, the cook methods—cook now screen architecture and related screen display templates illustrated in FIGS. 79-84 are equally applicable to the bottom chamber 108, accessible via the cook now bottom chamber icon 418.

From the main screen 400 at step 310, the user is able to access the favorites cook now icon 424, 426. Upon user selection of the icon cook now favorites icon 424 at step 338, a suitable screen template is then displayed at step 340. The architecture by which the favorites are displayed will be more readily apparent to those skilled in the art when viewed in connection with FIGS. 85-88, discussed more fully below. As will also be understood by those skilled in the art, the term “favorites” is used herein to refer to a dish or recipe that is frequently accessed by the user, is pre-selected by the user, or otherwise determined and typically includes cooking times and temperatures to cook and/or cool the food item thereon.

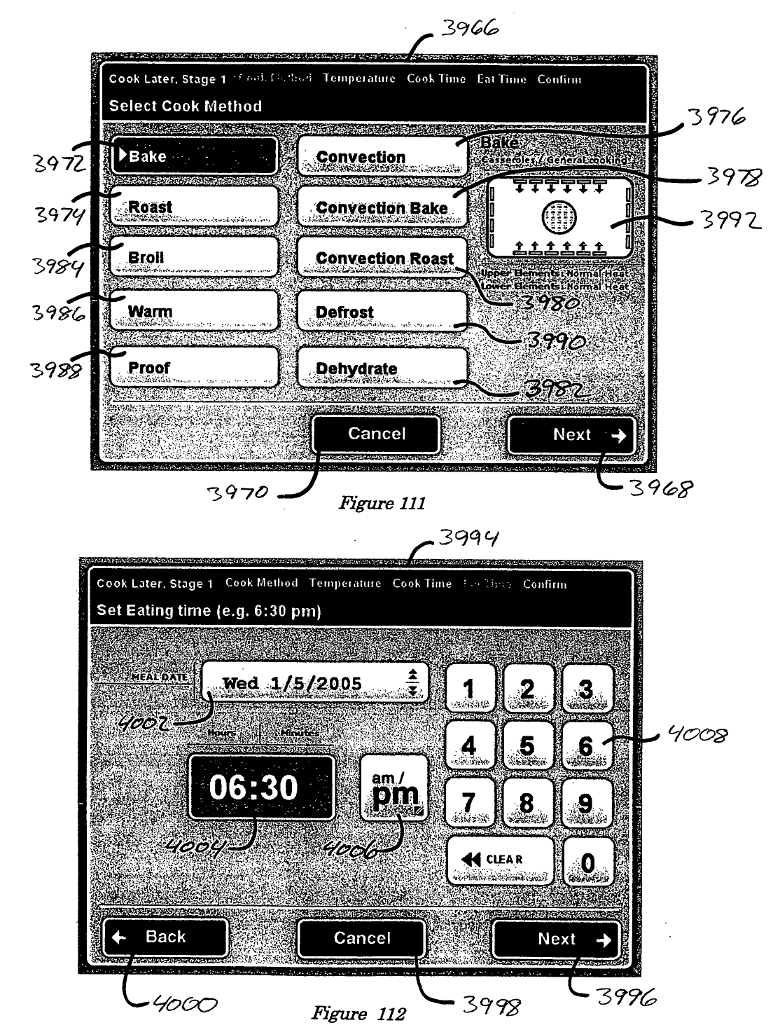

As previously discussed, the cooking appliance 102 is capable of both refrigeration and heating operations. Thus, the user is presented at step 310 on the main screen 400 the ability to select the cook later icons 420, 422. It will be appreciated by those skilled in the art that the cook now icon 416 is capable of being selected for the top chamber 106 while the cook later icon 422 is selected for the bottom chamber 108, thus enabling simultaneous cooking in the top chamber 106 and cooling in the bottom chamber 108, and vice versa. Returning to FIG. 3, at step 342, the user selects the cook later icon 420 via any means known in the art. Upon user selection of the cook later icon 420, a cook methods—cook later screen is suitably displayed to the user on the touchscreen 222 at step 344. The cook methods—cook later screen architecture and related screen display templates will be more fully explained below with respect to FIGS. 111-115.

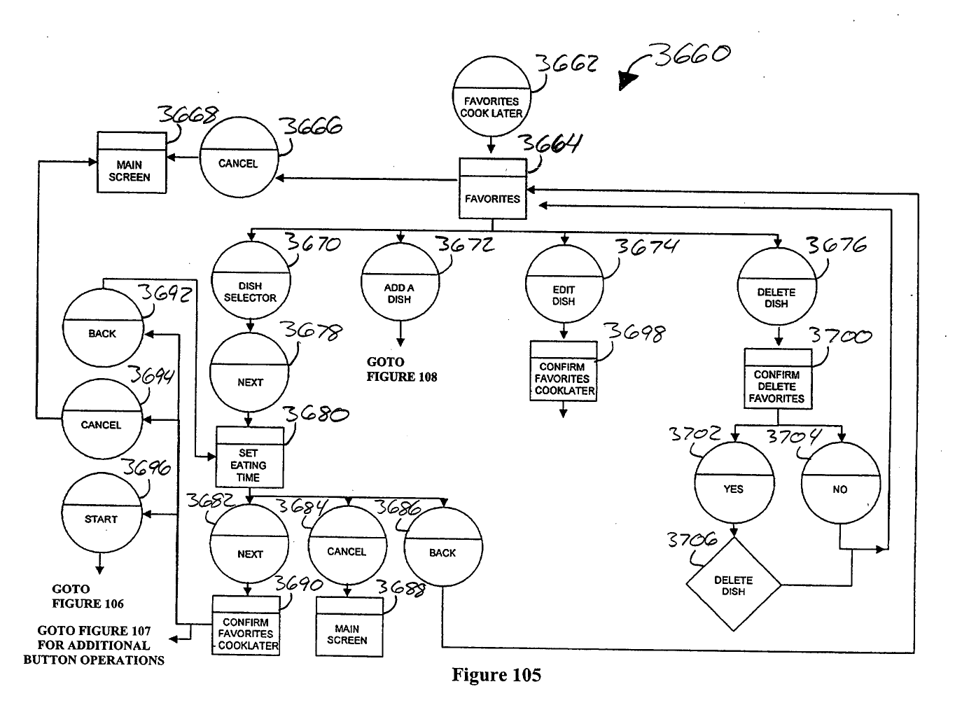

From the main screen 400, when the user selects the favorites cook later icon 428 at step 346, a favorites screen is displayed to the user on the touchscreen 222 at step 348. The skilled artisan will appreciate that while the graphics contained on the favorites screen displayed to the user at step 348 is similar to the favorites screen displayed at step 340, the screen architecture of the cook later favorites screen will differ in accordance with the screen architecture illustrated in FIGS. 105-110. As will be explained in greater detail below, FIGS. 105-110 correspondingly illustrate the steps and screen architecture consistent with the cook later favorites application in accordance with the present invention. As previously designated, the screen architecture and methodology contained within FIGS. 105-110 are equally applicable to the top chamber 106 and the bottom chamber 108 of the cooking appliance 102.

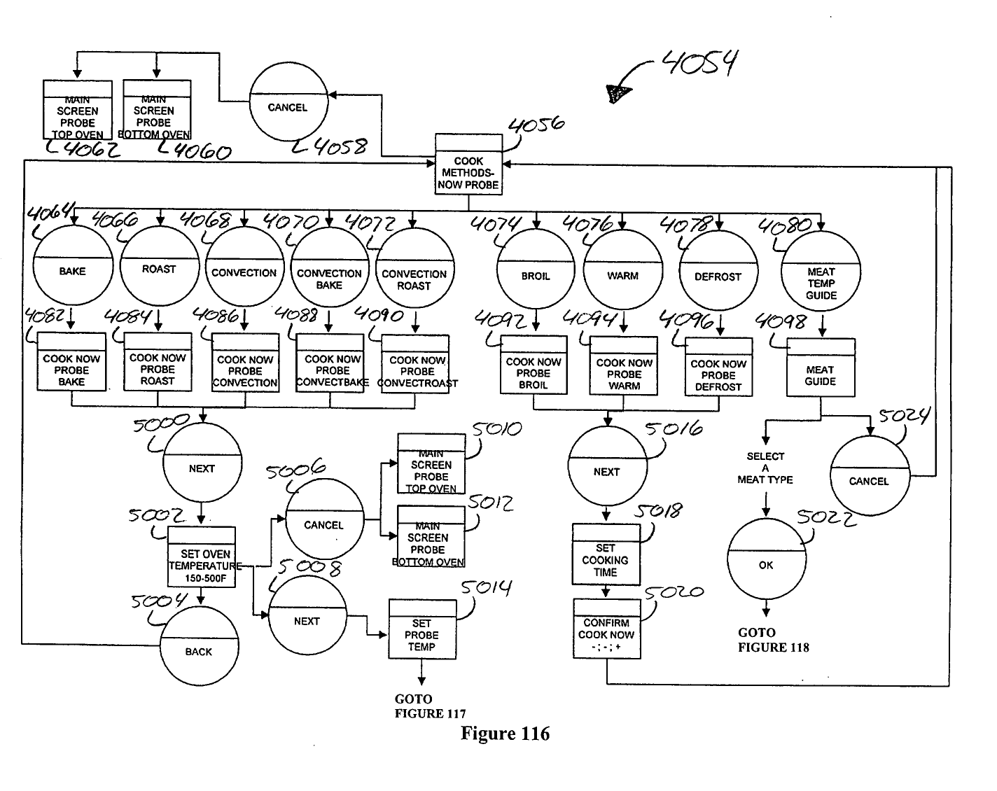

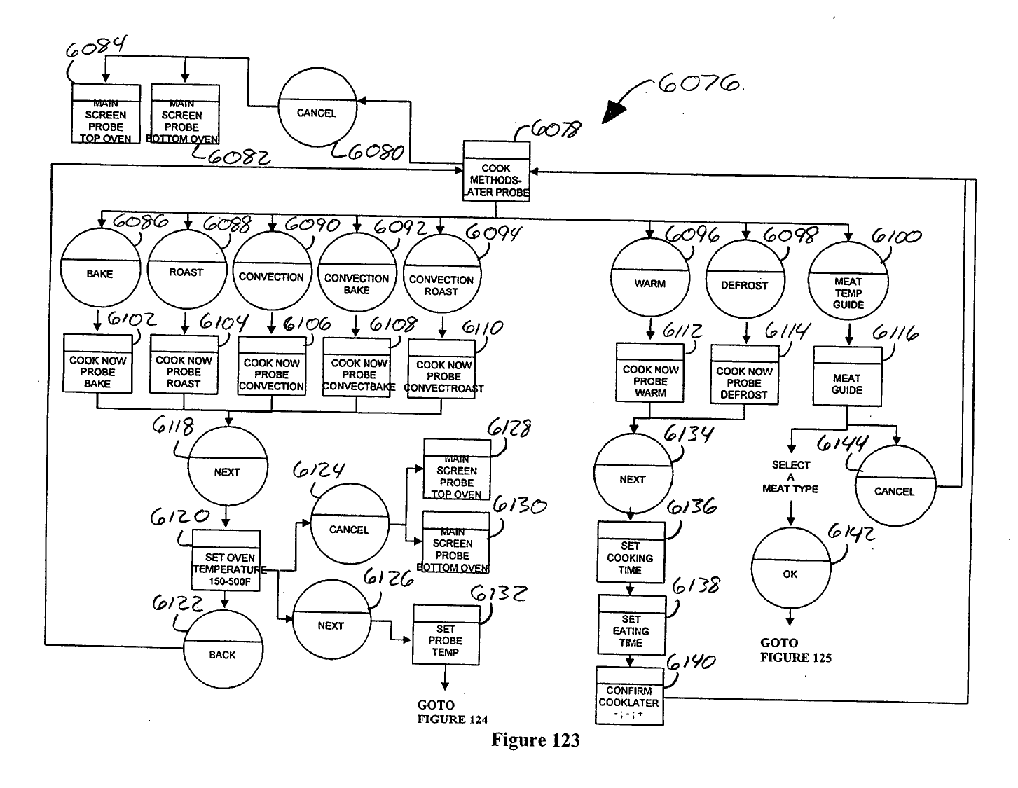

As discussed above with respect to the inclusion of the probe icon 432 of FIG. 4, the flow chart illustrating the main screen architecture of the present invention of FIG. 3 suitably includes a separate flowchart 350 depicting the insertion of probes 210, 216 into a cooking item in the top chamber 106 and the bottom chamber 108, respectively. Probes 210, 216 are suitably inserted into a food item contained in respective chambers 106, 108 of the cooking appliance 102. At step 352, the probe 210 has been inserted into a food item present in the top chamber 106. Accordingly, step 352 provides for the generation of the probe icon 432. Following display of the probe icon 432, the user suitably selects the cook now icon 416 at step 354, or selects the cook later icon 420 at step 360. When the user has selected the cook now icon 416 following insertion of the probe 210 in the top chamber 106, a cook methods—now probe screen is suitably displayed at step 356. The screen architecture enabling such display is advantageously discussed more fully below with respect to FIGS. 116-118. When the user selects the cook later icon 420 for the top chamber 106 at step 360, a cook methods—later probe is suitably displayed at step 362. The screen architecture enabling the display of the cook later probe screens is illustrated and explained more fully below with respect to FIGS. 123-125.

Returning to step 358, the bottom probe 216 is inserted into a food item in the bottom chamber 108, the screen architecture 300 of the main screen 400 enables the same selections as previously discussed for the top chamber 106. Thus, when the user selects the cook now icon 418 at step 354 following insertion of the probe 216 into the food item within the bottom chamber 108, the cook methods—now probe screen architecture is implemented at step 356 in the same manner as previously established with respect to the top chamber 106 probe 210. The screen architectures illustrated in FIGS. 116-118 and 123-125 are equally applicable to the insertion of the bottom probe 216 as to the top probe 210, discussed above.

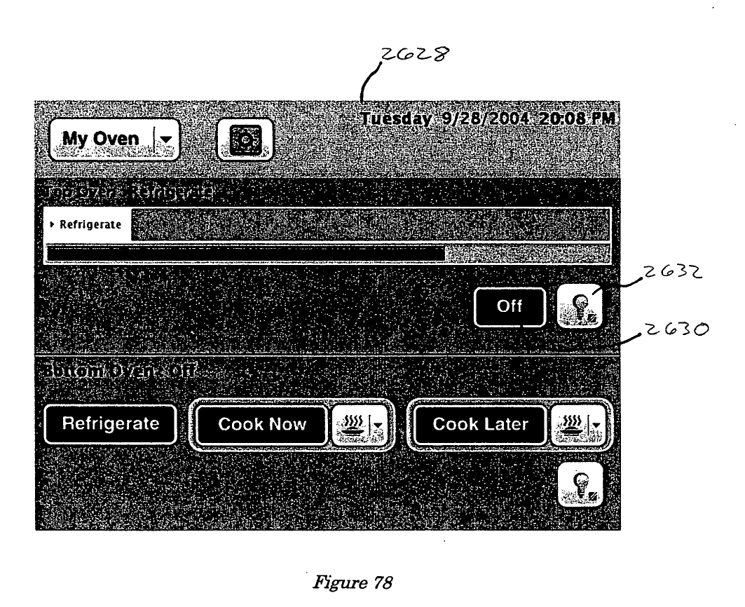

Having thus described the available linking architecture displayed to the user via the main screen 400, discussion now turns the subsequent screen architecture below that of the main screen architecture of FIG. 3. For example, where reference was made above to one or more subsequent screen architectures, such as FIG. 6, or FIG. 78, discussion and explanation thereof now ensues.

My Oven/Preferences Architecture

Referring now to FIG. 6, there is shown a my oven screen architecture 600, accessible from the main screen 400 of FIG. 4 via the my oven icon 402. When selected by the user, the my oven icon 402 activates a my oven screen, illustrated in FIG. 7 as 700. The my oven screen 700 is suitably displayed at step 328 of FIG. 3 and for explanatory purposes herein, the my oven screen 700 is further referenced by step 601 of FIG. 6. The skilled artisan will appreciate that throughout this written description, various flowcharts of screen architectures will depend from each other, where this occurs reference to both the step in the current flowchart and the immediately preceding flowchart will be referenced thereon to ensure continuity of flow from one chart to the next. Thus, step 601 of FIG. 6 corresponds to the flow from step 328 of FIG. 3, from the main screen architecture 300 to the my oven subscreen architecture 600 of FIG. 6. Or, to state differently, flow proceeds from the main screen 400 upon user selection of the my oven icon 402 to the my oven screen 700.

Following display of the my oven screen 700 at step 601, the user is presented with a variety of options. These options, displayed on the my oven screen 700 are represented by various icons, including a preferences icon 704, a my contact info icon 706, a cooking guide icon 708, a self clean icon 710, a sleep mode icon 712, a network settings icon 714, a set alerts icon 716, an oven service icon 718, a set date/time icon 720, and a Sabbath/holiday icon 722. Also displayed on the screen 700 are the my oven icon 702 and the favorites icon 724. The my oven icon 702 facilitates the exiting of the my oven screen 700 and returns flow to the main screen 400. The favorites icon 724 facilitates transition to the favorites entry screen, more fully described below. Each of the set icons 704-722 of the my oven screen 700 correspondingly link the my oven screen 700 to a sub-screen, as is known in the art. It will be understood by those skilled in the art that the selection of the my oven icon 702 at step 602 returns display to the main screen 400 at step 603.

As shown in FIG. 6, following the display of the my oven screen 700 at step 601, the user is able to select from one of a group of sub-screens, corresponding to the icons 704-722 depicted on the my oven screen 700. Beginning at step 604, the user selects the preferences icon 704, which prompts the display of the preferences screen template at step 606. The preferences screen template is illustrated in FIG. 8 as 726. As shown in FIG. 8, the preferences screen 726 contains tabbed windows 728-734 corresponding to the different preference settings available in accordance with the present invention. The skilled artisan will appreciate that while tabbed windows are used, other techniques of switching between the various preference options are capable of being used without departing from the scope of the present invention. From the main preference screen 726 accessed at step 606, the user is presented with four main preference options, shown as tabs 728-734.

When the user has selected the brightness tab 728 from the main preference screen 726, at step 608 a brightness preference screen is suitably displayed. It will be understood by those skilled in the art that the brightness preference screen is displayed once the user has selected the preferences screen, i.e., it is the first selected tab 728 upon entry into the preference screen 726 from the my oven screen 700. As shown in FIG. 8, the brightness preference tab 728 suitably includes a sliding bar 740 representing the level of brightness viewable on the touchscreen 222. The skilled artisan will appreciate that other methods of adjusting the brightness of the touchscreen 222 are capable of being used in addition to the illustrated slide bar 740, including for example and without limitation, numerical reference, percentages and the like. The skilled artisan will further appreciate that as shown in FIG. 8, the user is able to adjust the contrast of the touchscreen 222 in addition to adjusting the brightness.

Once the user has made the desired adjustments to the brightness/contrast of the touchscreen 222, the user suitably selects the OK icon 738 at step 640 to implement the changes, which are then made to the display of the touchscreen 222 at step 842. In contrast, when the user desires not to accept the changes made to the display of the touchscreen 222, the user selects the cancel icon 736 at step 636, whereupon no changes are implemented to the display of the touchscreen 222 at step 638. In either case, whether changes to the brightness/contrast are made or canceled, flow proceeds back from steps 638 and 642 to the main preference screen 726 at step 606.

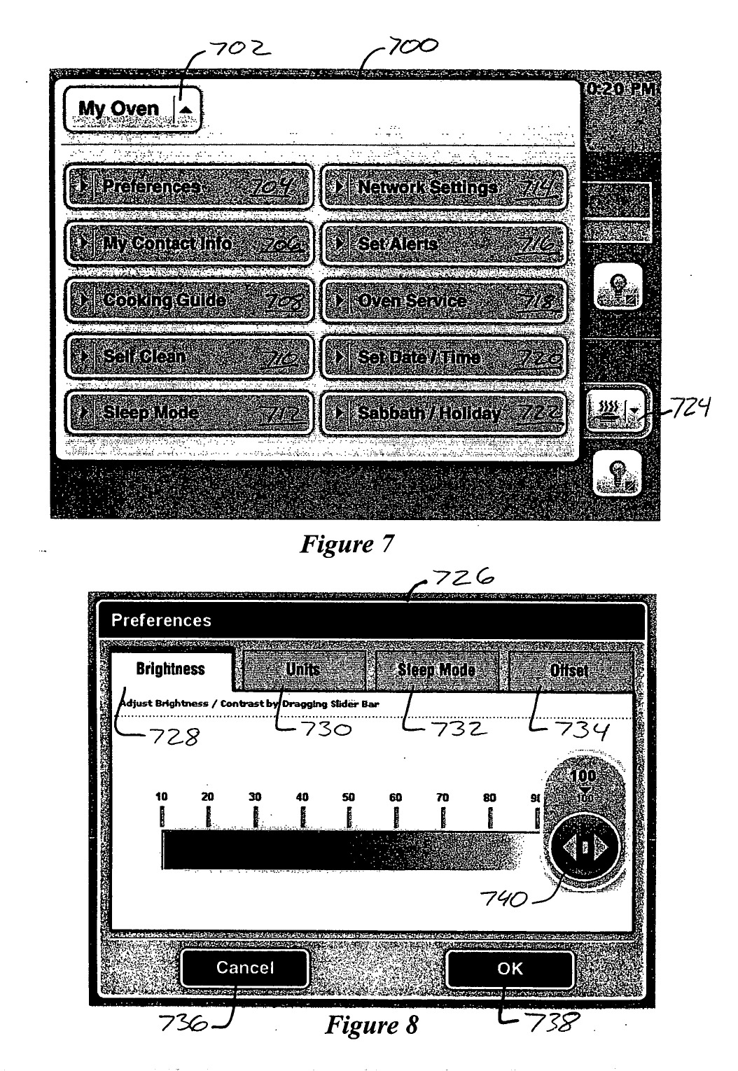

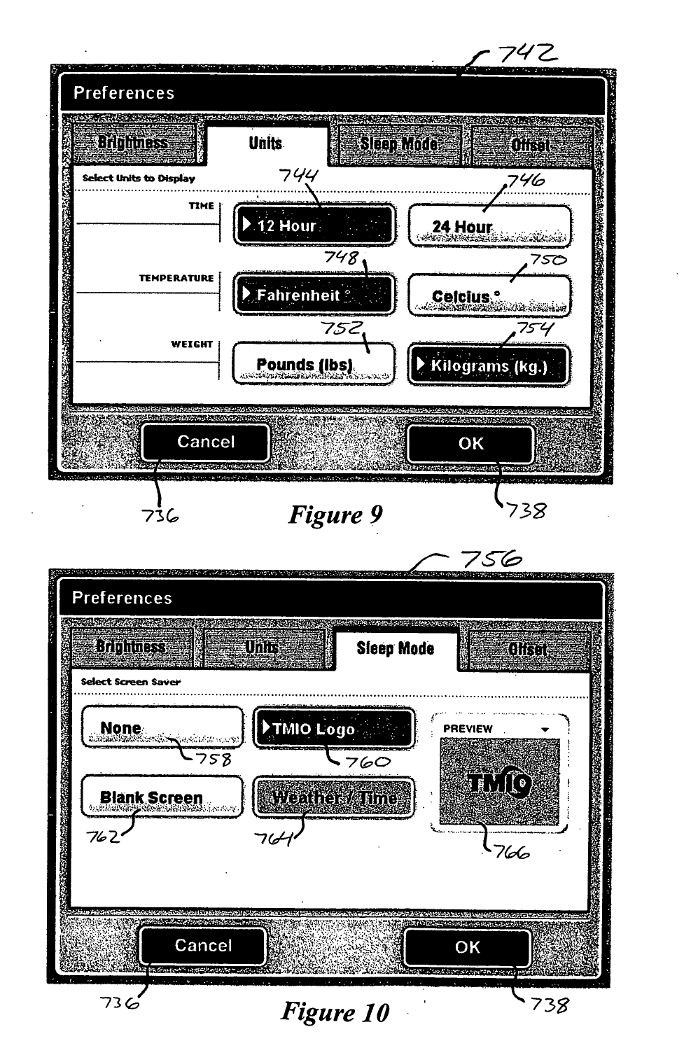

When the user desires to make a change to the type of units used by the cooking appliance 102, the user then selects the units tab 730 from the main preference screen 726, at step 610, upon which selection a units selection screen is displayed. FIG. 9 suitably illustrates the unit selection screen 742 in accordance with the present invention. As shown in FIG. 9, the unit screen 742 suitably includes user selectable icons representing the units to be input, displayed and used by the cooking appliance 102. As shown, the user is able to select the time display via the 12-hour icon 744 at step 612 or the 24-hour icon 746 at step 614, the unit of temperature to be used and displayed via the Fahrenheit icon 748 at step 616 or the Celsius icon 750 at step 618, and unit of weight to be used and displayed via the pound icon 752 at step 620 or the kilogram icon 754 at step 622. As the user selects the icon corresponding to the desired unit to be used, the icon changes fill pattern, illustrated in FIG. 9 as the selected 12-hour icon 744, the Fahrenheit icon 748 and the kilogram icon 754. Thus, the skilled artisan will appreciate that based upon the user selection of units, the display and input will be, for example, “2:00 PM, 350 F, 2.5 kg”, and the like.

Once satisfied with the selection, the user suitably selects the OK icon 738 at step 640 to implement the changes, which are then made to the display of the touchscreen 222 at step 642. When the user desires not to accept the changes made to the display of the touchscreen 222, the user selects the cancel icon 736 at step 636, whereupon no changes are implemented to the display of the touchscreen 222 at step 638. In either case, whether changes to the type of units used by the cooking appliance 102 are made or canceled, flow proceeds back from steps 838 and 642 to the main preference screen 726 at step 606.

When the user selects at step 606 the sleep mode tab 732, a sleep mode preference screen is suitably displayed at step 624. A template sleep mode screen 756 is illustrated in FIG. 10. As shown in FIG. 10, the sleep mode screen 756 corresponds to a user selectable screen display for the touchscreen 222 when the cooking appliance is not in use. Thus, the sleep mode screen 756 suitably includes graphical icons representing available screensavers for the touchscreen 222, including a none icon 758, a logo icon 760, a blank screen icon 762, and a weather/time icon 764. The sleep mode screen 756 further provides a preview display 766 of the selected icon 758-764. When the user selects at step 626, the none icon 758, the touchscreen 222 displays the main screen 400 in the preview display 766. When the user selects at step 628 the logo icon 760, the manufacturer logo is shown in the preview display 766. When the user selects, at step 630, the blank screen icon 762, a blackened screen is suitably depicted in the preview display 766. When the user selects the weather/time icon 764 at step 632, a weather and time is suitably shown in the preview display 766. It will be understood by those skilled in the art that the weather and time are advantageously retrieved from internal storage or via the Internet in accordance with the networking capabilities of the subject cooking appliance 102.

Once the user has made a selection via steps 626-632, the user selects the OK icon 738 at step 640 to implement the changes, which are then made to the display of the touchscreen 222 at step 642. When the user desires not to accept the changes made to the display of the touchscreen 222, the user selects the cancel icon 736 at step 636, whereupon no changes are implemented to the display of the touchscreen 222 at step 638. In either case, whether changes to the type of units used by the cooking appliance 102 are made or canceled, flow proceeds back from steps 638 and 642 to the main preference screen 726 at step 606.

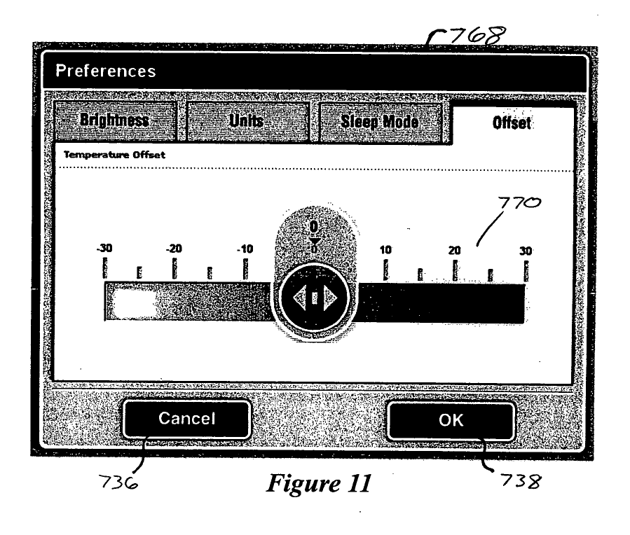

When the user selects the offset tab 734 from the main preferences screen 726, an offset setting screen is suitably displayed at step 634. A template temperature offset preference screen 768 is illustrated in FIG. 11. As shown in FIG. 11, the offset screen 768 includes a sliding scale 770 corresponding to the temperature offset desired by the user in accordance with the present invention. As the skilled artisan will appreciate, the sliding scale 770 is suitably defaulted to zero, with the ability for the user to offset the temperature by moving the slide to the left or right. One skilled in the art will understand that other methods of offsetting the temperature of the cooking appliance 102 are equally capable of being implemented without departing from the scope of the present invention. Once the user has made changes to the temperature offset, or desires to negate any changes made, the user selects the OK icon 738 at step 640 to implement the changes, which are then made to the display of the touchscreen 222 at step 642. When the user desires not to accept the changes made to the display of the touchscreen 222, the user selects the cancel icon 736 at step 636, whereupon no changes are implemented to the display of the touchscreen 222 at step 638. In either case, whether changes to the type of units used by the cooking appliance 102 are made or canceled, flow proceeds back from steps 638 and 642 to the main preference screen 726 at step 606.

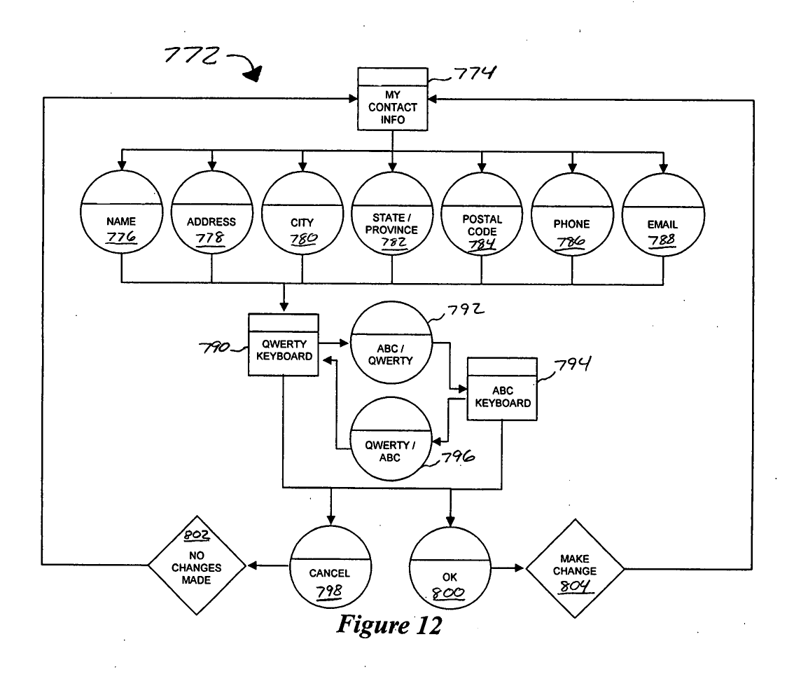

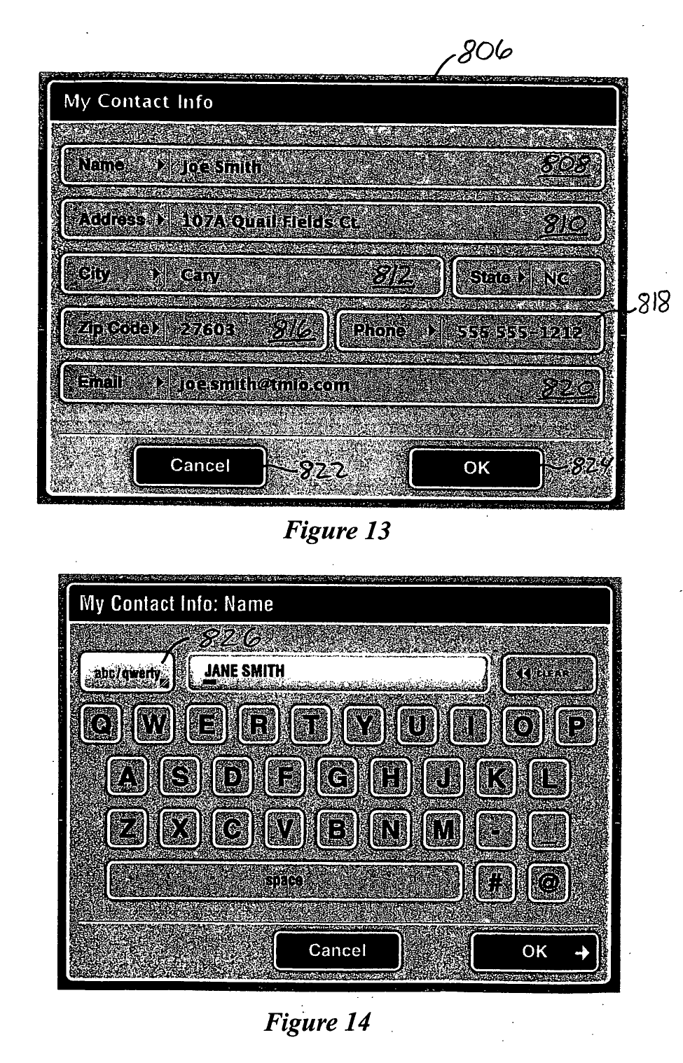

Returning to the my oven screen 700 at step 601, the user is able to select the my contact info icon 706, at step 644, which prompts the display of the my contact information screen at step 646. Referring now to FIG. 12, there is shown a my contact info screen architecture 772, accessible from the my oven screen 700 of FIG. 7 via the my contact info icon 706. When selected by the user, the my contact info icon 706 activates a my contact info screen, illustrated in FIG. 13 as 806. The my contact info screen 806 is suitably displayed at step 646 of FIG. 6 and for explanatory purposes herein, the my contact info screen 806 is further referenced by step 774 of FIG. 12. As previously discussed, the skilled artisan will appreciate that throughout this written description, various flowcharts of screen architectures will depend from each other, where this occurs reference to both the step in the current flowchart and the immediately preceding flowchart will be referenced thereon to ensure continuity of flow from one chart to the next. Thus, step 774 of FIG. 12 corresponds to the flow from step 646 of FIG. 6, from the my oven screen architecture 600 to the my contact info subscreen architecture 772 of FIG. 12. Or, to state differently, flow proceeds from the my oven screen 700 upon user selection of the my contact info icon 706 to the my contact info screen 806.

As shown in FIG. 13, the my contact info screen 806 contains graphical icons 808-820 corresponding to the different contact information representing the owner or user of the cooking appliance 102. The skilled artisan will appreciate that while the my contact info screen 806 employs icons in the present embodiment, other means of securing the user information are capable of being used, including for example and without limitation, fill-in forms, pull-down menus and the like. From the my contact info screen 806, accessed at step 646, the user is presented with seven contact information icons, shown as 808-820. As will be understood by those skilled in the art, the present invention is not limited to seven icons, and can include any number of information related icons to prompt the user to input information relating thereto, however for purposes of example only, the present embodiment uses seven fields, corresponding to the user's name, address, city, state/province, zip/postal code, telephone number and email address.

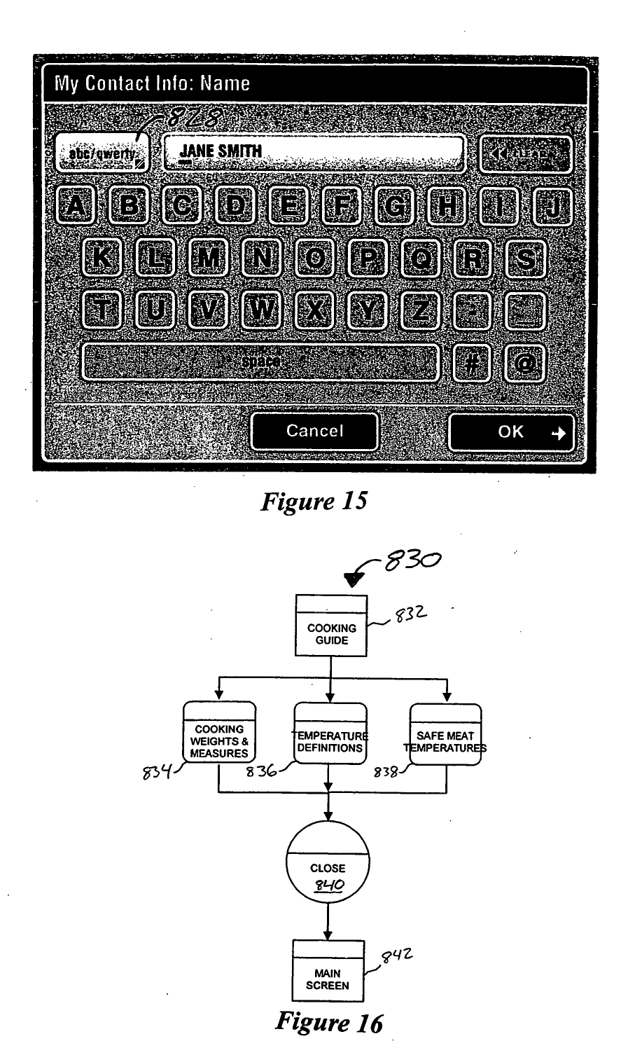

Those skilled in the art will appreciate that the contact icons 808-820 of FIG. 13 suitably correspond to the selection steps 776-788 of FIG. 12. Thus, when the user selects the name icon 808 of FIG. 13 at step 776 of FIG. 12, the touchscreen display 222 suitably displays to the user a QWERTY keyboard at step 790. A template QWERTY keyboard screen is suitably illustrated in FIG. 14. It will further be understood by those skilled in the art that user selection at steps 778-788 of the corresponding icons 810-820 will result in the display of the QWERTY keyboard of FIG. 14 at step 790. At step 792, the user is able to select an ABC keyboard, as shown in FIG. 15, by selecting the ABC/QWERTY toggle icon 826. When the user desires to switch from the ABC keyboard of FIG. 15 to the QWERTY keyboard of FIG. 14, the user selects the ABC/QWERTY toggle icon 828. Irrespective of the input screen selected by the user, i.e., FIG. 14 or FIG. 15, once entry of the desired contact information has been completed, the user selects the cancel icon 822 at step 798 or the okay icon 824 at step 800. When the user has selected the cancel icon 822 at step 798, flow proceeds to step 802, wherein no changes are made to the contact record and the touchscreen display 222 returns to displaying the my contact info screen at 774. When the user selects the okay icon 824 at step 800, flow proceeds to step 804, wherein the input changes are made to the contact record and saved as known in the art. Flow then returns to the display of the my contact info screen at step 774 for additional entries or exiting of the my contact info screen.

Cooking Guide Architecture

Returning to the my oven screen 700 at step 601, the user is able to select the cooking guide icon 708, at step 648, which prompts the display of the cooking guide screen at step 650.

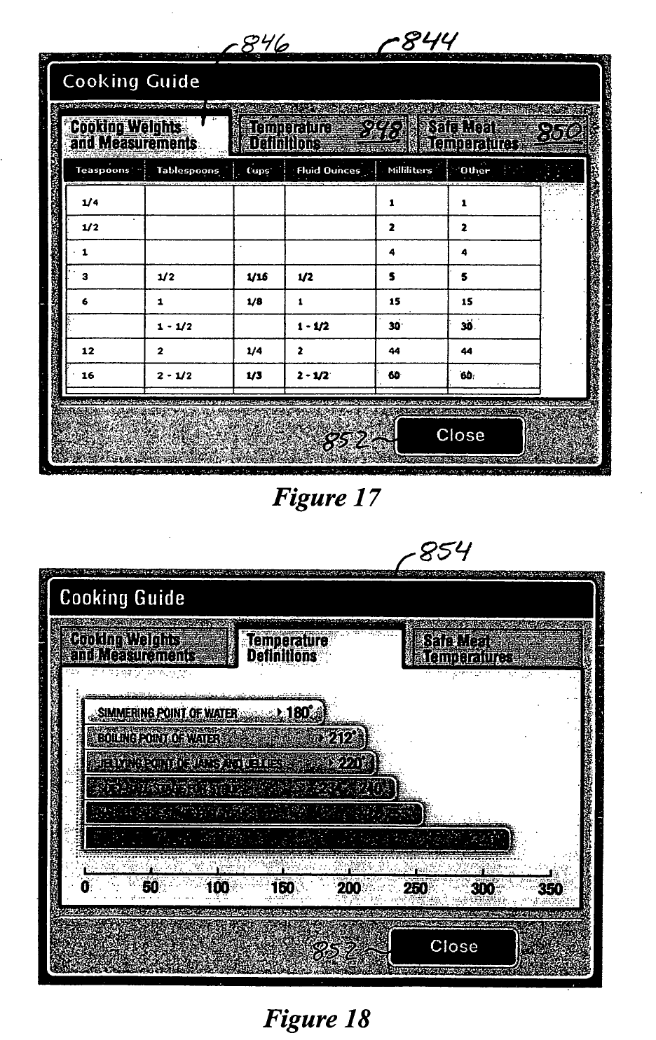

Referring now to FIG. 16, there is shown a cooking guide screen architecture 830, accessible from the my oven screen 700 of FIG. 7 via the cooking guide icon 708. When selected by the user, the cooking guide icon 708 activates a cooking guide screen, illustrated in FIG. 17 as 844. The cooking guide screen 844 is suitably displayed at step 650 of FIG. 6 and for explanatory purposes herein, the cooking guide screen 844 is further referenced by step 832 of FIG. 16. As previously discussed, the skilled artisan will appreciate that throughout this written description, various flowcharts of screen architectures will depend from each other, where this occurs reference to both the step in the current flowchart and the immediately preceding flowchart will be referenced thereon to ensure continuity of flow from one chart to the next. Thus, step 832 of FIG. 16 corresponds to the flow from step 648 of FIG. 6, from the my oven screen architecture 600 to the cooking guide subscreen architecture 830 of FIG. 16. Or, to state differently, flow proceeds from the my oven screen 700 upon user selection of the cooking guide icon 708 to the cooking guide screen 844.

As shown in FIG. 17, the cooking guide screen 844 contains tabbed windows 846, 848, and 850 corresponding to the different cooking information available in accordance with the present invention. The skilled artisan will appreciate that while tabbed windows are used, other techniques of switching between the various preference options are capable of being used without departing from the scope of the present invention. From the cooking guide screen 844, accessed at step 650, the user is presented with three varying cooking guides, shown as tabs 846-850. Those skilled in the art will appreciate that the tabs 846-850 correspond to the steps 834-838 of FIG. 16, as will be more fully explained below.

When the user has selected the cooking weights and measurements tab 846 from the cooking guide screen 844, at step 834 a cooking weights and measurements screen is suitably displayed. Those skilled in the art will appreciate that upon selection of the cooking guide screen 844, the cooking weights and measurements tab 846 is pre-selected. The present invention is equally capable of opening the cooking guide screen 844 with the temperature definition tab 848 or the safe meat temperature tab 850 selected, without departing from the scope of the present invention. As shown in FIG. 17, the cooking weights and measurements tab 846 suitably includes a table illustrating the various weights and measurements used in cooking an item. For example, as shown in FIG. 17, the number of teaspoons, corresponding tablespoons, corresponding cups, corresponding fluid ounces, corresponding milliliters, are illustrated in a tabular format. The skilled artisan will appreciate that other measurements are equally capable of being displayed in accordance with the present invention, including, without limitation, fully metric weights, customary weights, fully metric volumes, and any suitable combination thereof. When the user has finished viewing the cooking weights and measurements tab 846, the user is able to terminate viewing this tab 846 by selecting the close icon 852 at step 840. Flow then proceeds to step 842, wherein the main screen 400 is displayed, as set forth above.

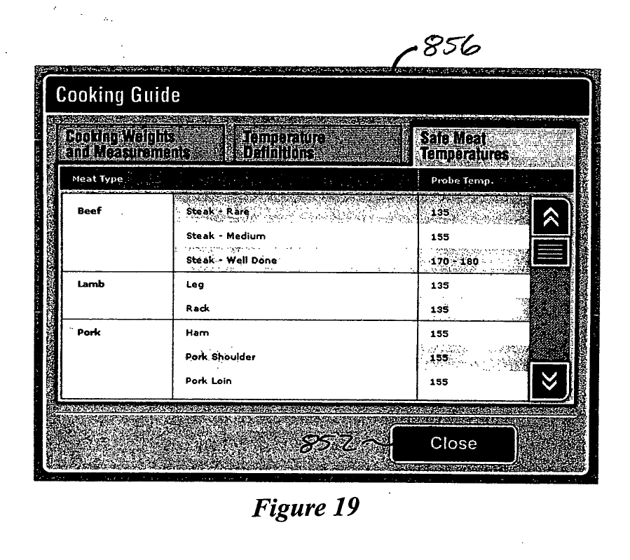

When the user desires to view other guides, the user activates the desired guide by selecting one of the tab icons 846-850 of the cooking guide screen 844. It will be understood by those skilled in the art that the use of tabbed browsing of cooking guides enables the same base screen 844 to be reused by the present invention, through the alternation of the various selected tabs. Thus, when the user desires to view the temperature definition guide of tab 848 at step 836, the temperature definition tab 848 is displayed on the touchscreen display 222. As shown in FIG. 18, the temperature definition tab 848 has been selected illustrated by the screen template 854, which displays to the user those temperatures associated with terms of art, for example and without limitation, the screen displays the corresponding Fahrenheit temperatures associated with boiling, simmering, jellying, and the like. Of course, it will be appreciated by those skilled in the art that metric units of temperature are equally capable of being displayed on the temperature definition screen 854, without departing from the scope of the present invention. When the user desires to view the safe meat temperature guide of tab 850 at step 838, the safe meat temperature screen 856 is suitably displayed. As illustrated in FIG. 19, the safe meat temperature screen 856 displays to the user a table containing various meats, such as beef, pork, lamb, chicken, and the like, and the corresponding temperatures to which the meat should be heated to effectuate the desired outcome, such as rare, medium, or well-done. Thus, the user is able to preset the cooking appliance 102 to heat a steak to a rare condition, or 135 degrees Fahrenheit. Alternatively, the present invention is capable of illustrating the appropriate corresponding temperatures in metric units, as so desired by the user. Irrespective of the guide viewed, when the user is finished with the guide, the user selects the close icon 852 at step 840 and flow proceeds to step 842, wherein the main screen 400 is then displayed.

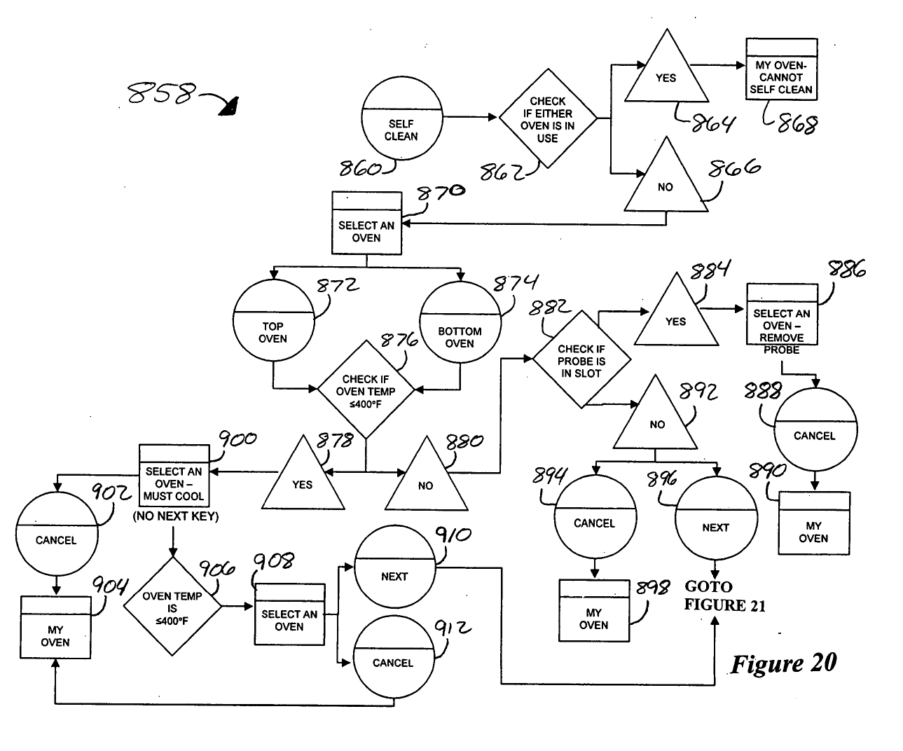

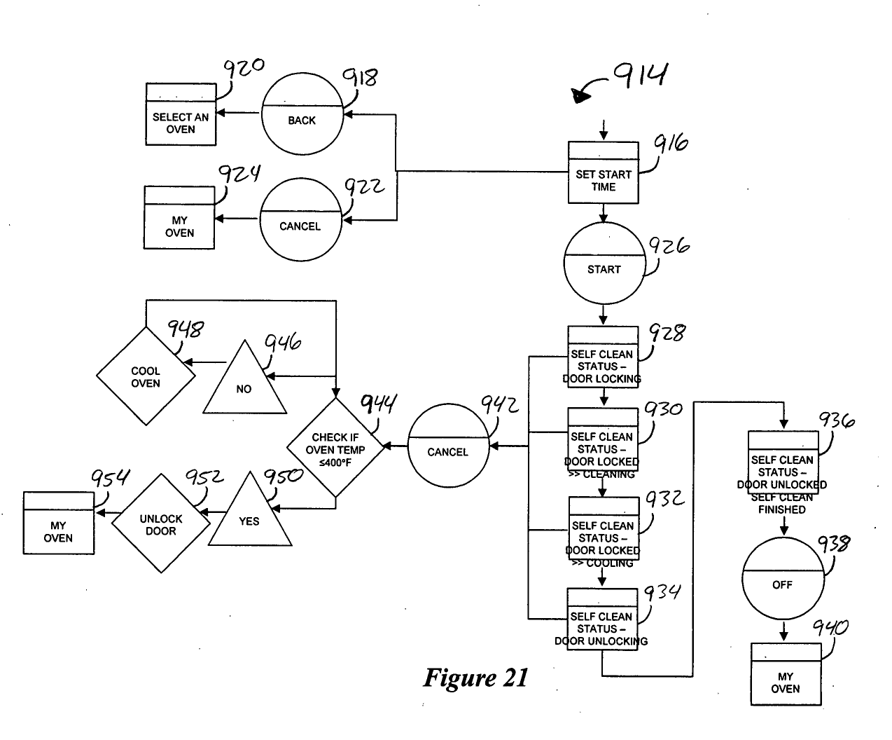

Turning back to the my oven screen 700 at step 601, the user is able to select the self clean icon 710, at step 652. Following selection of the self clean icon 710, flow proceeds to the screen architecture described in FIG. 20 and FIG. 21.

Self-Clean Architecture

FIG. 20 illustrates a self clean architecture 858 in accordance with one aspect of the present invention. FIG. 21 illustrates additional self clean architecture 914 in accordance with the present invention. Beginning at step 860, the self clean icon 710 has been selected, prompting a determination to be made at step 862 whether either the top chamber 106 or the bottom chamber 108 are currently being used. When it is determined at step 864 that either chamber 106 or 108 is presently in use, flow progresses to step 868, wherein the user is informed that the self clean features of the present invention are unable to be accessed due to one of the chambers being inaccessible. It will be understood by those skilled in the art that while described herein as being limited to having both chambers 106 and 108 not in use, the present invention is equally capable of cleaning one chamber while the other chamber is in use, and vice versa.

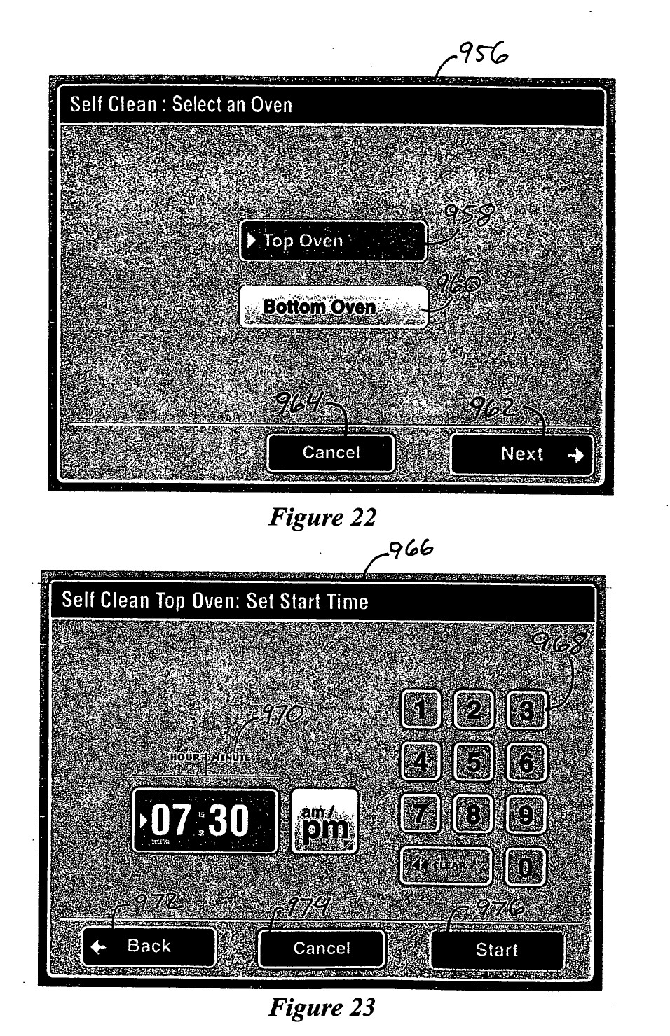

Returning to step 862, when it is determined that the chambers 106 and 108 are not currently in use, flow proceeds to the negative determination step 866, wherein function of the self clean feature prompts the display of the select an oven screen at step 870. FIG. 22 suitably illustrates a template screen 956 showing an example screen wherein the user selects one of the chambers for self cleaning. As will be understood by those skilled in the art, the template screen 956 is suitably displayed on the touchscreen interface 222 using any means known in the art. The template screen 956 advantageously includes selection icons 958 and 960, respectively representing the top chamber 106 and the bottom chamber 108. Once the user has selected the appropriate icon corresponding to the chamber to be cleaned, the user selects the next icon 962 to proceed to the next step, or cancels the operation by selecting the cancel icon 964, the effects of which are explained in detail below. Returning to FIG. 20, the user selects either the top oven icon 958 of FIG. 22 for the top chamber 106 at step 872, or alternatively selects the bottom oven icon 960 for the bottom chamber 108 at step 874. Irrespective of which oven is selected for self cleaning, a determination is made at step 876 to ascertain whether or not the then current oven temperature allows for safe cleaning. As will be appreciated by those skilled in the art, oven temperatures greater than or equal to 400 degrees Fahrenheit represent high temperatures which have a negative affect on self cleaning.

Upon a determination at step 876 that the internal temperature of the selected chamber is not greater than or equal to the preset safe cleaning temperature, for example, 400 degrees Fahrenheit, flow proceeds to step 880 and on to step 882. At step 882, a determination is made whether or not the probe is inserted in the selected chamber. For example, a query is made to determine if the probe 210 is present in the top chamber 106 or, if the bottom chamber 108 has been selected for cleaning, to determine if the probe 216 is present in the bottom chamber 108. When it is determined at step 884 that the probe is present in the selected chamber, flow proceeds to step 886, wherein a warning screen is displayed to the user. It will be understood by those skilled in the art that at step 886 the next icon 962 is removed and the screen 956 illustrates a suitable warning to the user that the probe 210 is present in the selected chamber. The user is then prompted to remove the probe 210 prior to the initiation of the self clean operation. The user then selects the cancel icon 964 at step 888 to remove the probe 210 and flow proceeds to return to the my oven screen 700 at step 890.

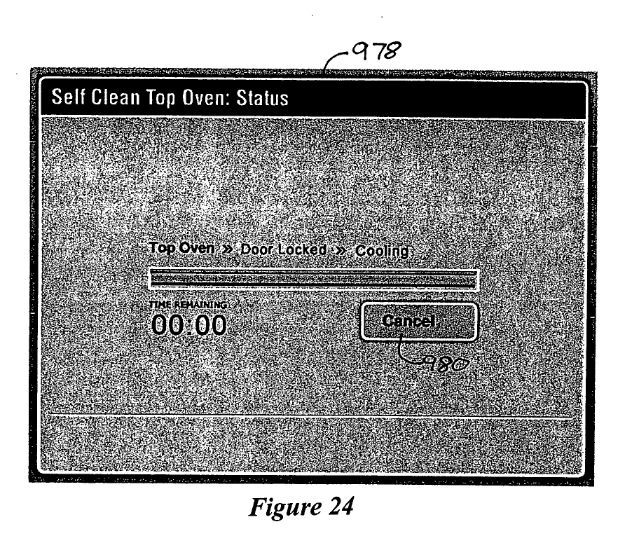

When the probe is not present in the selected chamber at step 892, the user is presented with two options for proceeding. The user is able to select the cancel icon 964 at step 894, which returns to the my oven screen 700 at step 898, or alternatively, selects the next icon 962 at step 896, which progresses the flow of the self clean operation to the architecture 914 of FIG. 21. Beginning at step 916 of FIG. 21, a set start time screen 966, illustrated in FIG. 23, is suitably displayed to the user, requiring the user to input the desired start time for beginning the self clean operation of the selected chamber. As shown in FIG. 23, the set start time screen 966 suitably includes a numeric keypad icon 968, allowing the user to select the start time at which to begin self cleaning operations. A readout 970 enables the user to view the time as it is entered. The screen 966 further includes a back icon 972, a cancel icon 974 and a start icon 976. When the user selects the back icon 972 at step 918, flow proceeds to step 920, wherein the display is returned to the self clean select an oven screen 956 of FIG. 22. When the cancel icon 974 is selected by the user at step 922, flow proceeds to step 924, wherein the display is returned to the my oven screen 700 of FIG. 7.

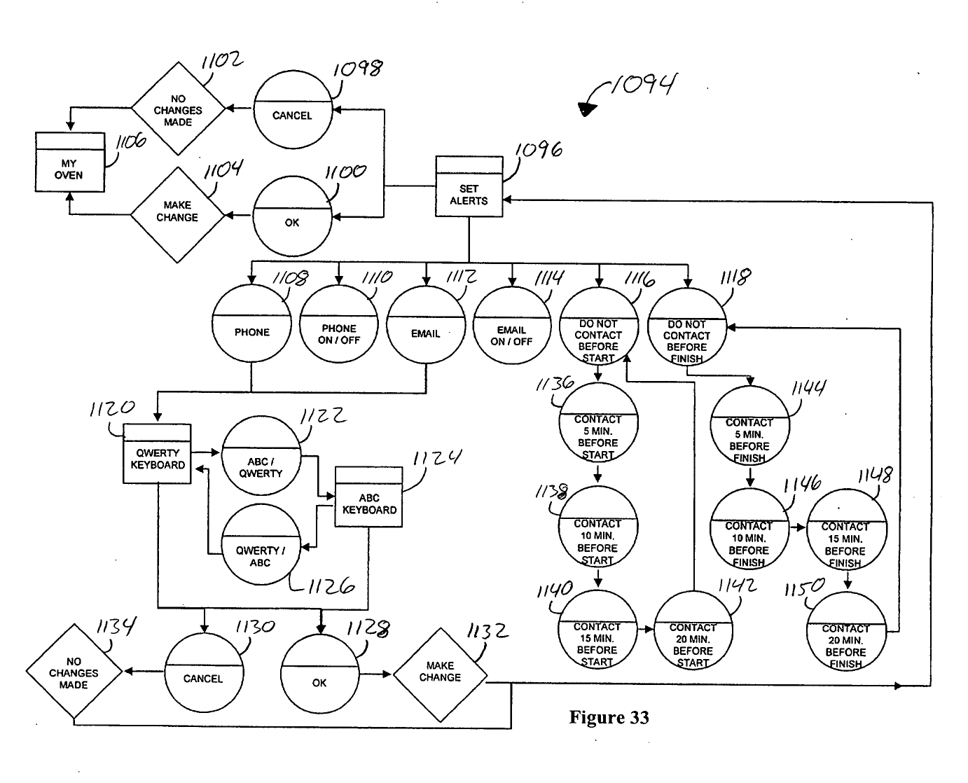

When the start icon 976 is selected at step 926, flow proceeds to step 928, wherein a self clean status screen 978 is displayed to the user. As illustrated by FIG. 24, the self clean status screen 978 informs the user that the door to the chamber selected for cleaning is in the process of locking. Following locking of the door to the selected chamber, the cleaning operations begin at step 930. In accordance with the self clean operation of the present invention, once cleaning operations begin at step 930, a cleaning status screen 978 is displayed to the user on the touchscreen interface 222. As shown in FIG. 33, the cleaning status screen 978 informs the user that the doors are locked, the time remaining in the clean cycle, and the current operation being performed. As will be understood by those skilled in the art, the time remaining, cleaning temperatures, and the like are well known in the art and the present invention is not limited to those times and temperatures illustrated in the accompanying figures. Following the cleaning of step 930, flow proceeds to step 932, wherein the cleaned chamber is suitably allowed to cool to a predetermined temperature. In particular, FIG. 24 illustrates the template 978 showing a cleaning status cooling screen displayed to the user via the touchscreen interface 222. Those skilled in the art will appreciate that the predetermined temperature is any temperature known in the art that is reached after cleaning and is safe to unlock the appliance door. Once the interior temperature of the cleaned chamber has lowered to the predetermined value, flow proceeds to step 934, wherein the door begins to unlock. It will be appreciated by those skilled in the art that the self cleaning status screen 978 of FIG. 24 is advantageously capable of showing the user that the door to the cleaned chamber is in the process of unlocking. Once the door has been unlocked, flow proceeds to step 936, wherein the user is informed that the self cleaning of the selected chamber has been accomplished and the door is presently unlocked. A suitable interface screen is then generated illustrating the self clean operation has completed. The user is then able to select an off icon at step 938, wherein the self clean operation is exited and flow returns to the my oven screen 700 at step 940.

The self cleaning status screen 978 includes a cancel icon 980, enabling the user to cancel the self cleaning of the selected chamber at any point during the cleaning operation. As shown at step 942, the user selects the cancel icon 980, resulting in a determination step at 944 to ascertain whether or not the internal temperature of the selected chamber is below a predetermined temperature. When it is determined at step 946 that the internal temperature of the selected chamber is above the predetermined temperature, flow proceeds to step 948 wherein the oven is allowed to cool. It will be understood by those skilled in the art that during this cooling period, the doors remain in a locked position, thereby preventing any harm to the user or damage to the equipment. When it is determined that the internal temperature has reached an acceptable level at step 950, the door to the selected chamber is unlocked at step 952. Flow then proceeds to return the user the my oven screen 700 at step 954.

Returning to FIG. 20, when a determination made at step 876 results in ascertaining that the temperature of the selected chamber is greater than the predetermined level at step 878, flow proceeds to step 900, wherein the user is informed that the selected cooking chamber must cool before the self cleaning operation is capable of being performed. It will be appreciated by those skilled in the art that the screen 956 in FIG. 22 is capable of illustrating the self clean status displayed to the user during self clean operations. Thus, an alert is displayed to the user indicating the necessity of waiting until the chamber has cooled before the oven commences cleaning operations. The user is able to select the cancel icon 964 at step 902, wherein flow returns to the my oven screen 700 at step 904. When the user determines to wait until such time as the internal temperature lowers adequately, flow proceeds from step 900 to step 906, wherein a determination is made whether or not the internal temperature has sufficiently lowered. When the temperature remains above the predetermined threshold, the self clean operation is delayed. When the temperature has lowered to the acceptable level, flow proceeds from step 906 to the display of the select an oven screen 956 of step 908. The user is then able to select the next icon 962 or the cancel icon 964. When the user selects the cancel icon 964 at step 912, flow proceeds to the my oven screen 700 as shown at step 904. When the user selects the next icon 962 at step 910, flow proceeds to step 916 of FIG. 21 and operations continue as discussed above.

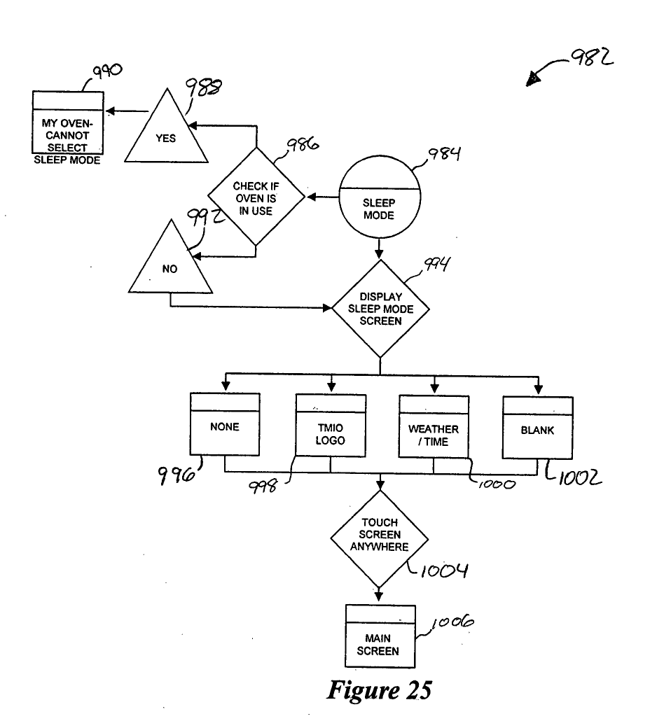

As will be understood by those skilled in the art, once the cooking appliance 102 has completed the self clean operation of the selected chamber, the touchscreen display 222 returns the my oven screen 700 of FIG. 7. The skilled artisan will further appreciate that the templates and screens discussed above should in no way limit the subject invention and rather should be used to expound thereon. Returning to the my oven screen architecture 600 of FIG. 6 and the corresponding main my oven screen 700 of FIG. 7, the user is able to select additional operations to be performed, as illustrated in the flowchart architecture 600 of FIG. 6. Thus, returning to step 601, the user is able to select the sleep mode at step 654. As will be understood by those skilled in the art, the sleep mode enables the cooking appliance 102 and user interface 222 to enter a low-power consumption state, while still retaining certain functionality, such as, for example and without limitation, display of time, date, weather and the like. By selecting the sleep mode icon 712 at step 654, flow proceeds from the architecture of FIG. 6 to the sleep mode architecture 982 of FIG. 25.

Sleep Mode Architecture

Turning now to FIG. 25, there is shown a template screen architecture 982 enabling the cooking appliance to enter into a low-power consumption state. The user selects the sleep mode icon 712 at step 984. As will be understood by those skilled in the art, the selection of the sleep mode icon 712 at step 984 suitably corresponds to the selection of the sleep mode icon 712 at step 654 of FIG. 6. Following selection of the sleep mode icon 712, flow proceeds in FIG. 25 to determine if the cooking appliance 102 is currently in use at step 986. When it is determined at step 988 that the appliance 102 is in use, flow proceeds to step 990, wherein the user is informed, via the touchscreen 222 that sleep mode cannot be selected. When the cooking appliance 102 is unable to enter sleep mode, a warning to that effect is advantageously displayed to the user via the my oven screen 700 of FIG. 7.

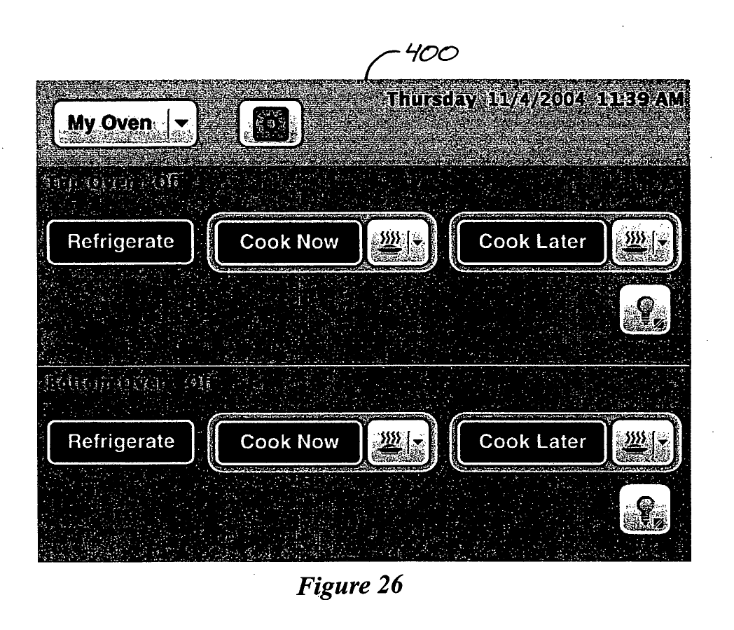

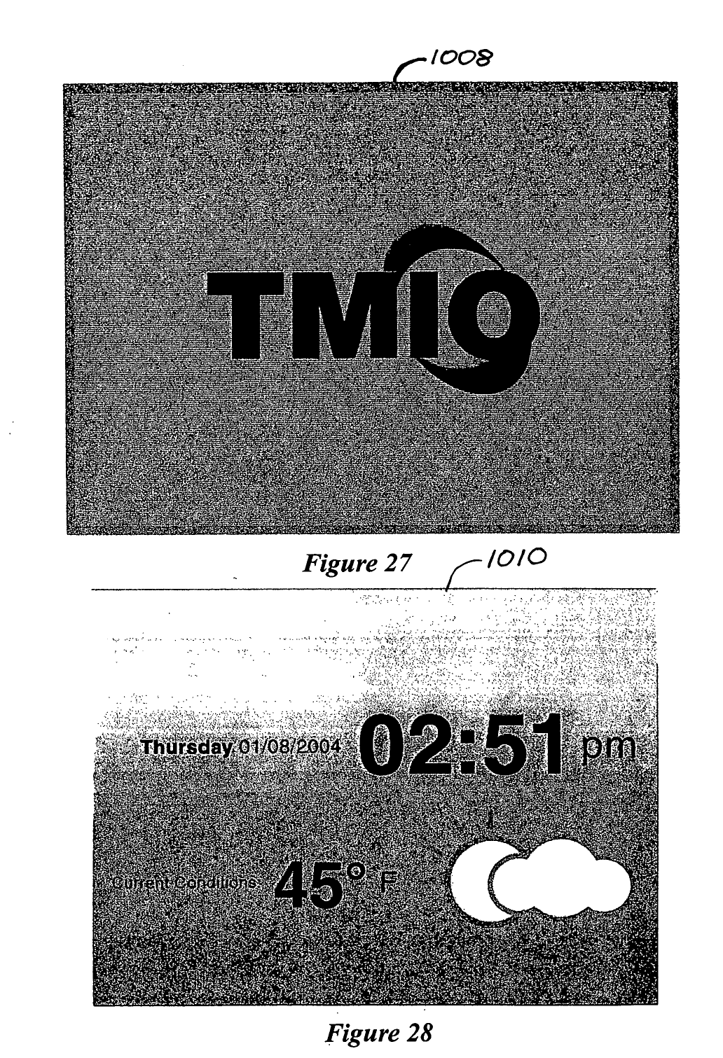

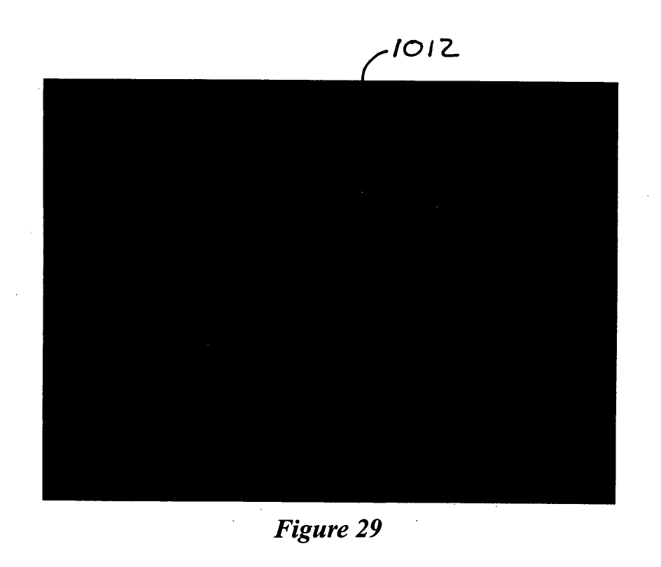

When it is determined at step 992 that the cooking appliance 102 is not presently in use, flow proceeds to step 994, wherein a suitable sleep mode screen is displayed. As will be understood by those skilled in the art, when the sleep mode has been activated, the cooking appliance enters a low-power consumption mode, or stated differently, the cooking appliance 102 enters a standby mode. As illustrated in FIG. 25, several variations of the sleep mode screen displayed to the user are able to be selected as the screen saver for the touchscreen interface 222. It will be appreciated by those skilled in the art that the sleep mode screens described hereinafter are for example purposes only, and any suitable screen saver, known in the art, is equally capable of being implemented without departing from the scope of the present invention. As shown in FIG. 25, four possible screen savers are selectable by the user via any known means, including no screen saver at step 996 illustrated in FIG. 26 as the main screen 400, a manufacturer logo at step 998 illustrated in FIG. 27, the weather/time screen saver at step 1000 illustrated in FIG. 28, and a blank screen saver at step 1002 illustrated in FIG. 29.

As shown in FIG. 26, the use of no screen saver returns the touchscreen interface 222 to displaying the main screen 400 of FIG. 4. FIG. 27 depicts a manufacturer logo screen saver 1008. Those skilled in the art will appreciate that in accordance with one aspect of the present invention, the screen saver 1008 is capable of being implemented using any suitable image, such as, for example, the user selected digital photograph, and the like. FIG. 28 illustrates a weather/time screen saver 1010, displaying to the user the time and local weather conditions. It will be understood that the weather/time screen saver illustrated at step 1000 is capable of being implemented by retrieving such information from a computer network, such as the Internet, via a dedicated server, an update server, and the like. FIG. 29 illustrates a blank screen saver 1012. The skilled artisan will appreciate that the blank screen saver 1012 suitably shuts down the touchscreen display 222 display-portion, while leaving the touch-portion operational, i.e., to exit the sleep mode. In one embodiment, a black screen is used to effectuate the blank screen saver 1012 of FIG. 29. When the user desires to reactivate the cooking appliance 102, the user touches the touchscreen 222 display surface at step 1004. The main screen 400 is then displayed to the user at step 1006, returning the flow to step 310 of the main architecture 300 of FIG. 3.

Network Settings Architecture

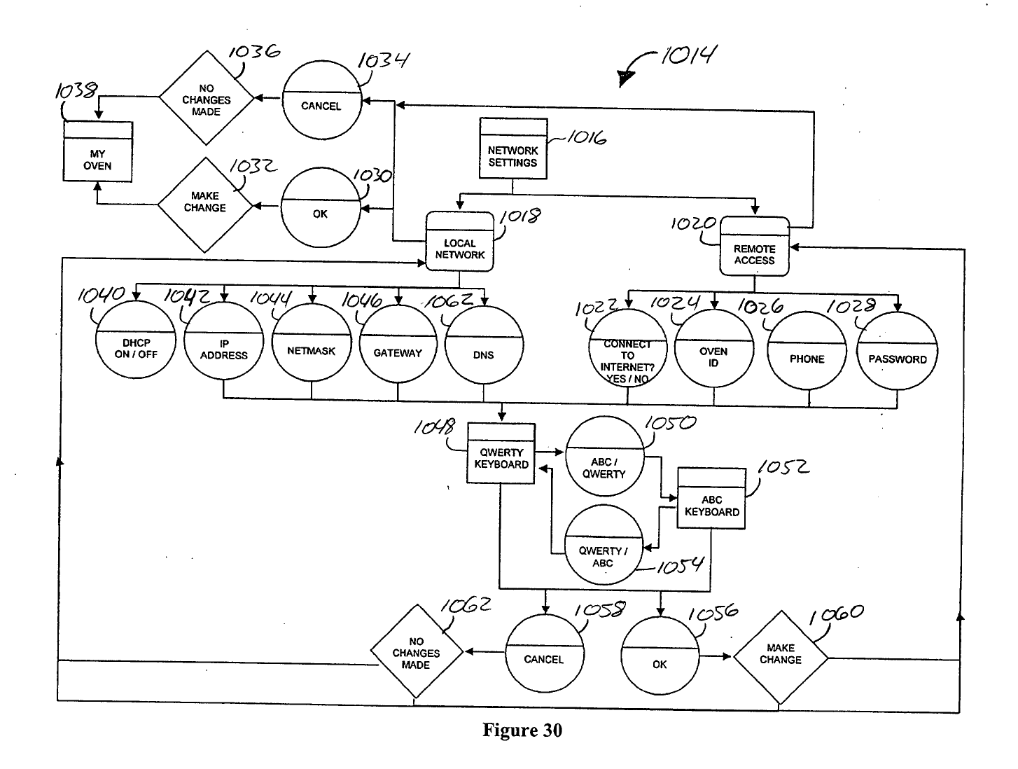

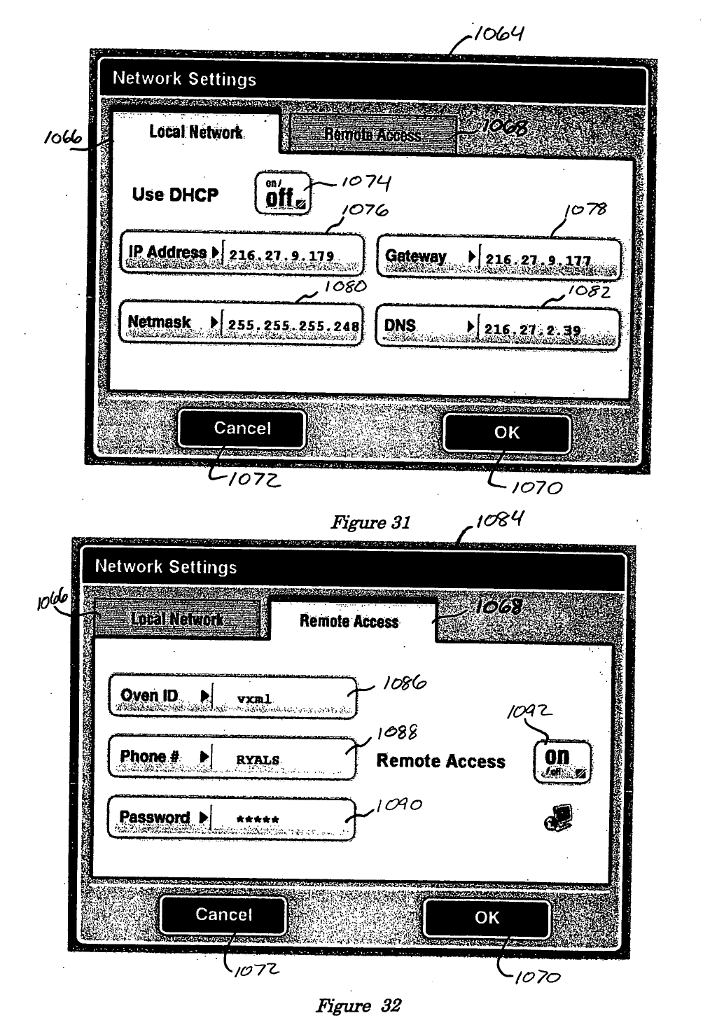

Returning to the my oven screen 700 (of FIG. 7) corresponding to step 601 of FIG. 6, the user is able to set and adjust the network settings by selecting the network settings icon 714 at step 656. Following selection of the network settings icon 714, flow proceeds to display, at step 658, a network settings screen, illustrated at 1064 of FIG. 31. The process by which the user is able to selectively alter the network settings for the cooking appliance 102 is illustrated in the network settings screen architecture 1014 of FIG. 30. In other words, flow proceeds from step 658 of FIG. 6 to step 1016 of FIG. 30 upon the selection of the network settings icon 714 displayed in FIG. 7. The network settings screen displayed at step 1016 is illustrated by the template 1064 of FIG. 31. As shown in FIG. 31, the template network settings screen 1064 includes offset tabs 1066 and 1068. The offset tabs 1066 and 1068 correspond to the local network and the remote access properties, respectively. The screen 1064 further includes an okay icon 1070 and a cancel icon 1072, the selection of either of which will be explained in detail below.

From the network settings screen 1064, the user is able to select either the local network settings tab 1066, as shown in FIG. 31, or the remote access settings tab 1068, prompting the display of FIG. 32. With respect to FIG. 30, when the user selects the local network offset tab 1066 at step 1018, the local network screen 1064 is shown, as illustrated in FIG. 31. As shown in FIG. 31, the local network screen 1064 includes a toggle icon 1074 corresponding to turning on or turning off DHCP, an IP address icon 1076, a gateway icon 1078, a netmask icon 1080, and a DNS icon 1082. When the user toggles the on/off DHCP icon 1074 at step 1040, the touchscreen interface 222 activates or deactivates the DHCP functionality of the present invention. In contrast, icons 1076-1082 correspond to fields that are capable of user editing or automatic device selection. Thus, when the user selects, at step 1042, the IP address icon 1076, flow proceeds to step 1048, wherein a QWERTY keyboard is displayed to the user enabling the user to fill in the desired IP address for the cooking appliance 102. The QWERTY keyboard corresponds to the template screen illustrated in FIG. 14, discussed above. Should the user desire to use an ABC keyboard, the user selects the ABC/QWERTY icon 826 at step 1050, which prompts the display of an ABC keyboard at step 1052. The ABC keyboard of step 1052 corresponds to the keyboard shown in FIG. 15 and discussed above. The user is able to alternate back to the QWERTY keyboard of FIG. 14 and step 1048 by selecting the ABC/QWERTY icon 828 of FIG. 15 at step 1054. Irrespective of which keyboard selected by the user, an IP address to be used by the cooking appliance 102 is input. The user then selects either the okay icon 1070 at step 1056 to make the appropriate changes at step 1060, wherein flow returns to step 1018. Alternatively, should the user determined that no changes should be saved, the user selects the cancel icon 1072 at step 1058. Following selection of the cancel icon 1072, no changes are made and the keyboards are no longer displayed at step 1062, wherein flow returns to the local network display screen 1064 at step 1018. From the local network display screen 1064 at step 1018, the user is able to allow any changes made by selecting the okay icon 1070 at step 1030, whereupon the changes are made at step 1032 and flow proceeds to step 1038, whereupon operations return to the my oven screen 700 of FIG. 7. Similarly, once flow has returned to the local network display screen 1064 at step 1018, the user is able to negate any changes made to the local network settings by selecting the cancel icon 1072 at step 1034, whereafter flow proceeds to step 1036 with no changes made to the local network settings and operations return, at step 1038 to the my oven screen 700 of FIG. 7.

Similar to the input of an IP address at step 1042, when the netmask icon 1080 is selected at step 1044, flow proceeds to steps 1048 through 1054, regarding entry of the appropriate netmask data. Once this data has been updated, the user is able to select the cancel icon 1072 or the okay icon 1070 at steps 1058 and 1056, respectively. Flow then proceeds in the manner discussed with respect to the selection of the IP address icon 1076. When the user desires to change the gateway address corresponding to operation of the cooking appliance 102, the user selects the gateway icon 1078 at step 1046. Once selected, flow proceeds to steps 1048-1054, as set forth above, resulting in the display of alpha-numeric keypads to facilitate the entry of the new or changed gateway address. Following the user input of the desired gateway address, either the okay icon 1070 is selected at step 1056 to update the changes at step 1060, or the cancel icon 1072 is selected 1058 to cancel any changes at step 1062. Flow then returns to the local network screen 1064 at step 1018 to await any additional changes the user desires to make to the network settings. When the user desires to change the domain name server (DNS) address corresponding to the function of the cooking appliance 102, the user selects the DNS icon 1082 at step 1062. The user then inputs the new information at steps 1048-1054, and selects the okay icon 1070 at step 1056 to accept the new DNS information, or selects the cancel icon 1072 at step 1058 to negate the changes made to the DNS address. Irrespective of whether or not the user makes changes to the DNS address, flow returns to the local network settings screen 1064 at step 1018. From the local network display screen 1064 at step 1018, the user is able to allow any changes made by selecting the okay icon 1070 at step 1030, whereupon the changes are made at step 1032 and flow proceeds to step 1038, whereupon operations return to the my oven screen 700 of FIG. 7. Similarly, once flow has returned to the local network display screen 1064 at step 1018, the user is able to negate any changes made to the local network settings by selecting the cancel icon 1072 at step 1034, whereafter flow proceeds to step 1036 with no changes made to the local network settings and operations return, at step 1038 to the my oven screen 700 of FIG. 7.

Returning to step 1016, when the user desires to adjust the remote access settings, i.e., those settings controlling when and how the user remotely accesses the cooking appliance 102, the user selects the remote access tab 1068 at step 1020. The remote access settings screen 1084, illustrated in FIG. 32, displays a variety of features and settings the user is able to adjust to configure the remote access of the cooking appliance. As shown in FIG. 32, the remote access settings screen 1084 includes an oven identification icon 1086, a phone number icon 1088, a password icon 1090, and a remote access on/off toggle icon 1092. To enable remote access of the cooking appliance 102, the user must first connect the appliance 102 to an accessible computer network, for example and without limitation, a local area network, a wide area network, and the Internet, by selecting the on/off toggle icon 1092 at step 1022. As will be understood by those skilled in the art, the connection to the computer network is accomplished via any suitable means known in the art.

Once the cooking appliance 102 has established a communications channel with the computer network, the user is prompted to input the appropriate information corresponding to the oven identification, the phone number, and the password. As will appreciated by those skilled in the art, the aforementioned information is capable of being manually input, as explained below, uploaded via the communications channel, and automatically generated. When the user desires to change one or more settings corresponding to the remote access of the cooking appliance 102, the user is able to select, at step 1024, the oven identification icon 1086. The skilled artisan will appreciate that the oven identification is representative of an alphanumeric identifier corresponding to the cooking appliance 102. This identifier is capable of being automatically generated, or selected by the user. When the user desires to input a personal name or other sequence of characters, flow proceeds from step 1024 to step 1048, wherein a QWERTY keyboard is displayed to the user enabling the user to fill in the desired oven identification for the cooking appliance 102. The QWERTY keyboard corresponds to the template screen illustrated in FIG. 14, discussed above. Should the user desire to use an ABC keyboard, the user selects the ABC/QWERTY icon 826 at step 1050, which prompts the display of an ABC keyboard at step 1052. The ABC keyboard of step 1052 corresponds to the keyboard shown in FIG. 15 and discussed above. The user is able to alternate back to the QWERTY keyboard of FIG. 14 and step 1048 by selecting the ABC/QWERTY icon 828 of FIG. 15 at step 1054. Irrespective of which keyboard selected by the user, an oven identifier to be used by the cooking appliance 102 is input. The user then selects either the okay icon 1070 at step 1056 to make the appropriate changes at step 1060, wherein flow returns to step 1020. Alternatively, should the user determine that no changes should be saved, the user selects the cancel icon 1072 at step 1058. Following selection of the cancel icon 1072, no changes are made and the keyboards are no longer displayed at step 1062, wherein flow returns to the remote access display screen 1084 at step 1020. From the remote access display screen 1084 at step 1020, the user is able to allow any changes made by selecting the okay icon 1070 at step 1030, whereupon the changes are made at step 1032 and flow proceeds to step 1038, whereupon operations return to the my oven screen 700 of FIG. 7. Similarly, once flow has returned to the remote access display screen 1084 at step 1020, the user is able to negate any changes made to the remote access settings by selecting the cancel icon 1072 at step 1034, whereafter flow proceeds to step 1036 with no changes made to the remote access settings and operations return, at step 1038 to the my oven screen 700 of FIG. 7.

When the user desires to input, update, or correct the telephone number associated with the cooking appliance, the user selects the telephone icon 1088 at step 1026. In accordance with one aspect of the present invention, the cooking appliance 102 is suitably equipped to communicate directly with a mobile computing device, such as a cellular telephone or other personal mobile communications device. During the initiation of such communications, the cooking appliance correspondingly verifies the telephone number of the originating device to facilitate authentication. In accordance with a particular aspect of the present invention, the telephone number input in the remote access settings screen 1084 is the dial-up number for an Internet Service Provider that enables communications by the cooking appliance 102 via the Internet. Irrespective of the use of the telephone number as shown in FIG. 32, once the user has selected the telephone icon 1088 at step 1026, flow proceeds to steps 1048-1054, as set forth above, resulting in the display of alpha-numeric keypads to facilitate the entry of the new or updated telephone number. Following the user input of the desired telephone number, either the okay icon 1070 is selected at step 1056 to update the changes at step 1060, or the cancel icon 1072 is selected 1058 to cancel any changes at step 1062. Flow then returns to the remote settings screen 1084 at step 1020, enabling the user to make any additional desired changes to the remote access settings corresponding to the cooking appliance 102. When the user desires to change the password corresponding to the authentication of the user via remote access, the user selects the password icon 1090 at step 1028. The user then inputs the new password using the QWERTY/ABC keyboard input screens illustrated in FIGS. 14 and 15 at steps 1048-1054, and selects the okay icon 1070 at step 1056 to accept the new password, or selects the cancel icon 1072 at step 1058 to negate the changes made to the password. Irrespective of whether or not the user makes changes to the password, flow returns to the remote network settings screen 1084 at step 1020. In one particular embodiment, once the user has entered a new password, the touchscreen display 222 prompts the user to re-enter the new password, so as to verify the newly selected password. When the two input passwords fail to correlate, the user is prompted to input the passwords again, or cancel the operation. It will be understood by those skilled in the art that once the user has finished adjusting the network settings and remote access features of the present invention, flow returns to the my oven screen 700 of FIG. 7, corresponding to step 601 of FIG. 6.

Set Alerts Architecture

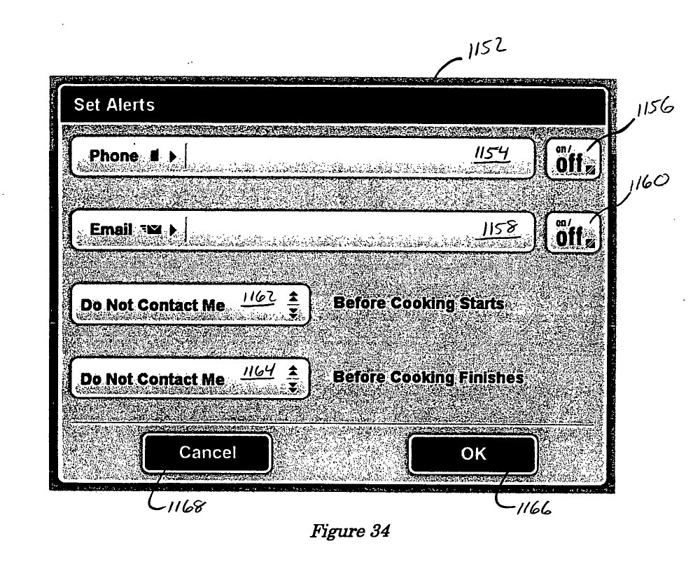

Returning to the my oven screen 700 (of FIG. 7) corresponding to step 601 of FIG. 6, the user is able to set and adjust alert notifications by selecting the set alerts icon 716 at step 660. Thus, the user is able to set the alert notifications that are capable of being generated to alert the user to a change in status of the cooking appliance, such as for example, and without limitation, when cooking begins, when cooking concludes, when cooling begins, and the methods by which the notification is transmitted, for example and without limitation, via email, text messaging, telephone, and the like. Upon user selection of the set alerts icon 716, flow proceeds to step 662, wherein a set alerts screen is displayed to the user. The skilled artisan will appreciate that the display of the set alerts screen at step 662 initiates the set alerts screen architecture 1094 of FIG. 33. In addition, those skilled in the art will understand the correlation, as discussed above, of step 662 of FIG. 6 and step 1096 of FIG. 33. Reference will further be made to the set alerts template screen 1152 illustrated in FIG. 34. As shown in FIG. 34, the screen 1152 includes a phone field icon 1154, corresponding to a phone number to which an alert call will be made, a phone on/off toggle icon 1156, an email field icon 1158 to which address an alert electronic message will be sent, an email on/off toggle icon 1160, a prior to cooking alert setting icon 1162, and a post cooking alert setting icon 1164. The screen 1152 further includes an okay icon 1166 and a cancel icon 1168, the selection of either of which will be explained in detail below.

When the user selects the phone field 1154 at step 1108, flow proceeds to step 1120, wherein a QWERTY keyboard is displayed to the user, thereby enabling the user to fill in the desired telephone number to which the cooking appliance 102 will call an alert. The QWERTY keyboard corresponds to the template screen illustrated in FIG. 14, as discussed above. Should the user desire to use an ABC formatted keyboard instead of the standard QWERTY keyboard, the user selects the ABC/QWERTY toggle icon 826 at step 1122, which prompts the display of an ABC keyboard at step 1124. The ABC keyboard of step 1124 corresponds to the keyboard shown in FIG. 15, as discussed above. The user is able to alternate back the QWERTY keyboard of FIG. 14, i.e. step 1120, by selecting the QWERTY/ABC toggle icon 828 at step 1126. Regardless of which keyboard is selected by the user, a telephone number to which the cooking appliance 102 calls to issue an alert is input. The user then selects the okay icon 1166 at step 1128 to make the appropriate changes at step 1132, wherein flow returns to step 1096. Alternatively, should the user determine that no changes should be made to the set alerts telephone number, the user selects the cancel icon 1168 at step 1130. After selection of the cancel icon 1168, no changes are made and the keyboards are no longer displayed at step 1134, wherein flow returns to the set alerts screen 1152 at step 1096. From the set alerts display screen 1152 at step 1096, the user is able to allow any changes made to the alert settings by selecting the okay icon 1166 at step 1100, whereupon the changes are made at step 1104 and flow proceeds to step 1106, whereupon operations return to the my oven screen 700 of FIG. 7. Similarly, once flow has returned to the set alerts display screen 1152 at step 1096, the user is able to negate any changes made to the alert settings by selecting the cancel icon 1168 at step 1098, thereinafter flow proceeds to step 1102 with no changes made to the alert settings and operations return, at step 1106 to the my oven screen 700 of FIG. 7. The skilled artisan will appreciate that to enable the cooking appliance 102 to communicate via telephone, the user must first select the telephone on/off icon 1156 at step 1110. As illustrated in FIG. 34, the set alert via telephone communication is set in the off position as default, however the instant invention is not intended to be so limited.

In much the same manner as the user inputs the telephone number at steps 1108 though step 1134, when the email field icon 1158 is selected at step 1112, flow proceeds to steps 1120-1134, as set forth above, resulting in the display of alpha-numeric keypads to facilitate the entrance of a new or updated email address to which the cooking appliance 102 is to send an alert. The skilled artisan will appreciate that to enable the cooking appliance 102 to communicate via electronic message, the user must first select the email on/off icon 1160 at step 1114. As illustrated in FIG. 34, the set alert via electronic messaging, e.g., email, is set in the off position as default, however the instant invention is not intended to be so limited.

Returning to the set alerts screen 1152 at step 1096, the user is then able to select when notification, either via telephone or electronic mail, is to be initiated by the cooking appliance 102 at steps 1116 through 1150. When the user depresses the before cooking starts scroll-down menu selection icon 1162 at step 1116, a variety of options are presented to the user for selection. Thus, the user is able to instruct the oven to not contact the user prior to beginning cooking at step 1116. Alternatively, the user is able to instruct the cooking appliance 102 to send an alert five minutes prior to the start of cooking operations at step 1136, ten minutes prior to the start of cooking operations at step 1138, fifteen minutes prior to the start of cooking operations at step 1140, or twenty minutes prior to the start of cooking operations at step 1142. Flow would then return to step 1116 should the user desire to not have the cooking appliance 102 contact the user prior to beginning cooking operations. From the set alerts display screen 1152 at step 1096, the user is able to allow any changes made to the alert settings by selecting the okay icon 1166 at step 1100, whereupon the changes are made at step 1104 and flow proceeds to step 1106, whereupon operations return to the my oven screen 700 of FIG. 7. Similarly, once flow has returned to the set alerts display screen 1152 at step 1096, the user is able to negate any changes made to the alert settings by selecting the cancel icon 1168 at step 1098, thereafter flow proceeds to step 1102 with no changes made to the alert settings and operations return, at step 1106 to the my oven screen 700 of FIG. 7. It will be appreciated by those skilled in the art that the aforementioned times for notification prior to the initiation of cooking operations is for example purposes only and the instant invention is not limited to the five, ten, fifteen, or twenty minute notifications illustrated in the flowchart 1094 of FIG. 33. Furthermore, the skilled artisan will appreciate that the menu choices, evidenced by selections steps 1116, 1136, 1138, 1140, and 1142 are displayed to the user via a scroll-down menu, as are known in the art. Other methods, as are known in the art, of allowing the user to select notification times are equally applicable to the instant invention.

From the set alerts screen 1152 at step 1096, the user is further capable of selecting whether notification is to be sent, either via telephone or electronic mail, prior to the completion of cooking operations by the cooking appliance 102. When the user depresses the before cooking finishes scroll-down menu selection icon 1164 at step 1118, a variety of options are presented to the user for selection. As illustrated by the flowchart 1094 of FIG. 33, the user is able to instruct the oven to not contact the user prior to the completion of cooking operations at step 1118. Similar to the discussion above with respect to the notification prior to the initiation of cooking operations, the user is able to instruct the cooking appliance 102 to send an alert five minutes prior to the completion of cooking operations at step 1144, ten minutes prior to the completion of cooking operations at step 1146, fifteen minutes prior to the completion of cooking operations at step 1148, or twenty minutes prior to the completion of cooking operations at step 1150. Flow would then return to step 1118 should the user desire to not have the cooking appliance 102 contact the user prior to completion of cooking operations. From the set alerts display screen 1152 at step 1096, the user is able to allow any changes made to the alert settings by selecting the okay icon 1166 at step 1100, whereupon the changes are made at step 1104 and flow proceeds to step 1106, whereupon operations return to the my oven screen 700 of FIG. 7. Similarly, once flow has returned to the set alerts display screen 1152 at step 1096, the user is able to negate any changes made to the alert settings by selecting the cancel icon 1168 at step 1098, thereupon flow proceeds to step 1102 with no changes made to the alert settings and operations return, at step 1106 to the my oven screen 700 of FIG. 7. It will be appreciated by those skilled in the art that the aforementioned times for notification prior to the completion of cooking operations is illustrated for example purposes only and the instant invention is not limited to the five, ten, fifteen, or twenty minute notifications explained above. In addition, the skilled artisan will appreciate that the menu choices, evidenced by selections steps 1118, 1144, 1146, 1148, and 1150 are displayed to the user via a scroll-down menu. Other methods, as are known in the art, of allowing the user to select notification times are equally applicable to the instant invention.

Oven Service Architecture

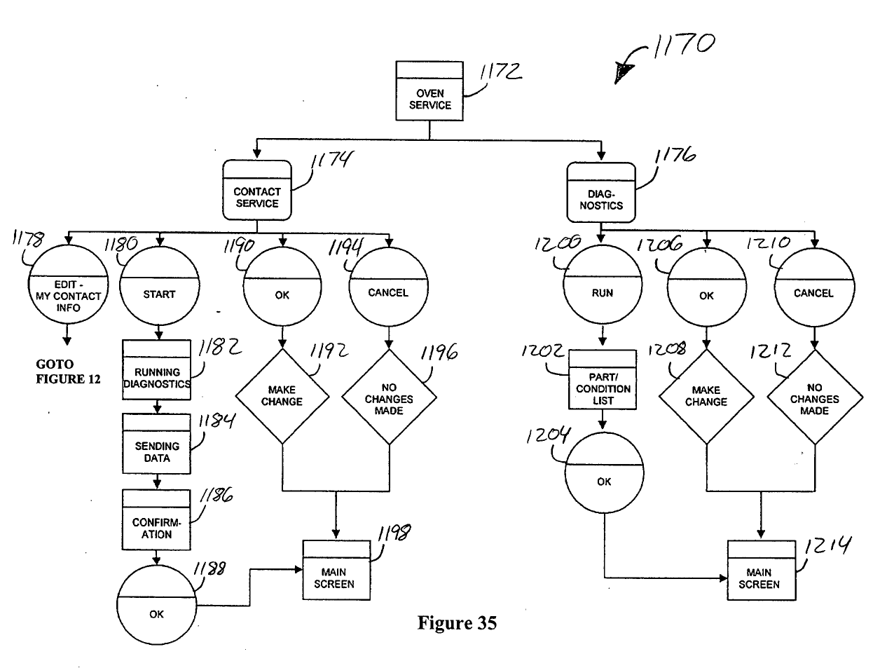

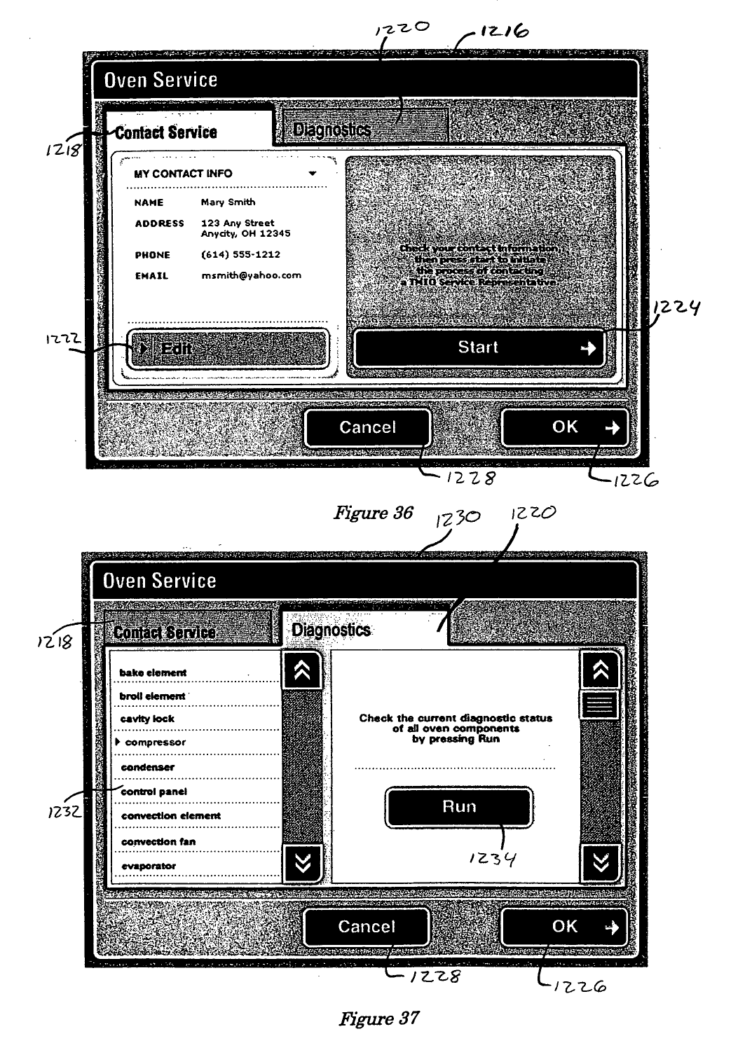

Referring now to the my oven screen 700 of FIG. 7, which corresponds to step 601 of FIG. 6, the user is capable of running diagnostics or contacting a service provider by selecting the oven services icon 718 at step 664. In the event that the user is experiencing errors or problems in the operation of the cooking appliance 102, the user is capable of initiating a self-run diagnostics program, to determine the problem, or to contact a repair service, via the touchscreen interface 222. Upon user selection of the oven service icon 718, flow proceeds to step 666, wherein an oven service screen is displayed to the user. The skilled artisan will appreciate that the display of the oven service screen at step 666 initiates the oven services architecture 1170 of FIG. 35. Those skilled in the art will further understand the correlation, as discussed above, of step 666 of FIG. 6 and step 1172 of FIG. 35. Reference will also be made to the oven service template screen 1216 illustrated in FIG. 36. As shown in FIG. 36, the oven service screen 1216 includes offset tabs 1218 and 1220, which correspond to contacting a service representative and running a self-diagnostic, respectively. This oven service screen 1216 further includes an okay icon 1226 and a cancel icon 1228, the selection of either of which will be explained in greater detail below.

From the oven services screen 1216, the user is able to select either contact service tab 1218, the default system setting as shown in FIG. 36, or the diagnostics tab 1220, prompting display of FIG. 37. Referring now to FIG. 35, when the user selects the contact service offset tab 1218 at step 1174, the contact a service representative screen 1216 is shown, as illustrated by FIG. 36. As shown in FIG. 36, the contact service screen 1216 includes a my contact information edit icon 1222, and a start icon 1224, which enables the user to initiate a service call to a designated appliance service representative. When the user selects the edit icon 1222 at step 1178, the touchscreen interface 222 is returned to the my contact information architecture 772 of FIG. 12 by displaying the my contact information screen 806 of FIG. 13. The user then updates the contact information and navigates through the screens and architectures discussed above to return to the oven service screen 1216 of FIG. 36. It will be appreciated by those skilled in the art that upon completion of updating the contact information, the preferred embodiment returns the display of the touchscreen interface 222 to the oven service screen 1216 upon user selection of the okay icon 824 of the my contact information screen 806 of FIG. 13.

Once the user has determined that the contact information displayed on the oven service screen 1216 is correct, flow proceeds to step 1180, whereupon the user selects the start icon 1224. At step 1182 the cooking appliance 102 initiates a self-run diagnostic program, wherein the cooking appliance 102 determines any components, parts, applications, or the like, which are not functioning according to predetermined specifications. Once this diagnostic program has completed, data generated during its operation is transmitted to the service representative at step 1184. In the preferred embodiment, a confirmation is returned to the user at step 1186, whereupon the user selects the okay icon 1226 at step 1188. It will be understood by those skilled in the art that the selection of the okay icon 1226 after completion of the contact service representative operation prompts the touchscreen 222 to return display to the main screen 400 at step 1198.

When the user has made changes to the contact service representative screen 1216, the user selects the okay icon 1226 at step 1190 to make the change at step 1192, or alternatively, when the user desires to negate the changes previously input, the user selects the cancel icon 1228 at step 1194, whereby the changes are deleted at step 1196. In either event, flow proceeds to step 1198, whereupon the main screen 400 is displayed to the user via the touchscreen interface 222. It will be understood by those skilled in the art that selection of the cancel icon 1228 after selecting the start icon 1224, will terminate the contact operation and return the user to the main screen 400 of FIG. 4. Thus, for example and without limitation, when the user has initiated the contact a service representative and then determines, from the diagnostic program that the problem is easily corrected, the user selects the cancel icon 1228, which terminates the transmission of the service request.

From the oven service screen 1216, the user is able to select the diagnostics offset tab 1220 to select a diagnostic routine to be run on the cooking appliance 102 without the necessity of contacting a service provider. User selection of the diagnostics offset tab 1220 prompts the display of the diagnostics screen 1230 at step 1176, which includes a component scroll-down list 1232 of components on which a diagnostic routine is capable of being performed, a run icon 1234, which initiates the diagnostic routine, an okay icon 1226 and a cancel icon 1228. When the user selects the run icon 1234 at step 1200, the cooking appliance 102 begins a self-diagnostic program as is known in the art to determine the various functionality and operational status of components. Once the diagnostic program has been run, flow proceeds to step 1106, whereupon the diagnostic results for each component in the scroll-down list 1232 are available for viewing by the user. The skilled artisan will appreciate that after completing the diagnostic operation, the user selects a first component from the scroll-down list 1232. The status of the selected component is then suitably displayed, via any suitable means, on the diagnostics screen 1230. The scroll-down list 1232 enables the user to select any one of the plurality of cooking appliance components 102 for diagnostic viewing. In accordance with one aspect of the present invention, a problem, such as a component failure, is advantageously displayed using an indicator, as would be appreciated by those skilled in the art.

Once the diagnostic has been completed, the user selects the okay icon 1226 at step 1108, which returns the display on the touchscreen interface 222 to the main screen 400 of FIG. 4 at step 1214. From the diagnostic screen 1230, the user is further capable of canceling any diagnostic operations by selecting the cancel icon 1228 at step 1210. Upon selection of the cancel icon 1228, flow proceeds to step 1212, whereupon no changes are made regarding diagnostics and flow returns to the main screen 400 at step 1214. When the user selects the okay icon 1226 at step 1206, any changes made to the diagnostic settings are thereby accepted at step 1208 and flow returns to the main screen 400 at step 1214. When the user determines that the changes made to the diagnostic settings should be negated, the user selects the cancel icon 1228 at step 1210, whereby the changes are removed at step 1212 and flow returns to the main screen 400 at step 1214.

It will be appreciated by those skilled in the art that the oven service architecture 1170 is for example purposes only and other implementations for providing service to the cooking appliance 102 are equally capable of being employed by the instant invention. For example and without limitation, when the user contacts a service representative, the service representative is able to access the diagnostic routines for any or all of the appliance components and remotely run diagnostics to determine if a problem is correctable remotely, or if a replacement part must be provided. In addition, the cooking appliance 102 is advantageously capable of providing the service representative with data to determine if a service visit is required, or if the service representative is able to correct the problem without physical access to the cooking appliance.

Set Date/Time Architecture

Returning to the my oven screen 700 at step 601, the user is able to set the time and date for use by the cooking appliance by selecting the set date/time icon 720 at step 668, which prompts the display of the set date and time screen at step 670.

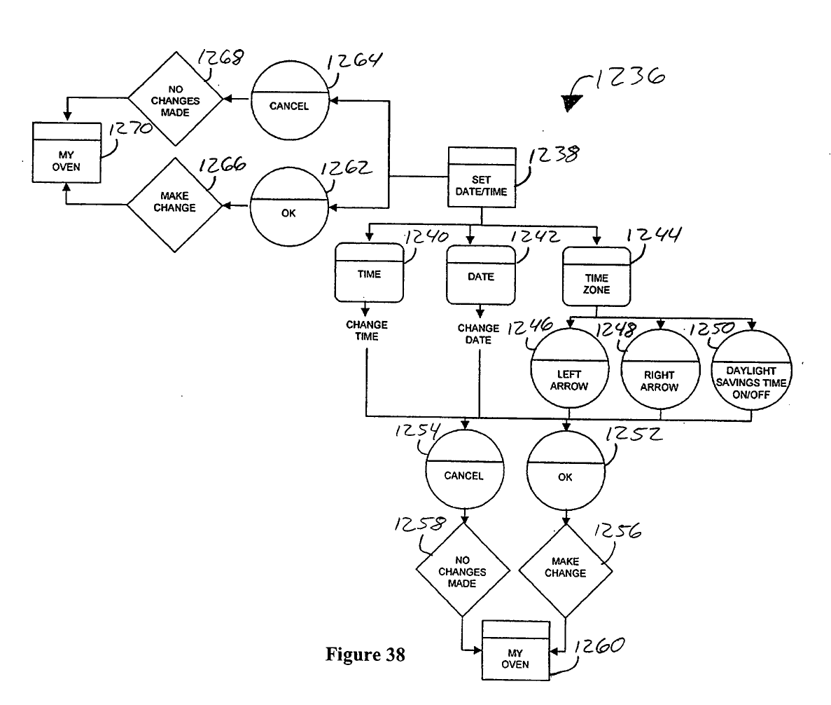

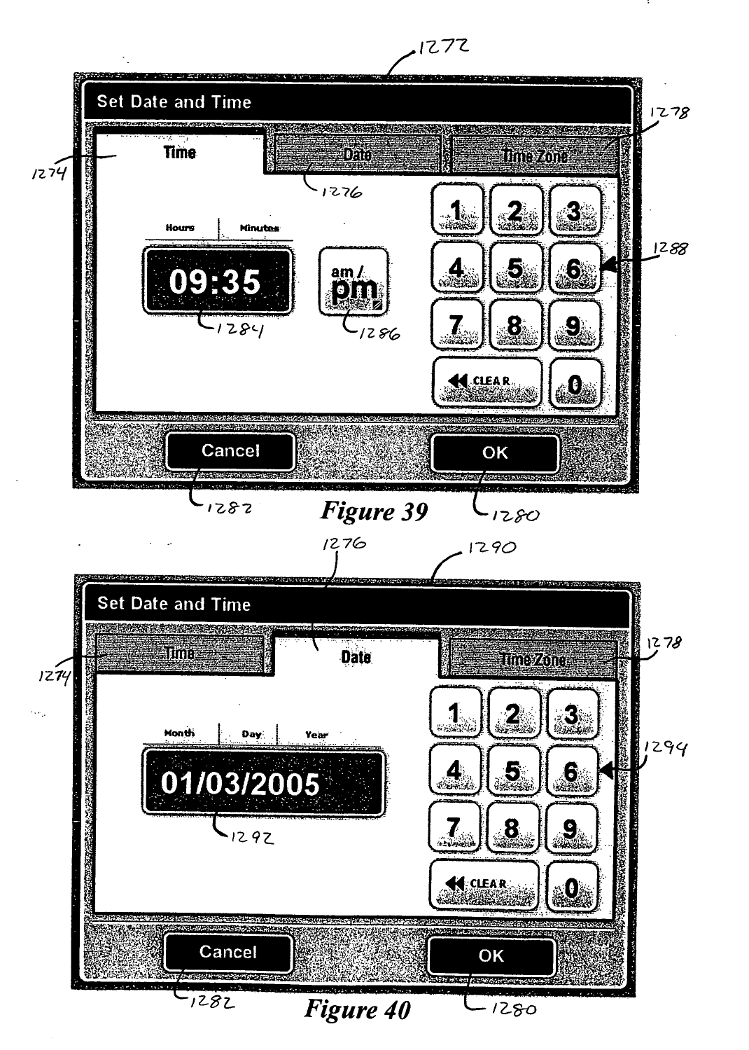

Following selection of the icon 720, flow proceeds to display, at step 668, the set date and time screen, illustrated at 1272 of FIG. 39. The process by which the user is able to selectively alter the date and time settings for the cooking appliance 102 is illustrated in the set date/time screen architecture 1236 of FIG. 38. In other words, flow proceeds from step 670 of FIG. 6 to step 1238 of FIG. 38 upon the selection of the set date/time icon 720 displayed in FIG. 7. The set date and time screen displayed at step 1236 is illustrated by the template 1272 of FIG. 39. As shown in FIG. 39, the template time and date settings screen 1272 includes offset tabs 1274, 1276, and 1278. The offset tabs 1274, 1276, and 1278 correspond to the time selection, date selection, and time zone selection capabilities of the appliance 102, respectively. The screen 1272 further includes an okay icon 1280 and a cancel icon 1282, the selection of either of which will be explained in detail below.

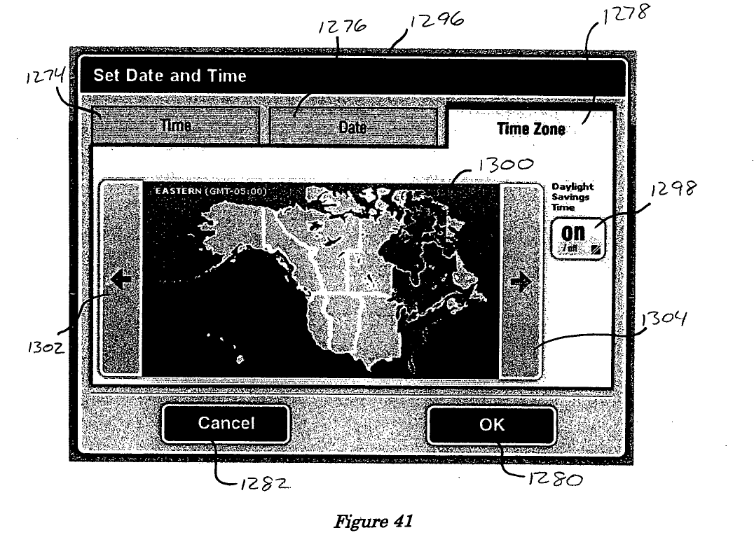

From the set date and time screen 1272, the user is able to select either the time settings tab 1274, shown in FIG. 39 as the default selection, the date settings tab 1276, prompting display of the date setting screen 1290 of FIG. 40, or the time zone setting tab 1278, prompting display of the time zone setting screen 1296 of FIG. 41. Beginning at step 1238 of FIG. 38, when the user selects the set time offset tab 1274 at step 1240, the time setting screen 1272 is shown, as illustrated in FIG. 39. As shown in FIG. 39, the time setting screen includes an hour/minutes preview window 1284, an AM/PM toggle icon 1286, and a numeric keypad 1288. The user then sets the time using the toggle icon 1286 and the numeric keypad 1288 and is able to either save all changes by selecting the okay icon 1280 at step 1252, whereupon the changes are saved and the time is updated at step 1256, resulting in a return to the my oven screen 700 at step 1260, or cancel the changes by selecting the cancel icon 1282 at step 1254, whereupon the changes are negated at step 1258 and the display returns to the my oven screen 700 at step 1260.

When the user desires to adjust the date of the cooking appliance 102, the user selects the date offset tab 1276 at step 1242 prompting the display of the set date screen 1290 of FIG. 40. As shown in FIG. 40, the date screen 1290 includes a date preview window 1292 and a numeric keypad 1294. As will be understood by those skilled in the art, the user inputs the desired date using a MM/DD/YYYY format using the keypad 1294, which is then displayed in the preview window 1292. To save the changes and return to the my oven screen 700, the user selects the okay icon 1280 at step 1252, which saves the date changes at step 1256 and displays the my oven screen 700 at step 1260. When the user does not desire that the changes made to the date be saved, the user selects the cancel icon 1282 at step 1254, whereby the changes are deleted at step 1258, resulting in a return to the my oven screen 700 at step 1260.

When the user desires to adjust the time zone associated with the cooking appliance 102, the user selects the time zone offset tab 1278, which prompts the display of the time zone screen 1296 of FIG. 41 at step 1244. As illustrated by FIG. 41, the time zone screen 1296 includes a graphical window 1300 representative of a map, from which the user selects the desired time zone location, an on/off toggle icon 1298, which allows the user to set daylight savings time, a left arrow icon 1302 and a right arrow icon 1304, which enable the user to scroll either right or left to locate the desired time zone in the window 1300. Thus, by selecting the left arrow 1302 at step 1246, the map shown in the window 1300 moves to reveal additional graphics to the left, while selecting the right arrow 1304 at step 1248 moves map shown in the window 1300 to the right. In addition, at step 1250, the user determines whether the selected time zone, as shown in the window 1300, adheres to daylight savings by selecting the on/off daylight savings time toggle icon 1298. Once the user has completed the changes, the user can return to any of the previous offset tabs 1274 or 1276 by selecting the appropriate tab, or accept the changes made to the time zone selection by selecting the okay icon 1280 at step 1252, which saves the changes to the time/date at step 1256 and returns display to the my oven screen 700 at step 1260. Alternatively, the user can negate the changes made to the time zone selections by selecting the cancel icon 1282 at step 1254, which deletes the changes at step 1258, whereby display is returned to the my oven screen 700 at step 1260.

It will be understood by those skilled in the art that the user is able to accept all changes or cancel all changes at any time while accessing the set date/time screen 1272 via the okay icon 1280 or the cancel icon 1282. Thus, as illustrated in the screen architecture 1236, the user is able to select the okay icon 1280 at step 1262, thereby accepting any and all changes made to the date and time settings of the cooking appliance 102 at step 1266. Operations then return from the set date/time screen 1272 to the my oven screen 700 at step 1270. Similarly, the user can reject any and all of the changes made to the date and/or time settings of the cooking appliance 102 by selecting the cancel icon 1282 at step 1264, which deletes the changes at step 1268, prompting a return to the my oven screen 700 at step 1270.

Sabbath/Holiday Architecture

Returning to the my oven screen 700 at step 601, the user is able to select the Sabbath/Holiday icon 722, at step 672, which prompts the display of the Sabbath/Holiday screen at step 674.

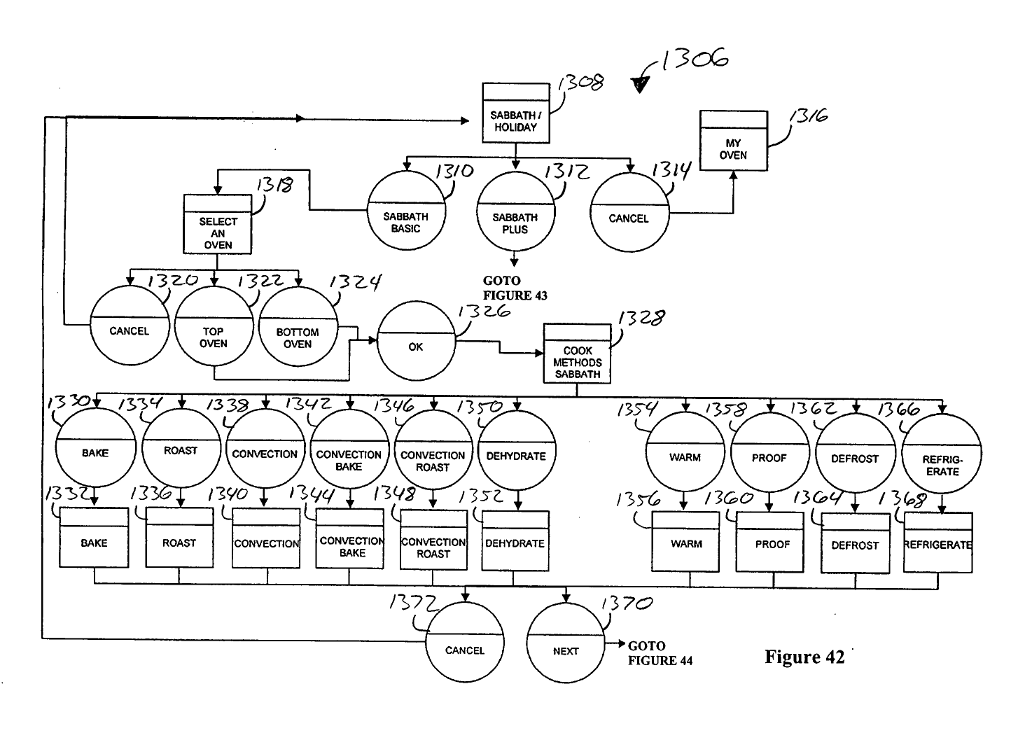

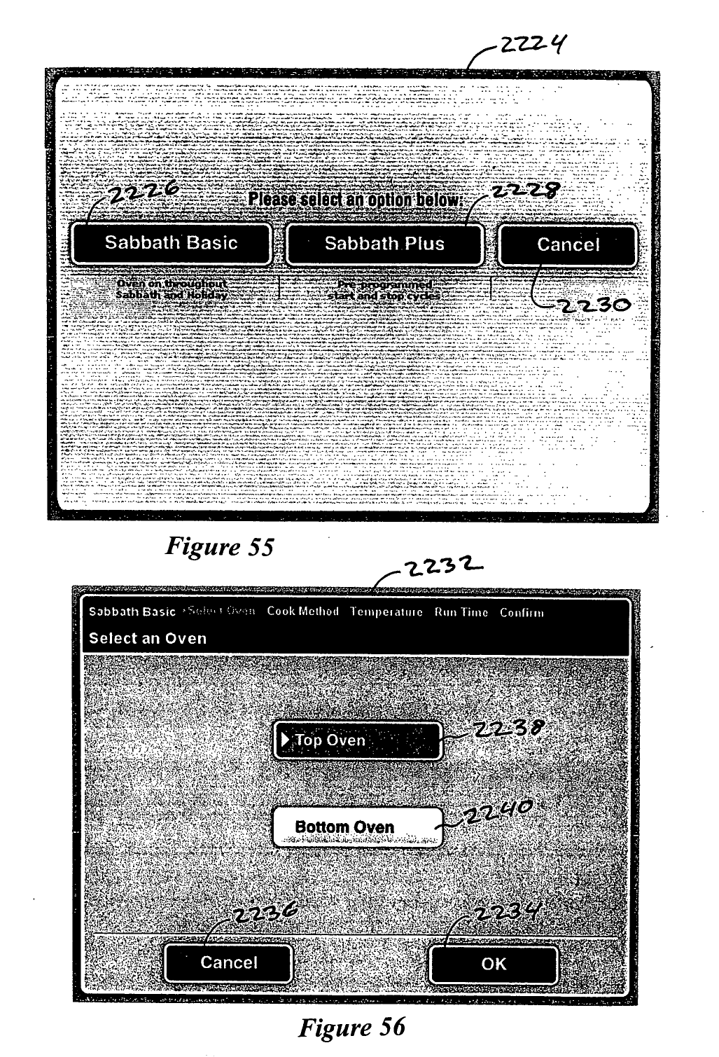

Referring now to FIG. 42, there is shown a Sabbath/Holiday screen architecture 1306, accessible from the my oven screen 700 of FIG. 7 via the Sabbath/Holiday icon 722. When selected by the user, the Sabbath/Holiday icon 722 activates a Sabbath/Holiday screen, illustrated in FIG. 55 as 2224. The Sabbath/Holiday screen 2224 is suitably displayed at step 674 of FIG. 6 and for explanatory purposes herein, the Sabbath/Holiday screen 2224 is further referenced by step 1308 of FIG. 42. As previously discussed, the skilled artisan will appreciate that throughout this written description, various flowcharts of screen architectures will depend from each other, where this occurs reference to both the step in the current flowchart and the immediately preceding flowchart will be referenced thereon to ensure continuity of flow from one chart to the next. Thus, step 1308 of FIG. 42 represents the flow from step 674 of FIG. 6, from the my oven screen architecture 600 to the Sabbath/Holiday subscreen architecture 1306 of FIG. 42. Or, to state differently, flow proceeds from the my oven screen 700 upon user selection of the Sabbath/Holiday icon 722 to the Sabbath/Holiday screen 2224.

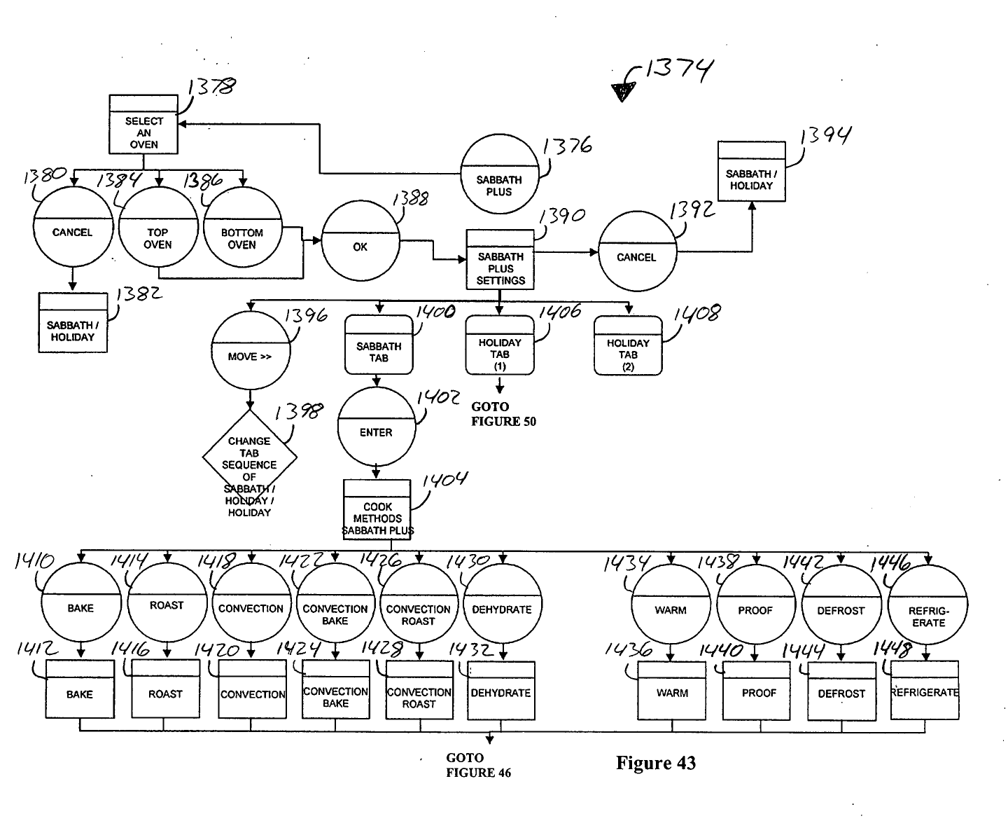

As shown in FIG. 55, the Sabbath/Holiday screen 2224 includes a Sabbath Basic icon 2226, a Sabbath Plus icon 2228 and a cancel icon 2230. Thus, the user is presented with three selectable operations upon display of the Sabbath/Holiday screen 2224, Sabbath Basic operations, Sabbath Plus operations, or cancel to return to the my oven screen 700. In accordance with the present invention, the Sabbath/Holiday Basic operation corresponds to the appliance 102 remaining powered throughout the Sabbath/holiday, whereas the Sabbath Plus operation shuts down the appliance 102, powering on and powering down the oven at preselected times. User selection of the Sabbath Plus operation, upon selection of the Sabbath Plus icon 2228 at step 1312 of FIG. 42 corresponds to the Sabbath Plus selection step 1376 of screen architecture 1374 corresponding to the initial setup of the Sabbath Plus operation, as illustrated in FIG. 43. The Sabbath Plus operation architecture 1374 of FIG. 43 will be discussed in greater detail below. User selection of the cancel icon 2230 at step 1314 prompts the display of the my oven screen 700 at step 1316, thereby ending the Sabbath/Holiday operation selection of FIGS. 42-59.

Sabbath Basic Settings

Returning to FIG. 42, which, as will be appreciated by those skilled in the art, corresponds to the Sabbath Basic operations in accordance with the present invention, the user selects the Sabbath Basic icon 2226 at step 1310. Following user selection of the Sabbath/Holiday icon 2226, flow proceeds to step 1318, whereupon a select an oven screen, illustrated in FIG. 56 as 2232, is advantageously displayed to the user. Referring now to FIG. 56, the select an oven screen 2232 includes graphical icons representative of the top chamber 104 and the bottom chamber 106, illustrated as the top oven icon 2238 and the bottom oven icon 2240, respectively. The select an oven screen 2232 further includes an okay icon 2234 and a cancel icon 2236. The skilled artisan will further appreciate that upon user selection of the cancel icon 2236 at step 1320, flow returns to the Sabbath/Holiday screen 2224 at step 1308. When the user does not desire to return to the previous screen, main Sabbath/Holiday screen 2224, the user selects either the top chamber 104 at step 1322 or the bottom chamber 106 at step 1324 by selecting the top oven icon 2238 or the bottom oven icon 2240, respectively. After selecting the desired chamber, the user has the option to cancel the selection and return to the main Sabbath/Holiday screen 2224 at step 1320, or proceed with the Sabbath/Holiday Basic programming operation by selecting the okay icon 2234 at step 1326.

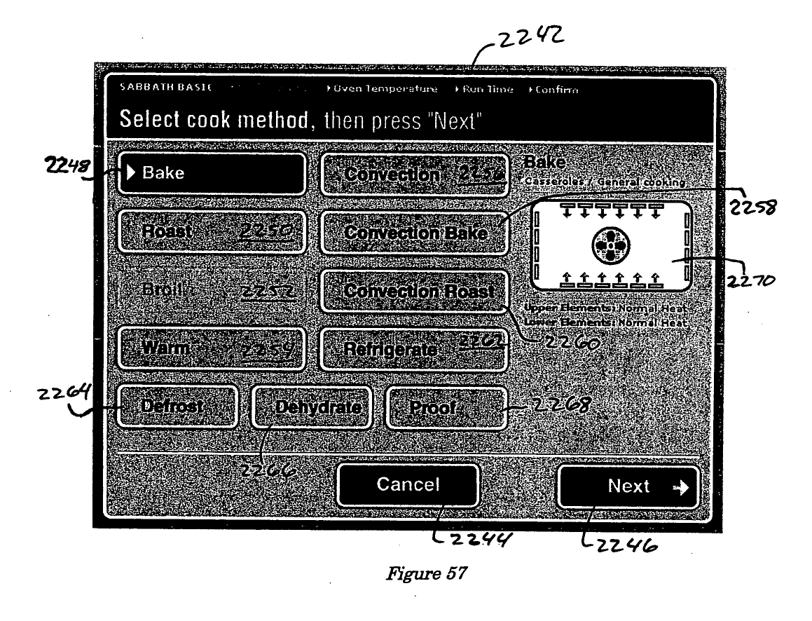

After electing to proceed, flow proceeds to step 1328, wherein a cook methods Sabbath Basic screen is displayed to the user. The cook methods Sabbath screen is suitably illustrated in the template 2242 shown in FIG. 57. As depicted in FIG. 57, the cook methods Sabbath Basic screen 2242 includes icons representative of several cooking options, including, for example and without limitation, a bake icon 2248, a roast icon 2250, a broil icon 2252, a warm icon 2254, a convection icon 2256, a convection bake icon 2258, a convection roast icon 2260, a refrigerate icon 2262, a defrost icon 2264, a dehydrate icon 2266 and a proof icon 2268. The skilled artisan will appreciate that the foregoing icons 2248-2268 are representative of cooking/cooling operations capable of being performed by the cooking appliance 102 and are for example purposes only. Other cooking/cooling operations are equally capable of being performed by the cooking appliance without departing from the scope of the present invention. FIG. 57 further includes a graphical illustration window 2270 suitably adapted to provide a visual queue to the user representative of the cooking or cooling operation selected. Thus, for example and without limitation, the screen 2242 illustrates that a bake operation has been selected, which is shown in the window 2270. It will be understood by those skilled in the art that each icon 2248-2268 advantageously corresponds to a different graphical representation which is capable of being shown to the user via the window 2270. The Sabbath/Holiday Basic screen template 2242 further includes a next icon 2246 and a cancel icon 2244, the function of which will be explained in greater detail below.

When the user selects the bake icon 2248 at step 1330, flow proceeds to step 1332, whereupon the window 2270 displays a graphical representation of a baking operation to be performed by the cooking appliance 102. Similarly, when the user selects the roast icon 2250 at step 1334, flow proceeds to step 1336, whereupon the window 2270 displays a graphical representation of a roasting operation to be performed by the cooking appliance 102. It will be appreciated by those skilled in the art that the broil cooking operation, represented by the broil icon 2252 is not available for pre-programming in the preferred embodiment. However, in accordance with one particular embodiment of the present invention, the user selects the broil icon 2252 and operations proceed, for example, as discussed below with respect to the roast cooking operation. To program a convection cooking operation, the user selects the convection icon 2256 at step 1338, whereupon the window 2270 depicts a convection cooking operation at step 1340. To program a convection bake cooking operation to be performed by the cooking appliance 102 as part of the Sabbath/Holiday Basic cooking operations, the user selects the convection bake icon 2258 at step 1342, whereupon a graphical representation of a convection baking operation is displayed in the window 2270 at step 1344. To program a convection roast operation, the user selects the convection roast icon 2260 at step 1346, whereupon the window 2270 displays a graphical representation of a convection roasting operation at step 1348. To program a dehydrating cooking operation, the user selects the dehydrate icon 2266 at step 1350, whereupon a graphical representation of a dehydrating operation is displayed in the window 2270 at step 1352. To include a warming operation in the Sabbath/Holiday Basic program, the user selects the warm icon 2254 at step 1354, whereupon the window 2270 illustrates a graphical representation of a warming operation at step 1356. To program a proofing cooking operation, the user selects the proof icon 2268 at step 1358, which prompts the display of a representation of a proofing cooking operation in the window 2270 at step 1360. When it is desired to include a defrosting operation, the user selects the defrost icon 2264 at step 1362, which prompts the window 2270 to display a graphical representation of a defrosting operation at step 1364. To incorporate a refrigeration operation into the Sabbath/Holiday Basic cooking program, the user selects the refrigerate icon 2262 at step 1366, whereupon a refrigeration illustration is shown in the window 2270 at step 1368. Irrespective of which icon 2248-2268 is selected by the user, to negate the selection, the user selects the cancel icon 2244 at step 1372, whereupon flow returns to the Sabbath/Holiday screen 2224 at step 1308. When the user desires to proceed with the programming of the Sabbath/Holiday Basic program, the user selects the next icon 2246 at step 1370, whereupon flow proceeds to step 1452, step 1454, or step 1456 of FIG. 44, dependent upon the type of cooking operation selected, e.g., bake, dehydrate, roast, convection, refrigerate, etc.

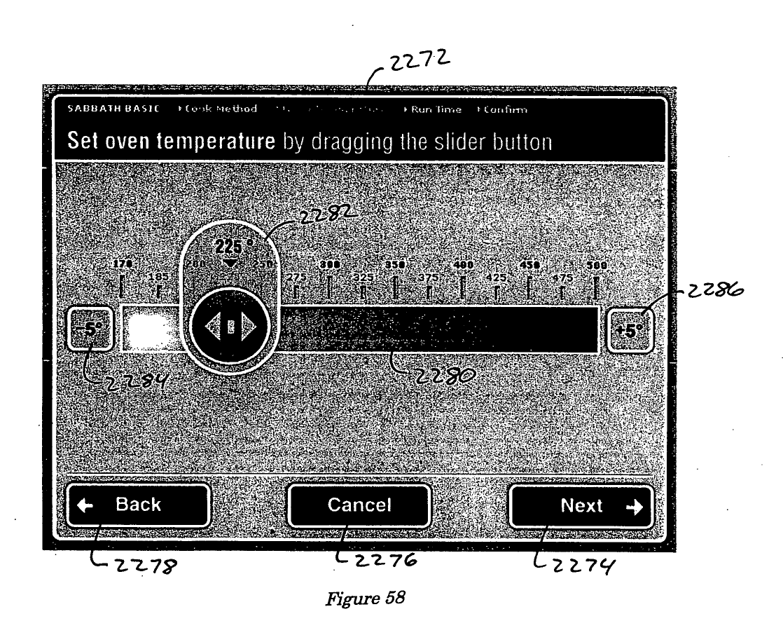

FIG. 44 illustrates a second tier architecture 1450 corresponding to the Sabbath/Holiday Basic cooking operations capable of being performed by the cooking appliance 102 in accordance with the present invention. Once the user has selected a bake, roast, convection, convection bake or convection roast operation, flow proceeds from step 1370 of FIG. 42 to step 1452 of FIG. 44, which signifies the user selection of the next icon 2246. As shown in FIG. 44, when the user has selected the dehydrate operation, flow proceeds from step 1370 of FIG. 42 to step 1454 of FIG. 44. Similarly, when the user selected the warm, defrost, refrigerate, or proof operations, flow proceeds from step 1370 of FIG. 42 to step 1456 of FIG. 44. Returning to step 1452, the user has selected the next icon, whereupon flow proceeds to step 1458. At step 1458, a temperature selection screen is suitably displayed to the user for selection of the temperature at which the cooking item is to be roasted, baked, or the like. In the preferred embodiment, the temperature variations correspond to oven temperatures of 150 degrees to 500 degrees Fahrenheit. The skilled artisan will appreciate that this temperature range is for example purposes only and the upper and lower ends of the range are capable of adjustment in either direction without departing from the scope of the present invention. A suitable template temperature selection screen 2272 is illustrated in FIG. 58.

As shown in FIG. 58, the temperature selection screen 2272 includes a graphical representation of a temperature range 2280, a sliding selector 2282, a minus five degree adjustment icon 2284, a plus five degree adjustment icon 2286, a next icon 2274, a cancel icon 2276, and a back icon 2278. The user adjusts the temperature at step 1458 to the desired cooking temperature using the slide 2282. When fine-tuning is necessary, i.e., to go from 240 degrees to 245 degrees, the user selects the plus five degrees icon 2286, which raises the selected temperature by five degrees. After setting the desired temperature, the user selects the next icon 2274 at step 1470, which prompts the display of a set start/stop time screen at step 1472. The skilled artisan will appreciate that the instant invention enables the user to return to the previous screen 2242 by selecting the back icon 2278 at step 1462, which returns the user to the cook methods Sabbath screen 2242 at step 1466. The skilled artisan will further appreciate that by selecting the cancel icon 2276 at step 1464, the user is returned to the Sabbath/Holiday main screen 2224 at step 1468. When the user has selected the dehydrate cooking operation, flow proceeds from step 1454 to step 1460, whereupon a temperature selection screen is displayed to the user. The skilled artisan will appreciate that the temperature selection screen 2272 is advantageously capable of being used by the user to select the desired dehydration temperature. In the preferred embodiment, the temperature range for the dehydration operation is one hundred degrees to two hundred degrees, in accordance with dehydration temperatures known in the art. Thus, those skilled in the art will understand that the graphical representation of the temperature range 2280 is suitably adjusted for the dehydration operation to reflect a minimum temperature of one hundred degrees and a maximum temperature of two hundred degrees. The foregoing dehydration temperature range is for example purposes only and any dehydration temperature range known in the art is equally capable of being implemented in accordance with the present invention. When the user has selected the warming, defrost, refrigeration, or proofing cooking operations, flow proceeds from step 1456 directly to step 1472, whereupon a start/stop time screen is displayed to the user for further selections.

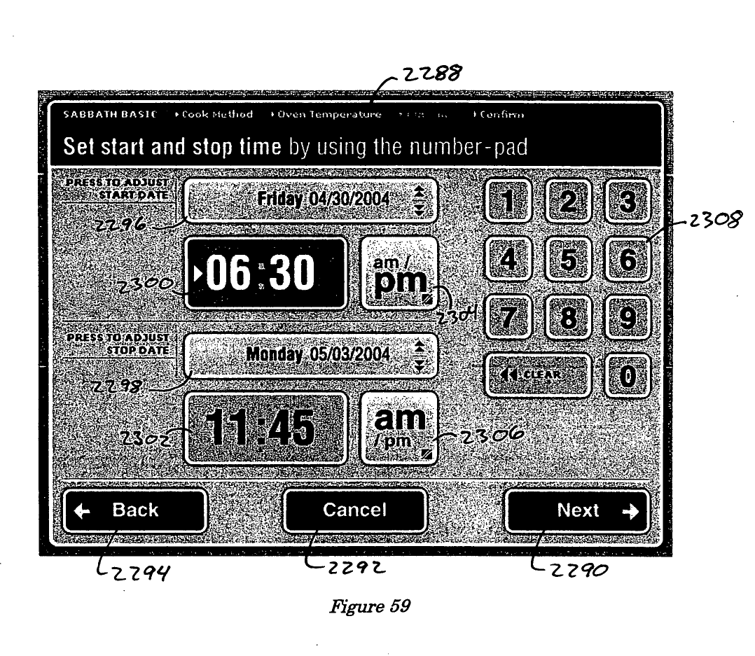

FIG. 59 illustrates a template set start/stop time screen 2288 displayed to the user at step 1472 in accordance with the present invention. As shown in FIG. 59, the screen 2288 includes a start date icon 2296, a stop date icon 2298, a start time icon 2300, a stop time icon 2302, a start time AM/PM toggle icon 2304, a stop time AM/PM toggle icon 2306, a numeric keypad 2308, a next icon 2290, a cancel icon 2292, and a back icon 2294. Returning to FIG. 44, with references herein to FIG. 59, the user first selects the desired start date by selecting the start date icon 2296 at step 1474. In the preferred embodiment, the start date icon 2296 is a scroll-down menu, as is known in the art, enabling the user to navigate to the desired date on which the selected cooking operation is to begin. The user then selects the time at which the selected cooking operation is to begin by selecting the start time icon 2300 at step 1476. It will be appreciated by those skilled in the art that upon selecting the start time icon 2300, the user then inputs the desired start time in hours and minutes using the numeric keypad 2308. The user then selects the appropriate setting via the AM/PM toggle icon 2304 at step 1478.

Similar to the setting of the start time and date information, the user sets the stop date for the cooking operation by selecting the stop date icon 2298 at step 1480. As with the start date icon 2296, the stop date icon 2298 is also a scroll-down menu, as are known in the art, from which the user selects the desired date on which the cooking operation is to be completed. The user then selects the stop time icon 2302 to set the time at which cooking is to be completed at step 1482. It will be appreciated by those skilled in the art that the user inputs the desired stop time via the numeric keypad 2308. The user then selects the appropriate setting via the AM/PM toggle icon 2306 at step 1484.

Upon completion of the selection of the start/stop time, the user is prompted to continue with the setup, cancel the setup, or return to the previous selection screen. To return to the previous selection screen, the user selects the back icon 2294 at step 1486, which returns the user to the previous screen. As the skilled artisan will appreciate, the screen to which the user is returned is dependent upon the cooking operation previously selected. Thus, when the user has selected either the bake, roast, convection, convection bake, or convection roast cooking operations, flow returns from step 1486 to step 1458, whereupon the user is prompted to select the desired cooking temperature. When the user has previously selected the dehydrate cooking operation, flow returns from step 1486 to step 1460, whereupon the user is prompted to select the desired dehydration cooking temperature. When the user had selected the warming cooking operation, flow proceeds from step 1486 to step 1496, whereupon the cook methods Sabbath/Holiday screen 2242 is displayed, with the warm icon 2254 highlighted, thereby indicating the previous selection made by the user. Similarly, when the user had previously selected the proofing cooking operation, flow proceeds from step 1486 to step 1498, whereupon the cook methods Sabbath/Holiday screen 2242 is displayed with the proof icon 2268 highlighted, thereby indicating that the user had previously selected the proof operation. Likewise, when the user selected the defrost operation, flow proceeds from step 1486 to step 1500, whereupon the cook methods Sabbath/Holiday screen 2242 is displayed with the defrost icon 2264 highlighted, thereby indicating the previous selection made by the user. Furthermore, when the user had selected the refrigeration operation, flow proceeds from step 1486 to step 1502, whereupon the cook methods Sabbath/Holiday screen 2242 is displayed, with the refrigerate icon 2262 highlighted, indicating the previous selection made by the user.

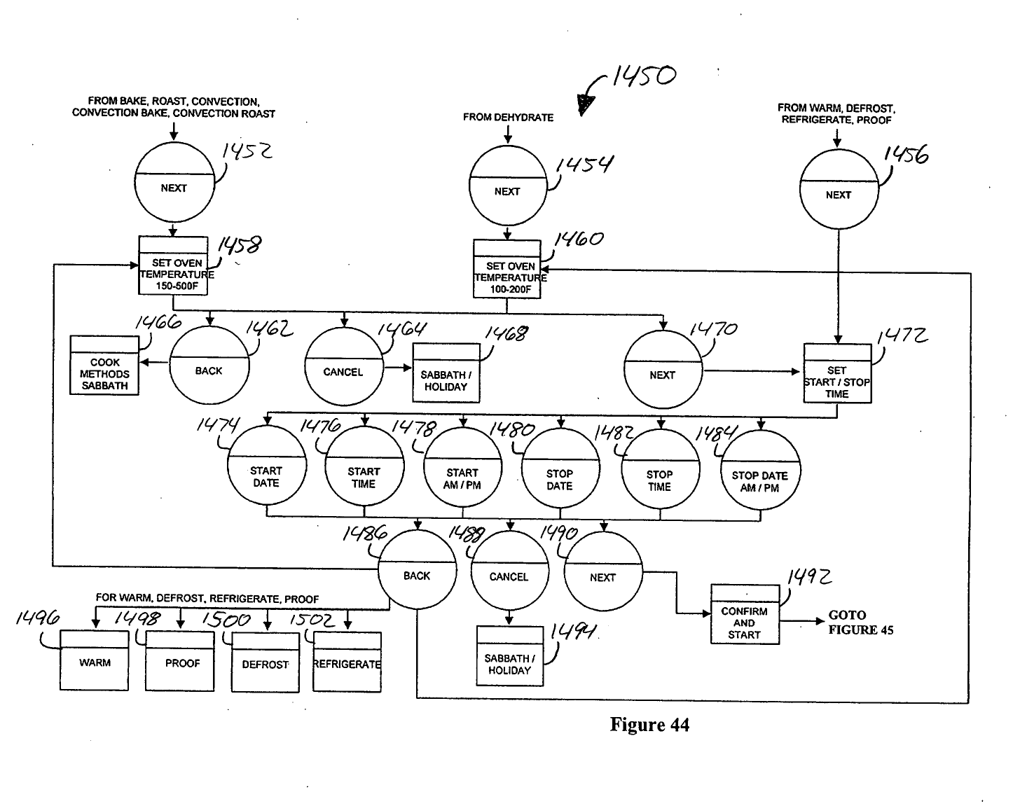

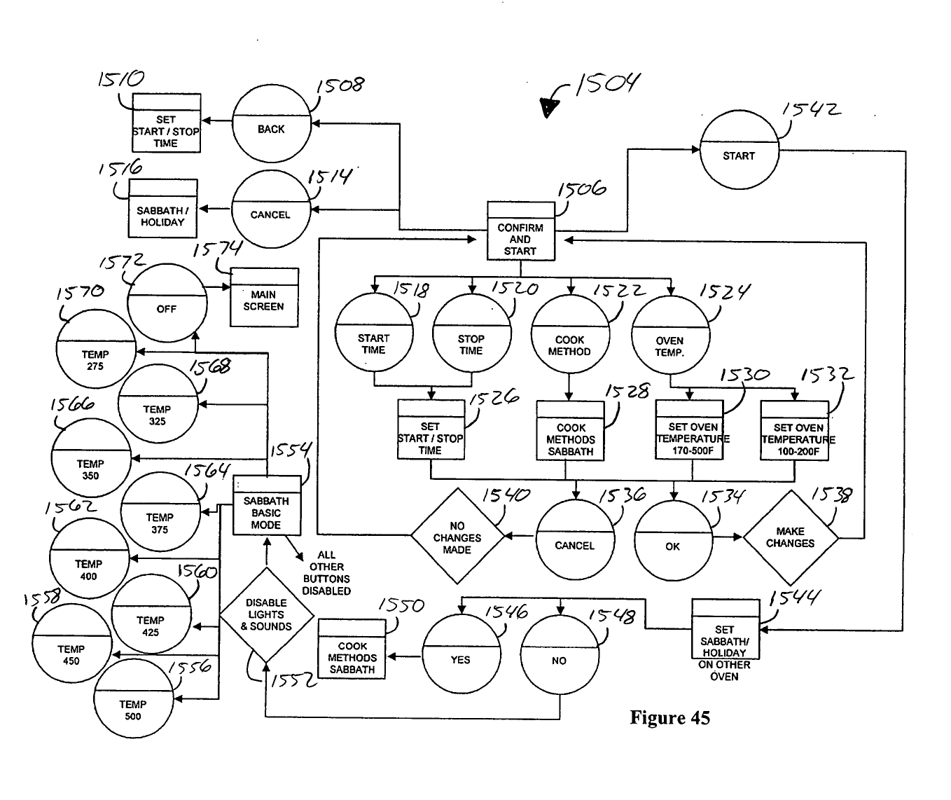

When the user desires to cancel the setup of the Sabbath/Holiday Basic program, the user selects the cancel icon 2292 at step 1488, thereby prompting the display of the main Sabbath/Holiday screen 2224 of FIG. 55 at step 1494, effectively returning the user to step 1308 of FIG. 42. When the user has completed inputting all time and date settings, the user selects the next icon 2290 of FIG. 59 at step 1490, prompting the display of a confirmation and start screen at step 1492. Flow then proceeds from step 1492 of FIG. 44 to step 1506 of FIG. 45. As will be understood by those skilled in the art, FIG. 45 illustrates a third tier architecture 1504 corresponding to the Sabbath/Holiday Basic operations of the cooking appliance 102 in accordance with the present invention. Thus, step 1492 of FIG. 44 correlates to step 1506 of FIG. 45, wherein a confirmation screen, such as screen 2310 of FIG. 60, is displayed to the user via the touchscreen interface 222.

As indicated at step 1506, the confirmation and start screen 2310 of FIG. 60 enables the user to confirm the previous selections made during setup of the Sabbath/Holiday Basic operation of the cooking appliance 102. As shown in FIG. 60, the confirmation and start screen 2310 includes a start time icon 2318, a stop time icon 2320, a cook method icon 2322, an oven temperature icon 2324, a start icon 2312, a cancel icon 2314, and a back icon 2316. Each of these icons will be explained in greater detail below with respect to the discussion corresponding to the screen architecture 1504 of FIG. 45. From the confirmation and start screen 2310 of FIG. 60, the user is able to select, at step 1508, the back icon 2316, which prompts the display to return to the set date and time screen 2288 of FIG. 59 at step 1510. In addition, should the user desire to cancel setup of the Sabbath/Holiday Basic operation previously input, the user selects the cancel icon 2314 at step 1514, which prompts the display of the Sabbath/Holiday main screen 2224 of FIG. 55 at step 1516.

In addition, the user is capable of modifying any of the previous selections for the Sabbath/Holiday Basic operation from the confirmation and start screen 2310 by selecting one of the icons 2318-2324. Thus, when the user selects, at step 1518, the start time icon 2318, flow returns to the set start and stop time screen 2288 of FIG. 59 at step 1526. When the user determines that no changes need be made, the user selects the cancel icon 2292 at step 1536, whereby no changes are made to the start time at step 1540 and flow returns to displaying the confirmation and start screen 2310 at step 1506. When the user has adjusted the start time, the user selects the okay, i.e., next icon 2290, at step 1534, whereby the changes to the start time are made to the Sabbath/Holiday Basic operation at step 1538 and flow returns to displaying the confirmation and start screen 2310 at step 1506. A similar operation occurs when the user desires to adjust the stop time by selection of the stop time icon 2320 at step 1520. Upon selection of the stop time icon 2320, flow proceeds to step 1526 and operations continue thereon, as set forth above with respect to the start time adjustment.

When the user desires to change the previously selected cooking method, the user selects the cook method icon 2322 at step 1522, prompting the display of the cook methods Sabbath screen 2242 of FIG. 57 at step 1528. The user then makes any desired changes to the cook method and selects the okay, i.e., next icon 2246, at step 1534, whereby the changes to the cooking method are made to the Sabbath/Holiday Basic operation at step 1538 and flow returns to displaying the confirmation and start screen 2310 at step 1506. It will be appreciated by those skilled in the art that after changing the desired cooking method, the user is capable of adjusting the other settings from the confirmation and start screen 2310 in accordance with the new cooking method. When the user determines that no changes to the cooking method are desired, the user selects the cancel icon 2244 at step 1536, whereby no changes are made to the cooking method at step 1540 and flow returns to displaying the confirmation and start screen 2310 at step 1506.

When the user desires to change the previously selected cooking or dehydration temperature, the user selects the oven temperature icon 2324 at step 1524, prompting the display of the temperature selection screen 2272 of FIG. 58 at step 1530 or step 1532. The skilled artisan will appreciate that steps 1530 and 1532 result in the display of similar temperature screens 2272, albeit with different temperature range scales 2280. When the cooking method is bake, roast, convection, convection bake, or convection roast, flow proceeds to step 1530, whereupon the temperature range 2280 displayed is from 150-500 degrees Fahrenheit. When the cooking method selected is the dehydrate cooking method, flow proceeds to step 1532, whereupon the temperature range 2280 displayed is from 100-200 degrees Fahrenheit. When the user determines that no changes to the oven temperature are desired, the user selects the cancel icon 2276 at step 1536, whereby no changes are made to the cooking temperature at step 1540 and flow returns to displaying the confirmation and start screen 2310 at step 1506. When the user has adjusted the temperature, the user selects the okay, i.e., next icon 2274 at step 1534, whereby the changes to the cooking temperature are made to the Sabbath/Holiday Basic operation at step 1538 and flow returns to displaying the confirmation and start screen 2310 at step 1506.

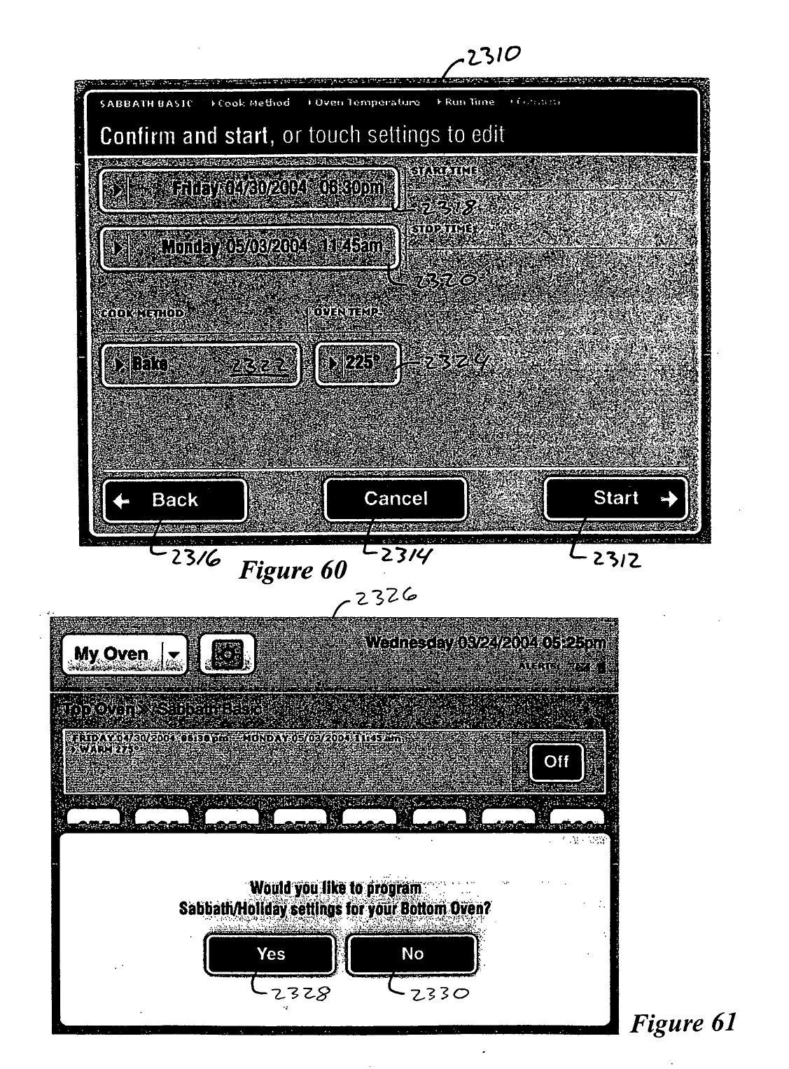

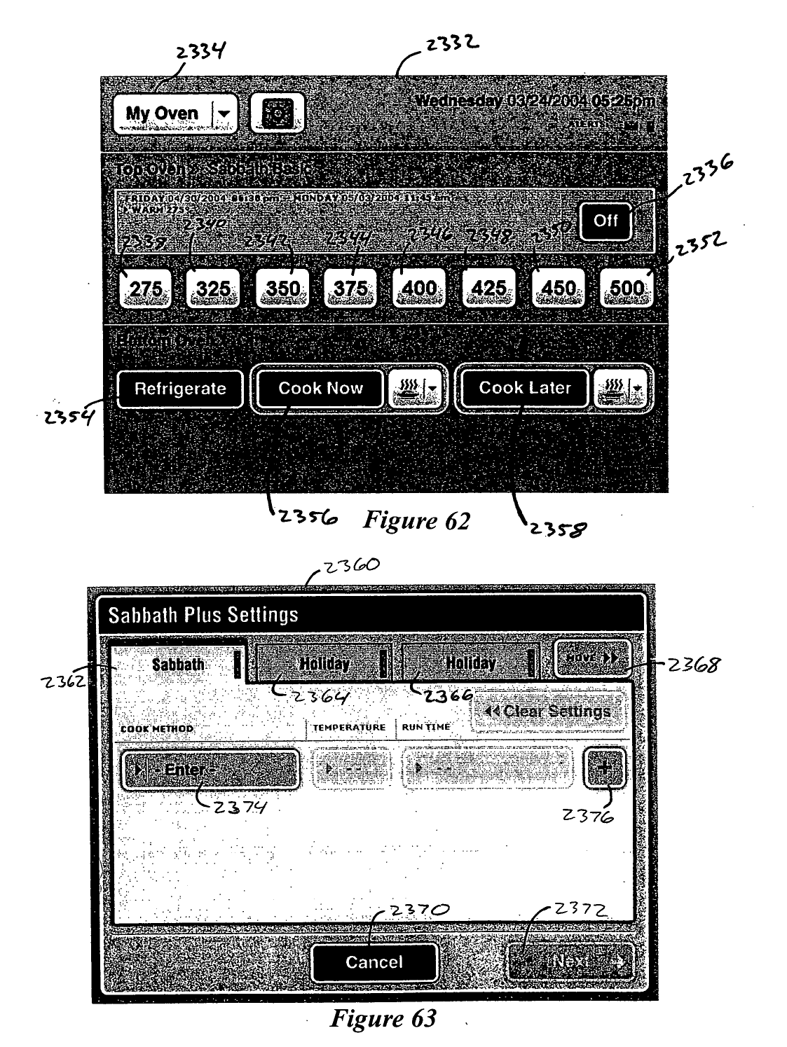

When the user selects the start icon 2312 at step 1542, flow proceeds to step 1544, whereupon the user is prompted to set a Sabbath/Holiday Basic program for the other cooking chamber. FIG. 61 suitably illustrates a template screen query window 2326 prompting the user to select a yes icon 2328 to set up a second program for the other cooking chamber or a no icon 2330 to continue with the current Sabbath/Holiday Basic program. When the user selects the yes icon 2328 at step 1546, flow proceeds to step 1550, whereupon the cook methods selection screen 2242 of FIG. 57 is displayed to the user for selection of the cooking method to be used by the new oven chamber. Operations continue thereon as discussed above. When the user selects the no icon 2330 at step 1548, indicating that no additional program is to be setup for the other oven chamber, flow proceeds to step 1552, wherein all lights and sounds produced by the cooking appliance are disabled, in accordance with the Sabbath settings. At step 1554 a Sabbath Basic mode screen is illustrated by the touchscreen interface 222 to the user. A suitable template for the Sabbath Basic screen is illustrated in FIG. 62 at 2332.

As shown in FIG. 62, the Sabbath Basic mode screen 2332 includes a my oven icon 2334, an off icon 2336, a 275 degree icon 2338, a 325 degree icon 2340, a 350 degree icon 2342, a 375 degree icon 2344, a 400 degree icon 2346, a 425 degree icon 2348, a 450 degree icon 2350, a 500 degree icon 2352, a refrigerate icon 2354, a cook now icon 2356 and a cook later icon 2358. In accordance with the Sabbath Basic operation mode, and as addressed above, there is limited functionality provided by the screen 2332 while Sabbath Basic mode is in operation. Thus, icons 2334, 2354, 2356, and 2358 are non-functioning while the Sabbath Basic program is running, per the selections made previously by the user. Temperature icons 2338-2352 remain functional and capable of selection by the user via steps 1570-1556, respectively. The off icon 2336 is also functional, and the selection thereof by the user at step 1572 prompts a return to the main screen 400 at step 1574.

Sabbath Plus Settings

Returning to step 1312 of the architecture 1306 of FIG. 42, flow proceeds, upon user selection of the Sabbath Plus icon 2228 of FIG. 55 to step 1376 of the first tier Sabbath Plus screen architecture 1374 illustrated in FIG. 43. Thus, step 1376 of FIG. 43 corresponds to the user selection of the Sabbath Plus icon 2228 at step 1312 of FIG. 42. When the user selects the Sabbath Plus operation via the Sabbath Plus icon 2228 at step 1376, flow proceeds to step 1378, whereupon the select an oven screen 2232 of FIG. 56 is displayed. The user then selects the desired cooking chamber, e.g., the top chamber 104 via the top oven icon 2238 at step 1384, the bottom chamber 106 via the bottom oven icon 2240 at step 1386. When the user desires to exit the setup of the Sabbath Plus operation, the user selects the cancel icon 2236 at step 1380, whereby the display is returned to the Sabbath/Holiday screen 2224 of FIG. 55 at step 1382. Once the user has selected the desired cooking chamber, the user selects the okay icon 2234 at step 1388, prompting display of a Sabbath Plus settings screen at step 1390.

A Sabbath Plus settings screen is illustrated in FIG. 63 as the template 2360, which includes a variety of selection options for the user. As shown in FIG. 63, the screen 2360 includes a Sabbath offset tab 2362, a first Holiday offset tab 2364, a second Holiday offset tab 2366, a move icon 2368, an enter icon 2374, an add a stage icon 2376, a cancel icon 2370, and a next icon 2372. It will be appreciated by those skilled in the art that the next icon 2372 illustrated in FIG. 63 is not enabled as shown. The skilled artisan will understand that the next icon 2372 of screen 2360 advantageously becomes enabled once preconditions, including for example and without limitation the completion of programming at least one cooking stage, have been fulfilled. The cancel icon 2370 is capable of being selected by the user at step 1392 when so desired, returning the display to the Sabbath/holiday main screen 2224 at step 1394.

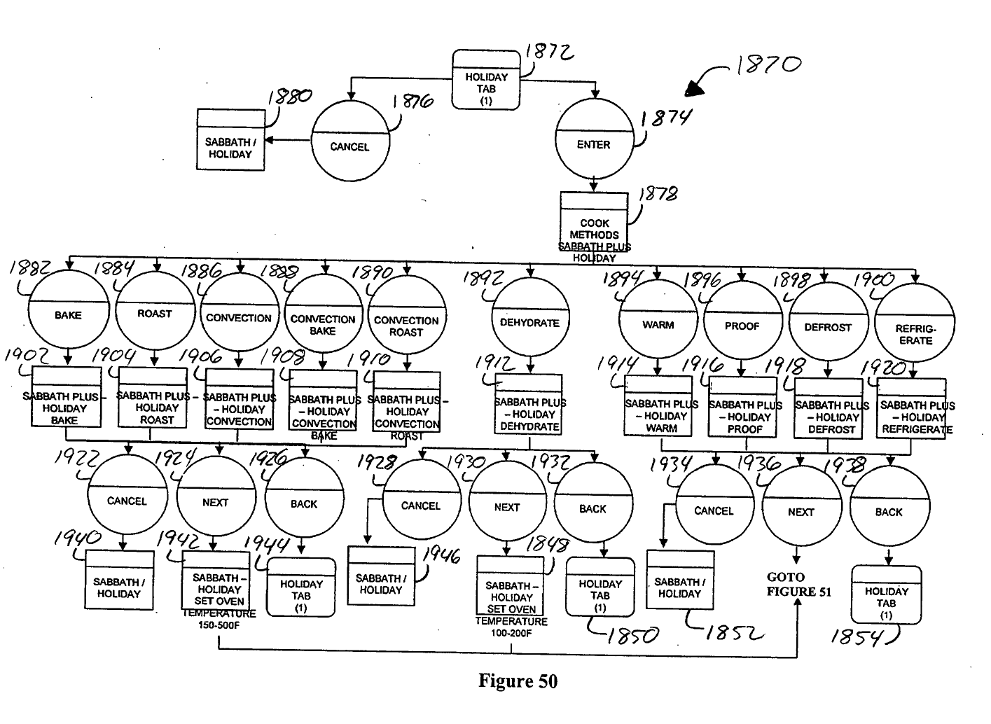

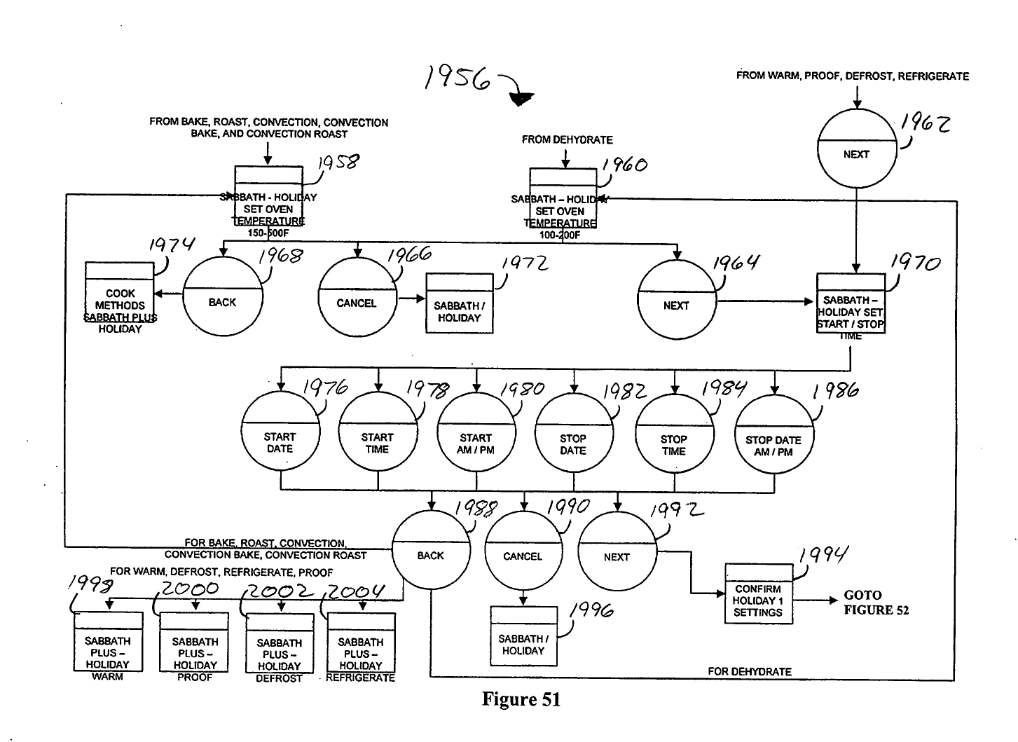

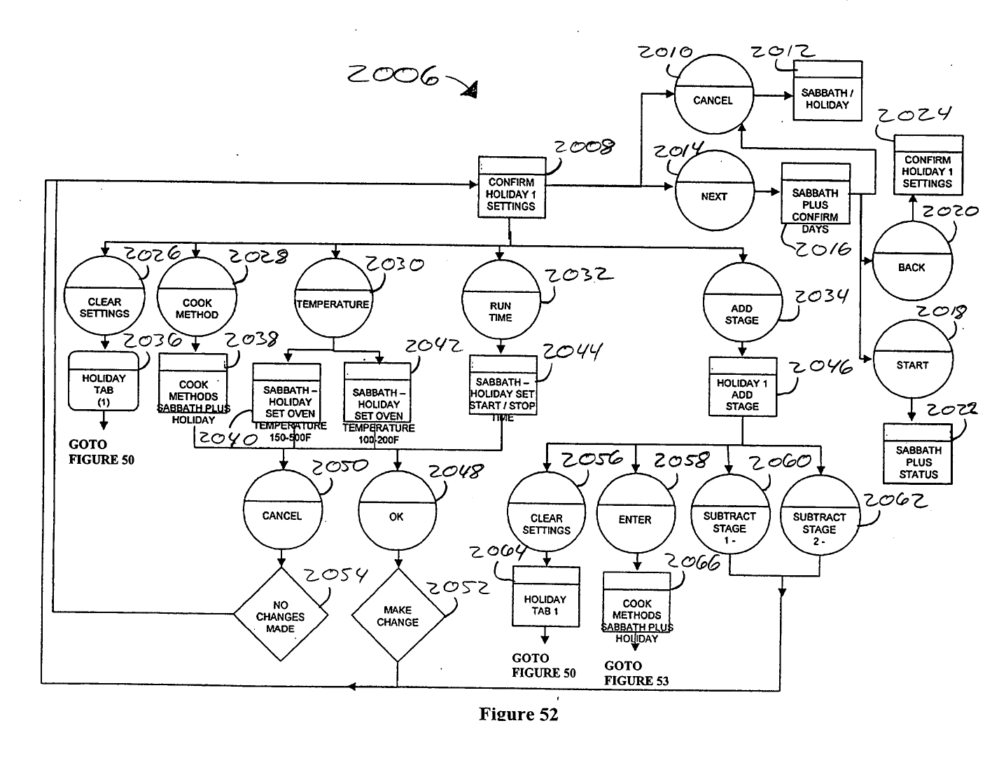

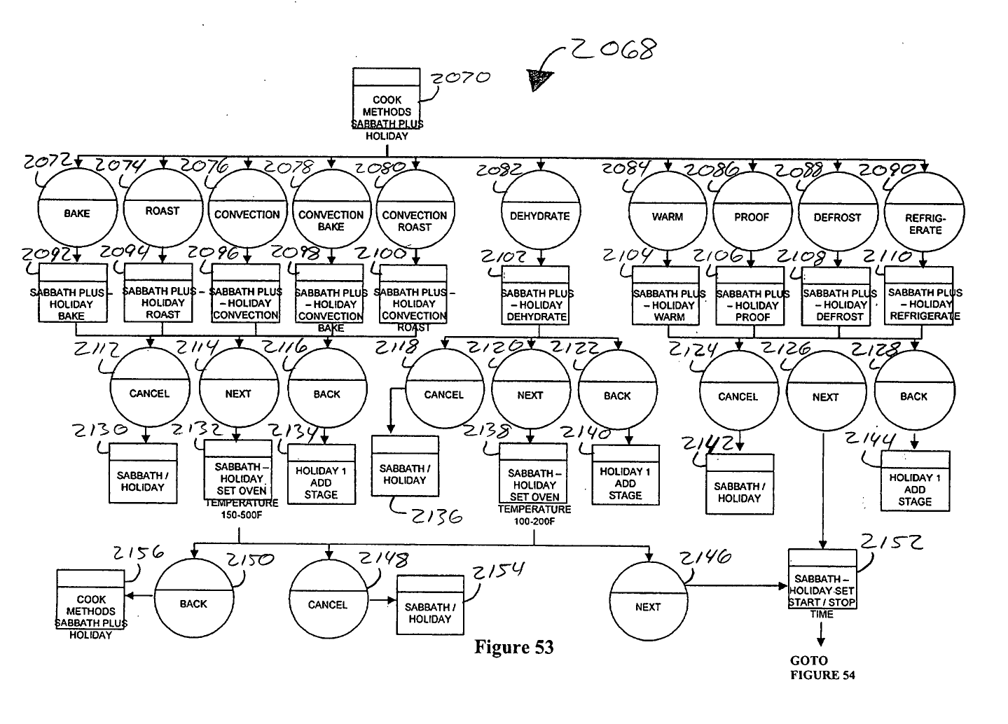

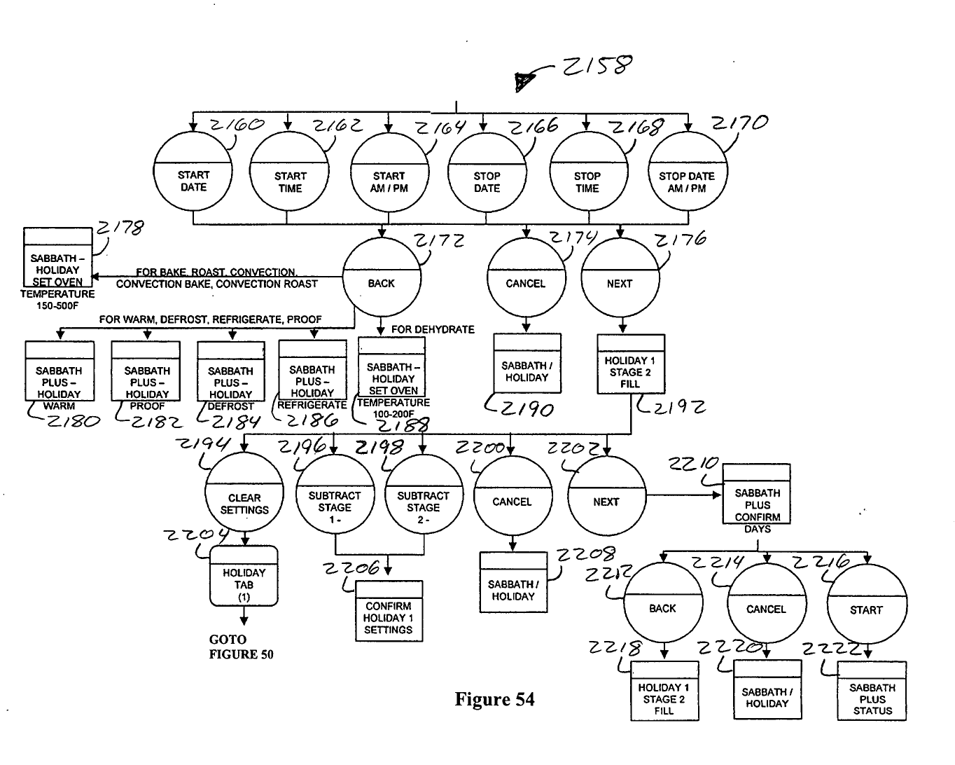

The skilled artisan will appreciate that navigation between the Sabbath offset tab 2362, the first Holiday offset tab 2364, and the second Holiday offset tab 2366 is accomplished upon selection of the move icon 2368 at step 1396. Each time the move icon 2368 is selected, the focus of the screen 2360 is shifted to the next offset tab at step 1398. In accordance with one embodiment of the present invention, the user is able to select the desired offset tab via direct interaction with the tab, thereby bypassing the move icon 2368. Once the last offset tab has been reached, selecting the move icon 2368 again returns the display to the first offset tab. The selection of the first Holiday offset tab 2364 at step 1406, which prompts display of the template screen will be discussed in greater detail below with respect to the system architecture 1870 of FIG. 50, and the selection of the second Holiday offset tab 2366 at step 1408 will be discussed in greater detail below with respect to the screen architecture 2224 of FIG. 55.

Referring now to the selection of the Sabbath offset tab 2362 at step 1400, when the enter icon 2374 is selected by the user at step 1402, flow proceeds to step 1404, whereupon the user is presented with a cook methods plus selection screen. A suitable cook methods Sabbath Plus screen is shown by the template 2380 illustrated in FIG. 65.

As depicted in FIG. 65, the cook methods Sabbath Plus screen 2380 includes icons representative of several cooking options, including, for example and without limitation, a bake icon 2388, a roast icon 2390, a broil icon 2392, a warm icon 2394, a convection icon 2398, a convection bake icon 2400, a convection roast icon 2402, a refrigerate icon 2404, a defrost icon 2396, a dehydrate icon 2406 and a proof icon 2408. The skilled artisan will appreciate that the foregoing icons 2388-2408 are representative of cooking/cooling operations capable of being performed by the cooking appliance 102 and are for example purposes only. Other cooking/cooling operations are equally capable of being performed by the cooking appliance without departing from the scope of the present invention. FIG. 65 further includes a graphical illustration window 2410 suitably adapted to provide a visual cue to the user representative of the cooking or cooling operation selected. Thus, for example and without limitation, the screen 2380 illustrates that a bake operation has been selected, which is shown in the window 2410. It will be understood by those skilled in the art that each icon 2388-2408 advantageously corresponds to a different graphical representation which is capable of being shown to the user via the window 2410. The Sabbath/Holiday Plus screen template 2380 further includes a next icon 2382, a cancel icon 2384, and a back icon 2386 the function of which will be explained in greater detail below.

When the user selects the bake icon 2388 at step 1410, flow proceeds to step 1412, whereupon the window 2410 displays a graphical representation of a baking operation to be performed by the cooking appliance 102. Similarly, when the user selects the roast icon 2390 at step 1414, flow proceeds to step 1416, whereupon the window 2410 displays a graphical representation of a roasting operation to be performed by the cooking appliance 102. It will be appreciated by those skilled in the art that the broil cooking operation, represented by the broil icon 2392 is not available for pre-programming in the preferred embodiment. However, in accordance with one particular embodiment of the present invention, the user selects the broil icon 2392 and operations proceed, for example, as discussed below with respect to the roast cooking operation. To program a convection cooking operation, the user selects the convection icon 2398 at step 1418, whereupon the window 2410 depicts a convection cooking operation at step 1420. To program a convection bake cooking operation to be performed by the cooking appliance 102 as part of the Sabbath/Holiday Plus cooking operations, the user selects the convection bake icon 2400 at step 1422, whereupon a graphical representation of a convection baking operation is displayed in the window 2410 at step 1424. To program a convection roast operation, the user selects the convection roast icon 2402 at step 1426, whereupon the window 2410 displays a graphical representation of a convection roasting operation at step 1428. To program a dehydrating cooking operation, the user selects the dehydrate icon 2406 at step 1430, whereupon a graphical representation of a dehydrating operation is displayed in the window 2410 at step 1432. To include a warming operation in the Sabbath/Holiday Plus program, the user selects the warm icon 2394 at step 1434, whereupon the window 2410 illustrates a graphical representation of a warming operation at step 1436. To program a proofing cooking operation, the user selects the proof icon 2408 at step 1438, which prompts the display of a representation of a proofing cooking operation in the window 2410 at step 1440. When it is desired to include a defrosting operation, the user selects the defrost icon 2396 at step 1442, which prompts the window 2410 to display a graphical representation of a defrosting operation at step 1444. To incorporate a refrigeration operation into the Sabbath/Holiday Plus cooking program, the user selects the refrigerate icon 2404 at step 1446, whereupon a refrigeration illustration is shown in the window 2410 at step 1448.

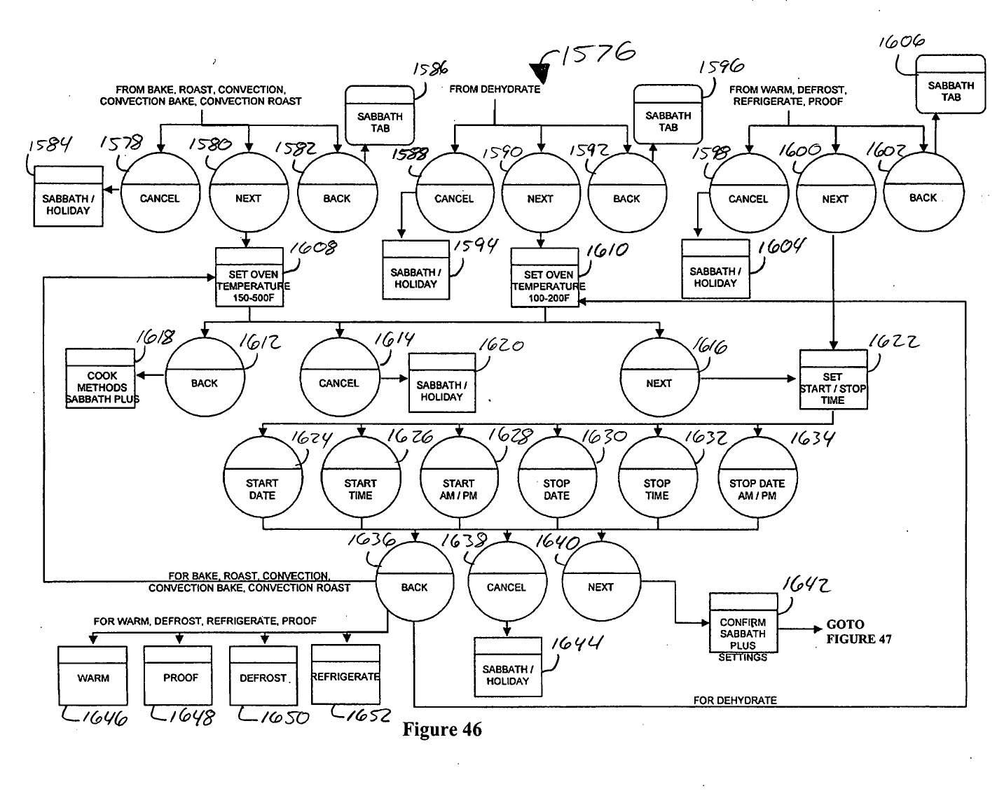

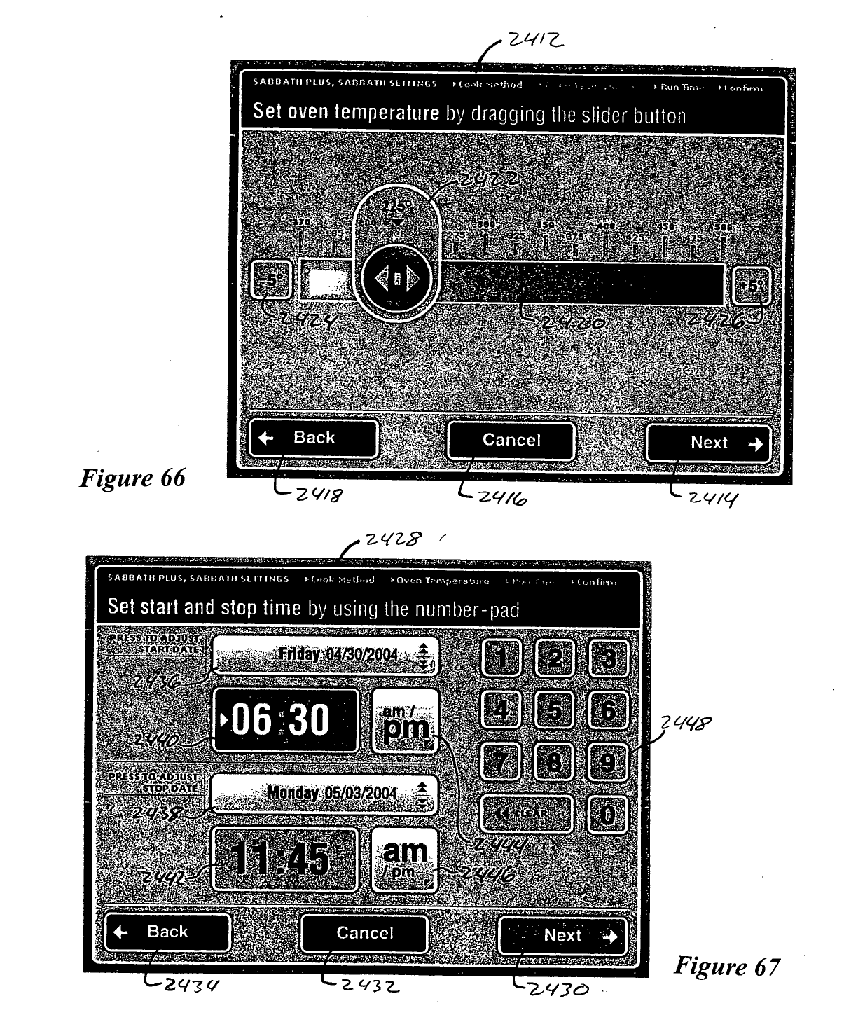

When the user desires to proceed with the programming of the Sabbath Plus program and has selected the bake icon 2388 at step 1410, the roast icon 2390 at step 1414, the convection icon 2398 at step 1418, the convection bake icon 2400 at step 1422, or the convection roast icon 2402 at step 1426, flow proceeds to the second tier of Sabbath Plus screen architecture 1576 of FIG. 46 for further user input at steps 1578, 1580, or 1582. As illustrated in FIG. 65, the user is presented with the ability to cancel the Sabbath Plus programming operation by selecting the cancel icon 2384 at step 1578, return to the previous screen 2378 by selecting the back icon 2386 at step 1582, or proceed to the next step of programming the Sabbath Plus operation by selecting the next icon 2382 at step 1580. When the user selects the cancel icon 2384 at step 1578, flow proceeds to step 1584, wherein the display is returned to the Sabbath/Holiday main screen 2224. When the user selects the back icon 2386 at step 1582, flow proceeds to step 1586, whereby the display reverts to the Sabbath tab screen 2360 of FIG. 63. When the user selects the next icon 2382 at step 1580, flow proceeds to step 1608, whereupon a set oven temperature screen 2412 is displayed, as illustrated in FIG. 66. In the preferred embodiment, the temperature variations corresponding to the bake, roast, convection, convection bake, and convection roast cooking operations correlate to a range of oven temperatures from 150 degrees to 500 degrees Fahrenheit. The skilled artisan will appreciate that this temperature range is for example purposes only and the upper and lower ends of the range are capable of adjustment in either direction without departing from the scope of the present invention.

As shown in FIG. 66, the temperature selection screen 2412 includes a graphical representation of a temperature range 2420, a sliding selector 2422, a minus five degree adjustment icon 2424, a plus five degree adjustment icon 2426, a next icon 2414, a cancel icon 2416, and a back icon 2418. The user adjusts the temperature at step 1608 to the desired cooking temperature using the sliding selector 2422. When fine-tuning is necessary, i.e., to change from 240 degrees to 245 degrees, the user selects that plus five degrees icon 2426, which raises the selected temperature by five degrees. The skilled artisan will appreciate that the instant invention enables the user to return to the previous screen 2380 by selecting the back icon 2418 at step 1612, which returns the user to the cook methods Sabbath screen 2380 at step 1618. The skilled artisan will further appreciate that by selecting the cancel icon 2416 at step 1614, the user is returned to the Sabbath/Holiday main screen 2224 of FIG. 55 at step 1620. After setting the desired temperature, the user selects the next icon 2414 at step 1616, which prompts the display of a set start/stop time screen at step 1622.

When the user desires to proceed with the programming of the Sabbath Plus program and has selected the dehydrate icon 2406 at step 1430 of FIG. 43, flow proceeds to the second tier of Sabbath Plus screen architecture 1576 of FIG. 46 for further user input at steps 1588, 1590, or 1592. As illustrated in FIG. 65, the user is presented with the ability to cancel the Sabbath Plus programming operation by selecting the cancel icon 2384 at step 1588, return to the previous screen 2378 by selecting the back icon 2386 at step 1592, or proceed to the next step of programming the Sabbath Plus operation by selecting the next icon 2382 at step 1590. When the user selects the cancel icon 2384 at step 1588, flow proceeds to step 1594, wherein the display is returned to the Sabbath/Holiday main screen 2224. When the user selects the back icon 2386 at step 1592, flow proceeds to step 1596, whereby the display reverts to the Sabbath tab screen 2378. When the user selects the next icon 2382 at step 1590, flow proceeds to step 1610, whereupon a set oven temperature screen 2412 is displayed, as illustrated in FIG. 66.

The skilled artisan will appreciate that the temperature selection screen 2412 advantageously enables the user to select the desired dehydration temperature. In the preferred embodiment, the temperature range for the dehydration operation is one hundred degrees to two hundred degrees, in accordance with dehydration temperatures known in the art. Thus, those skilled in the art will understand that the graphical representation of the temperature range 2412 is suitably adjusted for the dehydration operation to reflect a minimum temperature of one hundred degrees and a maximum temperature of two hundred degrees. The foregoing dehydration temperature range is for example purposes only and any dehydration temperature range known in the art is equally capable of being implemented in accordance with the present invention. The skilled artisan will appreciate that the instant invention enables the user to return to the previous screen 2380 by selecting the back icon 2418 at step 1612, which returns the user to the cook methods Sabbath screen 2380 at step 1618 of FIG. 46. The skilled artisan will further appreciate that by selecting the cancel icon 2416 at step 1614, the user is returned to the Sabbath/Holiday main screen 2224 at step 1620. After setting the desired temperature, the user selects the next icon 2414 at step 1616, which prompts the display of a set start/stop time screen at step 1622.

When the user desires to proceed with the programming of the Sabbath Plus program and has selected the warm icon 2394 at step 1434 of FIG. 43, the proof icon 2408 at step 1438, the defrost icon 2396 at step 1442, or the refrigerate icon 2404 at step 1446, flow proceeds to the second tier of Sabbath Plus screen architecture 1576 of FIG. 46 for further user input at steps 1598, 1600, or 1602. When the user has selected the warming, defrost, refrigeration, or proofing cooking operations, flow proceeds from step 1600 directly to step 1622, whereupon a start/stop time screen is displayed to the user for further selections.

FIG. 67 illustrates a template set start/stop time screen 2428 displayed to the user at step 1622 in accordance with the present invention. As shown in FIG. 67, the screen 2428 includes a start date icon 2436, a stop date icon 2438, a start time icon 2440, a stop time icon 2442, a start time AM/PM toggle icon 2444, a stop time AM/PM toggle icon 2446, a numeric keypad 2448, a next icon 2430, a cancel icon 2432, and a back icon 2434. Returning to FIG. 46, with references herein to FIG. 67, the user first selects the desired start date by selecting the start date icon 2436 at step 1624. In the preferred embodiment, the start date icon 2436 is a scroll-down menu, as is known in the art, enabling the user to navigate to the desired date on which the selected cooking operation is to begin. The user then selects the time at which the selected cooking operation is to begin by selecting the start time icon 2440 at step 1626. It will be appreciated by those skilled in the art that upon selecting the start time icon 2440, the user then inputs the desired start time in hours and minutes using the numeric keypad 2448. The user then selects the appropriate setting via the AM/PM toggle icon 2444 at step 1628.

Similar to the setting of the start time and date information, the user sets the stop date for the cooking operation by selecting the stop date icon 2438 at step 1630. As with the start date icon 2436, the stop date icon 2438 is also a scroll-down menu, as are known in the art, from which the user selects the desired date on which the cooking operation is to be completed. The user then selects the stop time icon 2442 to set the time at which cooking is to be completed at step 1632. It will be appreciated by those skilled in the art that the user inputs the desired stop time via the numeric keypad 2448. The user then selects the appropriate setting via the AM/PM toggle icon 2446 at step 1634.

Upon completion of the selection of the start/stop time, the user is prompted to continue with the setup, cancel the setup, or return to the previous selection screen. To return to the previous selection screen, the user selects the back icon 2434 at step 1636, which returns the user to the previous screen. As the skilled artisan will appreciate, the screen to which the user is returned is dependent upon the cooking operation previously selected. Thus, when the user has selected either the bake, roast, convection, convection bake, or convection roast cooking operations, flow returns from step 1636 to step 1608, whereupon the user is prompted to select the desired cooking temperature. When the user has previously selected the dehydrate cooking operation, flow returns from step 1636 to step 1610, whereupon the user is prompted to select the desired dehydration cooking temperature. When the user had selected the warming cooking operation, flow proceeds from step 1636 to step 1646, whereupon the cook methods Sabbath/Holiday screen 2380 is displayed, with the warm icon 2394 highlighted, thereby indicating the previous selection made by the user. Similarly, when the user had previously selected the proofing cooking operation, flow proceeds from step 1636 to step 1648, whereupon the cook methods Sabbath/Holiday screen 2380 is displayed with the proof icon 2408 highlighted, thereby indicating that the user had previously selected the proof operation. Likewise, when the user selected the defrost operation, flow proceeds from step 1636 to step 1650, whereupon the cook methods Sabbath/Holiday screen 2380 is displayed with the defrost icon 2396 highlighted, thereby indicating the previous selection made by the user. Furthermore, when the user had selected the refrigeration operation, flow proceeds from step 1636 to step 1652, whereupon the cook methods Sabbath/Holiday screen 2380 is displayed, with the refrigerate icon 2406 highlighted, indicating the previous selection made by the user.

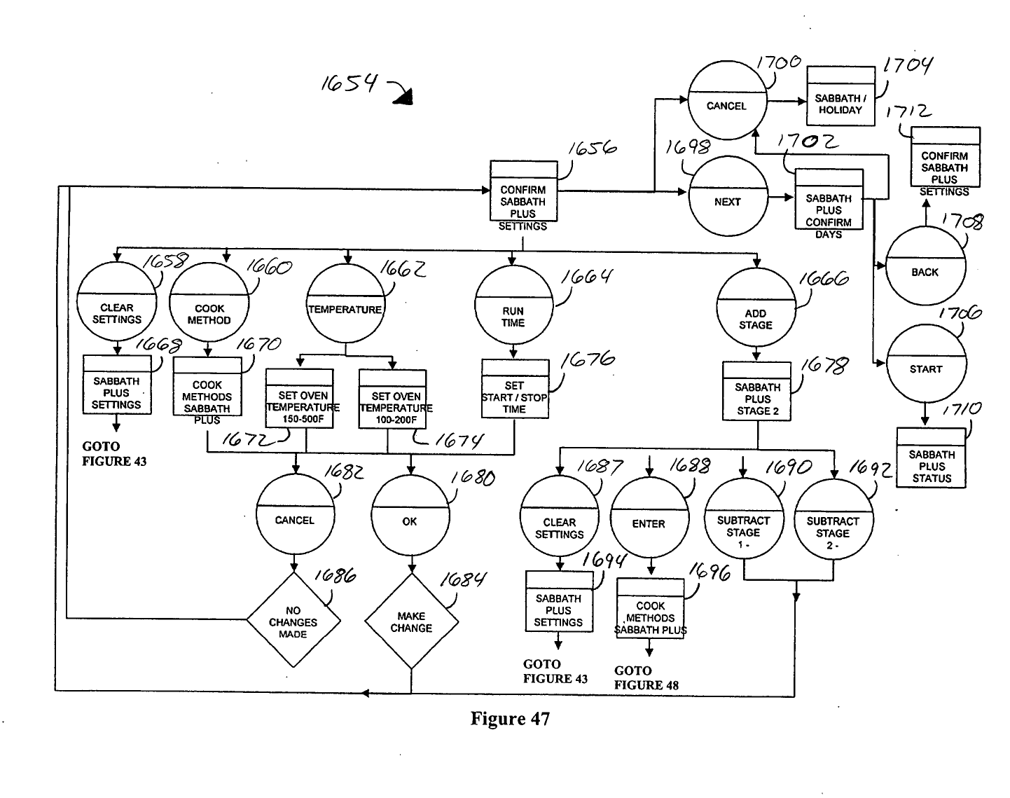

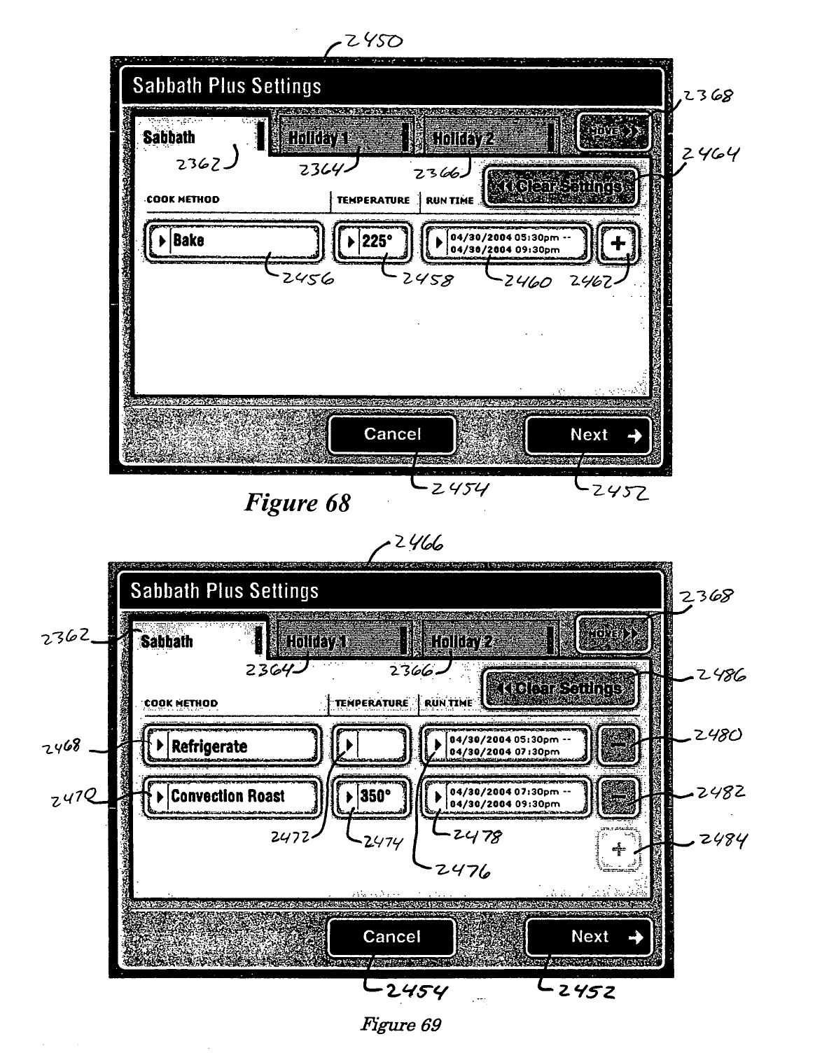

When the user desires to cancel the setup of the Sabbath/Holiday Plus program, the user selects the cancel icon 2432 at step 1638, thereby prompting the display of the main Sabbath/Holiday screen 2224 at step 1644, effectively returning the user to step 1308 of FIG. 42. When the user has completed inputting all time and date settings, the user selects the next icon 2430 at step 1640, prompting the display of a confirmation of Sabbath/Holiday Plus settings screen at step 1642. Flow then proceeds from step 1642 of FIG. 46 to step 1656 of FIG. 47. As will be understood by those skilled in the art, FIG. 47 illustrates a third tier architecture 1654 corresponding to the Sabbath/Holiday Plus operations of the cooking appliance 102 in accordance with the present invention. Thus, step 1642 of FIG. 46 correlates to step 1656 of FIG. 47, wherein a confirmation screen, such as screen 2450 of FIG. 68, is displayed to the user via the touchscreen interface 222.

As indicated at step 1656, the confirmation screen 2450 of FIG. 68 enables the user to confirm the previous selections made during setup of the Sabbath/Holiday Plus operation of the cooking appliance 102. As shown in FIG. 68, the confirmation screen 2450 includes the Sabbath offset tab 2362, the first Holiday offset tab 2364, the second Holiday offset tab 2366, the move icon 2368, a cook method icon 2456, an oven temperature icon 2458, a run-time icon 2460, an add stage icon 2462, a clear settings icon 2464, a next icon 2452, and a cancel icon 2454. Each of these icons will be explained in greater detail below with respect to the discussion corresponding to the screen architecture 1656 of FIG. 47. When the user desires to cancel setup of the Sabbath/Holiday Plus operation previously input, the user selects the cancel icon 2454 at step 1700, which prompts the display of the Sabbath/Holiday main screen 2224 of FIG. 55 at step 1704.

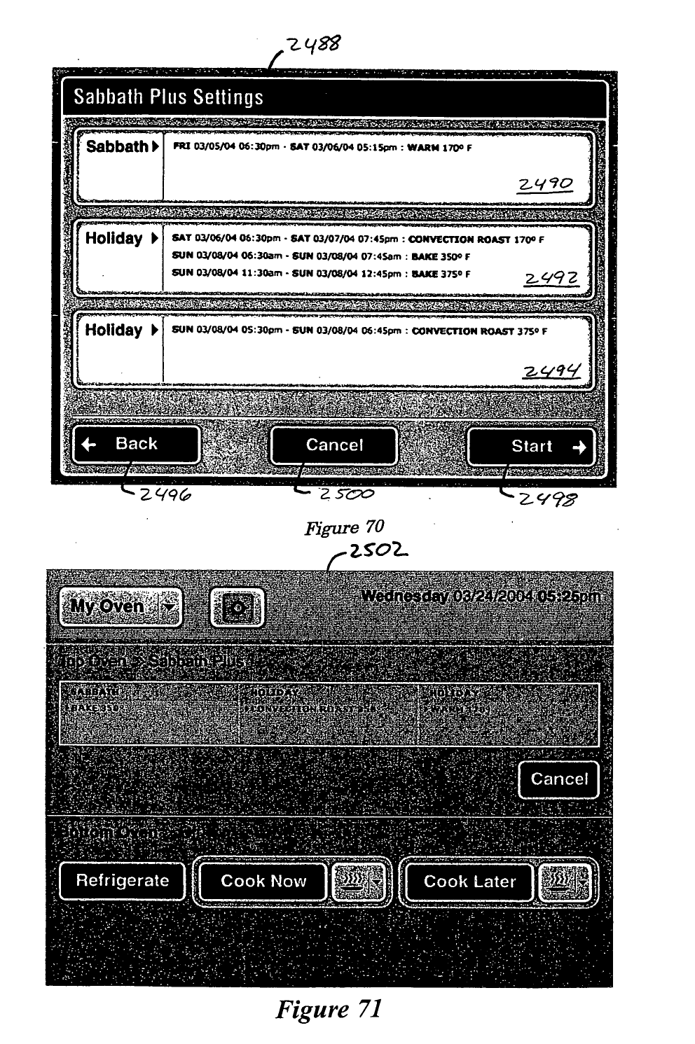

When the user is satisfied with the selections made to the Sabbath Plus cooking operation, the user selects the next icon 2452 at step 1698, which prompts the display of a confirm days screen 2488 of FIG. 70 at step 1702. As illustrated in FIG. 70, the confirm days screen 2488 includes text windows representative of the cooking program corresponding to the Sabbath Plus cooking operation 2490, the first Holiday cooking operation 2492, as well as the second Holiday cooking operation 2494. The skilled artisan will appreciate that in the preferred embodiment, when no program has been entered for a given cooking operation, the text window corresponding to that operation is left blank or not shown on the confirm days screen 2488. When the user desires to modify any of the programmed variables, the user selects the back icon 2496 of screen 2488 at step 1708, which returns display and operations to the confirm Sabbath Plus settings screen 2450 of FIG. 68 at step 1712. When the user is satisfied with the Sabbath Plus program, the user selects the start icon 2498 at step 1706, whereupon a Sabbath Plus status screen is displayed at step 1710. Those skilled in the art will appreciate that a suitable Sabbath Plus status screen is illustrated in FIG. 71 at 2502.

In addition, the user is capable of modifying any of the previous selections for the Sabbath/Holiday Plus operation from the confirmation screen 2450 by selecting one of the icons 2456-2464. From the confirmation screen 2450 of FIG. 68, the user is able to select, at step 1658, the clear settings icon 2464, which prompts display of the Sabbath Plus settings screen 2360 at step 1668. When the user desires to change the previously selected cooking method, the user selects the cook method icon 2456 at step 1660, prompting the display of the cook methods Sabbath screen 2380 of FIG. 65 at step 1670. The user then makes any desired changes to the cook method and selects the okay, i.e., next icon 2382, at step 1680, whereby the changes to the cooking method are made to the Sabbath/Holiday Plus operation at step 1684 and flow returns to displaying the confirmation screen 2450 at step 1656. It will be appreciated by those skilled in the art that after changing the desired cooking method, the user is capable of adjusting the other settings from the confirmation screen 2450 in accordance with the new cooking method. When the user determines that no changes to the cooking method are desired, the user selects the cancel icon 2384 at step 1682, whereby no changes are made to the cooking method at step 1686 and flow returns to displaying the confirmation screen 2450 at step 1656.

When the user desires to change the previously selected cooking or dehydration temperature, the user selects the oven temperature icon 2458 at step 1662, prompting the display of the temperature selection screen 2412 of FIG. 66 at step 1672 or step 1674. The skilled artisan will appreciate that steps 1672 and 1674 result in the display of similar temperature screens 2412, albeit with different temperature range scales 2420. When the cooking method is bake, roast, convection, convection bake, or convection roast, flow proceeds to step 1672, whereupon the temperature range 2420 displayed is from 150-500 degrees Fahrenheit. When the cooking method selected is the dehydrate cooking method, flow proceeds to step 1674, whereupon the temperature range 2420 displayed is from 100-200 degrees Fahrenheit. When the user determines that no changes to the oven temperature are desired, the user selects the cancel icon 2416 at step 1682, whereby no changes are made to the cooking temperature at step 1686 and flow returns to displaying the confirmation screen 2450 at step 1656. When the user has adjusted the temperature, the user selects the okay, i.e., next icon 2414 at step 1680, whereby the changes to the cooking temperature are made to the Sabbath/Holiday Plus operation at step 1684 and flow returns to displaying the confirmation screen 2450 at step 1656.

In the event that the user desires to adjust the run times associated with the selected cooking operations, the user selects the run-time icon 2460 at step 1664, which prompts the display of the set start and stop time screen 2428 of FIG. 67 at step 1676. The user is then able to adjust the start and stop times of the selected cooking operation as set forth above. When the user elects to save the changes made to the start or stop times, the user selects the okay, i.e., next icon 2430 at step 1680, whereupon the changes are made to the Sabbath/Holiday Plus program at step 1684. Flow then returns to the confirmation screen 2450 at step 1656. When the user determines that the changes made to the start or stop time are to be discarded, the user selects the cancel icon 2432 at step 1682, whereupon no changes are made to the previously input start or stop times at step 1686 and flow returns to the display of the confirmation screen 2450 at step 1656.

When the user determines that an additional stage is to be added, i.e., another step in the Sabbath Plus cooking or cooling operation is required, the user selects the add a stage icon 2462 at step 1666, which prompts the display of an add a stage screen at step 1678, illustrated at 2466 in FIG. 69. As shown in FIG. 69, the add a stage screen 2466 includes the Sabbath offset tab 2362, the first Holiday offset tab 2364, the second Holiday offset tab 2366, the move icon 2368, a first stage cook method icon 2468, a first stage temperature icon 2472, a first stage run time icon 2476, a remove first stage icon 2480, a second stage cook method icon 2470, a second stage temperature icon 2474, a second stage run time icon 2478, a remove second stage icon 2482, an add a third stage icon 2484, a clear settings icon 2486, a next icon 2452, and a cancel icon 2454.

When the user selects the clear settings icon 2486 at step 1687, flow proceeds to step 1694, whereupon all stages are removed and operations return to step 1390 of FIG. 43. When the user determines that the first cooking stage is no longer needed or desired, the user selects the remove first stage icon 2480 at step 1690, whereby flow returns to the confirmation screen 2450 at step 1656. In addition, when the user determines that an additional cooking stage is not desired, the user selects the remove second stage icon 2482 at step 1692, whereby flow returns to the confirmation screen 2450 at step 1656. However, when the user desires to program the second stage of the Sabbath Plus/Holiday cooking operation, the user selects the enter icon, which is illustrated in FIG. 69 as the second stage cook method icon 2470, the second stage temperature icon 2474, or the second stage run time icon 2478. The skilled artisan will appreciate that the selection of any of the second stage icons 2470, 2474, or 2478 prompts the display, at step 1696 of the cook methods Sabbath Plus selection screen 2380 of FIG. 65. Those skilled in the art will further appreciate that while reference is made above to the selection of one of the second stage icons 2470, 2474, or 2478, the instant invention is equally capable of using a single enter icon, not shown, in place of the three icons to initiate the programming of the second stage of the Sabbath Plus cooking operation.

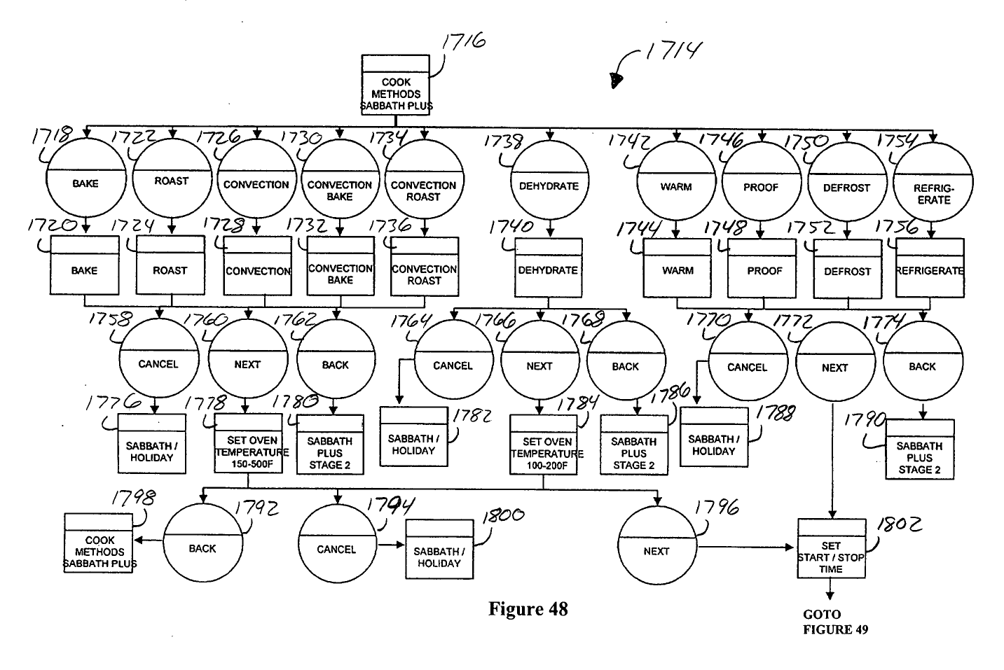

Flow then proceeds from step 1696 of FIG. 47 to the screen architecture 1714 of FIG. 48. Thus, step 1716 of FIG. 48 corresponds to step 1696 of FIG. 47, whereupon the Sabbath Plus cook method selection screen 2380 is displayed.

Add Second Stage to Sabbath Plus

Flow then proceeds from step 1696 of FIG. 47 to the screen architecture 1714 of FIG. 48. Thus, step 1716 of FIG. 48 corresponds to step 1696 of FIG. 47, whereupon the Sabbath Plus cook method selection screen 2380 of FIG. 65 is displayed. It will be appreciated by those skilled in the art that the Sabbath Plus cook method selection screen 2380 displayed in connection with the first stage is capable of being used to select the desired cooking method for the second stage. Thus, the same icons 2388-2408 are used herein with respect to the architecture 1714 of FIG. 48. Similarly, FIG. 65 includes the graphical illustration window 2410, which provides a visual queue to the user representing the cooking or cooling operation selected. Thus, for example and without limitation, the screen 2380 illustrates that a bake operation has been selected, which is shown in the window 2410. It will be understood by those skilled in the art that each icon 2388-2408 advantageously corresponds to a different graphical representation which is capable of being shown to the user via the window 2410. The Sabbath/Holiday Plus screen template 2380 further includes a next icon 2382, a cancel icon 2384, and a back icon 2386 the function of which will be explained in greater detail below.

When the user selects the bake icon 2388 at step 1718, flow proceeds to step 1720, whereupon the window 2410 displays a graphical representation of a baking operation to be performed by the cooking appliance 102. Similarly, when the user selects the roast icon 2390 at step 1722, flow proceeds to step 1724, whereupon the window 2410 displays a graphical representation of a roasting operation to be performed by the cooking appliance 102. It will be appreciated by those skilled in the art that the broil cooking operation, represented by the broil icon 2392 is not available for pre-programming in the preferred embodiment. However, in accordance with one particular embodiment of the present invention, the user selects the broil icon 2392 and operations proceed, for example, as discussed below with respect to the roast cooking operation. To program a convection cooking operation, the user selects the convection icon 2398 at step 1726, whereupon the window 2410 depicts a convection cooking operation at step 1728. To program a convection bake cooking operation to be performed by the cooking appliance 102 as part of the Sabbath/Holiday Plus second stage cooking operations, the user selects the convection bake icon 2400 at step 1730, whereupon a graphical representation of a convection baking operation is displayed in the window 2410 at step 1732. To program a convection roast operation, the user selects the convection roast icon 2402 at step 1734, whereupon the window 2410 displays a graphical representation of a convection roasting operation at step 1736.

To program a dehydrating cooking operation for the second stage of the Sabbath/Holiday Plus operation, the user selects the dehydrate icon 2406 at step 1738, whereupon a graphical representation of a dehydrating operation is displayed in the window 2410 at step 1740. To include a warming operation in the second stage of the Sabbath/Holiday Plus program, the user selects the warm icon 2394 at step 1742, whereupon the window 2410 illustrates a graphical representation of a warming operation at step 1744. To program a proofing cooking operation, the user selects the proof icon 2408 at step 1746, which prompts the display of a representation of a proofing cooking operation in the window 2410 at step 1748. When it is desired to include a defrosting operation, the user selects the defrost icon 2396 at step 1750, which prompts the window 2410 to display a graphical representation of a defrosting operation at step 1752. To incorporate a refrigeration operation into the second stage of the Sabbath/Holiday Plus cooking program, the user selects the refrigerate icon 2404 at step 1754, whereupon a refrigeration illustration is shown in the window 2410 at step 1756.

As illustrated in FIG. 65, the user is presented with the ability to cancel the Sabbath Plus programming operation by selecting the cancel icon 2384 at step 1758, return to the previous screen 2466 of FIG. 69 by selecting the back icon 2386 at step 1762, or proceed to the next step of programming the second stage of the Sabbath Plus operation by selecting the next icon 2382 at step 1760. When the user selects the cancel icon 2384 at step 1758, flow proceeds to step 1776, wherein the display is returned to the Sabbath/Holiday main screen 2224. When the user selects the back icon 2386 at step 1762, flow proceeds to step 1780, whereby the display reverts to the add a stage screen 2466. When the user selects the next icon 2382 at step 1760, flow proceeds to step 1778, whereupon a set oven temperature screen 2412 is displayed, as illustrated in FIG. 66. In the preferred embodiment, the temperature variations corresponding to the bake, roast, convection, convection bake, and convection roast cooking operations correlates to a range of oven temperatures from 150 degrees to 500 degrees Fahrenheit. The skilled artisan will appreciate that this temperature range is for example purposes only and the upper and lower ends of the range are capable of adjustment in either direction without departing from the scope of the present invention.

As shown in FIG. 66, the temperature selection screen 2412 includes a graphical representation of a temperature range 2420, a sliding selector 2422, a minus five degree adjustment icon 2424, a plus five degree adjustment icon 2426, a next icon 2414, a cancel icon 2416, and a back icon 2418. The user adjusts the temperature at step 1778 to the desired cooking temperature using the sliding selector 2422. When fine-tuning is necessary, i.e., to change from 240 degrees to 245 degrees, the user selects that plus five degrees icon 2426, which raises the selected temperature by five degrees. The skilled artisan will appreciate that the instant invention enables the user to return to the previous screen 2380 by selecting the back icon 2418 at step 1792, which returns the user to the cook methods Sabbath screen 2380 at step 1798. The skilled artisan will further appreciate that by selecting the cancel icon 2416 at step 1794, the user is returned to the Sabbath/Holiday main screen 2224 at step 1800. After setting the desired temperature, the user selects the next icon 2414 at step 1796, which prompts the display of a set start/stop time screen at step 1802.

Following user selection of the dehydrate icon 2406 at step 1738, the user is presented, as shown in FIG. 65, with the ability to cancel the Sabbath Plus programming operation by selecting the cancel icon 2384 at step 1764, return to the previous screen 2466 of FIG. 69 by selecting the back icon 2386 at step 1768, or proceed to the next step of programming the Sabbath Plus operation by selecting the next icon 2382 at step 1766. When the user selects the cancel icon 2384 at step 1764, flow proceeds to step 1782, wherein the display is returned to the Sabbath/Holiday main screen 2224 of FIG. 55. When the user selects the back icon 2386 at step 1768, flow proceeds to step 1786, whereby the display reverts to the add a stage screen 2466 of FIG. 69. When the user selects the next icon 2382 at step 1766, flow proceeds to step 1784, whereupon a set oven temperature screen 2412 is displayed, as illustrated in FIG. 66.

The skilled artisan will appreciate that the temperature selection screen 2412 is advantageously enables the user to select the desired dehydration temperature. In the preferred embodiment, the temperature range for the dehydration operation is one hundred degrees to two hundred degrees, in accordance with dehydration temperatures known in the art. Thus, those skilled in the art will understand that the graphical representation of the temperature range 2412 is suitably adjusted for the dehydration operation to reflect a minimum temperature of one hundred degrees and a maximum temperature of two hundred degrees. The foregoing dehydration temperature range is for example purposes only and any dehydration temperature range known in the art is equally capable of being implemented in accordance with the present invention. The skilled artisan will appreciate that the instant invention enables the user to return to the previous screen 2380 by selecting the back icon 2418 at step 1792, which returns the user to the cook methods Sabbath selection screen 2380 at step 1798. The skilled artisan will further understand that by selecting the cancel icon 2416 at step 1794, the user is returned to the Sabbath/Holiday main screen 2224 at step 1800. After setting the desired temperature, the user selects the next icon 2414 at step 1796, which prompts the display of a set start/stop time screen at step 1802.

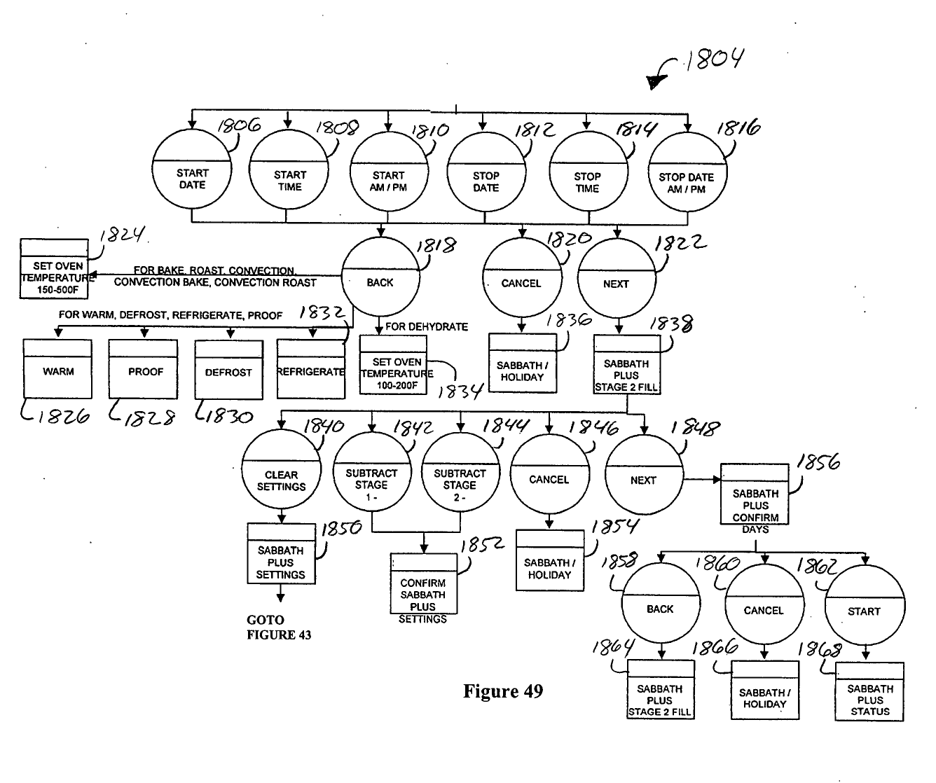

When the user desires to proceed with the programming of the Sabbath Plus program and has selected the warm icon 2394 at step 1742, the proof icon 2408 at step 1746, the defrost icon 2396 at step 1750, or the refrigerate icon 2404 at step 1754, flow proceeds to the second tier of Sabbath Plus screen architecture 1804 of FIG. 49 for further user input at steps 1770, 1772, or 1774. When the user has selected the warming, defrost, refrigeration, or proofing cooking operations, flow proceeds from step 1772 directly to step 1802, whereupon a start/stop time screen is displayed to the user for further selections. It will be appreciated by those skilled in the art that step 1802 of FIG. 48 prompts flow to proceed to the screen architecture 1804 of FIG. 49. Furthermore, the skilled artisan will understand that the screen displayed at step 1802 corresponds to the instructions to be selected by the user via screen architecture 1804, as illustrated by FIG. 67.

FIG. 67 illustrates the template set start/stop time screen 2428 displayed to the user at step 1802 in accordance with the present invention. Returning to FIG. 49, with references herein to FIG. 67, the user first selects the desired start date by selecting the start date icon 2436 at step 1806. In the preferred embodiment, the start date icon 2436 is a scroll-down menu, as is known in the art, enabling the user to navigate to the desired date on which the selected cooking operation is to begin. The user then selects the time at which the selected cooking operation is to begin by selecting the start time icon 2440 at step 1808. It will be appreciated by those skilled in the art that upon selecting the start time icon 2440, the user then inputs the desired start time in hours and minutes using the numeric keypad 2448. The user then selects the appropriate setting via the AM/PM toggle icon 2444 at step 1810.

Similar to the setting of the start time and date information, the user sets the stop date for the cooking operation by selecting the stop date icon 2438 at step 1812. As with the start date icon 2436, the stop date icon 2438 is also a scroll-down menu, as are known in the art, from which the user selects the desired date on which the cooking operation is to be completed. The user then selects the stop time icon 2442 to set the time at which cooking is to be completed at step 1814. It will be appreciated by those skilled in the art that the user inputs the desired stop time via the numeric keypad 2448. The user then selects the appropriate setting via the AM/PM toggle icon 2446 at step 1816.

Upon completion of the selection of the start/stop time, the user is prompted to continue with the setup, cancel the setup, or return to the previous selection screen. To return to the previous selection screen, the user selects the back icon 2434 at step 1818, which returns the user to the previous screen. As the skilled artisan will appreciate, the screen to which the user is returned is dependent upon the cooking operation previously selected for the second stage of the Sabbath/Holiday Plus operation. Thus, when the user has selected either the bake, roast, convection, convection bake, or convection roast cooking operations, flow returns from step 1818 to step 1824, whereupon the user is prompted to select the desired cooking temperature. When the user has previously selected the dehydrate cooking operation, flow returns from step 1818 to step 1834, whereupon the user is prompted to select the desired dehydration cooking temperature. When the user had selected the warming cooking operation, flow proceeds from step 1818 to step 1826, whereupon the cook methods Sabbath/Holiday screen 2380 of FIG. 65 is displayed, with the warm icon 2394 highlighted, thereby indicating the previous selection made by the user. Similarly, when the user had previously selected the proofing cooking operation, flow proceeds from step 1818 to step 1828, whereupon the cook methods Sabbath/Holiday screen 2380 is displayed with the proof icon 2408 highlighted, thereby indicating that the user had previously selected the proof operation. Likewise, when the user selected the defrost operation, flow proceeds from step 1818 to step 1830, whereupon the cook methods Sabbath/Holiday screen 2380 is displayed with the defrost icon 2396 highlighted, thereby indicating the previous selection made by the user. Furthermore, when the user had selected the refrigeration operation, flow proceeds from step 1818 to step 1832, whereupon the cook methods Sabbath/Holiday screen 2380 is displayed, with the refrigerate icon 2404 highlighted, indicating the previous selection made by the user.

When the user desires to cancel the setup of the Sabbath/Holiday Plus program, the user selects the cancel icon 2432 at step 1820, thereby prompting the display of the main Sabbath/Holiday screen 2224 at step 1836, effectively returning the user to step 1308 of FIG. 42. When the user has completed inputting all time and date settings, the user selects the next icon 2430 at step 1822, prompting the display of the add a stage screen 2466 of FIG. 69 at step 1838. It will be understood by those skilled in the art that the add a stage screen 2466 advantageously illustrates icons 2470, 2474, and 2478 as the cooking method, temperature and runtimes selected by the user in the preceding steps. From the add a stage screen 2466, the user is presented with several options for proceeding, including, for example and without limitation, clearing the settings, subtracting one or more stages from the Sabbath/Holiday Plus cooking operation, canceling the Sabbath/Holiday Plus cooking program, or proceeding with the final steps in setting the Sabbath/Holiday Plus cooking program.

To clear the settings, the user selects the clear settings icon 2486 at step 1840, thereby prompting display of the Sabbath Plus settings screen 2360 of FIG. 63 at step 1850, effectively returning flow to step 1390 of FIG. 43. Removal of the first cooking stage is accomplished by selection of the first subtract. cooking stage icon 2480 at step 1842, whereupon flow proceeds to the display of the confirm Sabbath Plus settings screen 2450 at step 1852. Similarly, to remove the second cooking stage from the program, the user selects the subtract second cooking stage icon 2482 at step 1844, thereafter flow proceeds to step 1852, which displays the confirm Sabbath Plus settings screen 2450. Upon user selection of the cancel icon 2454 at step 1846, flow returns to the Sabbath/Holiday screen 2224 of FIG. 55 at step 1854. When the user has completed entering the information for the second stage of the Sabbath Plus cooking operation, the user selects the next icon 2452 at step 1848, which prompts the display of the confirm days screen 2488 of FIG. 70 at step 1856.

As previously discussed, FIG. 70 illustrates a suitable template confirm days screen 2488, inclusive of the text windows representing the cooking program corresponding to the Sabbath Plus cooking operation 2490, the first Holiday cooking operation 2492, as well as the second Holiday cooking operation 2494. When the user desires to modify any of the programmed variables, the user selects the back icon 2496 of screen 2488 at step 1858, which returns display add a stage screen 2466 of FIG. 69 at step 1864. The user is capable of selecting the cancel icon 2500 to terminate the Sabbath Plus program, whereupon display returns to the Sabbath/Holiday Screen 2224 at step 1866. When the user is satisfied with the Sabbath Plus program, the user selects the start icon 2498 at step 1862, whereupon the Sabbath Plus status screen is displayed at step 1868. Those skilled in the art will appreciate that a suitable Sabbath Plus status screen is illustrated in FIG. 71 at 2502.

First Holiday Tab

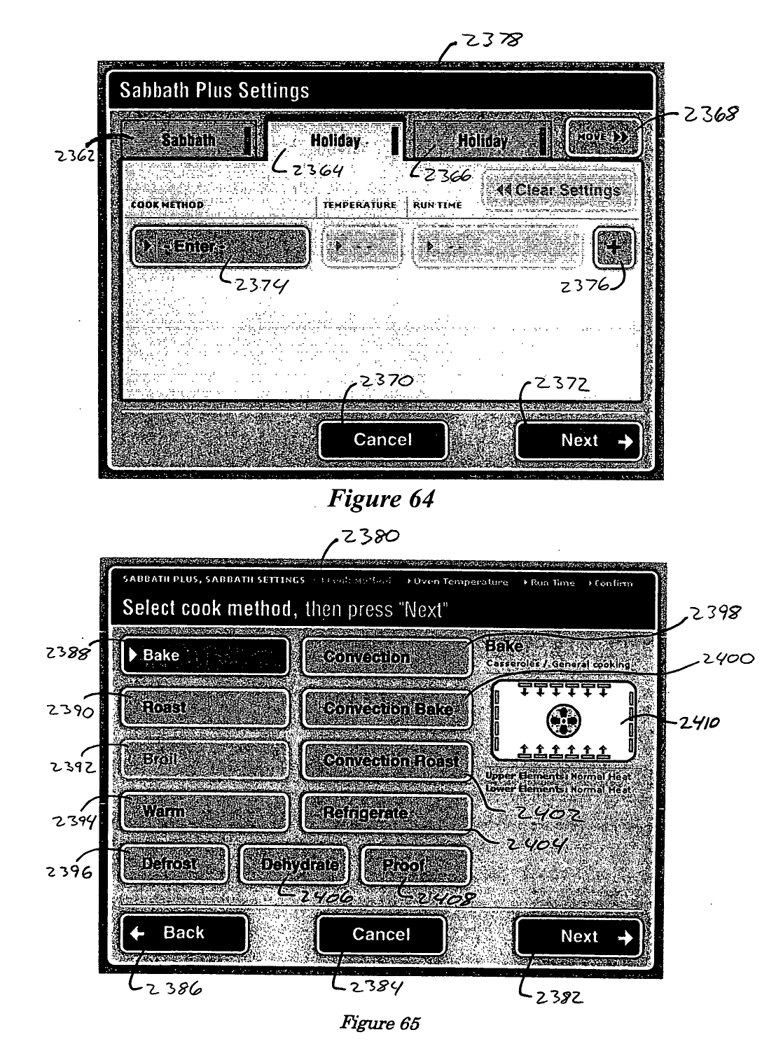

Returning to the Sabbath Plus settings screen at step 1390 of FIG. 43, the user is able to select the first Holiday tab 2364 or the second Holiday tab 2366 from the screen 2360 of FIG. 63, at steps 1406 and 1408, respectively. Referring first to the selection of the first Holiday tab 2364 at step 1406, flow proceeds to the screen architecture 1870 illustrated in FIG. 50. It will be appreciated by those skilled in the art that step 1872 of FIG. 50 corresponds to step 1406 of FIG. 43, such that when the user selects the first Holiday tab 2364 at step 1406, flow proceeds to step 1872 of FIG. 50. In accordance with one aspect of the present invention, the user selects the first Holiday tab 2364 by selecting the move icon 2368, whereby the active window changes from the screen 2360 of FIG. 63 to the screen 2378 of FIG. 64. Alternatively, the user is able to select the first Holiday tab 2364 via the touchscreen interface 222 by depressing the screen 2360 at the graphical location of the tab 2364, without depressing the move icon 2368.

FIG. 64 is now explained in connection with the screen architecture 1870 of FIG. 50, whereby the user sets up the first Holiday program in accordance with the present invention. Similar to the Sabbath Plus settings screen 2360 of FIG. 63, the first Holiday settings screen 2378 employs the same icons depicted in FIG. 63. Thus, for purposes of explanation, the same reference numbers will be used interchangeably for the description of the Sabbath Plus settings screen 2360 of FIG. 63, and the first Holiday settings screen 2378 of FIG. 64. It will be appreciated by those skilled in the art that the settings of the second Holiday program are capable of being implemented using the screen architectures of the first Holiday operation and for purposes of brevity, are not included hereinafter.

The first Holiday setting template screen 2378 includes a variety of selection options for the user. As shown in FIG. 64, the screen 2378 includes the Sabbath offset tab 2362, the first Holiday offset tab 2364, the second Holiday offset tab 2366, the move icon 2368, the enter icon 2374, the add a stage icon 2376, the cancel icon 2370, and the next icon 2372. It will be appreciated by those skilled in the art that the next icon 2372 illustrated in FIG. 64 is enabled as shown. The skilled artisan will understand that the next icon 2372 of screen 2378 advantageously becomes enabled once preconditions, including for example and without limitation the completion of programming at least one cooking stage, have been fulfilled. Thus, as shown in FIG. 64, a Sabbath Plus program has already been programmed, thereby enabling the next icon 2372. The skilled artisan will appreciate that the selection of the next icon 2372 by the user, absent any entries with respect to the first Holiday program, will result in execution of the previously input Sabbath Plus program. The cancel icon 2370 is capable of being selected by the user at 1876 when so desired, returning the display to the Sabbath/holiday main screen 2224 at step 1880.

Referring now to the selection of the first Holiday offset tab 2364 at step 1872, when the enter icon 2374 is selected by the user at step 1874, flow proceeds to step 1878, whereupon the user is presented with a cook methods Sabbath Plus Holiday selection screen, hereinafter “first Holiday cook methods screen”.

A first Holiday cook methods screen is shown by the template 2504 illustrated in FIG. 72. As shown in FIG. 72, the first Holiday cook methods screen 2504 includes icons representative of several cooking options, including, for example and without limitation, a bake icon 2512, a roast icon 2514, a broil icon 2516, a warm icon 2518, a convection icon 2522, a convection bake icon 2524, a convection roast icon 2526, a refrigerate icon 2528, a defrost icon 2520, a dehydrate icon 2530, and a proof icon 2532. The skilled artisan will appreciate that the foregoing icons 2512-2532 are representative of cooking/cooling operations capable of being performed by the cooking appliance 102 during the first Holiday program and are illustrated for example purposes only. Other cooking/cooling operations are equally capable of being performed by the cooking appliance without departing from the scope of the present invention.

FIG. 72 further includes a graphical illustration window 2534 suitably configured to provide a visual cue to the user representative of the cooking or cooling operation selected. Thus, for example and without limitation, the screen 2504 illustrates that a bake operation has been selected, which is shown in the window 2534. It will be understood by those skilled in the art that each icon 2512-2532 advantageously corresponds to a different graphical representation which is capable of being shown to the user via the window 2534. The first Holiday screen template 2504 further includes a next icon 2506, a cancel icon 2508, and a back icon 2510 the function of which will be explained in greater detail below.

When the user selects the bake icon 2512 at step 1882, flow proceeds to step 1902 whereupon the window 2534 displays a graphical representation of a baking operation to be performed by the cooking appliance 102. Similarly, when the user selects the roast icon 2514 at step 1884, flow proceeds to step 1904, whereupon the window 2534 displays a graphical representation of a roasting operation to be performed by the cooking appliance 102. It will be appreciated by those skilled in the art that the broil cooking operation, represented by the broil icon 2516 is not available for preprogramming in the preferred embodiment. However, in accordance with one particular embodiment of the present invention, the user selects the broil icon 2516 and operations proceed, for example, as discussed below with respect to the roast cooking operation. To program a convection cooking operation, the user selects the convection icon 2522 at step 1886, whereupon the window 2534 depicts a convection cooking operation at step 1906.

To program a convection bake cooking operation to be performed by the cooking appliance 102 as part of the Sabbath/Holiday Plus cooking operations, the user selects the convection bake icon 2524 at step 1888, whereupon a graphical representation of a convection baking operation is displayed in the window 2534 at step 1908. To program a convection roast operation, the user selects the convection roast icon 2526 at step 1890, whereupon the window 2534 displays a graphical representation of a convection roasting operation at step 1910. To program a dehydrating cooking operation, the user selects the dehydrate icon 2530 at step 1892, whereupon a graphical representation of a dehydrating operation is displayed in the window 2534 at step 1912. To include a warming operation in the first Holiday program, the user selects the warm icon 2518 at step 1894, whereupon the window 2534 illustrates a graphical representation of a warming operation at step 1914. To program a proofing cooking operation, the user selects the proof icon 2532 at step 1896, which prompts the display of a representation of a proofing cooking operation in the window 2534 at step 1916. When it is desired to include a defrosting operation, the user selects the defrost icon 2520 at step 1898, which prompts the window 2534 to display a graphical representation of a defrosting operation at step 1918. To incorporate a refrigeration operation into the first Holiday cooking program, the user selects the refrigerate icon 2528 at step 1900, whereupon a refrigeration illustration is shown in the window 2534 at step 1920.

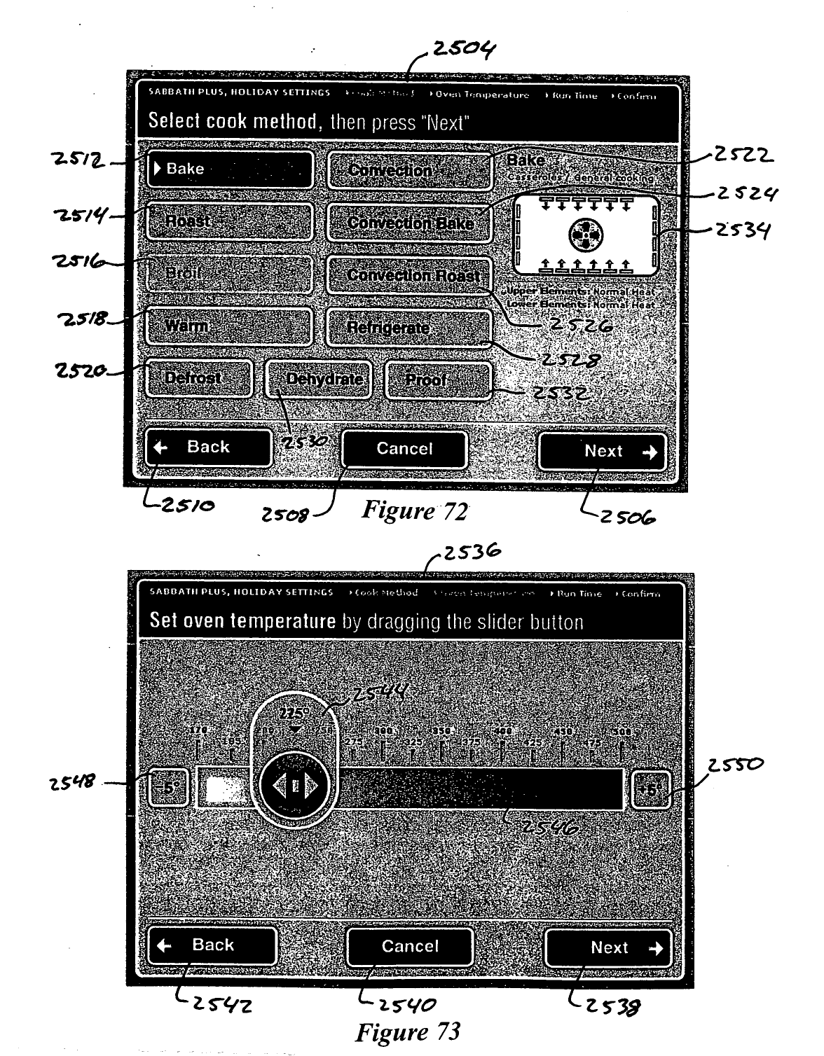

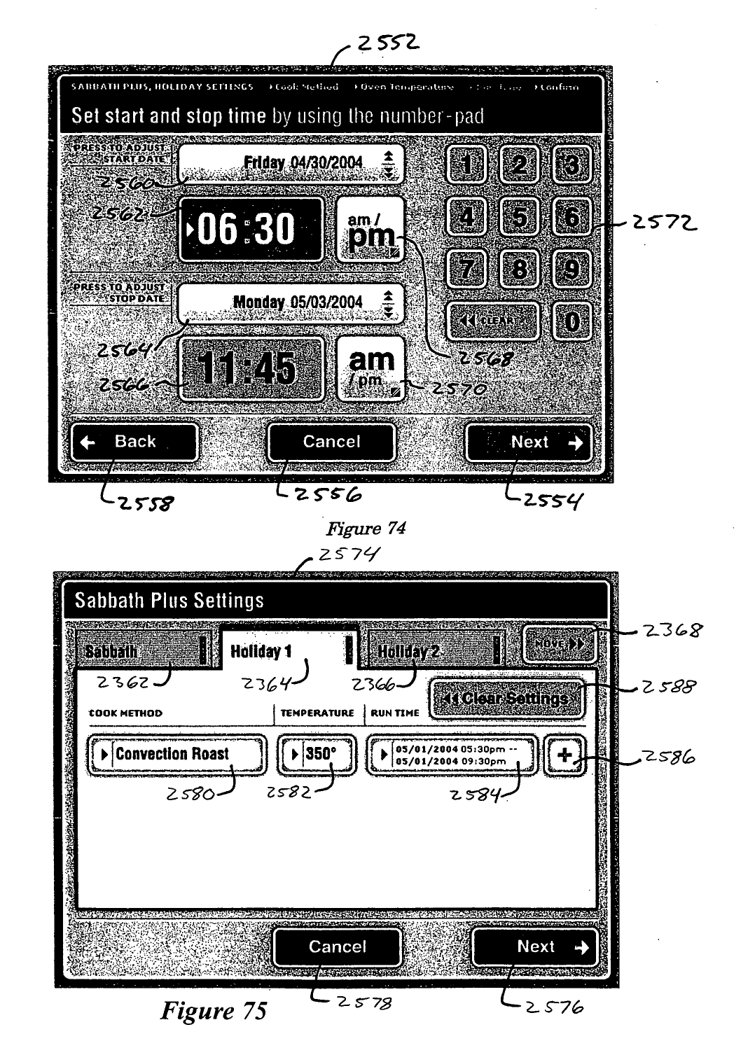

When the user desires to proceed with the programming of the first Holiday program and has selected the bake icon 2512 at step 1882, the roast icon 2514 at step 1884, the convection icon 2522 at step 1886, the convection bake icon 2524 at step 1888, or the convection roast icon 2526 at step 1890, flow proceeds to steps 1922, 1924, or 1926. As illustrated in FIG. 72, the user is presented with the ability to cancel the first Holiday programming operation by selecting the cancel icon 2508 at step 1922, return to the previous screen 2378 by selecting the back icon 2510 at step 1926, or proceed to the next step of programming the first Holiday operation by selecting the next icon 2506 at step 1924. When the user selects the cancel icon 2508 at step 1922, flow proceeds to step 1940, wherein the display is returned to the Sabbath/Holiday main screen 2224 of FIG. 55. When the user selects the back icon 2510 at step 1926, flow proceeds to step 1944, whereby the display reverts to the first Holiday tab screen 2378 of FIG. 5564 When the user selects the next icon 2506 at step 1924, flow proceeds to step 1942, whereupon a set oven temperature screen 2536 is displayed, as illustrated in FIG. 73. The skilled artisan will understand that step 1942 of FIG. 50 corresponds to step 1958 of the screen architecture 1956 of FIG. 51, such that user selection of the next icon 2506 at step 1924 prompts the display of the set oven temperature screen 2536 at step 1942 of FIG. 50 correlating to the display of the temperature screen 2536 of FIG. 73 at step 1958 of FIG. 51.

In the preferred embodiment, the temperature variations corresponding to the bake, roast, convection, convection bake, and convection roast cooking operations correlates to a range of oven temperatures from 150 degrees to 500 degrees Fahrenheit. The skilled artisan will appreciate that this temperature range is for example purposes only and the upper and lower ends of the range are capable of adjustment in either direction without departing from the scope of the present invention.

As shown in FIG. 73, the temperature selection screen 2536 includes a graphical representation of a temperature range 2546, a sliding selector 2544, a minus five degree adjustment icon 2548, a plus five degree adjustment icon 2550, a next icon 2538, a cancel icon 2540, and a back icon 2542. The user adjusts the temperature at step 1958 to the desired cooking temperature using the sliding selector 2544. When fine-tuning is necessary, i.e., to change from 225 degrees to 230 degrees, the user selects that plus five degrees icon 2550, which raises the selected temperature by five degrees. The skilled artisan will appreciate that the instant invention enables the user to return to the previous screen 2504 of FIG. 72 by selecting the back icon 2542 at step 1968, which returns the user to the cook methods Sabbath screen 2504 at step 1974. The skilled artisan will further appreciate that by selecting the cancel icon 2540 at step 1966, the user is returned to the Sabbath/Holiday main screen 2224 at step 1972. After setting the desired temperature, the user selects the next icon 2538 at step 1964, which prompts the display of a set start/stop time screen at step 1970.

When the user desires to proceed with the programming of the first Holiday program and has selected the dehydrate icon 2530 at step 1892 of FIG. 50, flow proceeds to steps 1928, 1930, or 1932. As illustrated in FIG. 72, the user is presented with the ability to cancel the first Holiday programming operation by selecting the cancel icon 2508 at step 1928, return to the previous screen 2378 of FIG. 64 by selecting the back icon 2510 at step 1932, or proceed to the next step of programming the first Holiday operation by selecting the next icon 2506 at step 1930. When the user selects the cancel icon 2508 at step 1928, flow proceeds to step 1946, wherein the display is returned to the Sabbath/Holiday main screen 2224. When the user selects the back icon 2510 at step 1932, flow proceeds to step 1850, whereby the display reverts to the first Holiday tab screen 2378. When the user selects the next icon 2506 at step 1930, flow proceeds to step 1848, whereupon a set oven temperature screen 2536 is displayed, as illustrated in FIG. 73. The skilled artisan will understand that step 1848 of FIG. 50 corresponds to step 1960 of the screen architecture 1956 of FIG. 51, such that user selection of the next icon 2506 at step 1930 prompts the display of the set oven temperature screen 2536 at step 1848 of FIG. 50 correlating to the display of the temperature screen 2536 at step 1960 of FIG. 51.

The skilled artisan will appreciate that the temperature selection screen 2536 advantageously enables the user to select the desired dehydration temperature. In the preferred embodiment, the temperature range for the dehydration operation is one hundred degrees to two hundred degrees, in accordance with dehydration temperatures known in the art. Thus, those skilled in the art will understand that the graphical representation of the temperature range 2536 is suitably adjusted for the dehydration operation to reflect a minimum temperature of one hundred degrees and a maximum temperature of two hundred degrees. The foregoing dehydration temperature range is for example purposes only and any dehydration temperature range known in the art is equally capable of being implemented in accordance with the present invention. The skilled artisan will further appreciate that the instant invention enables the user to return to the previous screen 2504 by selecting the back icon 2542 at step 1968, which returns the user to the cook methods first Holiday screen 2400 at step 1974. The skilled artisan will also appreciate that by selecting the cancel icon 2540 at step 1966, the user is returned to the Sabbath/Holiday main screen 2224 at step 1972. After setting the desired temperature, the user selects the next icon 2538 at step 1964, which prompts the display of a set start/stop time screen at step 1970.

When the user desires to proceed with the programming of the first Holiday program and has selected the warm icon 2518 at step 1894 of FIG. 50, the proof icon 2532 at step 1896, the defrost icon 2520 at step 1898, or the refrigerate icon 2528 at step 1900, flow proceeds to steps 1934, 1936, or 1938 for further user selections. Selection of the cancel icon 2508 at step 1934 prompts the display to return to the Sabbath/Holiday main screen 2224 at step 1852. User selection of the back icon 2510 at step 1938 prompts the display to return to the first Holiday tab screen 2378 at step 1854. When the user has selected the warming, defrost, refrigeration, or proofing cooking operations, and selects the next icon 2506 at step 1936, which corresponds to the selection step 1962 of FIG. 51, flow proceeds from step 1962 to step 1970, whereupon a start/stop time screen is displayed to the user for further selections. It will be understood by those skilled in the art that the screen architecture 1956 illustrated in FIG. 51 represents a sub-tier in the first Holiday programming.

FIG. 74 illustrates a first Holiday template set start/stop time screen 2552 displayed to the user at step 1970 in accordance with the present invention. As depicted in FIG. 74, the screen 2552 includes a start date icon 2560, a stop date icon 2564, a start time icon 2562, a stop time icon 2566, a start time AM/PM toggle icon 2568, a stop time AM/PM toggle icon 2570, a numeric keypad 2572, a next icon 2554, a cancel icon 2556, and a back icon 2558. Returning to FIG. 51, with references herein to FIG. 74, the user first selects the desired start date by selecting the start date icon 2560 at step 1976. In the preferred embodiment, the start date icon 2560 is a scroll-down menu, as is known in the art, enabling the user to navigate to the desired date on which the selected cooking operation is to begin. The user then selects the time at which the selected cooking operation is to begin by selecting the start time icon 2562 at step 1978. It will be appreciated by those skilled in the art that upon selecting the start time icon 2562, the user then inputs the desired start time in hours and minutes using the numeric keypad 2572. The user then selects the appropriate setting via the AM/PM toggle icon 2568 at step 1980.

Similar to the setting of the start time and date information, the user sets the stop date for the cooking operation by selecting the stop date icon 2564 at step 1982. As with the start date icon 2560, the stop date icon 2564 is also a scroll-down menu, as is known in the art, from which the user selects the desired date on which the cooking operation is to be completed. The user then selects the stop time icon 2566 to set the time at which cooking is to be completed at step 1984. It will be appreciated by those skilled in the art that the user inputs the desired stop time via the numeric keypad 2572. The user then selects the appropriate setting via the AM/PM toggle icon 2570 at step 1986.

Upon completion of the selection of the start/stop time, the user is prompted to continue with the setup of the first Holiday program, cancel the setup of the first Holiday program, or return to the previous selection screen. To return to the previous selection screen, the user selects the back icon 2558 at step 1988, which returns the user to the previous screen. As the skilled artisan will appreciate, the screen to which the user is returned is dependent upon the cooking operation previously selected. Thus, when the user has selected either the bake, roast, convection, convection bake, or convection roast cooking operations, flow returns from step 1988 to step 1958, whereupon the user is prompted to select the desired cooking temperature. When the user has previously selected the dehydrate cooking operation, flow returns from step 1988 to step 1960, whereupon the user is prompted to select the desired dehydration cooking temperature. When the user had selected the warming cooking operation, flow proceeds from step 1988 to step 1998, whereupon the cook methods Holiday selection screen 2504 of FIG. 72 is displayed, with the warm icon 2518 highlighted, thereby indicating the previous selection made by the user. Similarly, when the user had previously selected the proofing cooking operation, flow proceeds from step 1988 to step 2000, whereupon the cook methods Holiday selection screen 2504 is displayed with the proof icon 2532 highlighted, thereby indicating that the user had previously selected the proof operation. Likewise, when the user selected the defrost operation, flow proceeds from step 1988 to step 2002, whereupon the cook methods Holiday selection screen 2504 is displayed with the defrost icon 2520 highlighted, thereby indicating the previous selection made by the user. Furthermore, when the user had selected the refrigeration operation, flow proceeds from step 1988 to step 2004, whereupon the cook methods Holiday selection screen 2504 is displayed, with the refrigerate icon 2528 highlighted, indicating the previous selection made by the user.

When the user desires to cancel the setup of the first Holiday program, the user selects the cancel icon 2556 of FIG. 74 at step 1990, thereby prompting the display of the main Sabbath/Holiday screen 2224 at step 1996, effectively returning the user to step 1308 of FIG. 42. When the user has completed inputting all time and date settings, the user selects the next icon 2554 at step 1992, prompting the display of a confirmation of the First Holiday settings screen at step 1994. Flow then proceeds from step 1994 of FIG. 51 to step 2008 of FIG. 52. As will be understood by those skilled in the art, FIG. 52 illustrates a third tier architecture 2006 corresponding to the first Holiday operations of the cooking appliance 102 in accordance with the present invention. Thus, step 1994 of FIG. 51 correlates to step 2008 of FIG. 52, wherein a confirmation screen, such as screen 2574 of FIG. 75, is displayed to the user via the touchscreen interface 222.

As indicated at step 2008, the confirmation screen 2574 of FIG. 75 enables the user to confirm the previous selections made during setup of the first Holiday operation of the cooking appliance 102. As shown in FIG. 75, the confirmation screen 2574 includes the Sabbath offset tab 2362, the first Holiday offset tab 2364, the second Holiday offset tab 2366, the move icon 2368, a cook method icon 2580, an oven temperature icon 2582, a run-time icon 2584, an add stage icon 2586, a clear settings icon 2588, a next icon 2576, and a cancel icon 2578. Each of these icons will be explained in greater detail below with respect to the discussion corresponding to the screen architecture 2006 of FIG. 52. When the user desires to cancel setup of the first Holiday Plus operation previously input, the user selects the cancel icon 2578 at step 2010, which prompts the display of the Sabbath/Holiday main screen 2224 of FIG. 55 at step 2012.

When the user is satisfied with the selections made to the first Holiday operation, the user selects the next icon 2576 at step 2014, which prompts the display of the confirm days screen 2488 of FIG. 70 at step 2016. As illustrated in FIG. 70, the confirm days screen 2488 includes text windows representative of the cooking program corresponding to the Sabbath Plus cooking operation 2490, the first Holiday cooking operation 2492, as well as the second Holiday cooking operation 2494. The skilled artisan will appreciate that in the preferred embodiment, when no program has been entered for a given cooking operation, the text window corresponding to that operation is left blank or not shown on the confirm days screen 2488. When the user desires to modify any of the programmed variables, the user selects the back icon 2496 of screen 2488 at step 1060, which returns display and operations to the confirm first Holiday settings screen 2574 at step 1064. When the user is satisfied with the first Holiday program, the user selects the start icon 2498 at step 2018, whereupon the first Holiday status screen is displayed at step 1062. Those skilled in the art will appreciate that a suitable first Holiday status screen is illustrated in FIG. 71 at 2502.

In addition, the user is capable of modifying any of the previous selections for the first Holiday operation from the confirmation screen 2574 by selecting one of the icons 2580-2588. From the confirmation screen 2574 of FIG. 75, the user is able to select, at step 2026, the clear settings icon 2588, which prompts display of the first Holiday tab settings screen 2378 of FIG. 64 at step 2036. When the user desires to change the previously selected cooking method, the user selects the cook method icon 2580 at step 1068, prompting the display of the cook methods first Holiday screen 2504 of FIG. 72 at step 2038. The user then makes any desired changes to the cook method and selects the okay, i.e., next icon 2506, at step 1088, whereby the changes to the cooking method are made to the first Holiday operation at step 2052 and flow returns to displaying the confirmation screen 2574 at step 2008. It will be appreciated by those skilled in the art that after changing the desired cooking method, the user is capable of adjusting the other settings from the confirmation screen 2574 in accordance with the new cooking method. When the user determines that no changes to the cooking method are desired, the user selects the cancel icon 2508 at step 2050, whereby no changes are made to the cooking method at step 2054 and flow returns to displaying the confirmation screen 2574 at step 2008.

When the user desires to change the previously selected cooking or dehydration temperature, the user selects the oven temperature icon 2582 at step 2030, prompting the display of the temperature selection screen 2536 at step 1080 or step 1082. The skilled artisan will appreciate that steps 1080 and 1082 result in the display of similar temperature screens 2536, albeit with different temperature range scales 2546. When the cooking method is bake, roast, convection, convection bake, or convection roast, flow proceeds to step 1080, whereupon the temperature range 2546 displayed is from 150-500 degrees Fahrenheit. When the cooking method selected is the dehydrate cooking method, flow proceeds to step 1082, whereupon the temperature range 2546 displayed is from 100-200 degrees Fahrenheit. When the user determines that no changes to the oven temperature are desired, the user selects the cancel icon 2540 at step 2050, whereby no changes are made to the cooking temperature at step 2054 and flow returns to displaying the confirmation screen 2574 at step 2008. When the user has adjusted the temperature, the user selects the okay, i.e., next icon 2538 at step 1088, whereby the changes to the cooking temperature are made to the first Holiday operation at step 2052 and flow returns to displaying the confirmation screen 2574 at step 2008.

In the event that the user desires to adjust the run times associated with the selected cooking operations, the user selects the run-time icon 2584 at step 2032, which prompts the display of the set start and stop time screen 2552 at step 1084. The user is then able to adjust the start and stop times of the selected cooking operation as set forth above. When the user elects to save the changes made to the start or stop times, the user selects the okay, i.e., next icon 2554 at step 1088, whereupon the changes are made to the first Holiday program at step 2052. Flow then returns to the confirmation screen 2574 at step 2008. When the user determines that the changes made to the start or stop time are to be discarded, the user selects the cancel icon 2556 at step 2050, whereupon no changes are made to the previously input start or stop times at step 2054 and flow returns to the display of the confirmation screen 2574 at step 2008.

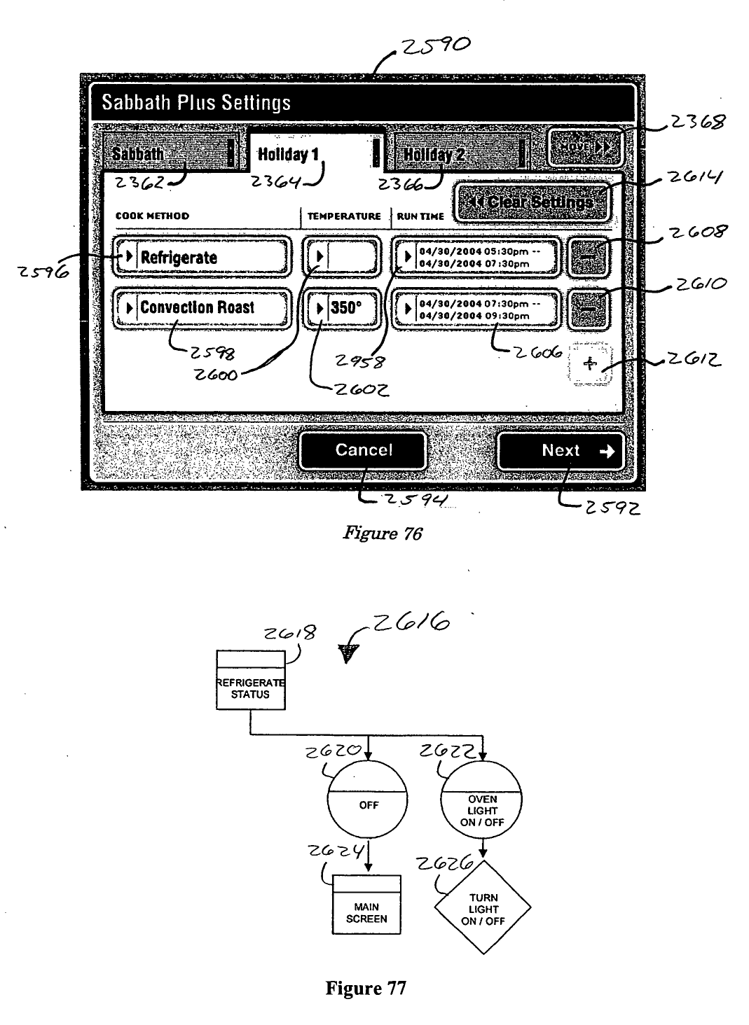

When the user determines that an additional stage is to be added, i.e., another step in the first Holiday cooking or cooling operation is required, the user selects the add a stage icon 2586 at step 2034, which prompts the display of an add a stage screen at step 1086, illustrated at 2590 in FIG. 76. As shown in FIG. 76, the add a stage screen 2590 includes the Sabbath offset tab 2362, the first Holiday offset tab 2364, the second Holiday offset tab 2366, the move icon 2368, a first stage cook method icon 2596, a first stage temperature icon 2600, a first stage run time icon 2958, a remove first stage icon 2608, a second stage cook method icon 2598, a second stage temperature icon 2602, a second stage run time icon 2606, a remove second stage icon 2610, an add a third stage icon 2612, a clear settings icon 2614, a next icon 2592, and a cancel icon 2594.

When the user selects the clear settings icon 2614 at step 2056, flow proceeds to step 2064, whereupon all stages are removed and operations return to step 1406 of FIG. 43. When the user determines that the first cooking stage is no longer needed or desired, the user selects the remove first stage icon 2608 at step 2060, whereby flow returns to the confirmation screen 2574 of FIG. 75 at step 2008. In addition, when the user determines that an additional cooking stage is not desired, the user selects the remove second stage icon 2610 at step 2062, whereby flow returns to the confirmation screen 2574 at step 2008. However, when the user desires to program the second stage of the first Holiday cooking operation, the user selects the enter icon, which is illustrated in FIG. 76 as the second stage cook method icon 2598, the second stage temperature icon 2602, or the second stage run time icon 2606. The skilled artisan will appreciate that the selection of any of the second stage icons 2598, 2602, or 2606 prompts the display, at step 2066 of the cook methods Holiday selection screen 2504 of FIG. 72. Those skilled in the art will further appreciate that while reference is made above to the selection of one of the second stage icons 2598, 2602, or 2606, the instant invention is equally capable of using a single enter icon, not shown, in place of the three icons to initiate the programming of the second stage of the first Holiday cooking operation.

It will be understood by those skilled in the art that step 2070 of FIG. 53 follows immediately from step 2066 of FIG. 52, which corresponds to the programming of the second stage of the first Holiday cooking operation. Thus, once the user has selected any of the icons 2598, 2602, or 2606 at step 2058, flow proceeds from step 2066 of FIG. 52 to step 2070 of FIG. 53. As will be appreciated by those skilled in the art, FIG. 53 illustrates a contemporaneous third-tier of screen architecture 2068 corresponding to the addition of the second stage cooking operation to the first Holiday cooking operation. For explanation purposes, the display on the touchscreen interface 222 progresses from displaying the second stage of the first Holiday screen 2590 of FIG. 76 to the cook methods selection screen 2504 of FIG. 72. Therefore, explanation of the second stage selection process of the first Holiday program will entail use of the selection screen 2504 in accordance with the screen architecture method 2068 of FIG. 53.

Those skilled in the art will appreciate that the addition and programming of the second stage, while undertaken in accordance with the method 2068 of FIG. 53, uses most of the same screen templates as used during the programming of the first stage of the first Holiday operation. As previously described with respect to FIG. 72, the selection screen 2504 includes cooking method icons corresponding to the bake icon 2512, the roast icon 2514, the convection icon 2522 the convection bake icon 2524, the convection roast icon 2526, the dehydrate icon 2530, the warm icon 2518, the proof icon 2532, the defrost icon 2520, the refrigerate icon 2528, and the broil icon 2516. As discussed above, the broil cooking operation, as represented by the broil icon 2516, in accordance with the preferred embodiment of the present invention, is not available for programming for a variety of reasons, as discussed above. The screen 2504 further includes the graphical representation window 2534, the function of which is the same as that for the first stage of the first Holiday program. The cook methods selection screen 2504 further includes the next icon 2506, the cancel icon 2508, and the back icon 2510, the function of which will be explained in greater detail below.

Returning to the method 2068 of FIG. 53, the screen 2504 is advantageously displayed to the user at step 2070, whereupon the user is able to select a desired cooking method for the second stage of the first Holiday cooking operation. Thus, when the user selects the bake icon 2512 at step 2072, flow proceeds to step 2092, whereupon the window 2534 displays the graphical representation of a baking operation to be performed by the cooking appliance 102. Similarly, when the user selects the roast icon 2514 at step 2074, flow proceeds to step 2094, whereupon the window 2534 displays the graphical representation of a roasting operation to be performed by the cooking appliance 102. To program a convection cooking operation, the user selects the convection icon 2522 at step 2076, whereupon the window 2534 depicts a convection cooking operation at step 2096. To program a convection bake cooking operation to be performed by the cooking appliance 102 as part of the second stage of the first Holiday cooking operations, the user selects the convection bake icon 2524 at step 2078, whereupon a graphical representation of a convection baking operation is displayed in the window 2534 at step 2098. To program a convection roast operation, the user selects the convection roast icon 2526 at step 2080, whereupon the window 2534 displays a graphical representation of a convection roasting operation at step 2100. To program a dehydrating cooking operation for the second stage of the first Holiday operation, the user selects the dehydrate icon 2530 at step 2082, whereupon a graphical representation of a dehydrating operation is displayed in the window 2534 at step 2102. To include a warming operation in the second stage of the first Holiday program, the user selects the warm icon 2518 at step 2084, whereupon the window 2534 illustrates a graphical representation of a warming operation at step 2104. To program a proofing cooking operation, the user selects the proof icon 2532 at step 2086, which prompts the display of a representation of a proofing cooking operation in the window 2534 at step 2106. When it is desired to include a defrosting operation, the user selects the defrost icon 2520 at step 2088, which prompts the window 2534 to display a graphical representation of a defrosting operation at step 2108. To incorporate a refrigeration operation into the second stage of the first Holiday cooking program, the user selects the refrigerate icon 2528 at step 2090, whereupon a refrigeration illustration is shown in the window 2534 at step 2110.

As shown in FIG. 72, the user is presented with the ability to cancel the addition of the second stage to the first Holiday programming operation by selecting the cancel icon 2508 at step 2112 for the bake, roast, convection, convection bake, or convection roast method, at step 2118 for the dehydrate method, and at step 2124 for the warm, proof, defrost, or refrigerate methods. The user is also able to return to the previous screen 2574 by selecting the back icon 2510 at step 2116 for the bake, roast, convection, convection bake, or convection roast method, at step 2122 for the dehydrate method, and at step 2128 for the warm, proof, defrost, or refrigerate methods. In addition, the user is able to proceed to the next step of programming the second stage of the first Holiday operation by selecting the next icon 2506 at step 2114 for the bake, roast, convection, convection bake, or convection roast method, at step 2120 for the dehydrate method, and at step 2126 for the warm, proof, defrost, or refrigerate methods

When the user selects the cancel icon 2508 at steps 2112, 2118, or 2124, flow proceeds to steps 2130, 2136, or 2142, respectively, wherein the display is returned to the Sabbath/Holiday main screen 2224 of FIG. 55. When the user selects the back icon 2510 at steps 2116, 2122, or 2128, flow proceeds to steps 2134, 2140, 2144, respectively, whereby the display reverts to the add a second stage screen 2574 of FIG. 75. When the user selects the next icon 2506 at step 2114 for the bake, roast, convection, convection bake, or convection roast cooking methods, flow proceeds to step 2132, whereupon the set oven temperature screen 2536 is displayed, as illustrated in FIG. 73. As previously discussed, the temperature variations corresponding to the bake, roast, convection, convection bake, and convection roast cooking operations correlates to a range of oven temperatures from 150 degrees to 500 degrees Fahrenheit. The skilled artisan will appreciate that this temperature range is for example purposes only and the upper and lower ends of the range are capable of adjustment in either direction without departing from the scope of the present invention.

The temperature selection screen 2536 of FIG. 73 includes a graphical representation of a temperature range 2546, a sliding selector 2544, a minus five degree adjustment icon 2548, a plus five degree adjustment icon 2550, a next icon 2538, a cancel icon 2540, and a back icon 2542. The user adjusts the temperature at step 2132 to the desired cooking temperature using the sliding selector 2544, the minus five degree adjustment icon 2548, or the plus five degree adjustment icon 2550. The user is then able to return to the previous screen 2504 by selecting the back icon 2542 at step 2150, which returns the user to the cook methods selection screen 2504 at step 2156. The user is also able to select the cancel icon 2540 at step 2148, whereupon the user is returned to the Sabbath/Holiday main screen 2224 at step 2154. After setting the desired temperature, the user selects the next icon 2538 at step 2146, which prompts the display of the set start/stop time screen of FIG. 74 at step 2152.

When the user selects the next icon 2506 at step 2120, after having previously selected the dehydrate cooking method, flow proceeds to step 2138, whereupon the user is presented with the set temperature screen 2536 illustrated in FIG. 73. As will be appreciated by those skilled in the art, and as discussed above, the temperature scale 2546 corresponding to the dehydrate operation varies from 100-200 degrees Fahrenheit. The user, via the temperature selection screen 2536, is presented with the ability to return to the previous screen, cancel the operation, or proceed to the next step in programming the second stage of the first Holiday operation. In order to return to the previous screen 2504, the user selects the back icon 2542 at step 2150, which returns the display to the select cook methods screen 2504 at step 2156. To cancel the operation, the user selects the cancel icon 2540 at step 2148, which returns the user to the main screen 2224 at step 2154. Following the setting and adjustment of the desired dehydrating temperature, the user selects the next icon 2538 at step 2146, which prompts display of the set start/stop time screen 2552 at step 2152.

When the user desires to proceed with the programming of the second stage of the first Holiday program and has selected the warm icon 2518, the proof icon 2532, the defrost icon 2520, or the refrigerate icon 2528, the user selects the next icon 2506 at step 2126, whereupon flow proceeds to step 2152, and the display of the set start/stop time screen. Those skilled in the art will understand that display of the set start/stop time screen at step 2152 corresponds to the display of the screen 2552 of FIG. 74, whereupon flow proceeds to the screen architecture 2158 of FIG. 54.

As previously described, FIG. 74 illustrates the template set start/stop time screen 2552 displayed to the user at step 2152 in accordance with the present invention. Turning now to FIG. 54, with references herein to FIG. 74, the user first selects the desired start date by selecting the start date icon 2560 at step 2160. In the preferred embodiment, the start date icon 2560 is a scroll-down menu, as is known in the art, enabling the user to navigate to the desired date on which the selected cooking operation is to begin. The user then selects the time at which the selected cooking operation is to begin by selecting the start time icon 2562 at step 2162. It will be appreciated by those skilled in the art that upon selecting the start time icon 2562, the user then inputs the desired start time in hours and minutes using the numeric keypad 2572. The user then selects the appropriate setting via the AM/PM toggle icon 2568 at step 2164.

The user then sets the stop date for the cooking operation by selecting the stop date icon 2564 at step 2166. As with the start date icon 2560, the stop date icon 2564 is also a scroll-down menu, from which the user selects the desired date on which the cooking operation is to be completed. The user then selects the stop time icon 2566 to set the time at which cooking is to be completed at step 2168. It will be appreciated by those skilled in the art that the user inputs the desired stop time via the numeric keypad 2572. The user then selects the appropriate setting via the AM/PM toggle icon 2570 at step 2170.

Upon completion of the selection of the start/stop time, the user is prompted to continue with the setup, cancel the setup, or return to the previous selection screen. To return to the previous selection screen, the user selects the back icon 2558 at step 2172, which returns the user to the previous screen. As the skilled artisan will appreciate, the screen to which the user is returned is dependent upon the cooking operation previously selected for the second stage of the first Holiday operation. Thus, when the user has selected either the bake, roast, convection, convection bake, or convection roast cooking operations, flow returns from step 2172 to step 2178, whereupon the user is prompted to select the desired cooking temperature. When the user has previously selected the dehydrate cooking operation, flow returns from step 2172 to step 2188, whereupon the user is prompted to select the desired dehydration cooking temperature. When the user had selected the warming cooking operation, flow proceeds from step 2172 to step 2180, whereupon the cook methods first Holiday selection screen 2504 is displayed, with the warm icon 2518 highlighted, thereby indicating the previous selection made by the user. Similarly, when the user had previously selected the proofing cooking operation, flow proceeds from step 2172 to step 2182, whereupon the cook methods first Holiday selection screen 2504 is displayed with the proof icon 2532 highlighted, thereby indicating that the user had previously selected the proof operation. Likewise, when the user selected the defrost operation, flow proceeds from step 2172 to step 2184, whereupon the cook methods first Holiday selection screen 2504 is displayed with the defrost icon 2520 highlighted, thereby indicating the previous selection made by the user. Furthermore, when the user had selected the refrigeration operation, flow proceeds from step 2172 to step 2186, whereupon the cook methods first Holiday selection screen 2504 is displayed, with the refrigerate icon 2528 highlighted, indicating the previous selection made by the user.

When the user desires to cancel the setup of the second stage of the first Holiday program, the user selects the cancel icon 2556 at step 2174, thereby prompting the display of the main Sabbath/Holiday screen 2224 at step 2190, effectively returning the user to step 1406 of FIG. 42. When the user has completed inputting all time and date settings, the user selects the next icon 2554 at step 2176, prompting the display of the add a stage screen 2590 of FIG. 76 at step 2192. From the add a stage screen 2590, the user is presented with several options for proceeding, including, for example and without limitation, clearing the settings, subtracting one or more stages from the first Holiday cooking operation, canceling the first Holiday cooking program, or proceeding with the final steps in setting the first Holiday cooking program.

To clear the settings, the user selects the clear settings icon 2614 at step 2194, thereby prompting display of the first Holiday settings screen 2378 of FIG. 64 at step 2108, effectively returning flow to step 1406 of FIG. 43. Removal of the first cooking stage is accomplished by selection of the first subtract cooking stage icon 2608 at step 2196, whereupon flow proceeds to the display of the confirm first Holiday settings screen 2574 at step 2206. Similarly, to remove the second cooking stage from the program, the user selects the subtract second cooking stage icon 2610 at step 2198, thereafter flow proceeds to step 2206, which displays the confirm first Holiday settings screen 2574 of FIG. 75. Upon user selection of the cancel icon 2594 at step 2200, flow returns to the Sabbath/Holiday screen 2224 at step 2208. When the user has completed entering the information for the second stage of the first Holiday cooking operation, the user selects the next icon 2592 at step 2106, which prompts the display of the confirm days screen 2488 at step 2210.

As previously discussed, FIG. 70 illustrates a suitable template confirm days screen 2488, inclusive of the text windows representing the cooking program corresponding to the Sabbath Plus cooking operation 2490, the first Holiday cooking operation 2492, as well as the second Holiday cooking operation 2494. When the user desires to modify any of the programmed variables, the user selects the back icon 2496 of screen 2488 at step 2212, which returns display add a stage screen 2590 at step 2218. The user is capable of selecting the cancel icon 2500 at step 2214 to terminate the first Holiday program, whereupon display returns to the Sabbath/Holiday Screen 2224 at step 2220. When the user is satisfied with the first Holiday program, the user selects the start icon 2498 at step 2216, whereupon the Sabbath Plus status screen 2502 is displayed at step 2222.

In accordance with the present invention, the programming of the second Holiday program is accomplished in the same manner as that of the first Holiday program. The user is thereby able to program two different holidays, in addition to a Sabbath program. The same screens and screen architecture, as described above with respect to the first Holiday program are equally capable of being used to provide the second Holiday program, and the skilled artisan will understand the application thereto.

Refrigerate Architecture

Returning to the main screen architecture 300 of FIG. 3, corresponding to the main screen 400 of FIG. 4, when the user selects the refrigerate icon 412 at step 330, flow proceeds to display a refrigeration status screen at step 332. The skilled artisan will appreciate that following user selection of the refrigerate icon 412, flow proceeds from the main tier architecture of FIG. 3 to the second tier refrigeration status architecture 2616 of FIG. 77. Thus, display of the status screen at step 332 corresponds to the display of the status screen at step 2618 of FIG. 77.

FIG. 77 illustrates the screen architecture 2616 implemented in accordance with the present invention to refrigeration status to the user. FIG. 78 depicts the template refrigeration status screen 2628 displayed to the user at step 2618. As shown in FIG. 78, the status screen 2628 includes an off icon 2630 and an oven light icon 2632 corresponding to a refrigeration operation in the top chamber 106 of the cooking appliance 102. Upon user selection of the off icon 2630 at step 2620, flow proceeds to step 2624, wherein the main screen 400 is illustrated to the user. The oven light icon 2632 advantageously controls the interior light of the top chamber 106. Upon user selection of the icon 2632 at step 2622, flow proceeds to step 2626, whereupon the light is turned on or off, depending upon the previous state of the oven. Discussion now turns to the cook now and cook now favorites features of the instant invention.

Cook Now Architecture

The instant invention enables the user to use the cooking appliance 102 to heat a food item immediately. To accomplish this feat, the user selects the cook now icon associated with the desired cooking chamber, e.g., the user selects the cook now icon 416 associated with the top cooking chamber 106. It will be understood by those skilled in the art that the functioning of the cook now features with respect to the bottom chamber 108 is suitably accomplished using the same architectures and methodologies described hereinafter with respect to the cook now operations of the top chamber 106. When the user selects the cook now icon 416 at step 334 of the main screen architecture 300, flow proceeds to step 336, wherein the cook methods available to the user are displayed for further selection. It will be understood by those skilled in the art that the operation of the cook now features proceeds from step 336 to step 2636 of the second tier screen architecture 2634 of FIG. 79.

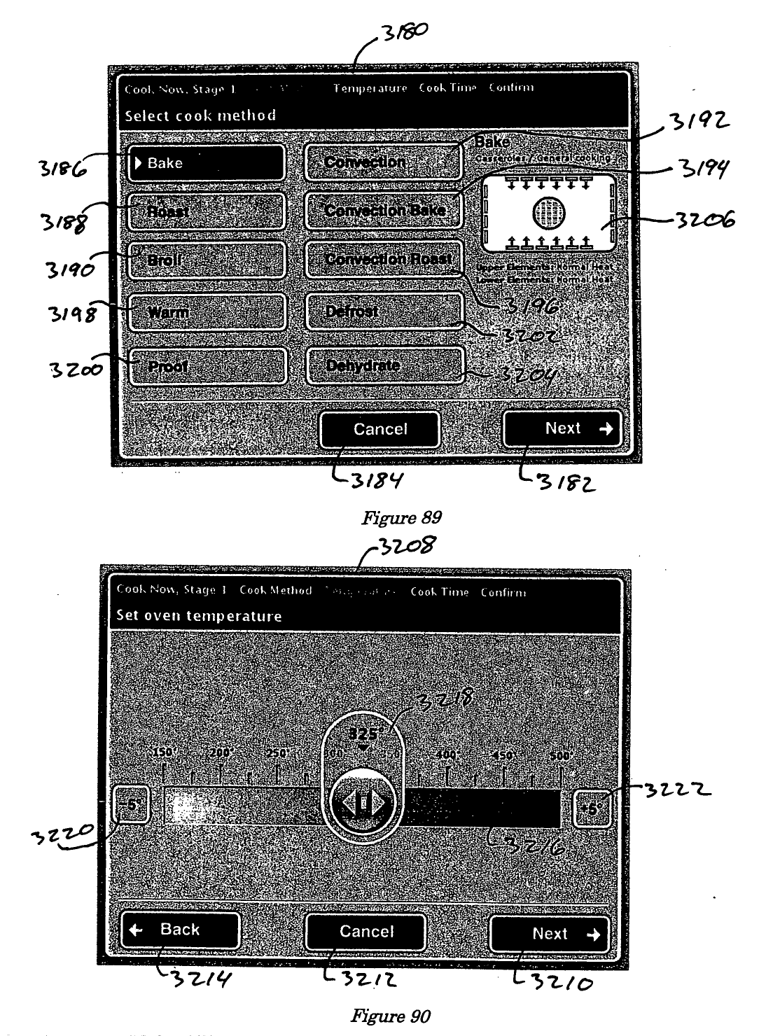

Thus, step 336 of FIG. 3 corresponds to step 2636 of FIG. 79, whereupon a cook now method selection screen, such as the screen template 3180 of FIG. 89 is displayed. In accordance with the present invention, the cook now operation is capable of including one or more cooking stages, such as, for example and without limitation, a defrost and warm series, a defrost, bake, warm series, and the like. Accordingly, several of the screen templates described hereinafter are capable of being used for a first stage, a second stage, a third stage of operation, up to the user's desired number of stages.

As depicted in FIG. 89, the cook now cook method selection screen 3180 includes icons representative of several cooking options, including, for example and without limitation, a bake icon 3186, a roast icon 3188, a broil icon 3190, a convection icon 3192, a convection bake icon 3194, a convection roast icon 3196, a warm icon 3198, a proof icon 3200, a defrost icon 3106, and a dehydrate icon 3108. The skilled artisan will appreciate that the icons 3186-3108 are examples of cooking operations which the cooking appliance 102 is capable of performing. Other cooking operations, in addition to those operations shown, are also capable of being performed by the cooking appliance without departing from the scope of the present invention. FIG. 89 further includes a graphical illustration window 3206 suitably adapted to provide a visual queue to the user representative of the cooking or cooling operation selected. Thus, for example and without limitation, the screen 3180 illustrates that a bake operation has been selected, which is shown in the window 3206. It will be understood by those skilled in the art that each icon 3186-3108 advantageously corresponds to a different graphical representation which is capable of being shown to the user via the window 3206. The cook now method selection screen template 3180 further includes a next icon 3182 and a cancel icon 3184, the function of which will be explained in greater detail below.

Returning to the screen architecture 2634 at step 2642, the user selects the bake icon 3186, whereupon flow proceeds to step 2662. At step 2662, the window 3206 displays a graphical representation of a baking operation, which is to be performed by the cooking appliance 102. Upon user selection of the roast icon 3188 at step 2644, flow proceeds to step 2664, whereupon the graphical window 3206 displays a roasting operation. To enable a convection cooking operation, the user selects the convection icon 3192 at step 2646, whereupon the window 3206 depicts a convection cooking operation at step 2666. When the user desires to initiate a convection baking operation, the user selects the convection bake icon 3194 at step 2648, whereupon the window 3206 displays a graphical representation of a convection baking operation at step 2668. In the event that the user elects to perform a convection roasting operation on a food item in the top chamber 106 of the cooking appliance 102, the user selects the convection roast icon 3196 at step 2650, whereupon the window 3206 displays a graphical representation of a convection roasting operation at step 2670.

When the user desires to dehydrate a food item, the user selects the dehydrate icon 3108 at step 2652, whereupon a graphical representation of a dehydrating operation is displayed in the window 3206 at step 2672. When the user desires to broil a food item, the user selects the broil icon 3190 at step 2654, following which the window 3206 displays a graphical representation of a broiling operation at step 2674. Similarly, to warm a food item in the top chamber 106 of the cooking appliance 102, the user selects the warm icon 3198 at step 2656, whereupon the window 3206 illustrates a graphical representation of a warming operation at step 2676. A proofing cooking operation is initiated upon user selection of the proof icon 3200 at step 2658, which prompts the display of a representation of a proofing operation in the window 3206 at step 2678. When the user desires to defrost a food item in the top chamber 106, the user selects the defrost icon 3106 at step 2660, which prompts the window 3206 to display a graphical representation of a defrosting operation at step 2680.

As illustrated in FIG. 89, the user is presented with the ability to cancel the cook now programming operation by selecting the cancel icon 3184 at step 2638. When the user selects the cancel icon 3184 at step 2638, flow proceeds to step 2640, wherein the display is returned to the main screen 400. Following user selection of the bake icon 3186, the roast icon 3188, the convection icon 3192, the convection bake icon 3194 or the convection roast icon 3196, the user continues with programming the cook now cooking operation by selecting the next icon 3182 at step 2682, which prompts display of a temperature selection screen at step 2688. A suitable temperature selection screen is illustrated in FIG. 90 at 3208. In the preferred embodiment, the temperature variations corresponding to the bake, roast, convection, convection bake, and convection roast cooking operations correlates to a range of oven temperatures from 150 degrees to 500 degrees Fahrenheit. The skilled artisan will appreciate that this temperature range is for example purposes only and the upper and lower ends of the range are capable of adjustment in either direction without departing from the scope of the present invention.

As shown in FIG. 90, the temperature selection screen 3208 includes a graphical representation of a temperature range 3216, a sliding selector 3218, a minus five degree adjustment icon 3220, a plus five degree adjustment icon 3222, a next icon 3210, a cancel icon 3212, and a back icon 3214. The user sets the desired cooking temperature at step 2688 using the sliding selector 3218. When fine-tuning is necessary, the user selects the plus five degrees icon 3222, which raises the selected temperature by five degrees, or the minus five degrees icon 3220, which lowers the cooking temperature by five degrees. The skilled artisan will appreciate that the instant invention enables the user to return to the previous screen 3180 by selecting the back icon 3214 at step 2690, which returns the user to the cook methods selection screen 3180. The skilled artisan will further appreciate that by selecting the cancel icon 3212 at step 2692, the user is returned to the main screen 400 at step 2696. After setting the desired temperature, the user selects the next icon 3210 at step 2694, which prompts the display of a set cooking time screen at step 2708.

Following user selection of the dehydrate icon 3108 at step 2652, the user is presented, as shown in FIG. 89, with the ability to cancel the cook now operation by selecting the cancel icon 3184 at step 2638, or proceed to the next step of programming the cook now operation by selecting the next icon 3182 at step 2684. When the user selects the cancel icon 3184 at step 2638, flow proceeds to step 2640, wherein the display is returned to the main screen 400. When the user selects the next icon 3182 at step 2684, flow proceeds to step 2698, whereupon a set oven temperature screen 3208 is displayed, as illustrated in FIG. 90.

The skilled artisan will appreciate that the temperature selection screen 3208 advantageously enables the user to select the desired dehydration temperature. In the preferred embodiment, the temperature range for the dehydration operation is one hundred degrees to two hundred degrees, in accordance with dehydration temperatures known in the art. Thus, those skilled in the art will understand that the graphical representation of the temperature range 3208 is suitably adjusted for the dehydration operation to reflect a minimum temperature of one hundred degrees and a maximum temperature of two hundred degrees. The foregoing dehydration temperature range is for example purposes only and any dehydration temperature range known in the art is equally capable of being implemented in accordance with the present invention. The skilled artisan will appreciate that the instant invention enables the user to return to the previous screen 3180 by selecting the back icon 3214 at step 2700, which returns the user to the cook methods selection screen 3180 at step 2672. The skilled artisan will further understand that by selecting the cancel icon 3212 at step 2702, the user is returned to the main screen 400 at step 2706. After setting the desired temperature, the user selects the next icon 3210 at step 2704, which prompts the display of a set cooking time screen at step 2708.

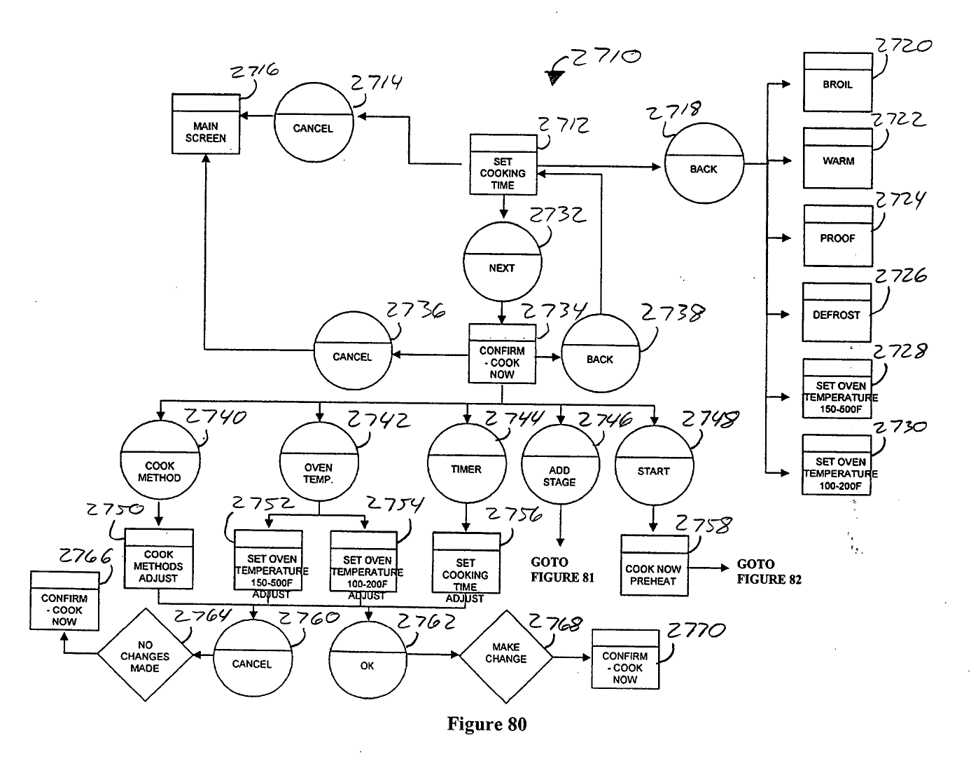

When the user desires to proceed with the cook now operation and has selected the broil icon 3190 at step 2654, warm icon 3198 at step 2656, the proof icon 3200 at step 2658, or the defrost icon 3106 at step 2660, flow proceeds to step 2686, wherein the user selects the next icon 3182. Following selection of the next icon 3182, flow proceeds to step 2708, whereupon a set cooking time screen is displayed to the user. Alternatively, the user is able to cancel the selected cooking operation by selecting the cancel icon 3184 at step 2638, which prompts the display to return to the main screen 400 at step 2640. It will be appreciated by those skilled in the art that step 2708 of FIG. 79 prompts flow to proceed to the screen architecture 2710 of FIG. 80. Furthermore, the skilled artisan will understand that the screen displayed at step 2708 of FIG. 79 is the same screen displayed to the user at step 2712 of FIG. 80.

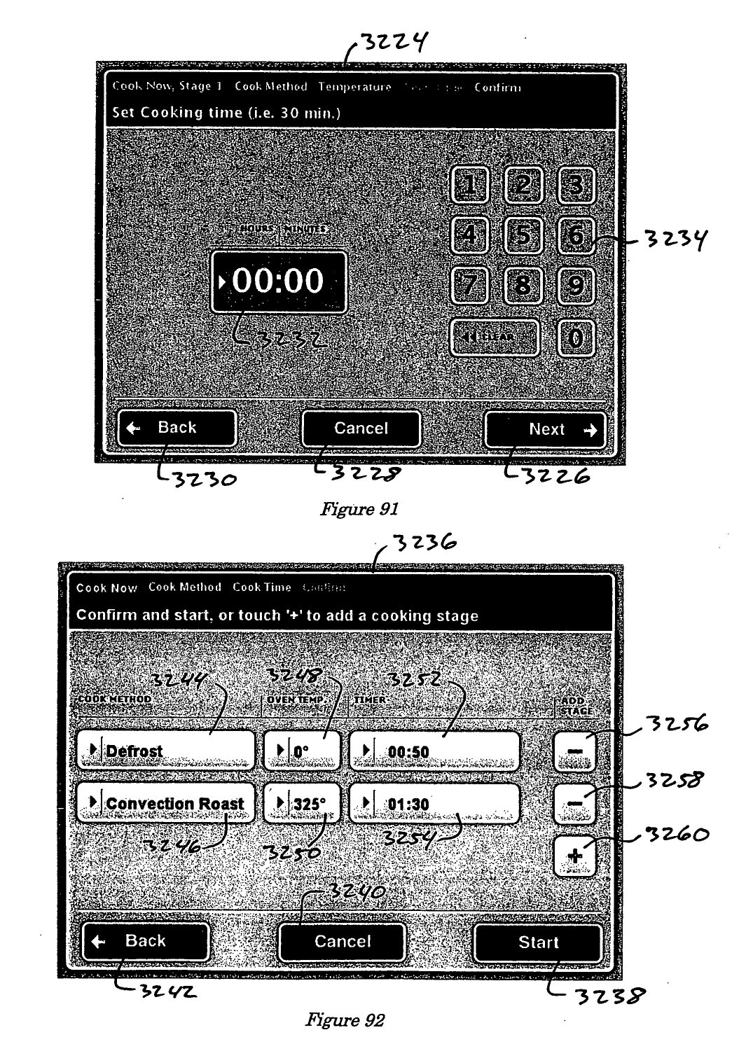

Turning now to FIG. 80, there is shown a flow chart illustrating the second-tier screen architecture 2710 associated with the cook now method in accordance with the present invention. At step 2712, a set cooking time screen is displayed for further input by the user. A suitable set cooking time screen is illustrated in FIG. 91 at 3224. As shown in FIG. 91, the set cooking time screen 3224 includes a timer window icon 3232, a numeric keypad 3234, a next icon 3226, a cancel icon 3228, and a back icon 3230. When the user desires to cancel the cooking operation, the user selects the cancel icon 3228 at step 2714, wherein display returns to the main screen 400 at step 2716. To return to the previous selection screen, the user selects the back icon 3230 at step 2718, whereupon the display returns to the previous screen. Thus, when the cooking method selected was the broil operation, flow returns to the broil display window screen 3180 at step 2720. When the cooking method was the warming operation, flow returns to the appropriate display screen 3180 at step 2722. This methodology continues for the proofing operation at step 2724 and the defrosting operation at step 2726. When the previously selected cooking method was the bake, roast, convection, convection bake, or convection roast operations, flow returns to the temperature setting screen 3208 at step 2728, with the corresponding temperature scale 3216 displayed. Similarly, when the previously selected operation was dehydration, flow returns to display the temperature setting screen 3208 at step 2730, with the corresponding reduced temperature scale 3216.

In order to continue with the cook now operation, the user inputs the desired cooking time via the numeric keypad 3234. As the user sets the cooking time, the display 3232 is updated to reflect the input time. When the user is satisfied with the set cooking time, the user selects the next icon 3226 at step 2732, which prompts display of a confirmation cook now screen at step 2734. A suitable confirmation screen is illustrated in FIG. 92 at 3236. The cook now confirmation screen 3236 includes a first stage cook method icon 3244, a second stage cook method icon 3246, a first stage oven temperature icon 3248, a second stage oven temperature icon 3250, a first stage timer icon 3252, a second stage timer icon 3254, a remove the first stage icon 3256, a remove the second stage icon 3258, an add a stage icon 3260, a start icon 3238, a cancel icon 3240, and a back icon 3242. Each of these icons will be explained in greater detail below with respect to the discussion corresponding to the screen architecture 2710 of FIG. 80. When the user desires to cancel setup of the cook now operation previously input, the user selects the cancel icon 3240 at step 2736, which prompts the display of the main screen 400 of FIG. 4 at step 2716. When the user desires to return to the previous input screen 3224, the user selects the back icon 3242, whereupon the user is returned to the set cooking time screen 3224 at step 2712.

From the cook now confirmation screen 3236, the user is capable of modifying any of the previous selections for the cook now operation by selecting one of the icons 3244-3254. When the user desires to change the previously selected cooking method, the user selects the first stage cook method icon 3244 at step 2740, prompting the display of the cook now cook method selection screen 3180 of FIG. 89 at step 2750. The user then makes any desired changes to the cook method and selects the okay, i.e., next icon 3182, at step 2762, whereby the changes to the cooking method are made to the cook now operation at step 2768 and flow returns to displaying the confirmation screen 3236 at step 2770. When the user determines that no changes to the cooking method are desired, the user selects the cancel icon 3184 at step 2760, whereby no changes are made to the cooking method at step 2764 and flow returns to displaying the confirmation screen 3236 at step 2766.

When the user desires to change the previously selected cooking or dehydration temperature, the user selects the first stage oven temperature icon 3248 at step 2742, prompting the display of the temperature selection screen 3208 at step 2752 or step 2754. The skilled artisan will appreciate that steps 2752 and 2754 result in the display of similar temperature screens 3208, albeit with different temperature range scales 3216. When the cooking method is bake, roast, convection, convection bake, or convection roast, flow proceeds to step 2752, whereupon the temperature range 3216 displayed is from 150-500 degrees Fahrenheit. When the cooking method selected is the dehydrate cooking method, flow proceeds to step 2754, whereupon the temperature range 3216 displayed is from 100-200 degrees Fahrenheit. When the user determines that no changes to the oven temperature are desired, the user selects the cancel icon 3212 at step 2760, whereby no changes are made to the cooking temperature at step 2764 and flow returns to displaying the confirmation screen 3236 at step 2766. When the user has adjusted the temperature, the user selects the okay, i.e., next icon 3210 at step 2762, whereby the changes to the cooking temperature are made to the cook now operation at step 2768 and flow returns to displaying the confirmation screen 3236 at step 2770.

In the event that the user desires to adjust the cooking time associated with the selected cooking operation, the user selects the first stage cooking time icon 3252 at step 2744, which prompts the display of the set cooking time screen 3224 at step 2756. The user is then able to adjust the duration of the cooking time of the selected cooking operation as set forth above. When the user elects to save the changes made to the cooking time, the user selects the okay, i.e., next icon 3226 at step 2762, whereupon the changes are made to the cook now operation at step 2768. Flow then returns to the confirmation screen 3236 at step 2770. When the user determines that the changes made to the cooking timer are to be discarded, the user selects the cancel icon 3228 at step 2760, whereupon no changes are made to the previously input cook time at step 2764 and flow returns to the display of the confirmation screen 3236 at step 2766.

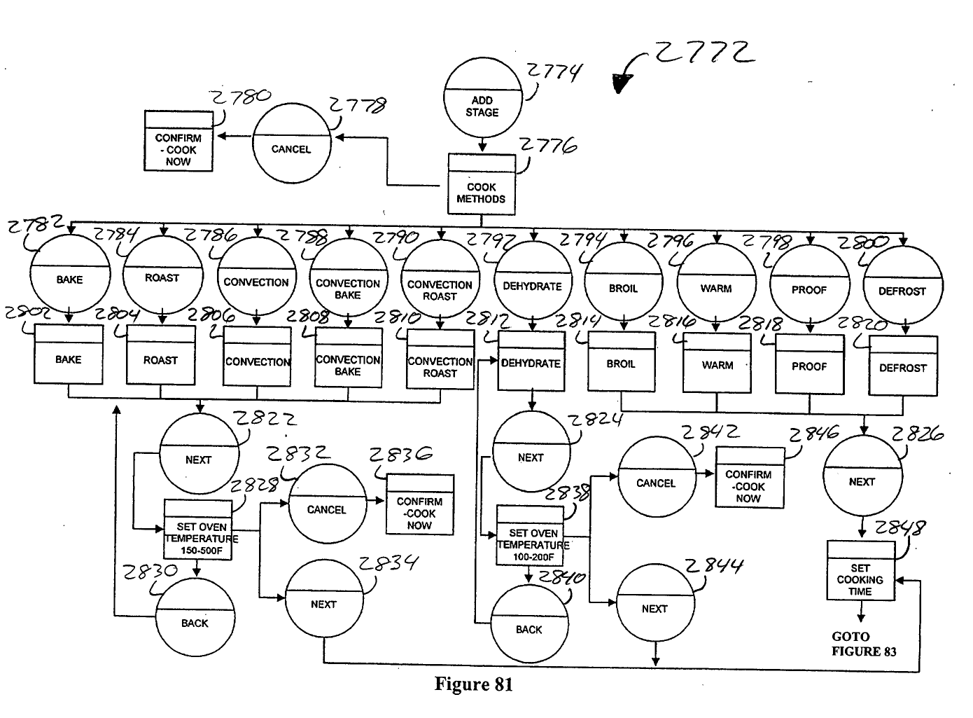

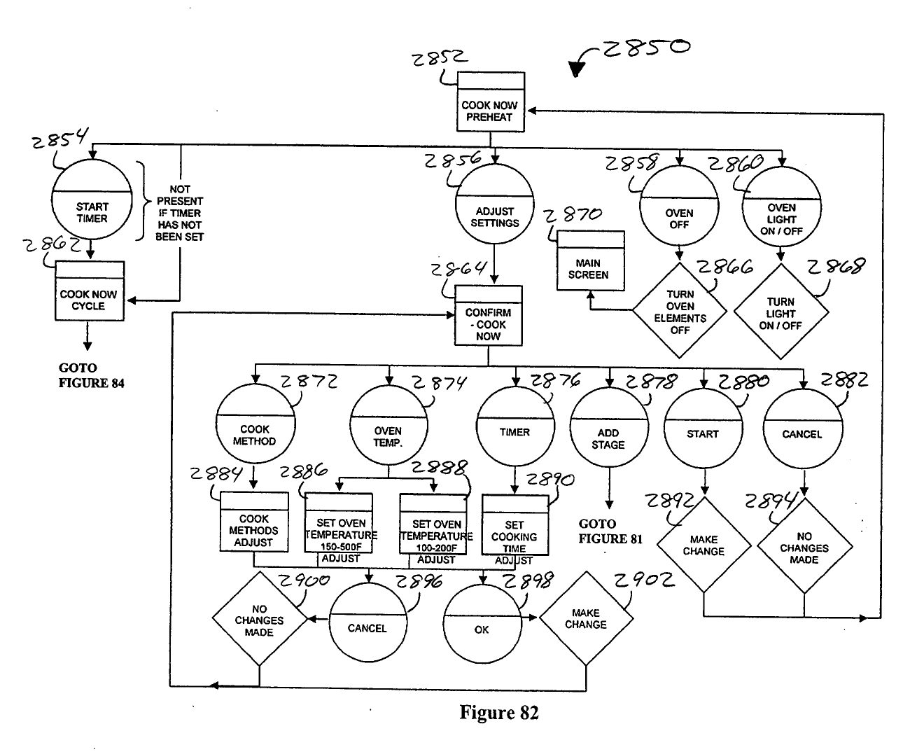

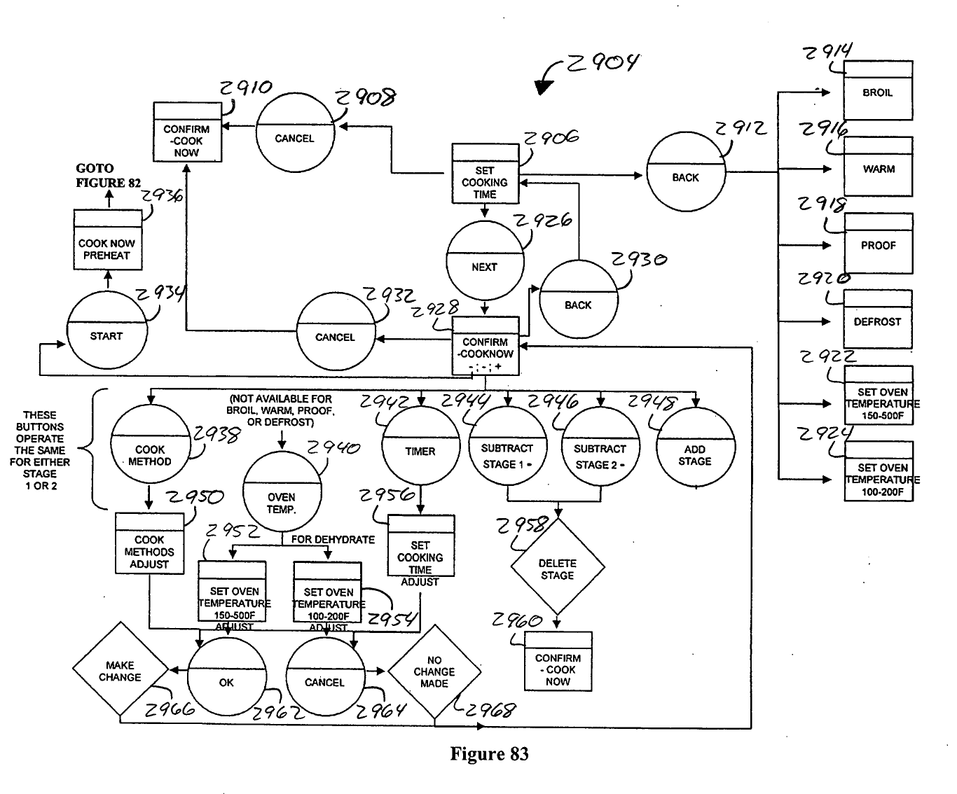

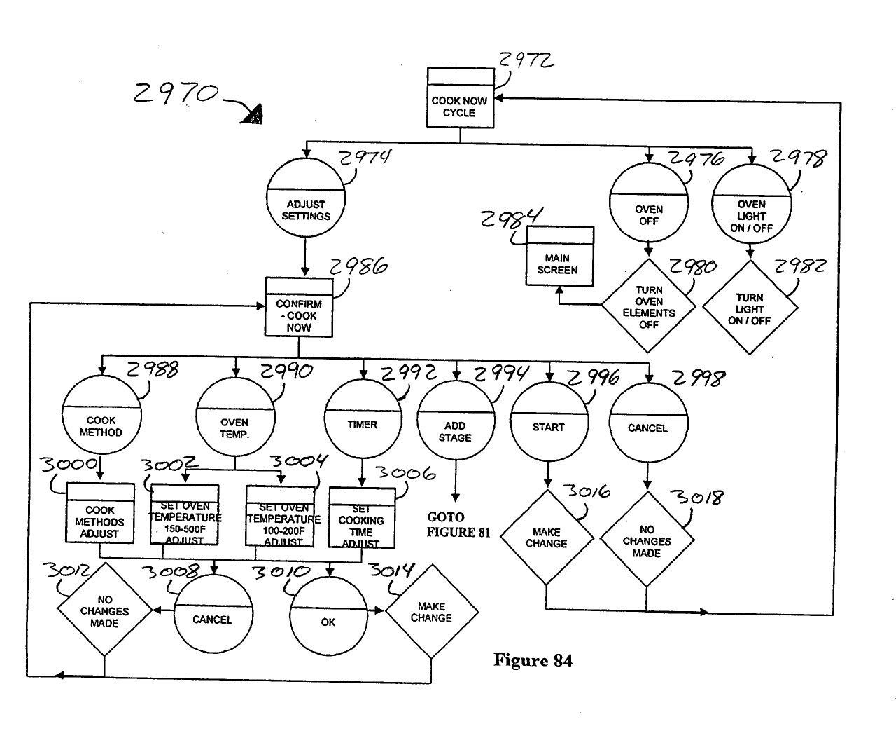

When the user determines that an additional stage is to be added, i.e., another step in the cook now operation is desired, the user selects the add a stage icon 3260 at step 2746, whereupon flow proceeds from step 2746 of FIG. 80 to step 2774 of FIG. 81. It will be appreciated by those skilled in the art that the screen architecture 2772 of FIG. 81 represents the adding of an additional stage to the cook now operation. Operations of the add a stage in accordance with the present invention will be discussed in further detail below. For purposes of continuity, discussion of the cook now methodology will first continue with the first stage and additional stages will be discussed thereinafter. When the user is satisfied with the cook now selections, the user selects the start icon 3238 at step 2748, whereupon flow proceeds to display a cook now preheat screen at step 2758. The skilled artisan will appreciate that flow proceeds from the screen architecture 2710 of FIG. 80 to preheat screen architecture 2850 of FIG. 82. Thus step 2758 of FIG. 80 corresponds to step 2852 of FIG. 82.

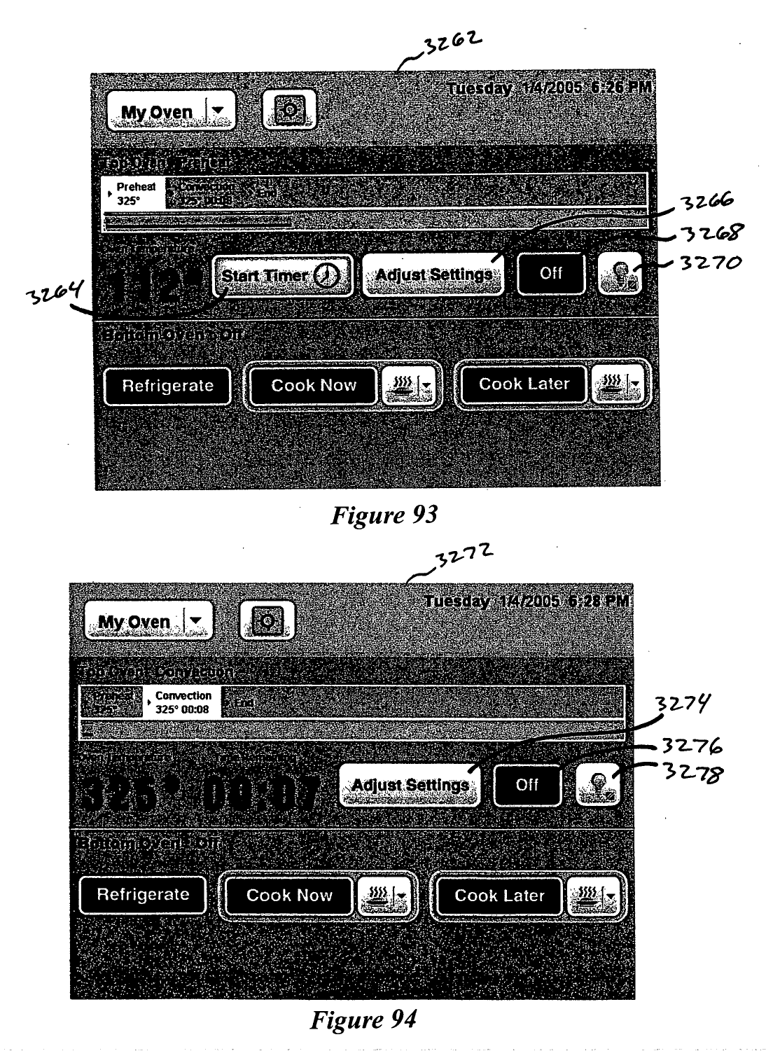

As indicated by step 2852 of FIG. 82, a screen template for a preheat of the oven in accordance with the cook now operation is advantageously displayed to the user. A suitable template is illustrated in FIG. 93 at 3262. As shown in FIG. 93, the preheat cook now screen 3262 includes a start timer icon 3264, an adjust settings icon 3266, an off icon 3268, and an oven light icon 3270. To turn on or off the oven light, the use selects the oven light icon 3270 at step 2860, whereupon the oven light is turned on or off, depending upon its previous state at step 2868. To turn the oven off, i.e., to terminate the preheat operation and the cook now operation, the user selects the off icon 3268 at step 2858, whereupon the preheat operation and cook now operation are terminated at step 2866 and flow returns to displaying the main screen 400 at step 2870.

When the user desires to adjust the previously input cook now settings, the user selects the adjust settings icon 3266 at step 2856, prompting display of the confirm cook now screen 3236 at step 2864. From the confirm now screen 3236, the user is able to adjust any of the previously input cook now settings, as desired. As previously discussed, the confirmation screen 3236 includes the first stage cook method icon 3244, the second stage cook method icon 3246, the first stage oven temperature icon 3248, the second stage oven temperature icon 3250, the first stage timer icon 3252, the second stage timer icon 3254, the remove the first stage icon 3256, the remove the second stage icon 3258, the add a stage icon 3260, the start icon 3238, the cancel icon 3240, and the back icon 3242. The functioning of these icons will be explained in greater detail below with respect to the corresponding screen architecture 2850 of FIG. 82. When the user desires to cancel setup of the cook now operation previously input, the user selects the cancel icon 3240 at step 2882, whereupon no changes are made to the cook now operation at step 2894, and flow returns to the preheat screen 3262 of FIG. 93 at step 2852. When the user desires to continue with the operation, i.e., leave the settings the way they appeared upon selection of the adjust icon 3266 or to incorporate any changes made, the user selects the start icon 3264 at step 2880, whereupon any changes made by the user are saved into the cook now operation at step 2892 and flow returns to the preheat screen 3262 at step 2852.

When the user desires to change the previously selected cooking method, the user selects the first stage cook method icon 3244 of FIG. 92 at step 2872, prompting the display of the cook now cook method selection screen 3180 of FIG. 89 at step 2884. The user then makes any desired changes to the cook method and selects the okay, i.e., next icon 3182, at step 2898, whereby the changes to the cooking method are made to the cook now operation at step 2902 and flow returns to displaying the confirmation screen 3236 of FIG. 92 at step 2864. When the user determines that no changes to the cooking method are desired, the user selects the cancel icon 3184 at step 2896, whereby no changes are made to the cooking method at step 2900 and flow returns to displaying the confirmation screen 3236 at step 2864.

When the user desires to change the previously selected cooking or dehydration temperature, the user selects the first stage oven temperature icon 3248 at step 2874, prompting the display of the temperature selection screen 3208 at step 2886 or step 2888. The skilled artisan will appreciate that steps 2886 and 2888 result in the display of similar temperature screens 3208 of FIG. 90, albeit with different temperature range scales 3216. When the cooking method is bake, roast, convection, convection bake, or convection roast, flow proceeds to step 2886, whereupon the temperature range 3216 displayed is from 150-500 degrees Fahrenheit. When the cooking method selected is the dehydrate cooking method, flow proceeds to step 2888, whereupon the temperature range 3216 displayed is from 100-200 degrees Fahrenheit. When the user determines that no changes to the oven temperature are desired, the user selects the cancel icon 3212 at step 2896, whereby no changes are made to the cooking temperature at step 2900 and flow returns to displaying the confirmation screen 3236 at step 2864. When the user has adjusted the temperature, the user selects the okay, i.e., next icon 3210 at step 2898, whereby the changes to the cooking temperature are made to the cook now operation at step 2902 and flow returns to displaying the confirmation screen 3236 at step 2864.

In the event that the user desires to adjust the cooking time associated with the selected cooking operation, the user selects the first stage cooking time icon 3252 at step 2876, which prompts the display of the set cooking time screen 3224 at step 2890. The user is then able to adjust the duration of the cooking time of the selected cooking operation as set forth above. When the user elects to save the changes made to the cooking time, the user selects the okay, i.e., next icon 3226 at step 2898, whereupon the changes are made to the cook now operation at step 2902. Flow then returns to the confirmation screen 3236 at step 2864. When the user determines that the changes made to the cooking timer are to be discarded, the user selects the cancel icon 3228 at step 2896, whereupon no changes are made to the previously input cook time at step 2900 and flow returns to the display of the confirmation screen 3236 at step 2864. It will be appreciated by those skilled in the art that the user is further able to add an additional stage to the cook now operation from the confirmation screen 3236 by selecting the add icon 3260 at step 2878, prompting flow to progress to step 2774 of FIG. 81, as discussed in greater detail below.

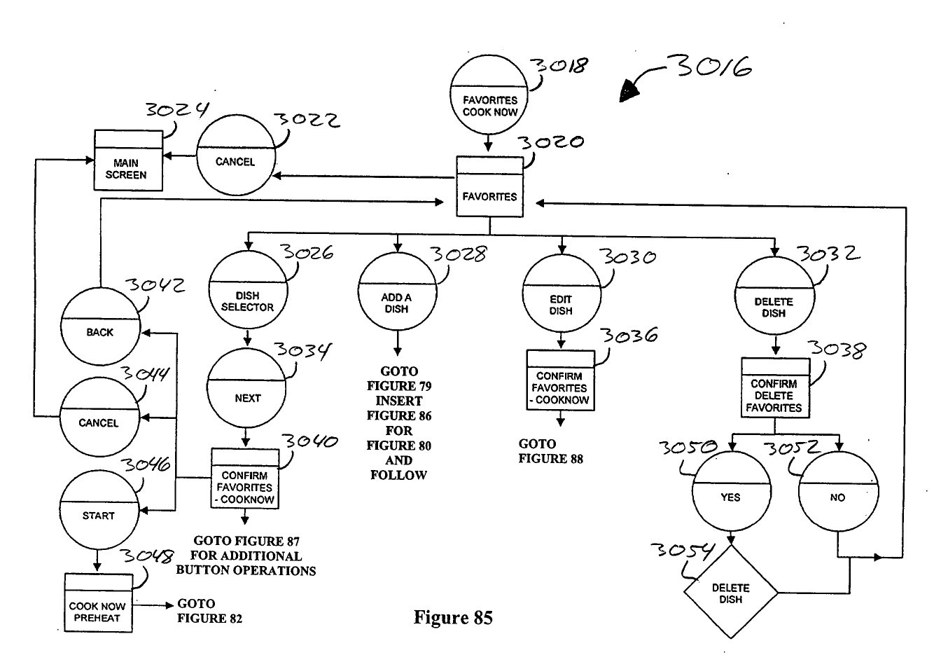

Once the user has completed all changes to the settings, or is ready to proceed from the preheat screen 3262 without making any setting changes, the user selects the start timer icon 3264 at step 2854, whereupon operations flow to step 2972 of FIG. 84. It will be appreciated by those skilled in the art that the start timer icon 3264 is only displayed to the user when the cooking time has been set. When no time has been set, the timer icon 3264 is not depicted on the screen 3262. Accordingly, once the preheat operation has completed, flow would proceed automatically, in the no cook time set, to the cook now cycle architecture 2970 of FIG. 84. Those skilled in the art will understand that in either event, flow progresses from the preheat cook now architecture 2850 of FIG. 82 to the cook now cycle architecture 2970 of FIG. 84, wherein step 2862 of FIG. 82 corresponds to step 2972 of FIG. 84.

Turning now to FIG. 84, there is shown a flowchart illustrating a cook now cycle architecture 2970 in accordance with the present invention. At step 2972, a cook now cycle screen is displayed to the user. A suitable template cook now cycle screen 3272 is illustrated in FIG. 94. As shown in FIG. 94, the cook now cycle screen 3272 includes an adjust settings icon 3274, an off icon 3276, and an oven light icon 3278. Preferably, the cook now cycle screen 3272 includes display data representative of the cook time left in the cook now operation, as well as temperature data and time data. The skilled artisan will appreciate that other data is equally capable of being displayed in accordance with present invention, and the instant invention is not limited to the data displayed in the template 3272. The user is able to terminate the cook now operation at any time from the screen 3272 upon selection of the off icon 3276 at step 2976, which then turns the oven heating elements, burners, or the like, off at step 2980. Flow then returns to the display of the main screen 400 at step 2984. To view the contents of the cooking chamber 106, the user selects the oven light icon 3278 at step 2978, whereupon the oven light is turned on or off, depending upon the light's current state, at step 2982.

From the screen cook now cycle template 3272, the user is able to further alter or adjust the cook now operation settings upon selection of the adjust settings icon 3274 at step 2974, whereupon the confirmation screen 3236 of FIG. 92 is displayed at step 2986. As previously discussed, the confirmation screen 3236 includes the cook method selection icon 3244, the oven temperature icon 3248, the timer icon 3252, and the add a stage icon 3260. When the user selects the cook method icon 3244 at step 2988, flow proceeds to step 3000, whereupon the cook method selection screen 3180 of FIG. 89 is displayed. The user then either selects a new cooking method or cancels the method adjust step. Once a new method is chosen, the user selects the okay, i.e., start, icon 3238 at step 3010, whereupon the changes are made to the selected method and flow returns to the confirmation screen 3236 at step 2986. When the user determines that the changes to the cooking method are to be negated, or that no changes are to be made, the user selects the cancel icon 3240 at step 3008, whereupon no changes are made to the cook now operation at step 3012, and flow returns to the confirmation screen 3236 at step 2986.

As previously discussed, the confirmation screen 3236 further enables the user to change the cooking temperature or dehydration temperature via selection of the oven temperature icon 3248 at step 2990. When the cook now cooking method selected is the bake, roast, convection, convection bake, or convention roast cooking operation, flow proceeds to step 3002, whereupon the temperature setting screen 3208, having the appropriate temperature scale 3216 is displayed to the user. Alternatively, when the dehydration method had been selected by the user, flow proceeds to step 3004, whereupon the temperature setting screen 3208 of FIG. 90 is displayed including the reduced temperature scale 3216 associated with dehydrating a food item. The user then selects the okay, i.e., next icon 3210 at step 3010, whereupon the temperature changes are made to the cook now operation at step 3014 and flow returns to the confirmation screen 3236 at step 2986. Should the user desire to ignore those changes made, the user selects the cancel icon 3212 at step 3008, whereupon no changes are made to the cook now operation at step 3012 and flow returns to the display of the confirmation screen 3236 at step 2986.

Adjustment of the cook time is accomplished upon selection of the cook timer 3252 at step 2992, whereupon the set cooking time screen 3224 of FIG. 91 is displayed to the user at step 3006. The user then updates the desired cook time and selects the okay, i.e., next icon 3226 at step 3010, whereupon the changes to the timer are made at step 3014 and flow returns to the confirmation screen 3236 at step 2986. When the changes made to the timer are to be ignored, the user selects the cancel icon 3228 at step 3008, whereupon any changes to the timer are ignored at step 3012, and flow returns to the confirmation screen 3236 at step 2986.

As mentioned above and discussed in greater detail below, the user is able to add an additional stage to the cook now operation from the confirmation screen 3236 by selecting the add a stage icon 3260 at step 2994, prompting flow to the add a stage screen architecture 2772 of FIG. 81. From the confirmation screen 3236, the user can save any changes made by selecting the start icon 3238 at step 2996, whereupon the changes are made at step 3016 and flow returns to the cook now cycle screen 3272 of FIG. 94 at step 2972. Additionally, the user may, at any time, cancel all changes and return to the cook now cycle screen 3272 by selecting the cancel icon 3240 at step 2998, following which no changes are made at step 3018 and flow returns to the display of the cook now cycle screen 3272 at step 2972.

It will be appreciated by those skilled in the art that the cook now cycle screen 3272 remains displayed on the touchscreen 222 throughout the cook now operation, displaying cooking information, such as oven temperature, cook time remaining, and the like. Following completion of the cook now operation, flow returns to the main screen 400, enabling further action by the user.

Discussion now turns to the addition of a second stage to the cook now operation, whereupon the user has selected the add a stage icon 3260 at step 2774 of FIG. 81. It will be understood by those skilled in the art that the discussion hereinafter refers to those circumstances in the cook now architecture, referenced above, wherein the user elects to add an additional stage to the cook now operation. It will further be understood that the addition of a stage to the cook now operation is accomplished from the confirmation screen 3236 of FIG. 92. Explanation of the addition of the new stage screen architecture 2772 of FIG. 81 will include reference to those screen templates used above with respect to the first stage of the cook operation. In addition, the user is able to add multiple stages to the cook now operation. For purposes of brevity, explanation is restricted to adding a single additional stage, although the instant invention is capable of incorporating a series of cooking stages in performing the cook now operation.

Once the user has selected the add a stage icon 3260 at step 2774, flow proceeds to step 2776, whereupon the cook now cooking method selection screen 3180 of FIG. 89 is displayed to the user. From the cooking method selection screen 3180, the user is able to return to the previous screen by selection of the cancel icon 3184 at step 2778, whereupon flow returns to displaying the confirmation screen 3236 at step 2780. As previously discussed, the user selects the desired cooking operation from the screen 3180, which then displays the corresponding graphical representation of the selected cooking method in the window 3206. Thus, for example, when the user selects the bake icon 3186 at step 2782, flow proceeds to step 2802, whereupon display window 3206 depicts a graphical representation of the bake operation. When the user selects the roast icon 3188 at step 2784, flow proceeds to step 2804, whereupon the window 3206 illustrates a roasting operation. Selection of the convection icon 3192 to add the convection cooking operation as the second stage at step 2786, prompts the display of the updated screen 3180 illustrating the convection cooking operation in the window 3206 at step 2806. When the user desires to add a convection bake operation as the second stage of the cook now operation, the user selects the convection bake icon 3194 at step 2788, which prompts the display of the graphical representation of a convection baking operation in the window 3206 at step 2808. A similar change in display occurs when the user selects the convection roast icon 3196 at step 2790, prompting the display window 3206 to depict a convection roasting operation at step 2810.

Once the user has selected the bake, roast, convection, convection bake, or convection roast operation, the user then proceeds to the next step in programming the second stage of the cook now operation by selecting the next icon 3182 at step 2822. Flow then progresses from the cook method selection screen 3180 to the temperature selection screen 3208 at step 2828. The user then inputs the desired cooking temperature, varying from 150 to 500 degrees Fahrenheit. The user then either returns to the previous screen, corresponding to the cooking method selected, by selecting the back icon 3214 at step 2830, cancels the operation by selecting the cancel icon 3212 at step 2832, or proceeding with the second stage cook now operation by selecting the next icon 3210 at step 2834. Upon user selection of the cancel icon 3212 at step 2832, flow proceeds to step 2836, whereupon display returns to the confirmation screen 3236 of FIG. 92. When the user selects the next icon 3210 at step 2834, flow proceeds to step 2848, whereupon a set cook time screen 3224 of FIG. 91 is displayed to the user. It will be appreciated by those skilled in the art that flow proceeds from the add stage architecture 2772 at step 2848 to the screen architecture 2904 of FIG. 83 at step 2906. Thus, step 2848 of FIG. 81 corresponds to step 2906 of FIG. 83.

Should the user desire to add a dehydration cooking operation to the cook now operation as the second stage, the user selects the dehydrate icon 3108 at step 2792. Following this selection, flow proceeds to step 2812, whereupon the window 3206 changes to display a dehydrate operation. The user then selects the next icon 3182 at step 2824, whereupon flow proceeds to display of the temperature selection screen 3208 at step 2838. It will be appreciated by those skilled in the art that the temperature selection screen 3208 advantageously illustrates the temperature scale 3216 of 100 to 200 degrees Fahrenheit in accordance with typical temperatures used in dehydrating food items. The user is then able to return to the previous method selection screen 3180 by selecting the back icon 3214 at step 2840, whereupon flow returns to step 2812. To cancel the cook now operation, the user selects the cancel icon 3184 at step 2842, whereupon flow proceeds to step 2846, which returns the display to the confirmation screen 3236. To proceed, the user selects the next icon 3210 at step 2844, following which flow proceeds to step 2848, whereupon the set cook time screen 3224 is displayed to the user. As stated in the preceding paragraph, flow then proceeds from the add stage architecture 2772 at step 2848 to the screen architecture 2904 of FIG. 83 at step 2906.

Selection of the broil cooking method, by selecting the broil icon 3190 at step 2794, flow proceeds to step 2814, whereupon a graphical representation of a broiling operation is illustrated in the window 3206 of the cooking method selection screen 3180. Similarly, when the user desires to add the warming operation as the second stage of the cook now operation, the user selects the warm icon 3198 at step 2796, whereupon the screen 3180 changes to reflect a graphical representation of a warming operation in the window 3206 at step 2816. Selection of the proof icon 3200 at step 2798 to indicate the addition of the proofing operation as the second stage of the cook now operation, prompts the display of a graphical representation of a proofing cooking method in the window 3206 at step 2818. In addition, when the user desires to add a defrosting operation as the second stage of the cook now operation, the user selects the defrost icon 3106 at step 2800, whereupon the window 3206 changes to display a graphical representation of a defrosting operation at step 2820.

When the next stage added to the cook now method is to broil, warm, proof, or defrost a food item, the user is able to cancel the operation, whereby flow returns to the confirmation screen 3236, or proceed to the next step. To proceed to the next step in adding a stage to cook now operation, the user selects the next icon 3182 at step 2826. Flow then proceeds to display the set cook time screen 3224 at step 2848. Accordingly, operational flow for adding the new stage to the cook now operation progresses from step 2848 of FIG. 81 to step 2906 of FIG. 83.

As shown in FIG. 83, the user is presented with a cooking timer setting screen 3224 of FIG. 91 at step 2906. To cancel the addition of the second stage to the cook now operation, the user selects the cancel icon 3228 from the set cook time screen 3224 at step 2908, whereupon flow returns to the confirmation screen 3236 at step 2910. To return to the previous screen, the user selects the back icon 3230 at step 2912, whereupon the display returns to the cook method selection screen 3180 for the broil operation at step 2914, the warm operation at step 2916, the proof operation at step 2918, or the defrost operation at step 2920. Display returns to the 150 to 500 degree Fahrenheit set oven temperature screen 3208 for the bake, roast, convection, convection bake, or convection roast at step 2922. Display returns to the 100 to 200 degree Fahrenheit set oven temperature screen 3208 for the dehydrate operation at step 2924.

The user then inputs the cook time, or leaves the cook time blank for the second stage of the cook now operation via the numeric keypad 3234 at step 2906 and selects the next icon 3226 at step 2926 to continue with the addition of the second stage to the cook now operation. User selection of the next icon 3226 prompts the display of the confirmation screen 3236 at step 2928. As shown in FIG. 92, the confirmation screen 3236 includes first stage icons 3244, 3248, and 3252, as well as second stage icons 3246, 3250, and 3254. From the confirmation screen the user is able to select the cancel icon 3240 at step 2932, which returns display to a confirmation screen 3236, which does not include a second stage for the cook now operation. It will be understood by those skilled in the art that while FIG. 92 illustrates a confirmation screen containing a second stage, the reversion to only displaying the first stage of the cook now operation is accomplished by removing the second stage icons 3246, 3250, and 3254. The user is also capable of returning to the set cooking time screen 3224 upon selection of the back icon 3242 at step 2930, whereby flow returns to step 2906.

From the confirmation screen 3236, the user is able to adjust the cook methods, the oven temperature, remove one or more stages, or add an additional stage. It will be appreciated that as shown in FIG. 92, the user is able to alter either the first stage, in accordance with the method described above, the second stage, or both. In editing the second stage, the user selects the second stage cook method icon 3246 at step 2938, which prompts the display of the cook method selection screen 3180 at step 2950. The user then makes any desired changes and selects the okay, i.e., next icon 3182 at step 2962, whereby the changes to the cooking method are made at step 2966 and flow returns to the confirmation screen 3236 at step 2928. To ignore or clear the changes, the user selects the cancel icon 3184 at step 2964, whereupon no changes are made at step 2968 and flow returns to the confirmation screen 3236 at step 2928.

The oven temperature icon 3250 is selected by the user to adjust the bake, roast, convection, convection bake, convection roast or dehydrate oven temperatures. It will be appreciated by those skilled in the art that the ability to change the oven temperature is not present when the warming, proofing, broil, or defrosting operation has been selected. In accordance with one embodiment of the instant invention, the icon 3250 is not presented to the user. In an alternate embodiment, the icon 3250 displays a zero degree temperature and is not selectable by the user. When the user desires to change the oven temperature for the bake, roast, convection, convection bake, or convection roast cooking operation, the user selects the temperature icon 3250 at step 2940, prompting the display of the temperature selection screen 3208 of FIG. 90, which allows the user to change the cooking temperature associated with the cooking operation. The user then accepts these changes by selecting the next icon 3210 at step 2962, whereupon the changes are made to the cook now operation at step 2966, thereafter returning display to the confirmation screen 3236 at step 2928. When the temperature is to remain the same, or alternatively the changes made are to be ignored, the user selects the cancel icon 3212 at step 2964, whereupon the changes are deleted at step 2968 and flow returns to step 2928.

Similarly, when the user desires to change the oven temperature for the dehydration operation, the user selects the temperature icon 3250 at step 2954, which prompts the display of the temperature selection screen 3208, albeit with the lower temperature range 3216 corresponding to dehydration operations. The user then makes any desired changes and either accepts the changes or cancels the changes. To accept the changes, the user selects the okay, i.e., next icon 3210 at step 2962, whereupon the changes are made at step 2966 and flow returns to the confirmation screen 3236 at step 2928. When the changes are to be ignored or no changes are made, the user selects the cancel icon 3212 at step 2964, whereupon no changes are made to the dehydration temperature settings at step 2968. Flow then returns to the confirmation screen 3236 at step 2928.

The user is further able to adjust the cooking time associated with the second stage by selecting the timer icon 3254 at step 2942, which prompts the display of the cook time selection screen 3224 at step 2956. The user then adjusts the cook time, as desired and accepts the changes or cancels the changes. To accept any changes, the user selects the next icon 3226 at step 2962, whereupon the changes are made to the cook time at step 2966 and flow returns to the confirmation screen 3236 at step 2928. To negate the changes, the user selects the cancel icon 3228 at step 2964, whereupon no changes are made to the cook time and flow returns to the confirmation screen 3236 at step 2928.

In addition to adjusting the settings for the second stage, the user is able to remove the first stage by selecting the first stage minus icon 3256 at step 2944, whereupon the first stage is deleted from the cook now operation and flow returns to the confirmation screen 3236 at step 2960. It will be appreciated by those skilled in the art that the confirmation screen 3236 displayed to the user at step 2960 contains only those stages remaining in the cook now operation. To delete the second stage, the user selects the minus second stage icon 3258 at step 2946, whereupon the second stage is deleted at step 2958. Flow then returns to the confirmation screen 3236 at step 2960, albeit without the second stage. Furthermore, the user is able to add an additional stage to the cook now operation by selecting the add a stage icon 3260 at step 2948, whereupon flow returns to step 2774 of FIG. 81 for the addition of a third stage to the cook now operation.

When all changes have been made, or when no changes are required, the user selects, from the confirmation screen 3236, the start icon 3238 at step 2934, which prompts the display of the cook now preheat screen 3262 at step 2936. Flow then proceeds to step 2852 of FIG. 82 and operation of the cooking appliance 102 continues thereon, as set forth above with respect to the operation of the first stage of the cook now operation. Those skilled in the art will appreciate that following completion of the addition of all stages to the cook now operation, flow proceeds through the preheat screen architecture 2850 of FIG. 82 through the cook now cycle screen architecture 2970 of FIG. 84, as described above.

Cook Now—Favorites Architecture

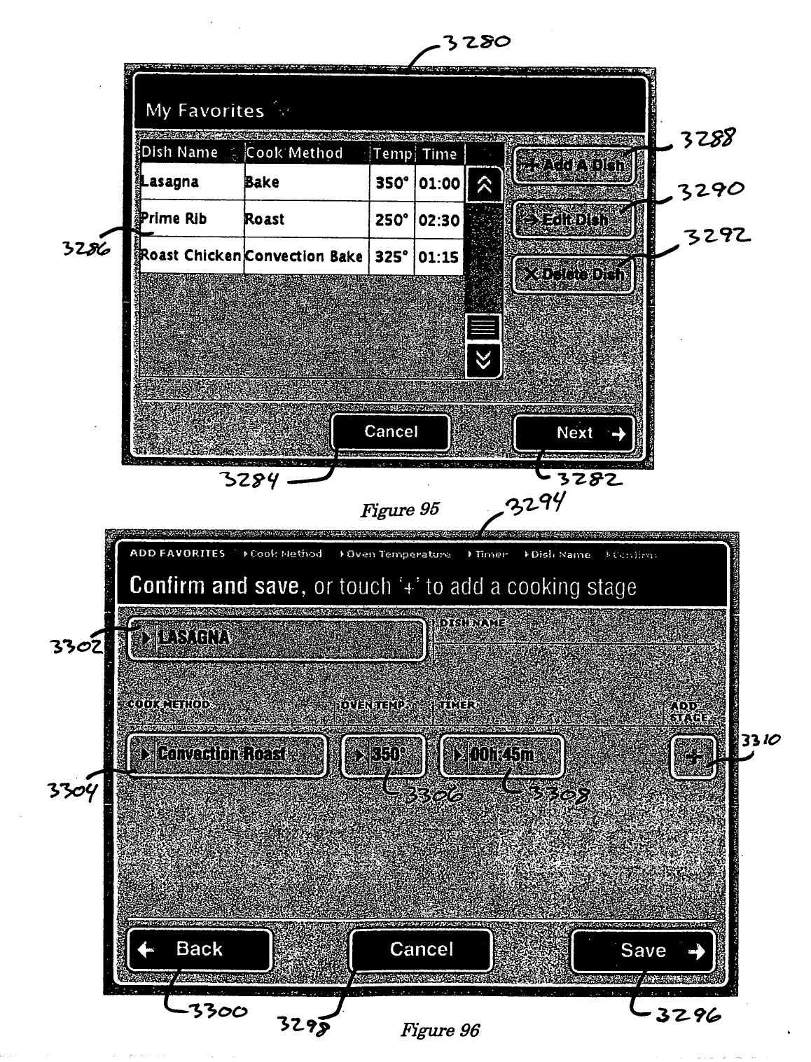

Returning to the main screen 400 of FIG. 4, the user is able to initiate a cook now operation for a favorite dish, i.e., a preprogrammed cooking operation stored by the cooking appliance 102. The cook now favorite operation is initiated by selection of the icon 424 at step 338 of FIG. 3, prompting display of the favorites screen 3280 of FIG. 95 at step 340. The skilled artisan will appreciate that step 340 of FIG. 3 corresponds to step 3018 of FIG. 85. Thus, flow proceeds from the main screen architecture 300 of FIG. 3 to the second tier architecture 3016 of FIG. 85. Following selection of the cook now favorites icon 424 at step 338, or 3018, flow proceeds to step 340, or 3020, whereupon the favorites screen 3280 is displayed.

As shown in FIG. 95, the favorites screen 3280 includes a scroll-down favorite dish menu 3286, an add a dish icon 3288, an edit a dish icon 3290, a delete a dish icon 3292, a next icon 3282, and a cancel icon 3284. Selection of the cancel icon 3284 at step 3022 cancels the cook now favorites operation, which returns the user to the main screen 400 at step 3024. When the user desires to initiate a cook now operation for an existing favorite dish, the user selects the desired dish from the menu 3286 at step 3026. The skilled artisan will appreciate that the selection is made by the user selecting the menu item from the menu 3286 via the touchscreen interface 222. Once the favorite dish is located, the user selects the next icon 3282 at step 3034, which prompts the display of a cook now favorite dish confirmation screen at step 3040. A suitable template screen 3294 is illustrated in FIG. 96. As shown in FIG. 96, the confirm favorites cook now screen 3294 includes a dish icon 3302, a cook method icon 3304, an oven temperature icon 3306, a timer icon 3308, an add a stage icon 3310, a save icon 3296, a cancel icon 3298, and a back icon 3300. The user is able to cancel the favorites cook now operation by selecting the cancel icon 3298 at step 3044, whereupon flow returns to the main screen 400 at step 3024. To return to the previous screen, the user selects the back icon at step 3042, whereupon flow returns to the favorites selection screen 3280 at step 3020. When the user does not desire to make any changes to the selected dish, the user initiates the cooking operation by selecting the start, i.e., save icon 3296 at step 3046, whereby flow proceeds to step 3048, with the display of the cook now preheat display 3262 of FIG. 93. The skilled artisan will appreciate that upon selection of the save icon 3296, the previously programmed cooking parameters are loaded as the first stage of the cook now operation, such that flow is able to proceed from step 3048 of FIG. 85 to step 2852 of FIG. 82. It will further be understood that operation of the cook now favorites cooking operation then progresses in the same manner as discussed above with respect to the cook now operation. Thus, once the cooking parameters for the selected dish have been input as the cook now settings, the cook now methodology, as described above, continues with performing the cooking operation.

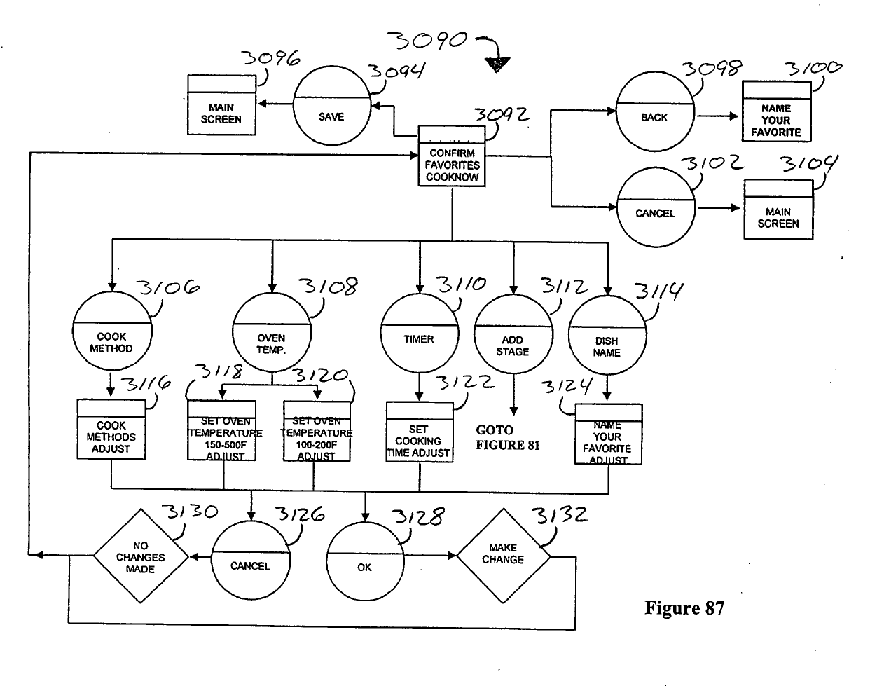

From the confirmation screen 3294, the user is able to adjust any of the settings for the selected dish by selecting the desired icon. Screen architecture 3090 of FIG. 87 is implemented at step 3040, such that step 3040 of FIG. 85 corresponds to step 3092 of FIG. 87. The skilled artisan will appreciate that the two screen architectures 3016 and 3092 contain overlapping functions, however the artisan will understand that such overlap is for purposes of explanation only. Thus, the user selection of the back icon 3300 at step 3042 of FIG. 85 corresponds to the user selection of the back icon 3300 at step 3090 of FIG. 87.

Therefore, turning now to FIG. 96, when the user desires to make changes to the selected dish, the user makes the changes using the icons 3302-3310, and selects the save icon 3296 at step 3094 of FIG. 87, whereupon the changes are saved into the favorites library at step 3094 and flow returns to the main screen 400 of FIG. 4 at step 3096. Similarly, when the user desires to cancel any changes input from the confirmation screen 3294, the user selects the cancel icon 3298 at step 3102, whereupon no changes are made to the selected dish and flow returns to the main screen 400 at step 3104. To change the cook method associated with the selected dish, the user selects the cook method icon 3304 at step 3106, whereby the cook methods selection screen 3180 of FIG. 89 is displayed to the user at step 3116. Once the user has made the desired changes to the cook method associated with the selected dish, the user selects the okay, i.e., next icon 3182 at step 3128, whereby the changes are made to the cooking method at step 3132 and flow returns to the confirmation screen 3294 at step 3092. To cancel the changes to the cooking method, the user selects the cancel icon 3184 at step 3126, whereupon the changes are discarded at step 3130 and flow returns to the confirmation screen 3294 at step 3092.

When the user desires to adjust the cooking temperature, the user selects the oven temperature icon 3306 at step 3108, whereupon flow proceeds to the 150 to 500 degrees Fahrenheit temperature selection screen 3208 of FIG. 90 at step 3118 when the cook method associated with the favorite dish is the bake, roast, convection, convection bake, or convection roast cooking operation. When the cooking method of the favorite dish is the dehydrate cooking operation, flow proceeds to step 3120, whereupon the 100 to 200 degree Fahrenheit temperature selection screen 3208 is displayed to the user. Once the user has adjusted the desired cooking temperature, the user selects the okay, i.e., next icon 3210 at step 3128 to make the changes to the cooking temperature. Flow then returns to the confirmation screen 3294 at step 3092. When the user desires to ignore or cancel the changes made to the cooking temperature, the user selects the cancel icon 3298 at step 3126, whereupon no changes are made to the cooking temperature and flow returns to the confirmation screen 3294 at step 3092.

When the user desires to change the cooking time associated with the selected favorites dish, the user selects the timer icon 3308 at step 3110, which prompts the display of the set timer screen 3224 of FIG. 91 at step 3122. The user then adjusts the time and saves the changes or cancels the changes. To save the changes to the cooking time, the user selects the okay, i.e., next icon 3226 at step 3128, wherein the changes are saved to the cooking timer associated with the selected favorites dish at step 3132. Operations then return to step 3092 with the display of the confirmation screen 3294 of FIG. 96. To ignore the changes and restore the originally programmed cooking time, the use selects the cancel icon 3298 at step 3126, whereupon no changes are made to the cooking time and flow returns to the confirmation screen 3294 at step 3092.

When the user desires to add a stage to the favorite dish, for example the user desires to keep the dish warm after cooking, the user selects the add a stage icon 3310 at step 3112. Flow then proceeds to the add a stage screen architecture 2772 of FIG. 81. The operation and programming of the new stage for the favorite dish then proceeds in accordance with the description of FIGS. 81 and 83, whereupon after completion of the new stage, flow returns to the confirmation screen 3294 at step 3092. The skilled artisan will understand the interconnection of the screen architectures for programming the new stage to the favorite dish in view of the description of FIGS. 81 and 83 above, and as such, discussion will continue hereinafter with FIG. 87.

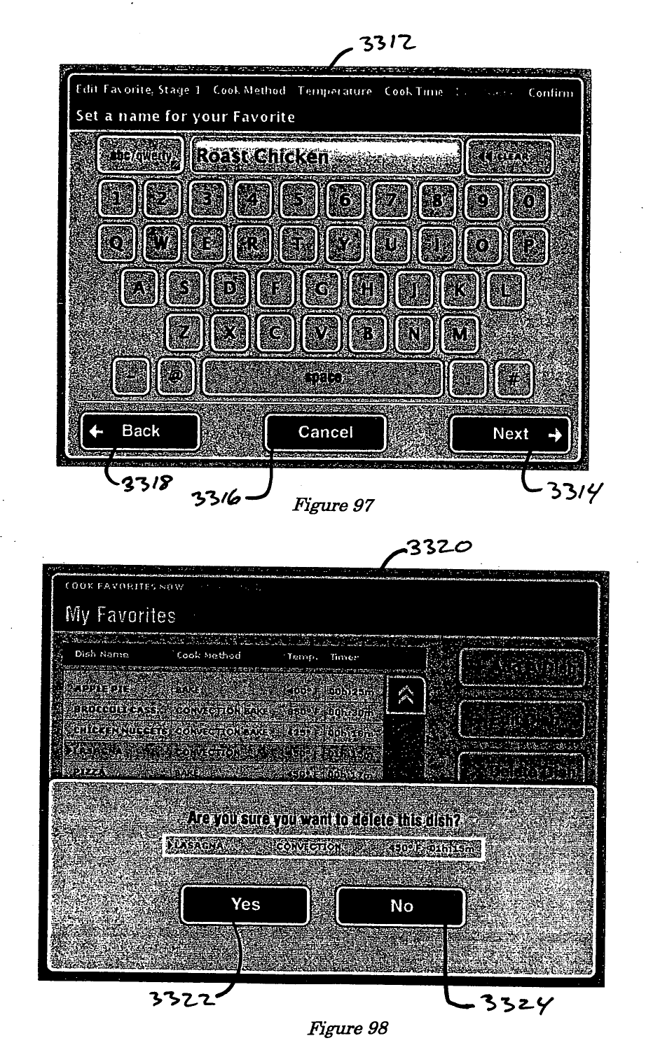

In the event that user requires the name of the dish be amended, the user selects the name icon 3302 at step 3114, which prompts the display of the favorites name screen 3312 of FIG. 97 at step 3124. The user then makes the desired name changes and selects the okay, i.e., next icon 3314 at step 3128, whereupon the changes to the favorite name are saved at step 3132 and flow returns to the confirmation screen 3294 at step 3092. When the user determines that the name changes are not to be made, the user selects the cancel icon 3316 at step 3126, whereupon no changes are made to the favorite name at step 3130. Flow then returns to the confirmation screen 3294 at step 3092.

In addition to immediately proceeding to the performance of the cook now favorites cooking operation, the user is able to add a new dish to the favorites library, edit an existing dish in the favorites library, or delete a dish from the favorites library. It will be understood by those skilled in the art that the term favorites library refers to a plurality of preprogrammed cooking operations, or recipes, that are capable of being performed by the cooking appliance, without requiring the user to input a cooking method, cooking time, oven temperature, or the like. It will further be understood by those skilled in the art that the favorites library is accessible in the context of a cook now operation, as well as a cook later cooking operations.

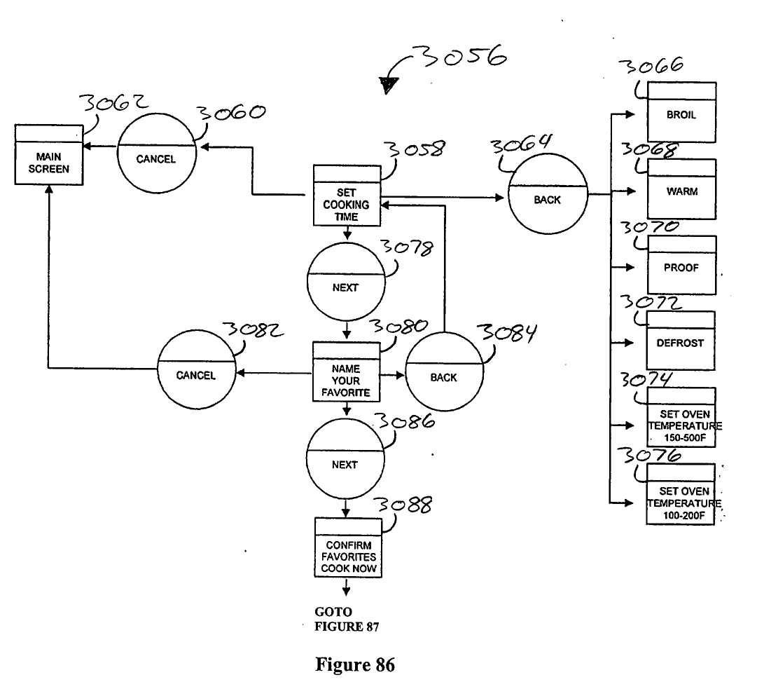

To add a new dish to the favorites library, the user selects the add a dish icon 3288 of FIG. 95 at step 3028 of FIG. 85, whereupon flow proceeds to step 2636 of FIG. 79 for user selection of the desired cooking method and oven temperature. The description of the screen architecture 2634 of FIG. 79, as set forth above with respect to the cook now cooking operation is incorporated into the programming of a new dish for the favorites library. Thus, the user, from the cooking method selection screen 3180 of FIG. 89 at step 2636, selects the appropriate cooking method, such as bake, roast, convection, convection bake, convection roast, dehydrate, broil, warm, proof, or defrost, sets the appropriate oven temperatures, when required, at steps 2688 or 2698, and proceeds to the next screen architecture, which for adding a new dish is the screen architecture 3056 of FIG. 86. Thus, step 2708 of FIG. 79 corresponds to step 3058 of FIG. 86.

Turning now to FIG. 86, there is shown a template screen architecture 3056 corresponding to the add a dish feature of the instant invention. Beginning at step 3058, the set cooking time screen 3224 is displayed to the user for input of the cooking time associated with the new dish. As previously discussed, the screen 3224 of FIG. 91 includes a next icon 3226, a cancel icon 3228, a back icon 3230, a timer display 3232 and a numeric keypad 3234. The user enters the desired cooking time via the numeric keypad 3234, which is then displayed in the timer display 3232. When the user desires to cancel the programming of the new favorite dish, the user selects the cancel icon 3228 at step 3060, whereupon flow proceeds to step 3062 and the display reverts to the main screen 400. When the user desires to change the previously selected cooking method, the user selects the back icon 3230 at step 3064, whereupon the display returns to the cook method selection screen 3180 of FIG. 89 for the broil operation at step 3066, the warm operation at step 3068, the proof operation at step 3070, or the defrost operation at step 3072. Display returns to the 150 to 500 degree Fahrenheit set oven temperature screen 3208 for the bake, roast, convection, convection bake, or convection roast at step 3074. Display returns to the 100 to 200 degree Fahrenheit set oven temperature screen 3208 for the dehydrate operation at step 3076.

Once the user has input the desired cooking time, the user selects the next icon 3226 at step 3078, whereupon flow proceeds to step 3080. At step 3080, a name your favorite screen is displayed to the user for naming the new dish. A suitable naming screen is illustrated in FIG. 97 as the screen template 3312. As shown in FIG. 97, the naming screen includes a next icon 3314, a cancel icon 3316, and a back icon 3318. It will be appreciated by those skilled in the art that the naming screen illustrated in FIG. 97 displays a QWERTY keyboard, however an ABC keyboard is also capable of being implemented, so as to allow the user to input a desired name for the new favorites dish. From the naming screen 3312, the user is able to cancel the favorites operation by selecting the cancel icon 3316 at step 3082, whereupon flow proceeds to step 3062 and the display returns to the main screen 400. The user is also capable of returning to the previous screen, i.e., the set cook time screen 3224, by selecting the back icon 3318 at step 3084, whereupon flow returns to step 3058. To proceed with the programming of the new dish, the user selects the next icon 3314 at step 3086, whereupon the confirmation of favorite screen 3294 of FIG. 96 is displayed at step 3088.

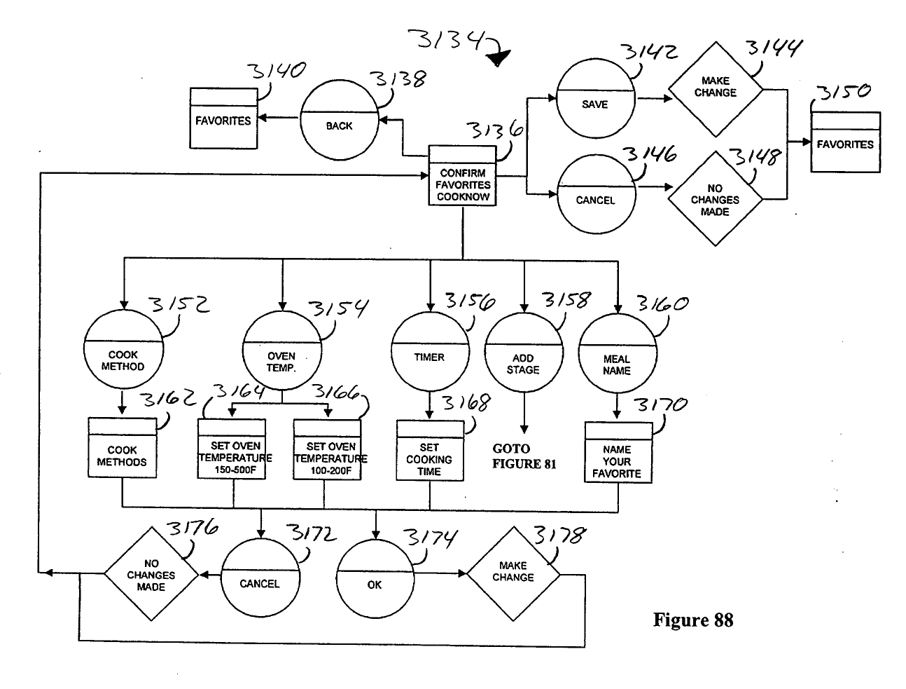

As previously discussed, the confirmation screen 3294 enables the user to change any of the previously input settings associated with the favorite dish. Screen architecture 3134 of FIG. 87 is implemented at step 3088, such that step 3088 of FIG. 86 corresponds to step 3092 of FIG. 88. Referring now to FIG. 87, the user is able to return to the previous screen, i.e., the favorites screen 3280 at step 3100 by selecting the back icon 3300 at step 3098. When the user has made any changes to the favorite dish and desires to save the changes, or is ready to save the new dish into the favorite menu without making the changes afforded by the confirmation screen 3294, the user selects the save icon 3296 at step 3094, whereupon the new dish and/or the changes to the new dish are saved into the favorite library at step 3096. Flow then returns to displaying the main screen 400 at step 3096. When the user does not desire to save the new dish, the user selects the cancel icon 3298 at step 3102, whereupon the new dish is discarded and flow returns to the main screen 3280 at step 3104.

When the user desires to change the cook method associated with the new dish, the user selects the cook method icon 3304 at step 3106, following which the cook methods selection screen 3180 of FIG. 89 is displayed to the user at step 3116. The user then makes any desired changes to the cook method associated with the new dish and selects the okay, i.e., next icon 3182 at step 3128, whereby the changes are made to the cooking method at step 3132 and flow returns to the confirmation screen 3294 at step 3092. When the changes made to the cooking method are to be disregarded, the user selects the cancel icon 3184 at step 3126 which discards the changes at step 3130 and returns to the confirmation screen 3294 at step 3092.

To change the cooking temperature previously input for the new favorite dish, the user selects the oven temperature icon 3306 at step 3108, whereupon flow proceeds to the 150 to 500 degrees Fahrenheit temperature selection screen 3208 at step 3118 for the bake, roast, convection, convection bake, or convection roast cooking methods, or to the 100 to 200 degrees Fahrenheit temperature selection screen 3208 at step 3120 for the dehydrate cooking method. The user adjusts the cooking temperature to the desired level and selects the okay, i.e., next icon 3210 at step 3128 to make the changes to the cooking temperature. Flow then returns to the confirmation screen 3294 at step 3092. To maintain the originally input cooking temperature and ignore any changes, the user selects the cancel icon 3298 at step 3126, whereupon no changes are made to the cooking temperature and flow returns to the confirmation screen 3294 at step 3092.

To alter the cooking time associated with the new dish, the user selects the timer icon 3308 at step 3110, prompting the display of the timer screen 3224 of FIG. 91 at step 3122. The user then adjusts the time and saves the changes or cancels the changes. When the changes to the cooking time are to be saved for the new dish, the user selects the okay, i.e., next icon 3226 at step 3128, wherein the changes to the cooking timer associated with the new favorites dish are saved at step 3132. Flow then return to step 3092 with the display of the confirmation screen 3294. When the original timer settings are to be restored, i.e., the changes are to be disregarded, the user selects the cancel icon 3298 at step 3126, whereupon no changes are made to the cooking time and flow returns to the confirmation screen 3294 at step 3092.

When the user desires to add a stage to the new favorite dish, for example the user desires to bake the dish after defrosting, the user selects the add a stage icon 3310 at step 3112. Following selection of the add a stage icon 3310, the add a stage screen architecture 2772 of FIG. 81 is then implemented. The operation and programming of the additional stage for the new favorite dish thereafter progresses in accordance with the description of FIGS. 81 and 82, whereupon after completion of the additional stage, flow returns to the confirmation screen 3294 at step 3092. The skilled artisan will understand the interconnection of the screen architectures for programming the new stage to the favorite dish in view of the description of FIGS. 80 and 82 above, and as such, discussion will continue hereinafter with FIG. 87.

If the user desires to change the name associated with the new dish, the user selects the name icon 3302 at step 3114, prompting the display of the favorites name screen 3312 of FIG. 97 at step 3124. The user then makes the desired name changes and selects the okay, i.e., next icon 3314 at step 3128, whereupon the changes to the favorite name are saved at step 3132 and flow returns to the confirmation screen 3294 at step 3092. When the user determines that the name changes are not to be made, the user selects the cancel icon 3316 at step 3126, whereupon no changes are made to the favorite name at step 3130. Flow then returns to the confirmation screen 3294 at step 3092. The user is then able to immediately implement the new dish by selecting the start, i.e., save icon 3296 from the confirmation screen 3296 or return to the favorites screen 3280 by selecting the cancel icon 3298.

Returning to FIG. 85, when the user desires to edit an existing favorite dish, the user selects the desired dish from the dish menu 3286 and selects the edit dish icon 3290 at step 3030. Following selection of the edit option, flow proceeds to step 3036, whereupon the confirmation screen 3294 is displayed to the user. In accordance with the discussion above, flow proceeds from step 3036 of FIG. 85 to step 3136 of FIG. 88. The cooking parameters associated with the selected dish to be edited are retrieved and then displayed on the confirmation screen 3294. The user then edits the cooking method by selecting the cook method icon 3304 at step 3152, the oven temperature by selecting the oven temperature icon 3306 at step 3154, the cooking time by selecting the timer icon 3308 at step 3156, add a dish to the selected favorite dish by selecting the add a dish icon 3310, or modify the selected favorite's name by selecting the name icon 3302 at step 3160. The user selects the desired parameters, performs the modifications, and saves the modifications to the selected dish in accordance with the architecture 3134 of FIG. 88 described above.

Screen architecture 3134 of FIG. 88 is implemented at step 3036, such that step 3036 of FIG. 85 corresponds to step 3136 of FIG. 88. The skilled artisan will appreciate that the two screen architectures 3016 and 3134 contain overlapping functions, however the artisan will understand that such overlap is for purposes of explanation only. Thus, the user selection of the back icon 3300 at step 3042 of FIG. 85 corresponds to the user selection of the back icon 3300 of FIG. 96 at step 3138 of FIG. 88.

Therefore, turning now to FIG. 96, when the user desires to make changes to the selected dish, the user makes the changes using the icons 3302-3310, and selects the save icon 3296 at step 3142 of FIG. 88, whereupon the changes are saved into the favorites library at step 3144 and flow returns to the favorites screen 3280 of FIG. 95 at step 3150. Similarly, when the user desires to cancel any changes input from the confirmation screen 3294, the user selects the cancel icon 3298 at step 3148, whereupon no changes are made to the selected dish and flow returns to the favorites screen 3280 at step 3150. To change the cook method associated with the selected dish, the user selects the cook method icon 3304 at step 3152, whereby the cook methods selection screen 3180 of FIG. 89 is displayed to the user at step 3162. Once the user has made the desired changes to the cook method associated with the selected dish, the user selects the okay, i.e., next icon 3182 at step 3174, whereby the changes are made to the cooking method at step 3178 and flow returns to the confirmation screen 3294 at step 3136. To cancel the changes to the cooking method, the user selects the cancel icon 3184 at step 3172, whereupon the changes are discarded at step 3176 and flow returns to the confirmation screen 3294 at step 3136.

When the user desires to adjust the cooking temperature, the user selects the oven temperature icon 3306 at step 3154, whereupon flow proceeds to the 150 to 500 degrees Fahrenheit temperature selection screen 3208 of FIG. 90 at step 3164 when the cook method associated with the favorite dish is the bake, roast, convection, convection bake, or convection roast cooking operation. When the cooking method of the favorite dish is the dehydrate cooking operation, flow proceeds to step 3166, whereupon the 100 to 200 degree Fahrenheit temperature selection screen 3208 is displayed to the user. Once the user has adjusted the desired cooking temperature, the user selects the okay, i.e., next icon 3210 at step 3174 to make the changes to the cooking temperature. Flow then returns to the confirmation screen 3294 at step 3136. When the user desires to ignore or cancel the changes made to the cooking temperature, the user selects the cancel icon 3298 at step 3172, whereupon no changes are made to the cooking temperature and flow returns to the confirmation screen 3294 at step 3136.

When the user desires to change the cooking time associated with the selected favorites dish, the user selects the timer icon 3308 at step 3156, which prompts the display of the set timer screen 3224 of FIG. 91 at step 3168. The user then adjusts the time and saves the changes or cancels the changes. To save the changes to the cooking time, the user selects the okay, i.e., next icon 3226 at step 3174, wherein the changes are saved to the cooking timer associated with the selected favorites dish at step 3178. Operations then return to step 3136 with the display of the confirmation screen 3294 of FIG. 96. To ignore the changes and restore the originally programmed cooking time, the use selects the cancel icon 3298 at step 3172, whereupon no changes are made to the cooking time and flow returns to the confirmation screen 3294 at step 3136.

When the user desires to add a stage to the favorite dish, for example the user desires to keep the dish warm after cooking, the user selects the add a stage icon 3310 at step 3158. Flow then proceeds to the add a stage screen architecture 2772 of FIG. 81. The operation and programming of the new stage for the favorite dish then proceeds in accordance with the description of FIGS. 81 and 83, whereupon after completion of the new stage, flow returns to the confirmation screen 3294 at step 3136. The skilled artisan will understand the interconnection of the screen architectures for programming the new stage to the favorite dish in view of the description of FIGS. 81 and 83 above, and as such, discussion will continue hereinafter with FIG. 88.

In the event that user requires the name of the dish be amended, the user selects the name icon 3302 at step 3160, which prompts the display of the favorites name screen 3312 of FIG. 97 at step 3170. The user then makes the desired name changes and selects the okay, i.e., next icon 3314 at step 3174, whereupon the changes to the favorite name are saved at step 3178 and flow returns to the confirmation screen 3294 at step 3136. When the user determines that the name changes are not to be made, the user selects the cancel icon 3316 at step 3172, whereupon no changes are made to the favorite name at step 3176. Flow then returns to the confirmation screen 3294 at step 3136.

In addition to immediately proceeding to the performance of the cook now favorites cooking operation, the user is able to add a new dish to the favorites library, edit an existing dish in the favorites library, or delete a dish from the favorites library. It will be understood by those skilled in the art that the term favorites library refers to a plurality of preprogrammed cooking operations, or recipes, that are capable of being performed by the cooking appliance, without requiring the user to input a cooking method, cooking time, oven temperature, or the like. It will further be understood by those skilled in the art that the favorites library is accessible in the context of a cook now operation, as well as a cook later cooking operations.

To add a new dish to the favorites library, the user selects the add a dish icon 3288 of FIG. 95 at step 3028 of FIG. 85, whereupon flow proceeds to step 2636 of FIG. 79 for user selection of the desired cooking method and oven temperature. The description of the screen architecture 2634 of FIG. 79, as set forth above with respect to the cook now cooking operation is incorporated into the programming of a new dish for the favorites library. Thus, the user, from the cooking method selection screen 3180 of FIG. 89 at step 2636, selects the appropriate cooking method, such as bake, roast, convection, convection bake, convection roast, dehydrate, broil, warm, proof, or defrost, sets the appropriate oven temperatures, when required, at steps 2688 or 2698, and proceeds to the next screen architecture, which for adding a new dish is the screen architecture 3056 of FIG. 86. Thus, step 2708 of FIG. 79 corresponds to step 3058 of FIG. 86.

Turning now to FIG. 86, there is shown a template screen architecture 3056 corresponding to the add a dish feature of the instant invention. Beginning at step 3058, the set cooking time screen 3224 is displayed to the user for input of the cooking time associated with the new dish. As previously discussed, the screen 3224 of FIG. 91 includes a next icon 3226, a cancel icon 3228, a back icon 3230, a timer display 3232 and a numeric keypad 3234. The user enters the desired cooking time via the numeric keypad 3234, which is then displayed in the timer display 3232. When the user desires to cancel the programming of the new favorite dish, the user selects the cancel icon 3228 at step 3060, whereupon flow proceeds to step 3062 and the display reverts to the main screen 400. When the user desires to change the previously selected cooking method, the user selects the back icon 3230 at step 3064, whereupon the display returns to the cook method selection screen 3180 of FIG. 89 for the broil operation at step 3066, the warm operation at step 3068, the proof operation at step 3070, or the defrost operation at step 3072. Display returns to the 150 to 500 degree Fahrenheit set oven temperature screen 3208 for the bake, roast, convection, convection bake, or convection roast at step 3074. Display returns to the 100 to 200 degree Fahrenheit set oven temperature screen 3208 for the dehydrate operation at step 3076.

Once the user has input the desired cooking time, the user selects the next icon 3226 at step 3078, whereupon flow proceeds to step 3080. At step 3080, a name your favorite screen is displayed to the user for naming the new dish. A suitable naming screen is illustrated in FIG. 97 as the screen template 3312. As shown in FIG. 97, the naming screen includes a next icon 3314, a cancel icon 3316, and a back icon 3318. It will be appreciated by those skilled in the art that the naming screen illustrated in FIG. 97 displays a QWERTY keyboard, however an ABC keyboard is also capable of being implemented, so as to allow the user to input a desired name for the new favorites dish. From the naming screen 3312, the user is able to cancel the favorites operation by selecting the cancel icon 3316 at step 3082, whereupon flow proceeds to step 3062 and the display returns to the main screen 400. The user is also capable of returning to the previous screen, i.e., the set cook time screen 3224, by selecting the back icon 3318 at step 3084, whereupon flow returns to step 3058. To proceed with the programming of the new dish, the user selects the next icon 3314 at step 3086, whereupon the confirmation of favorite screen 3294 of FIG. 96 is displayed at step 3088.

As previously discussed, the confirmation screen 3294 enables the user to change any of the previously input settings associated with the favorite dish. Screen architecture 3134 of FIG. 88 is implemented at step 3088, such that step 3088 of FIG. 86 corresponds to step 3136 of FIG. 88. Referring now to FIG. 88, the user is able to return to the previous screen, i.e., the favorites screen 3280 by selecting the back icon 3300 at step 3138. When the user has made any changes to the favorite dish and desires to save the changes, or is ready to save the new dish into the favorite menu without making the changes afforded by the confirmation screen 3294, the user selects the save icon 3296 at step 3142, whereupon the new dish and/or the changes to the new dish are saved into the favorite library at step 3144. Flow then returns to displaying the favorites screen 3280 at step 3150. When the user does not desire to save the new dish, the user selects the cancel icon 3298 at step 3146, whereupon the new dish is discarded and flow returns to the favorites screen 3280 at step 3150.

When the user desires to change the cook method associated with the new dish, the user selects the cook method icon 3304 at step 3152, following which the cook methods selection screen 3180 of FIG. 89 is displayed to the user at step 3162. The user then makes any desired changes to the cook method associated with the new dish and selects the okay, i.e., next icon 3182 at step 3174, whereby the changes are made to the cooking method at step 3178 and flow returns to the confirmation screen 3294 at step 3136. When the changes made to the cooking method are to be disregarded, the user selects the cancel icon 3184 at step 3172, which discards the changes at step 3176 and returns to the confirmation screen 3294 at step 3136.

To change the cooking temperature previously input for the new favorite dish, the user selects the oven temperature icon 3306 at step 3154, whereupon flow proceeds to the 150 to 500 degrees Fahrenheit temperature selection screen 3208 at step 3164 for the bake, roast, convection, convection bake, or convection roast cooking methods, or to the 100 to 200 degrees Fahrenheit temperature selection screen 3208 for the dehydrate cooking method. The user adjusts the cooking temperature to the desired level and selects the okay, i.e., next icon 3210 at step 3174 to make the changes to the cooking temperature. Flow then returns to the confirmation screen 3294 at step 3136. To maintain the originally input cooking temperature and ignore any changes, the user selects the cancel icon 3298 at step 3172, whereupon no changes are made to the cooking temperature and flow returns to the confirmation screen 3294 at step 3136.

To alter the cooking time associated with the new dish, the user selects the timer icon 3308 at step 3156, prompting the display of the timer screen 3224 of FIG. 91 at step 3168. The user then adjusts the time and saves the changes or cancels the changes. When the changes to the cooking time are to be saved for the new dish, the user selects the okay, i.e., next icon 3226 at step 3174, wherein the changes to the cooking timer associated with the new favorites dish are saved at step 3178. Flow then return to step 3136 with the display of the confirmation screen 3294. When the original timer settings are to be restored, i.e., the changes are to be disregarded, the user selects the cancel icon 3298 at step 3172, whereupon no changes are made to the cooking time and flow returns to the confirmation screen 3294 at step 3136.

When the user desires to add a stage to the new favorite dish, for example the user desires to bake the dish after defrosting, the user selects the add a stage icon 3310 at step 3158. Following selection of the add a stage icon 3310, the add a stage screen architecture 2772 of FIG. 81 is then implemented. The operation and programming of the additional stage for the new favorite dish thereafter progresses in accordance with the description of FIGS. 81 and 82, whereupon after completion of the additional stage, flow returns to the confirmation screen 3294 at step 3136. The skilled artisan will understand the interconnection of the screen architectures for programming the new stage to the favorite dish in view of the description of FIGS. 80 and 82 above, and as such, discussion will continue hereinafter with FIG. 88.

If the user desires to change the name associated with the new dish, the user selects the name icon 3302 at step 3160, prompting the display of the favorites name screen 3312 of FIG. 97 at step 3170. The user then makes the desired name changes and selects the okay, i.e., next icon 3314 at step 3174, whereupon the changes to the favorite name are saved at step 3178 and flow returns to the confirmation screen 3294 at step 3136. When the user determines that the name changes are not to be made, the user selects the cancel icon 3316 at step 3172, whereupon no changes are made to the favorite name at step 3176. Flow then returns to the confirmation screen 3294 at step 3136. The user is then able to immediately implement the new dish by selecting the start, i.e., save icon 3296 from the confirmation screen 3296 or return to the favorites screen 3280 by selecting the cancel icon 3298.

Returning to FIG. 85, when the user desires to edit an existing favorite dish, the user selects the desired dish from the dish menu 3286 and selects the edit dish icon 3290 at step 3030. Following selection of the edit option, flow proceeds to step 3036, whereupon the confirmation screen 3294 is displayed to the user.

When the user desires to remove a favorite dish from the dish library, the user selects the dish to be deleted from the menu 3286 and then selects the delete a dish icon 3292 at step 3032 of FIG. 85. Following selection of the delete icon 3292, flow proceeds to step 3038, whereupon a delete confirmation screen 3320, as illustrated in FIG. 98, is shown to the user. As depicted in FIG. 98, the confirm deletes favorite screen 3320 includes a yes icon 3322 and a no icon 3324. To remove the dish from the library, the user selects the yes icon 3322 at step 3050, whereupon the dish is deleted at step 3054. Flow then returns to the favorites screen 3280 at step 3020. When the user determines that the dish should not be removed, the user selects the no icon 3324 at step 3052, whereupon flow returns to the favorites screen 3280 at step 3020.

Cook Later Architecture

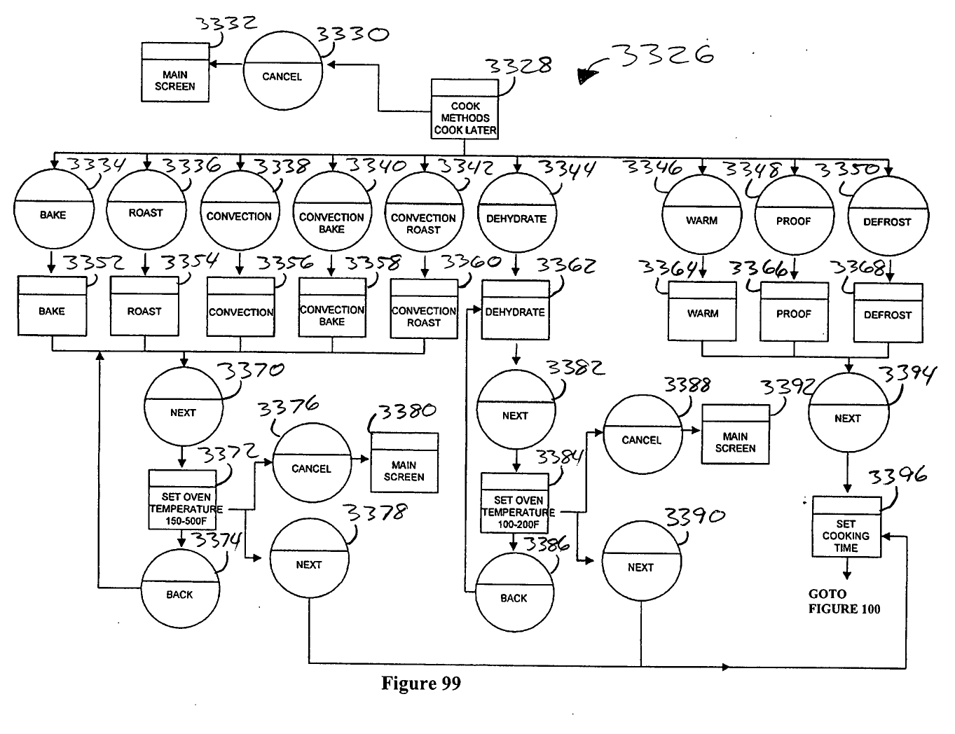

In addition to immediately preparing a food item, the instant invention enables the user to store and then heat a food item at a later time. In order to program the cooking appliance 102 to make use of this feature, the user selects the cook later icon associated with the desired cooking chamber, e.g., the user selects the cook later icon 420 associated with the top cooking chamber 106. It will be understood by those skilled in the art that the functioning of the cook later feature with respect to the bottom chamber 108 is suitably accomplished using the same architectures and methodologies described hereinafter with respect to the cook later operation of the top chamber 106. When the user selects the cook later icon 420 of FIG. 4 at step 342 of the main screen architecture 300 of FIG. 3, flow proceeds to step 344, wherein the cook methods available to the user are displayed for further selection. It will be understood by those skilled in the art that the operation of the cook later feature proceeds from step 344 to step 3328 of the second tier screen architecture 3326 of FIG. 99.

That is, step 344 of FIG. 3 corresponds to step 3328 of FIG. 99, whereupon a cook later cooking method selection screen, such as the screen template 3966 of FIG. 111 is displayed. According to the present invention, the cook later operation of the cooking appliance is able to provide the user with the ability to program one or more stages, such as, a refrigeration and baking operation, a refrigeration, roasting and warming operation, and the like. The screen templates described hereinafter are suitably adapted for use for a first stage, a second stage, and a third stage of operation. The skilled artisan will appreciate that any number of desired stages are capable of being programmed by the user in accordance with the present invention.

As shown in FIG. 111, the cook later cooking method selection screen 3966 includes icons representative of several cooking options, such as, for example and without limitation, a bake icon 3972, a roast icon 3974, a convection icon 3976, a convection bake icon 3978, a convection roast icon 3980, a dehydrate icon 3982, a broil icon 3984, a warm icon 3986, a proof icon 3988, and a defrost icon 3990. The skilled artisan will appreciate that the icons 3972-3990 are examples of cooking operations which the cooking appliance 102 is capable of performing. Other cooking operations, in addition to those operations shown, are also capable of being performed by the cooking appliance without departing from the scope of the present invention. The skilled artisan will appreciate that due to the nature of a broil cooking operation, broiling a food item in the cook later program is not provided in accordance with the preferred embodiment of the present invention. However, alternate embodiments of the instant invention are capable of providing for programming a broil cooking operation into the cook later program. FIG. 111 further includes a graphical illustration window 3992 suitably adapted to provide a visual queue to the user representative of the cooking or cooling operation selected. Thus, for example and without limitation, the screen 3996 illustrates that a bake operation has been selected, which is shown in the window 3992. It will be understood by those skilled in the art that each icon 3972-3990 advantageously corresponds to a different graphical representation which is capable of being shown to the user via the window 3992. The cook later method selection screen template 3966 further includes a next icon 3968 and a cancel icon 3970, the function of which will be explained in greater detail below.

Returning to the cook later screen architecture 3326 at step 3328, upon user selection of the bake icon 3972 at step 3334, flow proceeds to step 3352, whereupon the window 3992 displays a graphical representation of a baking operation. When the user selects the roast icon 3974 at step 3336, flow proceeds to step 3354, which prompts the graphical window 3992 to display a roasting operation. User selection of the convection icon 3976 at step 3338 directs the window 3992 to illustrate a convection cooking operation at step 3356. In the event that the user desires to initiate a convection baking operation, the user selects the convection bake icon 3978 at step 3340, whereupon the window 3992 displays a graphical representation of a convection baking operation at step 3358. When the user elects to perform a convection roasting operation in connection with the cook later operation, the user selects the convection roast icon 3980 at step 3342, whereupon the window 3992 displays a graphical representation of a convection roasting operation at step 3360.

To program a dehydration operation into the cook later program, the user selects the dehydrate icon 3982 at step 3344, following which flow proceeds to step 3362 with the graphical window 3992 illustrating a dehydrating operation. Similarly, to include a warming operation in the cook later program, the user selects the warm icon 3986 at step 3346, whereupon the window 3992 illustrates a graphical representation of a warming operation at step 3364. A proofing cooking operation is initiated upon user selection of the proof icon 3988 at step 3348, which prompts the display of a representation of a proofing operation in the window 3992 at step 3366. In the event that the user desires to defrost a food item, the user selects the defrost icon 3990 at step 3350, whereupon the window 3992 displays a graphical representation of a defrosting operation at step 3368.

As shown in FIG. 111, the user is capable of canceling the cook later operation by selecting the cancel icon 3970 at step 3330. When the user selects the cancel icon 3970 at step 3330, flow proceeds to step 3332, wherein the display is returned to the main screen 400. Following user selection of the bake icon 3972, the roast icon 3974, the convection icon 3976, the convection bake icon 3978 or the convection roast icon 3980, the user continues with programming the cook later cooking operation by selecting the next icon 3968 at step 3370, which prompts display of the temperature selection screen 3208 of FIG. 90 at step 3372. In the preferred embodiment, the temperature variations corresponding to the bake, roast, convection, convection bake, and convection roast cooking operations correlates to a range of oven temperatures from 150 degrees to 500 degrees Fahrenheit. The skilled artisan will appreciate that this temperature range is for example purposes only and the upper and lower ends of the range are capable of adjustment in either direction without departing from the scope of the present invention.

As previously described, the temperature selection screen 3208 of FIG. 90 includes a graphical representation of a temperature range 3216, a sliding selector 3218, a minus five degree adjustment icon 3220, a plus five degree adjustment icon 3222, a next icon 3210, a cancel icon 3212, and a back icon 3214. Selection of the desired temperature for the cook later cooking operation is accomplished as described above with respect to FIG. 90. Returning to the previous screen is accomplished when the user selects the back icon 3214 at step 3374, which returns the user to the cook methods selection screen 3966. The skilled artisan will further appreciate that by selecting the cancel icon 3212 at step 3376, the user is returned to the main screen 400 at step 3380. After setting the desired temperature, the user selects the next icon 3210 at step 3378, which prompts the display of a set cooking time screen at step 3396.

Following user selection of the dehydrate icon 3982 at step 3344, the user is presented, as shown in FIG. 111, with the ability to cancel the cook later operation by selecting the cancel icon 3970 at step 3330, or proceed to the next step of programming the cook later operation by selecting the next icon 3968 at step 3382. When the user selects the cancel icon 3970 at step 3330, flow proceeds to step 3332, wherein the display is returned to the main screen 400. When the user selects the next icon 3968 at step 3382, flow proceeds to step 3384, whereupon the set oven temperature screen 3208 of FIG. 90 is displayed.

As explained in greater detail above, the temperature selection screen 3208 illustrated upon the selection of the dehydration cooking method enables the user to select a temperature for dehydrating the food item. In the preferred embodiment, the temperature range for the dehydration operation is one hundred degrees to two hundred degrees, in accordance with dehydration temperatures known in the art. The foregoing dehydration temperature range is for example purposes only and any dehydration temperature range known in the art is equally capable of being implemented in accordance with the present invention. The user is capable of returning to the previous screen by selecting the back icon 3214 at step 3386, which returns the user to the cook methods selection screen 3966 at step 3362. Upon selection of the cancel icon 3212 at step 3388, the user returns to the main screen 400 at step 3392. After setting the desired temperature, the user selects the next icon 3210 at step 3390, which prompts the display of a set cooking time screen at step 3396.

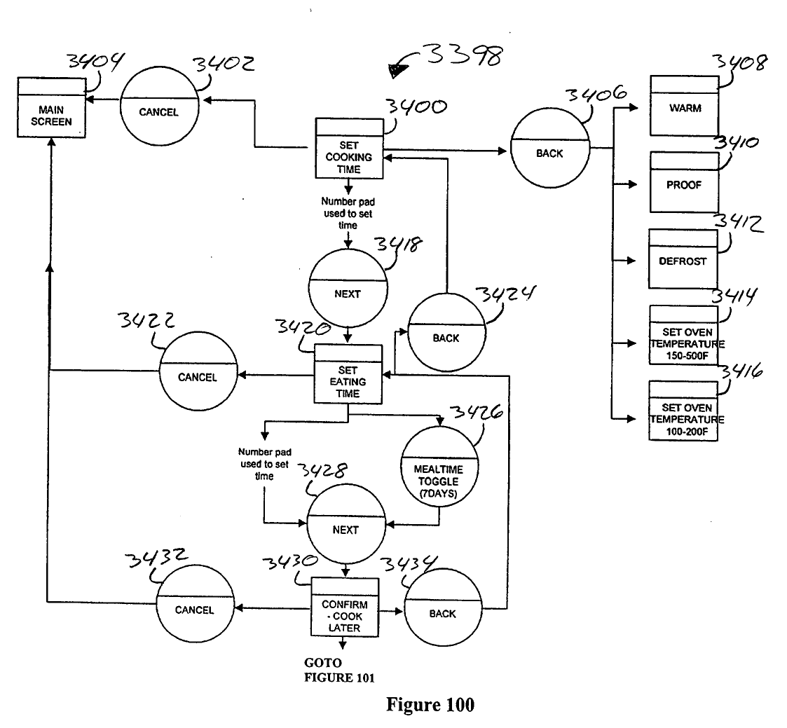

When the user desires to proceed with the cook later operation and has selected the warm icon 3986 at step 3346, the proof icon 3988 at step 3348, or the defrost icon 3990 at step 3350, flow proceeds to step 3394, wherein the user selects the next icon 3968. Following selection of the next icon 3968, flow proceeds to step 3396, whereupon a set cooking time screen is displayed to the user. Alternatively, the user is able to cancel the selected cooking operation by selecting the cancel icon 3970 at step 3330, which prompts the display to return to the main screen 400 at step 3332. It will be appreciated by those skilled in the art that step 3396 of FIG. 99 prompts flow to proceed to the screen architecture 3398 of FIG. 100. Furthermore, the skilled artisan will understand that the screen displayed at step 3396 of FIG. 99 is the same screen displayed to the user at step 3400 of FIG. 100.

Turning now to FIG. 100, there is shown a flow chart illustrating the second-tier screen architecture 3398 associated with the cook later method in accordance with the present invention. At step 3400, a set cooking time screen is displayed for the user to set the time necessary for the selected method to cook the food item. A suitable set cooking time screen is illustrated in FIG. 91 at 3224. The user then sets the desired cooking time via the numeric keypad 3234 and selects the next icon 3226 at step 3418, whereupon flow proceeds to a set eating time screen for further input by the user. A suitable set eating time screen is illustrated in FIG. 112 at 3994 and displayed to the user at step 3420. As shown in FIG. 112, the set eating time screen 3994 includes a meal date icon 4002, a timer window icon 4004, an AM/PM toggle icon 4006, a numeric keypad 4008, a next icon 3996, a cancel icon 3998, and a back icon 4000. When the user desires to cancel the cook later cooking operation, the user selects the cancel icon 3998 at step 3402, wherein display returns to the main screen 400 at step 3404. To return to the previous selection screen, the user selects the back icon 4000 at step 3406, whereupon the display returns to the previous screen. Thus, when the cooking method selected was the warming operation, flow returns to the appropriate display screen 3966 at step 3408. This same method applies for the proofing operation at step 3410 and the defrosting operation at step 3412. When the previously selected cooking method was the bake, roast, convection, convection bake, or convection roast operations, flow returns to the temperature setting screen 3208 of FIG. 90 at step 3414, with the corresponding temperature scale 3216 displayed. Similarly, when the previously selected operation was dehydration, flow returns to display the temperature setting screen 3208 at step 3416, with the corresponding reduced temperature scale 3216.

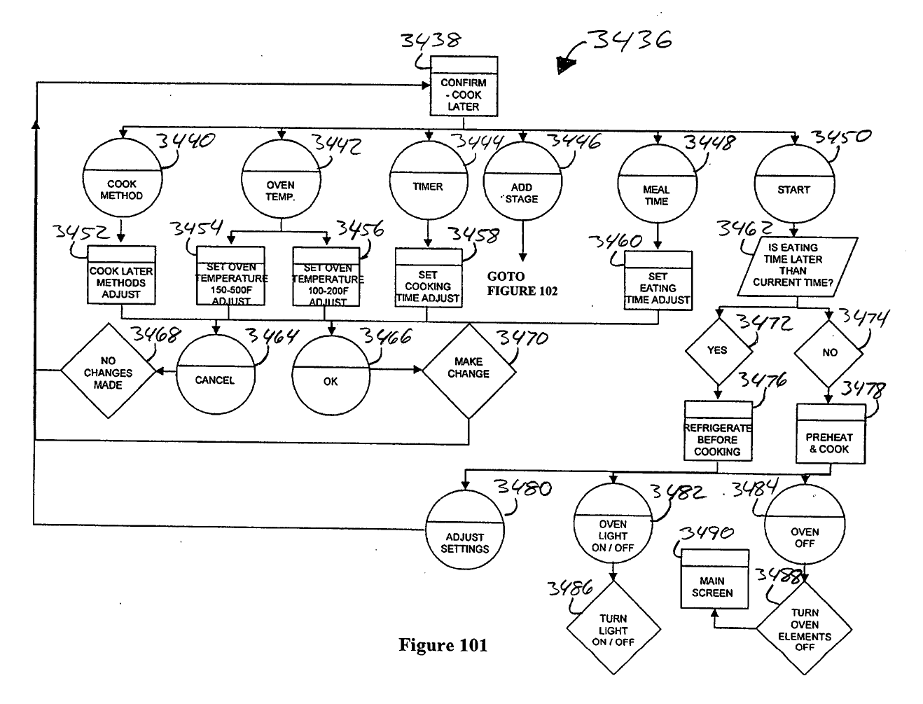

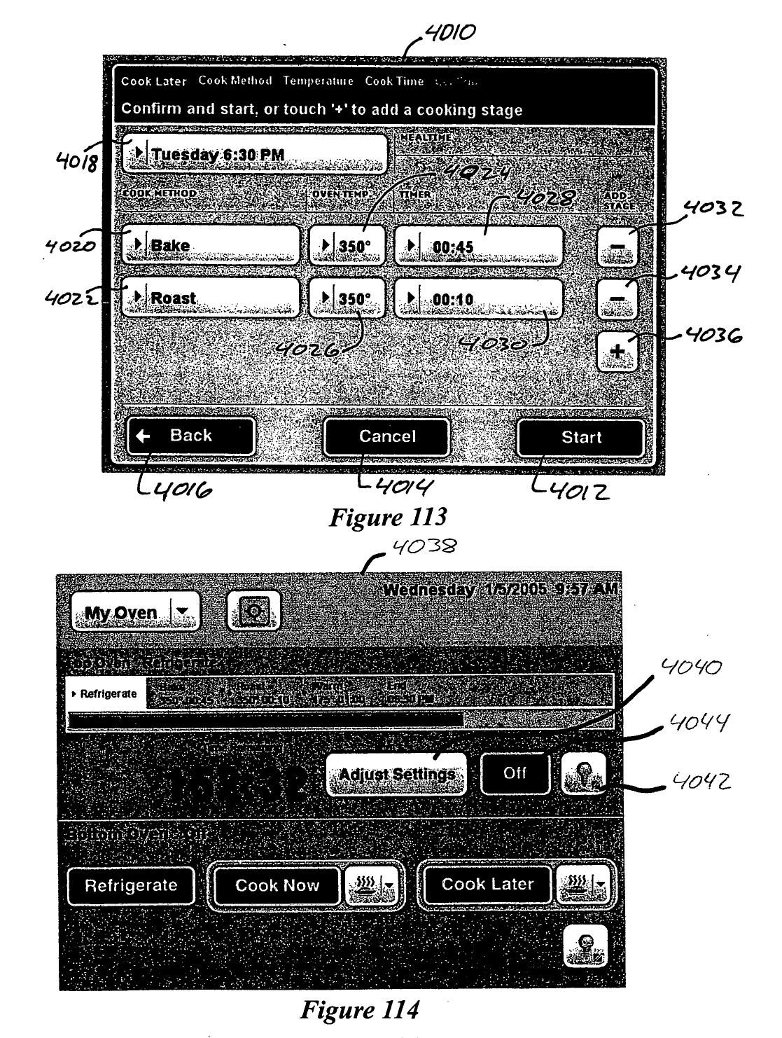

In order to continue with the cook later operation, the user sets the date for the cook later program using meal date icon 4002 at step 3426 to adjust the date on which the cooking method is to be performed. The user then inputs the desired time at which to begin cooking using the numeric keypad 4008, which is then displayed in the time window 4004. AM or PM is set using the AM/PM toggle icon 4006. When the user is satisfied with the cooking time, the user selects the next icon 3996 at step 3428, which prompts display of a confirmation cook later screen at step 3430. A suitable confirmation screen is illustrated in FIG. 113 at 4010. The cook later confirmation screen 4010 includes a meal time icon 4018, a first stage cook method icon 4020, a second stage cook method icon 4022, a first stage oven temperature icon 4024, a second stage oven temperature icon 4026, a first stage timer icon 4028, a second stage timer icon 4030, a remove the first stage icon 4032, a remove the second stage icon 4034, an add a stage icon 4036, a start icon 4012, a cancel icon 4014, and a back icon 4016. Each of these icons will be explained in greater detail below with respect to the discussion corresponding to the screen architecture 3436 of FIG. 101. When the user desires to cancel setup of the cook later operation previously input, the user selects the cancel icon 4014 at step 3432, which prompts the display of the main screen 400 of FIG. 4 at step 3404. When the user desires to return to the previous input screen 3994, the user selects the back icon 4016 at step 3434 of FIG. 101, whereupon the user is returned to the set eating time screen 3994 at step 3420.

From the cook later confirmation screen 4010, the user is capable of modifying any of the previous selections for the cook later operation by selecting one of the icons 4018-4036. When the user desires to change the previously selected cooking method, the user selects the first stage cook method icon 4020 at step 3440, prompting the display of the cook later cook method selection screen 3966 of FIG. 111 at step 3452. The user inputs any desired changes to the cook method and selects the okay, i.e., next icon 3968, at step 3466, whereupon the changes to the cooking method are made to the cook later operation at step 3470. Flow then returns to the display of the confirmation screen 4010 of FIG. 113 at step 3438. In the event that the user decides that no changes to the cooking method are desired, the user selects the cancel icon 4014 at step 3464, whereby no changes are made to the cooking method at step 3468 and flow returns to displaying the confirmation screen 4010 at step 3438.

When the user desires to change the previously set cooking or dehydration temperature, the user selects the first stage oven temperature icon 4024 at step 3442, prompting the display of the temperature selection screen 3208 of FIG. 90 at step 3454 or step 3456. The skilled artisan will appreciate that steps 3454 and 3456 correspond to the display of the same temperature screens 3208, although different temperature range scales 3216 are shown. In the event that the cooking method selected for the cook later operation was the bake, roast, convection, convection bake, or convection roast, flow proceeds to step 3454, resulting in the temperature range 3216 displayed as varying from 150-500 degrees Fahrenheit. When the cooking method selected was the dehydration cooking method, flow progresses to step 3456, at which the temperature range 3216 displayed is from 100-200 degrees Fahrenheit. Should the user determine that no changes to the oven temperature are to be made, the user selects the cancel icon 3212 at step 3464, whereby no changes are made to the cooking temperature at step 3468 and flow returns to displaying the confirmation screen 4010 at step 3438. When the user has made adjustments to the temperature, and desires that these adjustments be implemented, the user selects the okay, i.e., next icon 3210 at step 3466, whereby the changes to the cooking temperature are made to the cook later operation at step 3470 and flow returns to displaying the confirmation screen 4010 at step 3438.

When the user desires to adjust the cooking time associated with the selected cooking method, the user selects the first stage timer icon 4024 at step 3444, whereupon the set cooking time screen 3224 of FIG. 91 is displayed at step 3458. From the set cooking time screen 3224, the user is able to adjust the duration of the cooking time of the selected cooking operation as set forth above. When the user elects to save the changes made to the cooking time, the user selects the okay, i.e., next icon 3226 at step 3466, whereupon the changes are made to the cook later operation at step 3470. Flow then returns to the confirmation screen 4010 at step 3438. When the user determines that the changes made to the cooking timer are to be discarded, the user selects the cancel icon 3228 at step 3464, whereupon no changes are made to the previously input cook time at step 3468 and flow returns to the display of the confirmation screen 4010 at step 3438.

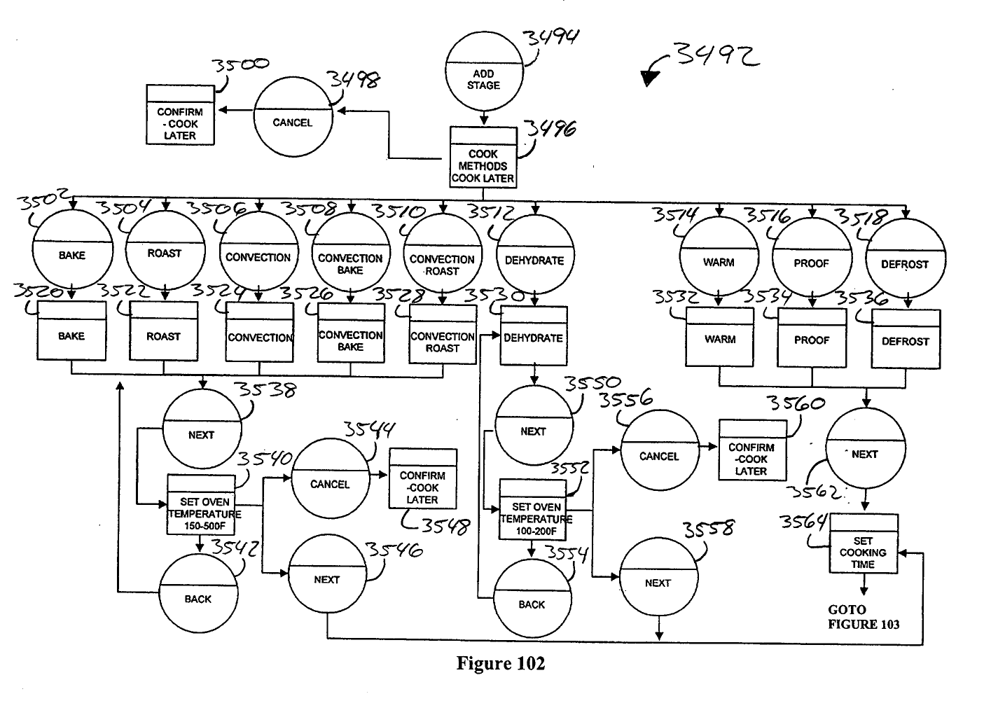

When the user determines that an additional stage is to be added, i.e., another step in the cook later operation is desired, the user selects the add a stage icon 4036 at step 3446, whereupon flow proceeds from step 3446 of FIG. 101 to step 3494 of FIG. 102. It will be appreciated by those skilled in the art that the screen architecture 3492 of FIG. 102 represents the adding of an additional stage to the cook later operation. Operations of the add a stage method in accordance with the present invention will be discussed in further detail below. For purposes of continuity, discussion of the cook later methodology will first continue with the first stage and additional stages will be discussed thereinafter.

When the user desires to adjust the meal time, the user selects the meal time icon 4018 at step 3448, whereupon flow proceeds to display the set eating time screen 3994 of FIG. 112 at step 3460. The user then makes any changes desired to the meal time and selects the okay, i.e., next icon 3996 at step 3466, whereupon the changes are made to the cook later operation at step 3470. Flow then returns to the confirmation screen 4010 at step 3438. When no changes are to be made to the meal time, or when the changes made are to be discarded, the user selects the cancel icon 3998 at step 3464, following which no changes are made to the previously input meal time at step 3468 and flow returns to step 3438, whereupon the cook later confirmation screen 4010 is displayed.

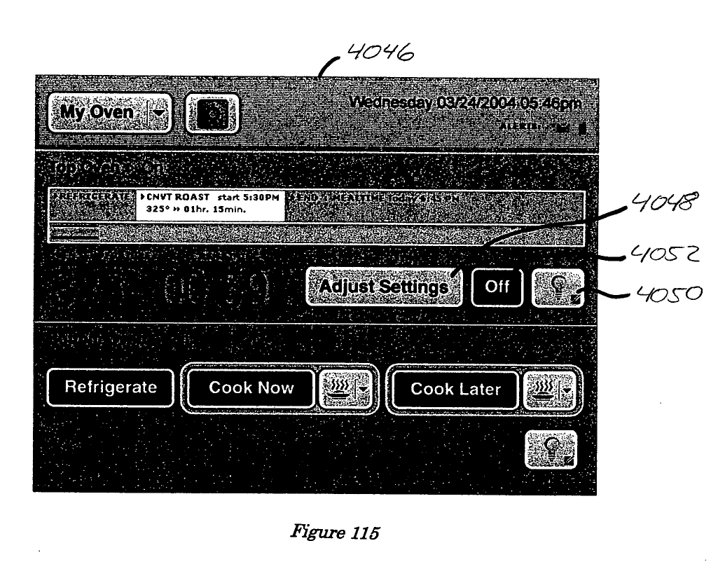

When the user is satisfied with the cook later selections, the user selects the start icon 4012 at step 3450, whereupon flow proceeds to determine, at step 3462, whether the eating time has been set later than the current time. When it is determined at step 3472 that the eating time is to occur after the current time, flow proceeds to step 3476, whereupon a refrigerate before cooking screen is displayed. A suitable template refrigeration screen is illustrated at 4038 in FIG. 115. As shown in FIG. 115, the refrigerate screen 4038 includes an adjust settings icon 4040, an oven light icon 4042, and an off icon 4044. When the user desires to adjust the settings from the refrigerate screen 4038, the user selects the adjust settings icon 4040 at step 3480, whereupon flow returns to the confirmation screen 4010 at step 3438. When the user desires to change the state of the oven light, i.e., turn it on or turn it off, the user selects the oven light icon 4042 at step 3482, whereupon the current state of the oven light is reversed at step 3486. When the user determines that the refrigeration operation is to be terminated, in essence ending the cook later operation, the user selects the off icon 4044 at step 3484. Following selection of the off icon 4044, the heating elements or cooling elements are shutdown at step 3488 and the main screen 400 is displayed at step 3490.

Returning to step 3462, when it is determined that the eating time is before or equal to the current time at step 3474, flow proceeds to step 3478, whereupon a preheat and cook screen is displayed to the user. A suitable preheat and cook screen is illustrated in FIG. 115 at 4046. As shown in FIG. 115, the preheat and cook screen 4046 includes an adjust settings icon 4048, an oven light icon 4050, and an off icon 4052. When the user desires to adjust the settings from the preheat and cook screen 4046, the user selects the adjust settings icon 4048 at step 3480, whereupon flow returns to the confirmation screen 4010 at step 3438. When the user elects to change the turn the oven light on or off, depending upon its current state, the user selects the oven light icon 4050 at step 3482, whereupon the current state of the oven light is reversed at step 3486. When the user determines that the cook later operation is to be terminated, the user selects the off icon 4052 at step 3484. Following selection of the off icon 4052, the heating elements are turned off at step 3488 and the main screen 400 is displayed at step 3490.

Returning now to the selection of the add a stage icon 4036 of FIG. 113 at step 3446, flow proceeds from the screen architecture 3436 of FIG. 101 to the screen architecture 3492 of FIG. 102. It will be appreciated by those skilled in the art that the addition of another stage to the cook later operation is accomplished from the confirmation screen 4010 of FIG. 114. The explanation of the adding a stage operation will be understood by those skilled in the art when viewed in conjunction with the template screens discussed above with respect to the first stage of the cook later operation. Furthermore, the skilled artisan will appreciate that while only the addition of a second stage is discussed hereinafter, the user is capable of adding any number of additional stages to the cook later operation.

Upon selection of the add a stage icon 4036 at step 3494, the cook later cooking method selection screen 3966 of FIG. 111 is displayed to the user at step 3496. From the cook later cooking method selection screen 3966, the user is able to return to the previous screen by selection of the cancel icon 3970 at step 3498, whereupon flow returns to displaying the confirmation screen 4010 of FIG. 113 at step 3500. As addressed above, the user selects the desired cooking operation for the new stage from the screen 3966, which then displays the corresponding graphical representation of the selected cooking method in the window 3992. Thus, for example, when the user selects the bake icon 3972 at step 3502, flow proceeds to step 3520, whereupon display window 3992 depicts a graphical representation of the bake operation. Similarly, in the event that the user selects the roast icon 3974 at step 3504, flow proceeds to step 3522, whereupon the window 3992 illustrates a roasting operation. The choice of the convection icon 3976 at step 3506 prompts the display of a convection cooking operation in the window 3992 at step 3524. Selection of the convection bake icon 3978 at step 3508 prompts the display of a graphical representation of a convection baking operation in the window 3992 at step 3526. A similar change in display occurs when the user selects the convection roast icon 3980 at step 3510, prompting the display window 3992 to depict a convection roasting operation at step 3528.

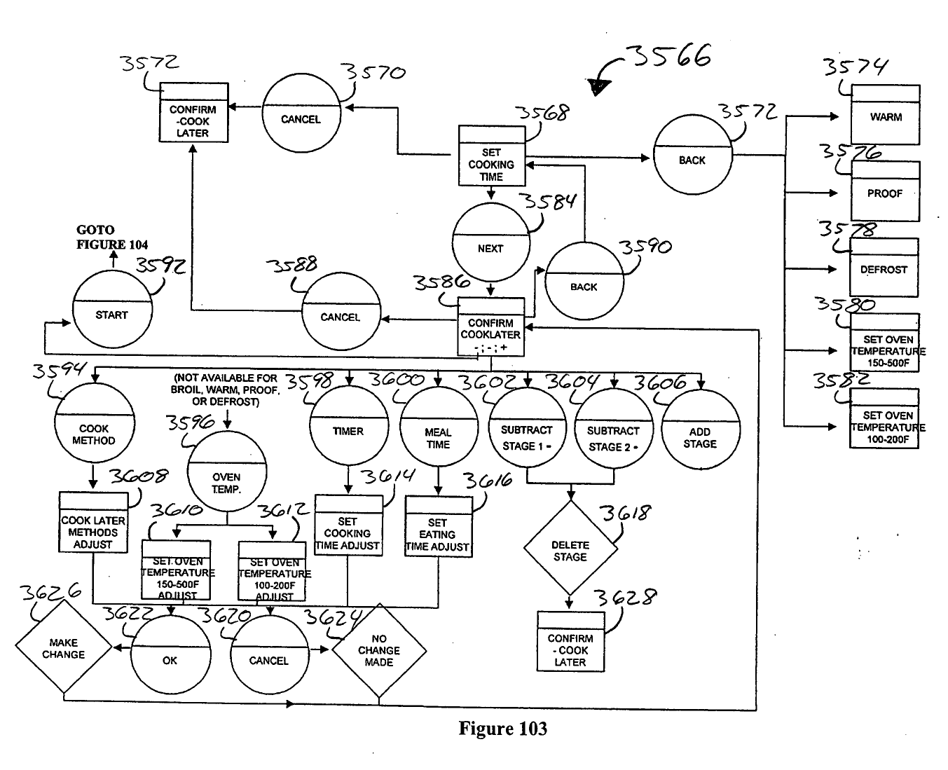

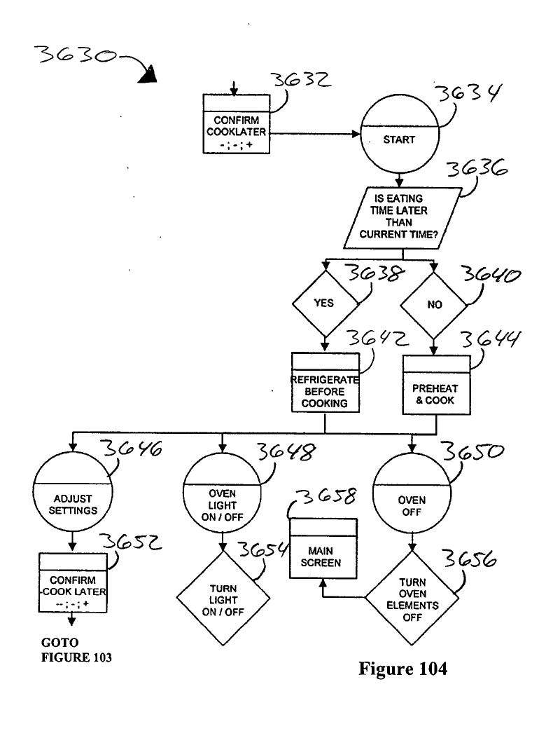

Once the user has selected the bake, roast, convection, convection bake, or convection roast operation, the user then proceeds to the next step in programming the second stage of the cook later operation by selecting the next icon 3968 at step 3538. The method then proceeds to the temperature selection screen 3208 of FIG. 90 at step 3540. The user selects the desired cooking temperature, varying from 150 to 500 degrees Fahrenheit, and either returns to the previous screen, corresponding to the cooking method selected, by selecting the back icon 3214 at step 3542, cancels the operation by selecting the cancel icon 3212 at step 3544, or proceeds with the second stage cook later operation by selecting the next icon 3210 at step 3546. Upon user selection of the cancel icon 3212 at step 3544, flow proceeds to display the confirmation screen 4010 at step 3548. When the user selects the next icon 3210 at step 3546, flow proceeds to step 3564, whereupon a set cook time screen 3224 of FIG. 91 is displayed to the user. It will be appreciated by those skilled in the art that flow proceeds from the add stage architecture 3492 at step 3564 to step 3568 of the screen architecture 3566 illustrated in FIG. 103. Thus, step 3564 of FIG. 102 corresponds to step 3568 of FIG. 103.

Should the user desire to add a dehydration cooking operation to the cook later operation as the second stage, the user selects the dehydrate icon 3982 at step 3512. Flow then proceeds to step 3530, whereupon the window 3992 illustrates a dehydrate operation. The user then selects the next icon 3968 at step 3550, which prompts the display of the temperature selection screen 3208 of FIG. 90 at step 3552. It will be appreciated by those skilled in the art that the temperature selection screen 3208 advantageously illustrates a temperature scale 3216 of 100 to 200 degrees Fahrenheit in accordance with typical temperatures used in dehydrating food items. The user is then able to return to the previous method selection screen 3966 by selecting the back icon 3214 at step 3554, whereupon flow returns to step 3530. To cancel the cook later operation, the user selects the cancel icon 3212 at step 3556, whereupon flow proceeds to step 3560, which returns the display to the confirmation screen 4010 of FIG. 113. To proceed, the user selects the next icon 3210 at step 3558, whereupon flow proceeds to step 3564.

When the user desires to add the warming operation as the second stage of the cook later operation, the user selects the warm icon 3986 at step 3514, whereupon the screen 3966 changes to reflect a graphical representation of a warming operation in the window 3992 at step 3532. Selection of the proof icon 3988 at step 3516 adds the proofing operation as the second stage of the cook later operation, prompting the display of a graphical representation of a proofing cooking method in the window 3992 at step 3534. In the event that the user desires to add a defrosting operation to the cook later operation, the user selects the defrost icon 3990 at step 3518, whereupon the window 3992 changes to display a graphical representation of a defrosting operation at step 3536.

When the next stage added to the cook later method is to warm, proof, or defrost a food item, the user is able to cancel the operation, whereby flow returns to the confirmation screen 4010, or proceed to the next step. To proceed to the next step in adding a stage to cook later operation, the user selects the next icon 3968 at step 3562, whereupon the set cook time screen 3224 of FIG. 91 is displayed to the user at step 3564. Accordingly, operational flow for adding the new stage to the cook later operation progresses from step 3564 of FIG. 102 to step 3568 of FIG. 103.

As illustrated in FIG. 103, a cooking timer setting screen 3224 is displayed to the user at step 3568. To cancel the addition of the second stage to the cook later operation, the user selects the cancel icon 3228 from the set cook time screen 3224 at step 3570, which returns the user to the confirmation screen 4010 at step 3572. To return to the previous screen, the user selects the back icon 3230 at step 3572, whereupon the display returns to the cook method selection screen 3996 of FIG. 111 for the warm operation at step 3574, the proof operation at step 3576, or the defrost operation at step 3578. Display returns to the 150 to 500 degree Fahrenheit set oven temperature screen 3208 of FIG. 90 for the bake, roast, convection, convection bake, or convection roast at step 3580. Display returns to the 100 to 200 degree Fahrenheit set oven temperature screen 3208 for the dehydrate operation at step 3582.

The user then inputs the cook time, or leaves the cook time blank for the second stage of the cook later operation via the numeric keypad 3234 at step 3568 and selects the next icon 3226 at step 3584 to continue with the addition of the second stage to the cook later operation. User selection of the next icon 3226 prompts the display of the confirmation screen 4010 at step 3586. As previously discussed with respect to the confirmation screen 4010 of FIG. 114, the icons presented to the user include first stage icons 4020, 4024, and 4028, as well as second stage icons 4022, 4026, and 4030. In accordance with the present invention, the user is able to cancel the addition of the second stage from the confirmation screen 4010 at step 3588, which then returns operations to step 3572 and the display of the confirmation screen 4010 without the second stage shown, i.e., icons 4022, 4026, and 4030 will not be shown. The user is also capable of returning to the set cooking time screen 3224 upon selection of the back icon 4016 at step 3590, which returns flow to step 3568.

As previously stated, the user is able to adjust any of the cooking parameters from the confirmation screen 4010 corresponding to both the first and second stages of the cook later operation, in accordance with the method described above. In order to edit the second stage, the user selects the second stage cook method icon 4022 at step 3594, whereupon the cooking method selection screen 3966 of FIG. 111 is illustrated to the user at step 3608. The user then makes any desired changes and selects the okay, i.e., next icon 3968 at step 3622, whereby the changes to the cooking method are made at step 3626 and flow returns to the confirmation screen 4010 at step 3586. To disregard the changes, the user selects the cancel icon 3970 at step 3620, whereupon no changes are made the cooking method at step 3624 and flow returns to the confirmation screen 4010 at step 3586.

The second stage oven temperature icon 4026 is selected by the user to adjust the bake, roast, convection, convection bake, convection roast or dehydrate oven temperatures. It will be appreciated by those skilled in the art that the ability to change the oven temperature is not present when the warming, proofing, or defrosting operation has been selected. When the user desires to change the oven temperature for the bake, roast, convection, convection bake, or convection roast cooking operation, the user selects the temperature icon 4026 at step 3596, prompting the display of the temperature selection screen 3208 of FIG. 90 at step 3610, which allows the user to change the cooking temperature associated with the cooking operation. The user then accepts these changes by selecting the next icon 3210 at step 3622, whereupon the changes are made to the cook later operation at step 3626, thereafter returning display to the confirmation screen 4010 at step 3586. When the temperature changes are to be disregarded, the user selects the cancel icon 3212 at step 3620, whereupon the changes are deleted at step 3624 and flow returns to step 3586.

Similarly, when the user desires to change the oven temperature for the dehydration operation, the user selects the temperature icon 4026 at step 3596, prompting the display of the temperature selection screen 3208 at step 3612. It will be appreciated by those skilled in the art that the temperature screen 3208 illustrated to the user at step 3612 suitably incorporates the reduced 100 to 200 degree Fahrenheit temperature range, as set forth above. The user then makes any desired changes and accepts the changes by selecting the okay, i.e., next icon 3210 at step 3622, whereupon the changes are made at step 3626 and flow returns to the confirmation screen 4010 at step 3586. When the changes are to be discarded, the user selects the cancel icon 3212 at step 3620, whereupon no changes are made to the dehydration temperature settings at step 3624. Flow then returns to the confirmation screen 4010 at step 3586.

The user is further able to adjust the cooking time associated with the second stage by selecting the timer icon 4030 at step 3598, which prompts the display of the cook time selection screen 3224 of FIG. 91 at step 3614. The user then adjusts the cook time, as desired and accepts the changes or cancels the changes. To accept any changes, the user selects the next icon 3226 at step 3622, whereupon the changes are made to the cook time at step 3626 and flow returns to the confirmation screen 4010 of FIG. 113 at step 3586. To ignore the changes, the user selects the cancel icon 3228 at step 3620, whereupon no changes are made to the cook time at step 3624 and flow returns to the confirmation screen 4010 at step 3586.

The user is also able to adjust the meal time associated with the cook later operation by selecting the meal time icon 4018 at step 3600, prompting the display of the set eating time screen 3994 of FIG. 112 at step 3616. The user then makes any desired changes and accepts the changes by selecting the okay, i.e., next icon 3996 at step 3622, or cancels the changes by selecting the cancel icon 3998 at step 3620. Upon selection of the next icon 3996, flow proceeds to step 3626, whereupon the changes are made to the eating time and operations return to the confirmation screen 4010 at step 3586. When the user selects the cancel icon 3998, any changes made are ignored at step 3624 and flow returns to the confirmation screen 4010 at step 3586.

In addition to adjusting the settings for the second stage, the user is able to remove the first stage by selecting the first stage minus icon 4032 at step 3602, whereupon the first stage is deleted from the cook later operation at step 3618 and flow returns to the confirmation screen 4010 at step 3628. To delete the second stage, the user selects the minus second stage icon 4034 at step 3604, whereupon the second stage is deleted at step 3618, returning operations to the confirmation screen 4010 at step 3628. Furthermore, the user is able to add an additional stage to the cook later operation by selecting the add a stage icon 4036 at step 3606, whereupon flow returns to step 3492 of FIG. 102 for the addition of a third stage to the cook later operation.

When all changes have been made, or when no changes are required, the user selects the start icon 4012 from the confirmation screen 4010 at step 3592. It will be understood by those skilled in the art that the screen architecture 3566 of FIG. 103 and the screen architecture 3630 of FIG. 104 overlap, to a certain extent. Thus, step 3586 of FIG. 103 corresponds to step 3632 of FIG. 104 and step 3592 of FIG. 103 corresponds to step 3634 of FIG. 104. Therefore, discussion continues from the selection of the start icon 4012 by the user at step 3634 (or step 3592). Following selection of the start icon 4012, a determination is made whether the eating, or meal time, set during the programming of the cook later operation occurs after the current time at step 3636. When the eating time occurs after the current time, as determined at step 3638, flow proceeds to step 3642, wherein the refrigerate prior to cooking screen 4038 of FIG. 115 is displayed to the user. From this screen, the user is able to adjust the settings by selecting the adjust settings icon 4040 at step 3646, prompting the display of the confirmation screen 4010 of FIG. 113 at step 3652. Additionally, the user is able turn on or off the oven light by selecting the oven light icon 4042 at step 3648, whereupon the oven light is turned off or on, depending upon its current state, at step 3654. Furthermore, the user is able to terminate the cook later operation by selecting the off icon 4044, whereupon the heating or cooling elements are shutdown at step 3656 and flow returns to the main screen 400 at step 3658.

When the eating time occurs at or prior to the current time, as determined at step 3640, flow proceeds to step 3644, wherein the preheat and cook screen 4046 of FIG. 115 is displayed to the user. From this screen 4046, the user is capable of adjusting the settings via the selection of the adjust settings icon 4048 at step 3646, prompting the display of the confirmation screen 4010 at step 3652. This screen 4046 also enables the user to turn on or off the oven light by selecting the oven light icon 4050 at step 3648, whereupon the oven light is turned off or on, depending upon its current state, at step 3654. In addition, the user is able to terminate the cook later operation by selecting the off icon 4052, whereupon the heating elements are shutdown at step 3656 and flow returns to the main screen 400 at step 3658.

Cook Later—Favorites Architecture

As an alternative to programming an entire cook later cooking operation, the user is able to select, from the main screen 400 of FIG. 4 the cook later favorites icon 420 at step 346 of FIG. 3. As addressed above with respect to the cook now favorite operation, the cook later favorites operation allows the user to select a preprogrammed cooking operation stored in the favorites library associated with the cooking appliance. Following selection of the cook later favorite icon 428, flow proceeds to the display of the favorites screen 3280 of FIG. 95 at step 348. The skilled artisan will appreciate that step 346 of FIG. 3 corresponds to step 3662 of FIG. 105. Thus, flow proceeds from the main screen architecture 300 of FIG. 3 to the second tier architecture 3660 of FIG. 105. Following selection of the cook later favorites icon 428 at step 346, or 3662, flow proceeds to step 348, or 3664, whereupon the favorites screen 3280 of FIG. 95 is displayed.

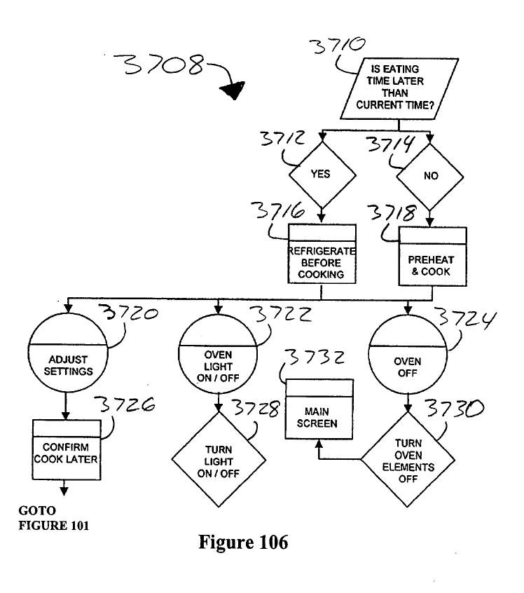

As previously discussed with respect to FIG. 95, the favorites screen 3280 includes the scroll-down favorite dish menu 3286, the add a dish icon 3288, the edit a dish icon 3290, the delete a dish icon 3292, the next icon 3282, and the cancel icon 3284. Selection of the cancel icon 3284 at step 3666 cancels the cook later favorites operation, which returns the user to the main screen 400 at step 3668. In order to initiate a cook later program incorporating an existing dish, the user selects the desired dish from the menu 3286 at step 3670. Once the favorite dish has been selected, the user chooses the next icon 3282 at step 3678, which prompts the display of the set eating time screen 3994 of FIG. 113. As explained in greater detail above, the set eating time enables the user to set the date and time at which the cook later operation is to be performed. From the set eating time screen 3994, the user is capable of canceling the cook later operation by selecting the cancel icon 3998 at step 3684, whereupon flow returns to the main screen 400 at step 3688. To return to the previous screen from the eating time screen 3994, the user selects the back icon 4000 at step 3686, following which flow returns to the display of the favorites screen 3280 at step 3664. To proceed with the cook later operation, the user selects the next icon 3996 at step 3682 prompting the display of the confirmation of favorites screen 3294 of FIG. 96 at step 3690. As previously explained, the confirmation of favorites screen 3294, illustrated in FIG. 96, includes a dish icon 3302, a cook method icon 3304, an oven temperature icon 3306, a timer icon 3308, an add a stage icon 3310, a save icon 3296, a cancel icon 3298, and a back icon 3300. To cancel the cook later operation, the user selects the cancel icon 3298 at step 3694, whereupon flow returns to the main screen 400 at step 3024. To return to the previous screen, the user selects the back icon 3300 at step 3692, whereupon flow returns to the set eating time screen 3994 at step 3680. When the user does not desire to make any changes to the selected dish, the user initiates the cooking operation by selecting the start, i.e., save icon 3296 at step 3696, whereafter flow proceeds to step 3710 of FIG. 106.

As shown in FIG. 106, a determination is made at step 3710 whether the eating time selected by the user is later than the current time. When the eating time is later than the current time, as determined at step 3712, flow proceeds to step 3716, whereupon the refrigerate before cooking screen 4038 of FIG. 114 is displayed to the user. The user then changes the state of the oven light, if desired, by selection of the oven light icon 4042 at step 3722, following which the oven light is accordingly turned on or turned off at step 3728. To turn the oven heating or cooling elements off, thereby ending the cook later favorites operation, the user selects the off icon 4044 at step 3724, prompting the shutdown of the elements at step 3730 and operations return to the main screen 400 at step 3732. The user is also capable of adjusting the settings of the cook later favorite operation by selecting the adjust settings icon 4040 at step 3720. This prompts the display of the cook later confirmation screen 4010. From the confirmation screen 4010, operation of the cook later favorites program proceeds in accordance with the screen architecture 3436 of FIG. 101 for the cook later program, as described in detail above.

When the eating time is at or before the current time, as determined at step 3714, flow proceeds to step 3718, prompting the display of the preheat and cook screen 4046 to the user. As shown in FIG. 115, the user is capable of changing the state of the oven light, by selecting the oven light icon 4050 at step 3722, following which the oven light is accordingly turned on or turned off at step 3728. In order to end the cook later favorite operation, effectively shutting down the top chamber 106 of the cooking appliance 102, the user selects the off icon 4052 at step 3724, prompting the shutdown of the heating elements at step 3730. Following selection of the off icon 4052 and shutdown of the heating elements, operations return to the main screen 400 at step 3732. As previously discussed, the user is further capable of modifying the settings of the cook later favorite operation by selecting the adjust settings icon 4048 at step 3720. This prompts the display of the cook later confirmation screen 4010 of FIG. 113. From the confirmation screen 4010, operation of the cook later favorites program proceeds in accordance with the screen architecture 3436 of FIG. 101 for the cook later program, as described in detail above. It will further be understood that operation of the cook later favorites cooking operation then progresses in the same manner as discussed above with respect to the cook later operation. Thus, once the cooking parameters for the selected dish have been input as the cook later settings, the cook later methodology, as described above, continues with performing the cooking operation.

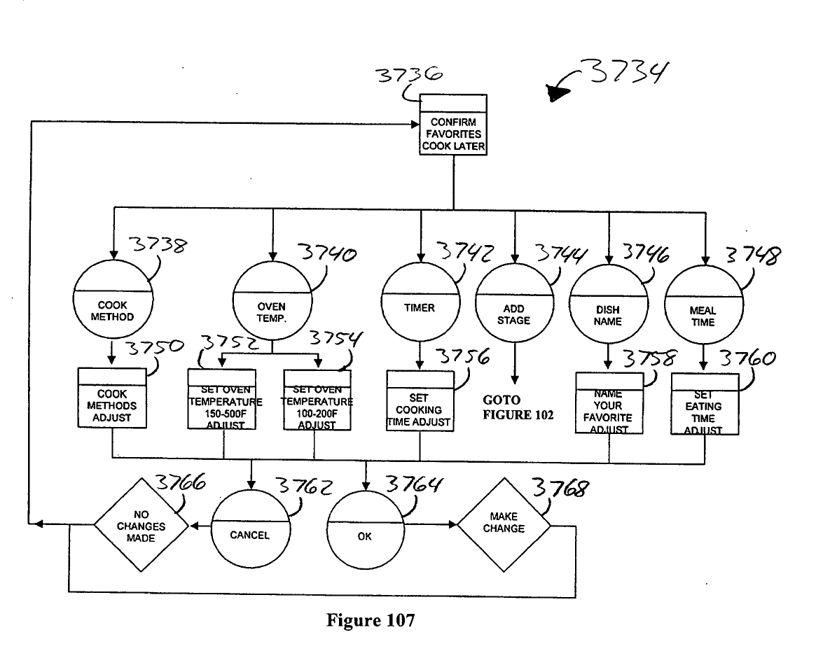

Prior to selecting the start icon 4012 at step 3696 of FIG. 105, the user is able to adjust any of the various parameters associated with the favorite dish from the confirmation screen 3294 of FIG. 95. Screen architecture 3734 of FIG. 107 is implemented at step 3690, such that step 3690 of FIG. 105 corresponds to step 3736 of FIG. 107. When the user desires to make changes to the selected dish, the user navigates through the icons 3302-3310, and then saves the changes to the selected favorites dish by selecting the save icon 3296 at step 3764, thereby saving the changes to the favorites library at step 3768 and returning to the confirmation screen 3294 at step 3736. Negating any changes to the selected favorite dish is accomplished when the user selects the cancel icon 3298 at step 3762, whereupon the changes are discarded at step 3766 and display returns to the confirmation screen 3294 for instructions by the user to start the cook later operation. To change the cook method associated with the cook later favorite dish, the user selects the cook method icon 3304 at step 3738, whereby the cook methods selection screen 3966 of FIG. 111 is displayed to the user at step 3750. Once the user has made the desired changes to the cook method, the user selects the okay, i.e., next icon 3968 at step 3764, following which the changes are made to the cooking method at step 3768. Flow then returns to the confirmation screen 3294 at step 3736. To cancel the changes to the cooking method, the user selects the cancel icon 3970 at step 3762, whereupon the changes are discarded at step 3766 and flow returns to the confirmation screen 3294 of FIG. 96 at step 3736.

When the user desires to adjust the cooking temperature, the user selects the oven temperature icon 3306 at step 3740, whereupon flow proceeds to the 150 to 500 degrees Fahrenheit temperature selection screen 3208 of FIG. 90 at step 3752 when the cook method associated with the favorite dish is the bake, roast, convection, convection bake, or convection roast cooking operation. When the cooking method of the favorite dish is the dehydrate cooking operation, flow proceeds to step 3754, whereupon the 100 to 200 degree Fahrenheit temperature selection screen 3208 is displayed to the user. Once the user has adjusted the desired cooking temperature, the user selects the okay, i.e., next icon 3210 at step 3764 to make the changes to the cooking temperature at step 3768. Flow then returns to the confirmation screen 3294 at step 3736. When the user desires to disregard the changes made to the cooking temperature, the user selects the cancel icon 3212 at step 3762, whereupon no changes are made to the cooking temperature at step 3766 and flow returns to the confirmation screen 3294 at step 3736.

When the user desires to change the cooking time associated with the selected favorites dish, the user selects the timer icon 3308 at step 3742, which prompts the display of the set timer screen 3224 of FIG. 91 at step 3756. The user then adjusts the time and saves the changes or cancels the changes. To save the changes to the cooking time, the user selects the okay, i.e., next icon 3226 at step 3764, wherein the changes are saved to the cooking timer associated with the selected favorites dish at step 3768. Operations then return to step 3736 with the display of the confirmation screen 3294. To ignore the changes and restore the originally programmed cooking time, the user selects the cancel icon 3228 at step 3762, whereupon no changes are made to the cooking time at step 3766 and flow returns to the confirmation screen 3294 at step 3736.

When the user desires to add a stage to the favorite dish, the user selects the add a stage icon 3310 at step 3744. Flow then proceeds to the add a stage screen architecture 3492 of FIG. 102. The operation and programming of the new stage for the favorite dish then proceeds in accordance with the description of FIGS. 102, 103, and 104, whereupon after completion of the new stage, flow returns to the confirmation screen 3294 at step 3736. The skilled artisan will understand the interconnection of the screen architectures for programming the new stage to the favorite dish in view of the description of FIGS. 102, 103, and 104 above, and as such, discussion will continue hereinafter with FIG. 107.

When the user desires to change the name of the favorite dish, the user selects the dish name icon 3302 at step 3746, whereupon the favorites name screen 3312 of FIG. 97 is presented to the user at step 3758. The desired name changes are then made to the dish name and the user accepts the changes by selecting the okay, i.e., next icon 3314, at step 3764, whereupon the changes to the name of the favorite dish are made at step 3768 and flow returns to the confirmation screen 3294 at step 3736. If the changes to the name are to be discarded, the user selects the cancel icon 3316 at step 3762, which clears the changes at step 3766 and flow returns to the confirmation screen 3294 at step 3736. Although not shown in FIG. 96, in accordance with the present invention, the cook later operation further includes an additional icon, not shown, for the adjustment of the meal time settings. Thus, upon user selection, at step 3748, of a meal time icon displayed on the favorite confirmation screen 3294 of FIG. 112, flow proceeds to step 3760, whereupon the set eating time screen 3994 is displayed to the user for adjustment. Once the adjustments have been made, the user accepts the changes by selection of the next icon 3996 at step 3764, whereupon the changes are saved to the cook later favorite cooking operation at step 3768. Flow then returns to the favorites confirmation screen 3294 at step 3736. When the changes to the meal time are to be ignored, the user selects the cancel icon 3998 at step 3762, prompting the clearance of any changes from the meal time settings at step 3766, and thereafter flow returns to the favorites confirmation screen 3294 at step 3736.

In addition to immediately a cook later operation incorporating a favorite dish from the favorites library, the user is also capable to add a new dish to the favorites library, edit an existing dish in the favorites library, or delete a dish from the favorites library. It will be understood by those skilled in the art that the term favorites library refers to a plurality of preprogrammed cooking operations, or recipes, that are capable of being performed by the cooking appliance, without requiring the user to input a cooking method, cooking time, oven temperature, or the like.

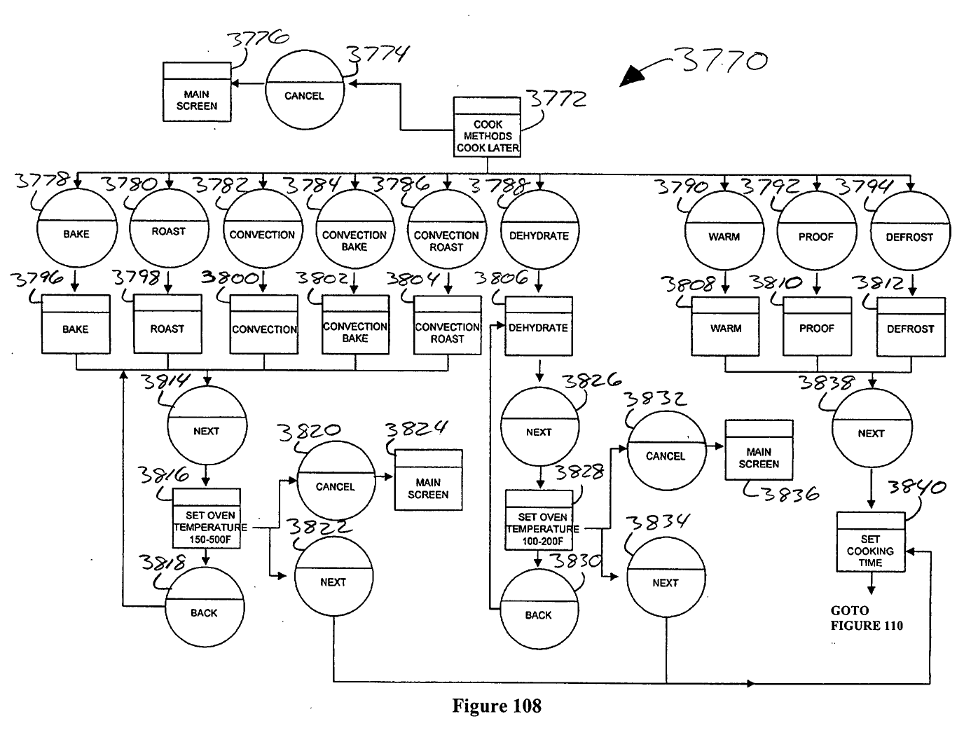

To add a new dish to the favorites library, the user selects the add a dish icon 3288 at step 3672, whereupon flow proceeds to step 3772 of FIG. 108 for user selection of the desired cooking method. Thus, at step 3772 the cooking method selection screen 3966 of FIG. 111 is displayed to the user. As previously discussed, the cook later cooking selection screen 3966 used to select the cooking method for the new dish includes several cooking icons, including a bake icon 3972, a roast icon 3974, a convection icon 3976, a convection bake icon 3978, a convection roast icon 3980, a dehydrate icon 3982, a broil icon 3984, a warm icon 3986, a proof icon 3988, and a defrost icon 3990. The skilled artisan will appreciate that due to the nature of a broil cooking operation, broiling a food item in the cook later program is not provided in accordance with the preferred embodiment of the present invention. However, alternate embodiments of the instant invention are capable of providing for programming a broil cooking operation into the cook later program. The cook later method selection screen template 3966 further includes a next icon 3968, a cancel icon 3970, and a graphical representation window 3992, the function of which will be explained in greater detail below.

Returning to the cook later add a dish screen architecture 3770 of FIG. 108, from step 3722, the user selects the bake icon 3972 at step 3778, prompting flow to proceed to step 3796, whereupon the window 3992 displays a graphical representation of a baking operation. When the user selects the roast icon 3974 at step 3780, flow proceeds to step 3798, which prompts the graphical window 3992 to display a roasting operation. User selection of the convection icon 3976 at step 3782 directs the window 3992 to illustrate a convection cooking operation at step 3800. In the event that the user desires to initiate a convection baking operation, the user selects the convection bake icon 3978 at step 3784, whereupon the window 3992 displays a graphical representation of a convection baking operation at step 3802. When the user elects to perform a convection roasting operation in connection with the cook later operation, the user selects the convection roast icon 3980 at step 3786, whereupon the window 3992 displays a graphical representation of a convection roasting operation at step 3804.

To program a dehydration operation into the cook later program, the user selects the dehydrate icon 3982 at step 3788, following which flow proceeds to step 3806 with the graphical window 3992 illustrating a dehydrating operation. Similarly, to include a warming operation in the cook later program, the user selects the warm icon 3986 at step 3790, whereupon the window 3992 illustrates a graphical representation of a warming operation at step 3808. A proofing cooking operation is initiated upon user selection of the proof icon 3988 at step 3792, which prompts the display of a representation of a proofing operation in the window 3992 at step 3810. In the event that the user desires to defrost a food item, the user selects the defrost icon 3990 at step 3794, whereupon the window 3992 displays a graphical representation of a defrosting operation at step 3812.

As shown in FIG. 111, the user is capable of terminating the cook later operation by selecting the cancel icon 3970 at step 3774. When the user selects the cancel icon 3970 at step 3774, flow proceeds to step 3776, wherein the display is returned to the main screen 400. Following user selection of the bake icon 3972, the roast icon 3974, the convection icon 3976, the convection bake icon 3978 or the convection roast icon 3980, the user continues with programming the cook later cooking operation by selecting the next icon 3968 at step 3814, which prompts display of the temperature selection screen 3208 of FIG. 90 at step 3816. In the preferred embodiment, the temperature variations corresponding to the bake, roast, convection, convection bake, and convection roast cooking operations correlates to a range of oven temperatures from 150 degrees to 500 degrees Fahrenheit. The skilled artisan will appreciate that this temperature range is for example purposes only and the upper and lower ends of the range are capable of adjustment in either direction without departing from the scope of the present invention.

As previously described, the temperature selection screen 3208 FIG. 90 includes a graphical representation of a temperature range 3216, a sliding selector 3218, a minus five degree adjustment icon 3220, a plus five degree adjustment icon 3222, a next icon 3210, a cancel icon 3212, and a back icon 3214. Selection of the desired temperature for the cook later cooking operation is accomplished as described above with respect to FIG. 90. Returning to the previous screen is accomplished when the user selects the back icon 3214 at step 3818, which returns the user to the cook methods selection screen 3966 of FIG. 111. The skilled artisan will further appreciate that by selecting the cancel icon 3212 at step 3820, the user is returned to the main screen 400 at step 3824. After setting the desired temperature, the user selects the next icon 3210 at step 3822, which prompts the display of a set cooking time screen at step 3840.

Following user selection of the dehydrate icon 3982 at step 3788, the user is presented at step 3806, as shown in FIG. 111, with the ability to cancel the cook later operation by selecting the cancel icon 3970 at step 3774, or proceed to the next step of programming the cook later operation by selecting the next icon 3968 at step 3826. When the user selects the cancel icon 3970 at step 3774, flow proceeds to step 3776, wherein the display is returned to the main screen 400. When the user selects the next icon 3968 at step 3826, flow proceeds to step 3828, whereupon the set oven temperature screen 3208 is displayed.

As explained in greater detail above, the temperature selection screen 3208 of FIG. 90 illustrated upon the selection of the dehydration cooking method enables the user to select a temperature for dehydrating the food item. In the preferred embodiment, the temperature range for the dehydration operation is one hundred degrees to two hundred degrees, in accordance with dehydration temperatures known in the art. The foregoing dehydration temperature range is for example purposes only and any dehydration temperature range known in the art is equally capable of being implemented in accordance with the present invention. The user is capable of returning to the previous screen by selecting the back icon 3214 at step 3830, which returns the user to the cook methods selection screen 3966 at step 3806. Upon selection of the cancel icon 3212 at step 3832, the user returns to the main screen 400 at step 3836. After setting the desired temperature, the user selects the next icon 3210 at step 3834, which prompts the display of a set cooking time screen at step 3840.

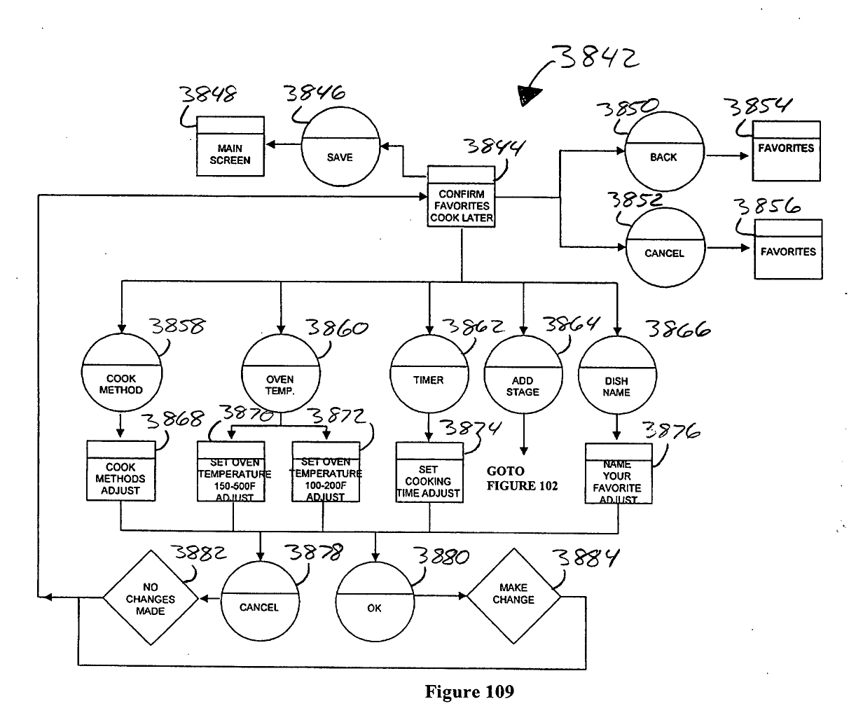

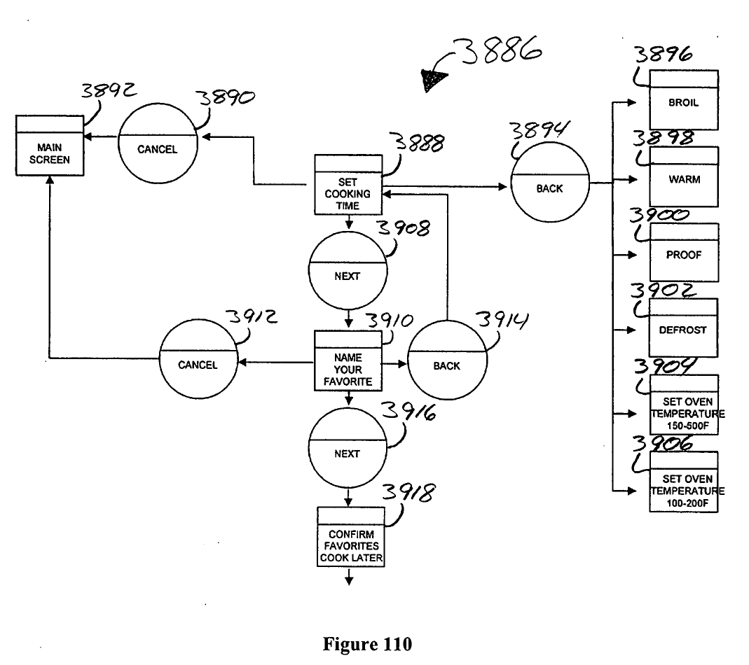

When the user desires to proceed with the cook later operation and has selected the warm icon 3986 of FIG. 111 at step 3790, the proof icon 3988 at step 3792, or the defrost icon 3990 at step 3794, flow proceeds to step 3838, wherein the user selects the next icon 3968. Following selection of the next icon 3968, flow proceeds to step 3840, whereupon a set cooking time screen is displayed to the user. Alternatively, the user is able to cancel the selected cooking operation by selecting the cancel icon 3970 at step 3774, which prompts the display to return to the main screen 400 at step 3776. It will be appreciated by those skilled in the art that step 3840 of FIG. 108 prompts flow to proceed to the screen architecture 3886 of FIG. 110. Furthermore, the skilled artisan will understand that the screen displayed at step 3840 of FIG. 108 is the same screen displayed to the user at step 3888 of FIG. 110.

Turning now to FIG. 110, there is shown a flow chart illustrating the second-tier screen architecture 3886 associated with the add a favorite dish in the context of the cook later method in accordance with the present invention. At step 3888, the set cooking time screen 3224 of FIG. 91 is displayed for the user to set the time necessary for the selected method to cook the food item. The user then sets the desired cooking time via the numeric keypad 3234 and selects the next icon 3226 at step 3908, whereupon flow proceeds to display the name your favorite screen 3312 of FIG. 97. When the user desires to cancel the addition of the new dish, the user selects the cancel icon 3316 at step 3912, whereupon flow returns to the main screen 400 at step 3892. The user is able to return to the set cooking time screen 3224 by selecting the back icon 3318 at step 3914, whereupon flow returns to step 3888. Once the user has completed entry of the desired name using the QWERTY/ABC keyboard, as shown in FIG. 97, the user selects the next icon 3314 at step 3916, whereupon flow proceeds to displaying the confirm favorites screen 3294 of FIG. 96 at step 3918.

As previously discussed, the confirmation screen 3294 enables the user to change any of the previously input settings associated with the favorite dish. The screen architecture 3842 of FIG. 109 is implemented at step 3918, such that step 3844 of FIG. 109 corresponds to step 3918 of FIG. 110. Referring now to FIG. 109, the user is able to return to the previous screen, i.e., the favorites screen 3280 of FIG. 95 by selecting the back icon 3300 at step 3850. When the user has made any changes to the favorite dish and desires to save the changes, or is ready to save the new dish into the favorite menu without making the changes afforded by the confirmation screen 3294, the user selects the save icon 3296 at step 3846, whereupon the new dish and/or the changes to the new dish are saved into the favorite library. Flow then returns to displaying the main screen 400 at step 3848. When the user does not desire to save the new dish, the user selects the cancel icon 3298 at step 3852, whereupon the new dish is discarded and flow returns to the favorites screen 3280 at step 3856.

When the user desires to change the cook method associated with the new dish, the user selects the cook method icon 3304 at step 3858, following which the cook methods selection screen 3966 of FIG. 111 is displayed to the user at step 3868. The user then makes any desired changes to the cook method associated with the new dish and selects the okay, i.e., next icon 3968 at step 3880, whereby the changes are made to the cooking method at step 3884 and flow returns to the confirmation screen 3294 at step 3844. When the changes made to the cooking method are to be disregarded, the user selects the cancel icon 3298 at step 3878, which discards the changes at step 3882 and returns to the confirmation screen 3294 at step 3844.

To change the cooking temperature previously input for the new favorite dish, the user selects the oven temperature icon 3306 at step 3860, whereupon flow proceeds to the 150 to 500 degrees Fahrenheit temperature selection screen 3208 of FIG. 90 at step 3870 for the bake, roast, convection, convection bake, or convection roast cooking methods, or to the 100 to 200 degrees Fahrenheit temperature selection screen 3208 at step 3872 for the dehydrate cooking method. The user adjusts the cooking temperature to the desired level and selects the okay, i.e., next icon 3210 at step 3880 to make the changes to the cooking temperature at step 3884. Flow then returns to the confirmation screen 3294 at step 3844. To maintain the originally input cooking temperature and ignore any changes, the user selects the cancel icon 3212 at step 3878, whereupon no changes are made to the cooking temperature at step 3882 and flow returns to the confirmation screen 3294 at step 3844.

To alter the cooking time associated with the new dish, the user selects the timer icon 3308 at step 3862, prompting the display of the timer screen 3224 of FIG. 91 at step 3874. The user then adjusts the time and saves the changes or cancels the changes. When the changes to the cooking time are to be saved for the new dish, the user selects the okay, i.e., next icon 3226 at step 3880, wherein the changes to the cooking timer associated with the new favorites dish are saved at step 3884. Flow then return to step 3844 with the display of the confirmation screen 3294. When the original timer settings are to be restored, i.e., the changes are to be disregarded, the user selects the cancel icon 3228 at step 3878, whereupon no changes are made to the cooking time and flow returns to the confirmation screen 3294 at step 3844.

When the user desires to add a stage to the new favorite dish, for example the user desires to bake the dish after defrosting, the user selects the add a stage icon 3310 at step 3864. Following selection of the add a stage icon 3310, the add a stage screen architecture 3492 of FIG. 102 is then implemented. The operation and programming of the additional stage for the new favorite dish thereafter progresses in accordance with the description of FIGS. 101 and 102, whereupon after completion of the additional stage, flow returns to the configuration screen 3294 of FIG. 96 at step 3844. The skilled artisan will understand the interconnection of the screen architectures for programming the new stage to the favorite dish in view of the description of FIGS. 103 and 103 above.

If the user desires to change the name associated with the new dish, the user selects the name icon 3302 at step 3866, prompting the display of the favorites name screen 3312 of FIG. 97 at step 3876. The user then makes the desired name changes and selects the okay, i.e., next icon 3314 at step 3880, whereupon the changes to the favorite name are saved at step 3884 and flow returns to the confirmation screen 3294 at step 3844. When the user determines that the name changes are not to be made, the user selects the cancel icon 3316 at step 3878, whereupon no changes are made to the favorite name at step 3882. Flow then returns to the confirmation screen 3294 at step 3844.

Returning to FIG. 105, when the user desires to edit an existing favorite dish, the user selects the desired dish from the dish menu 3286 of FIG. 95 and selects the edit dish icon 3290 at step 3674. Following selection of the edit option, flow proceeds to step 3698, whereupon the confirmation screen 3294 is displayed to the user. In accordance with the discussion above, flow proceeds from step 3698 of FIG. 105 to step 3844 of FIG. 109. The cooking parameters associated with the selected dish to be edited are retrieved and then displayed on the confirmation screen 3294. The user then edits the cooking method by selecting the cook method icon 3304 at step 3858 of FIG. 109, the oven temperature by selecting the oven temperature icon 3306 at step 3860, the cooking time by selecting the timer icon 3308 at step 3862, add a dish to the selected favorite dish by selecting the add a dish icon 3864, or modify the selected favorite's name by selecting the name icon 3302 at step 3866. The user selects the desired parameters, performs the modifications, and saves the modifications to the selected dish in accordance with the architecture 3842 of FIG. 109, as described above.

When the user desires to remove a favorite dish from the dish library, the user selects the dish to be deleted from the menu 3286 and then selects the delete a dish icon 3292 at step 3676 of FIG. 105. Following selection of the delete icon 3292, flow proceeds to step 3700, whereupon the delete confirmation screen 3320, as illustrated in FIG. 98, is shown to the user. As depicted in FIG. 98, the confirm deletes favorite screen 3320 includes a yes icon 3322 and a no icon 3324. To remove the dish from the library, the user selects the yes icon 3322 at step 3702, whereupon the dish is deleted from the library at step 3706. Flow then returns to the favorites screen 3280 at step 3664. When the user determines that the dish should not be removed, the user selects the no icon 3324 at step 3704, whereupon flow returns to the favorites screen 3280 of FIG. 95 at step 3664.

Cook Now—Probe Cooking Architecture

Returning to FIG. 3, when the user inserts a probe 210 in the top chamber 106 or a probe 216 in the bottom chamber 108, the main screen 400 changes to indicate the presence of the probe 210 at step 352, or the presence of the probe 216 at step 358. As illustrated in the main screen 400, for example purposes only, the probe icon 432 is shown indicating that the probe 210 has been inserted in the top chamber 106. The skilled artisan will appreciate that a similar icon appears with respect to the bottom chamber 108 when the probe 216 is similarly activated. For explanation purposes only, reference will be made to the probe 210 in the top chamber 106 hereinafter, although those skilled in the art will appreciate that the methods and templates described below correspond equally to both the top probe 210 and the bottom probe 216. After insertion of the probe 210 at step 352, the user selects the cook now icon 416 at step 354, prompting display of a cook now probe cooking method selection screen at step 356, or the cook later icon 420 at step 360, prompting display of a cook later probe cooking method selection screen at step 362. Discussion turns first to the use of the probe in the cook now operation.

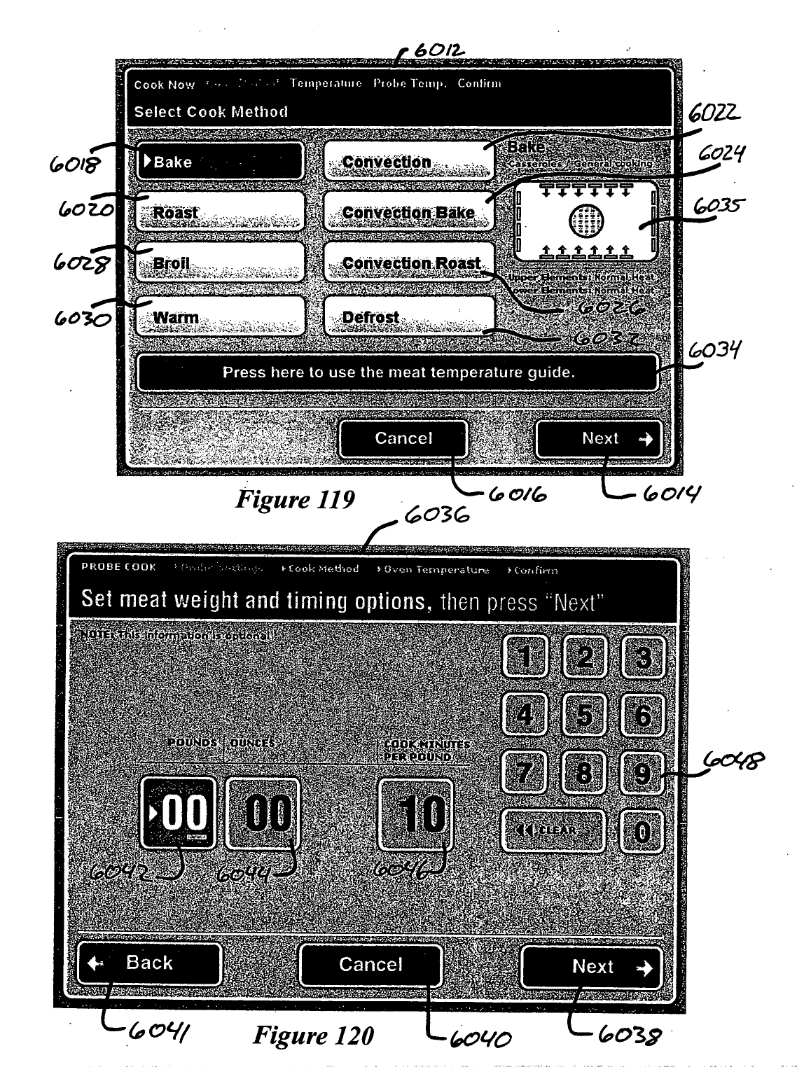

The display of the cook now probe cooking method selection screen at step 356 of FIG. 3 corresponds to the display of the cook now probe cooking method selection screen at step 4056 of FIG. 116. Thus, the skilled artisan will appreciate that flow proceeds from the screen architecture 300 of FIG. 3 to the cook now probe cooking screen architecture 4054 of FIG. 116. At step 4056, a probe cook now cooking method selection screen is displayed to the user. A suitable selection screen is illustrated in FIG. 119 as the cook now probe method selection screen 6012. As shown in FIG. 119, the method selection screen 6012 includes icons representative of several cooking options, such as, for example and without limitation, a bake icon 6018, a roast icon 6020, a convection icon 6022, a convection bake icon 6024, a convection roast icon 6026, a broil icon 6028, a warm icon 6030, a defrost icon 6032, and a meat temperature guide icon 6034. The skilled artisan will appreciate that the icons 6018-6032 are examples of cooking operations which the cooking appliance 102 is capable of performing. Other cooking operations, in addition to those operations shown, are also capable of being performed by the cooking appliance without departing from the scope of the present invention. FIG. 119 further includes a graphical illustration window 6035 suitably adapted to provide a visual queue to the user representative of the cooking or cooling operation selected. Thus, the screen 6012 illustrates that a bake operation has been selected, which is shown in the window 6035. It will be understood by those skilled in the art that each icon 6018-6032 advantageously corresponds to a different graphical representation which is capable of being shown to the user via the window 6035. The cook now probe method selection screen 6012 further includes a next icon 6014 and a cancel icon 6016, the function of which will be explained in greater detail below.

Returning to the cook now probe screen architecture 4054 at step 4056, upon user selection of the bake icon 6018 at step 4064, flow proceeds to step 4082, whereupon the window 6035 displays a graphical representation of a baking operation. When the user selects the roast icon 6020 at step 4066, flow proceeds to step 4084, which prompts the graphical window 6035 to display a roasting operation. User selection of the convection icon 6022 at step 4068 directs the window 6035 to illustrate a convection cooking operation at step 4086. In the event that the user desires to initiate a convection baking operation, the user selects the convection bake icon 6024 at step 4070, whereupon the window 6035 displays a graphical representation of a convection baking operation at step 4088. When the user elects to perform a convection roasting operation in connection with the cook now operation, the user selects the convection roast icon 6026 at step 4072, whereupon the window 6035 displays a graphical representation of a convection roasting operation at step 4090.

To program a broil operation into the cook now program, the user selects the broil icon 6028 at step 4074, following which flow proceeds to step 4092 with the graphical window 6035 illustrating a broiling operation. Similarly, to include a warming operation in the cook now program, the user selects the warm icon 6030 at step 4076, whereupon the window 6035 illustrates a graphical representation of a warming operation at step 4094. In the event that the user desires to defrost a food item, the user selects the defrost icon 6032 at step 4078, whereupon the window 6035 displays a graphical representation of a defrosting operation at step 4096. When the user desires to view a meat temperature guide, the user selects the meat temperature guide icon 6034 at step 4080, whereupon flow proceeds to display a meat temperature guide screen at step 4098.

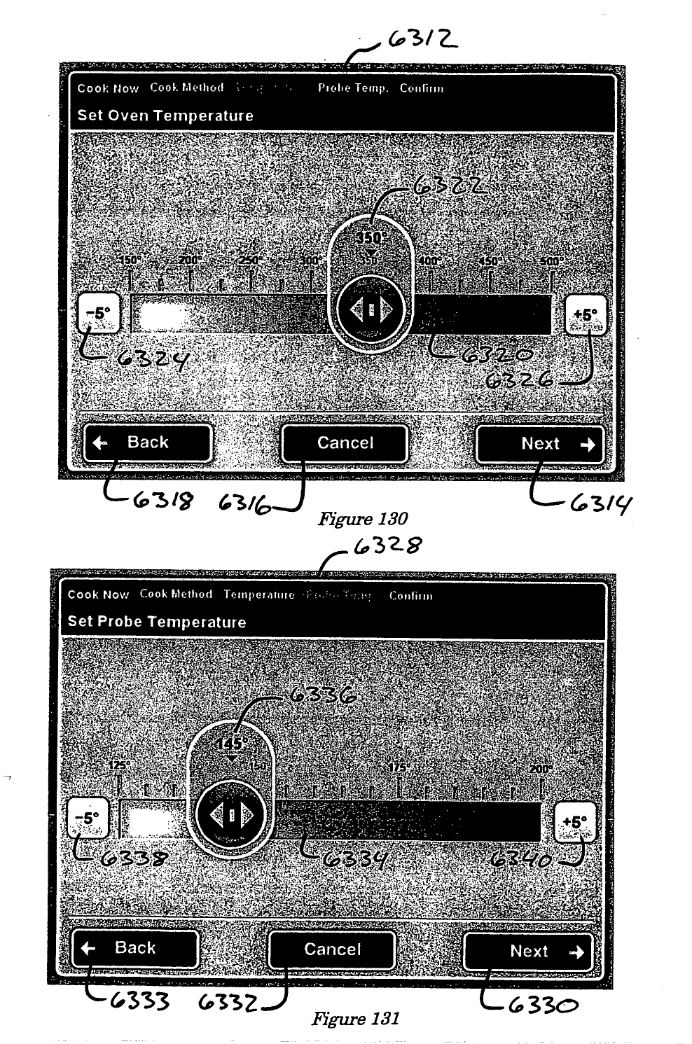

As shown in FIG. 119, the user is capable of canceling the cook now probe operation by selecting the cancel icon 6016 at step 4058. When the user selects the cancel icon 6016 at step 4058, flow proceeds to step 4060 to indicate the use of the bottom oven probe 216 or to step 4062 to indicate the use of the top oven probe 210, wherein the display is returned to the main screen 400. Following user selection of the bake icon 6018, the roast icon 6020, the convection icon 6022, the convection bake icon 6024 or the convection roast icon 6026, the user continues with programming the cook now cooking operation by selecting the next icon 6014 at step 5000, which prompts display of the temperature selection screen 6312 of FIG. 130 at step 5002. In the preferred embodiment, the temperature variations corresponding to the bake, roast, convection, convection bake, and convection roast cooking operations correlates to a range of oven temperatures from 150 degrees to 500 degrees Fahrenheit. The skilled artisan will appreciate that this temperature range is for example purposes only and the upper and lower ends of the range are capable of adjustment in either direction without departing from the scope of the present invention.

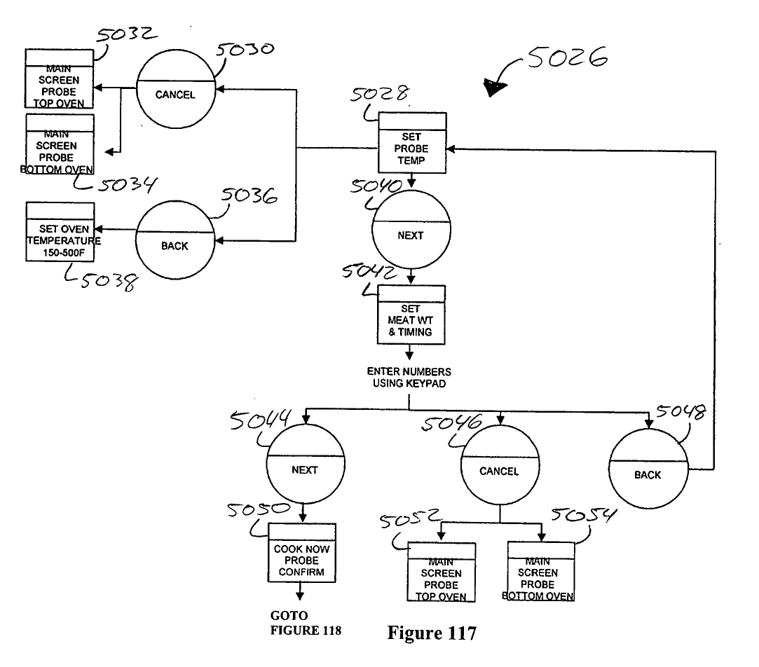

The temperature selection screen 6312 of FIG. 130 includes a graphical representation of a temperature range 6320, a sliding selector 6322, a minus five degree adjustment icon 6324, a plus five degree adjustment icon 6326, a next icon 6314, a cancel icon 6316, and a back icon 6318. Selection of the desired temperature for the cook now cooking operation is accomplished by dragging the sliding selector 6322 along the range 6320 until the desired cooking temperature is selected. To facilitate fine adjustment of the selected temperature, the user lowers the temperature in the sliding selector 6322 by selecting the minus five degree icon 6324, or raises the temperature by selecting the plus five degree icon 6326. Returning to the previous screen is accomplished when the user selects the back icon 6318 at step 5004, which returns the user to the cook now probe methods selection screen 6012. The skilled artisan will further appreciate that by selecting the cancel icon 6316 at step 5006, the user is returned to the corresponding main screen 400 at steps 5010 or 5012. After setting the desired temperature, the user selects the next icon 6314 at step 5008, which prompts the display of a set probe temperature screen at step 5014. A suitable probe temperature selection screen 6328 is illustrated in FIG. 131. Similar to the screen 6312 of FIG. 130, the probe temperature screen 6328 includes a temperature range 6334, a sliding selector 6336, a minus five degree adjustment icon 6338, a plus five degree adjustment icon 6340, a next icon 6330, a cancel icon 6332, and a back icon 6333. Selection of the desired temperature for the cook later cooking operation is accomplished by dragging the sliding selector 6336 along the range 6334 until the desired cooking temperature is selected. Explanation of the probe selection process will best be understood in conjunction with the methodology described in FIG. 117.

FIG. 117 illustrates a screen architecture 5026 corresponding to the selection of the probe temperature, the weight of the meat being cooked, and the cook minutes per pound. Thus, the skilled artisan will appreciate that flow proceeds from step 5014 of FIG. 116 to step 5028, wherein the screen 6328 of FIG. 131 is displayed to the user. At step 5028, the user selects the desired probe cooking temperature, i.e., that temperature at which the probe will issue an alarm, notification, or control signal to the computer. From the screen 6328, the user is able to cancel the cook now probe cooking operation by selecting the cancel icon 6332 at step 5030, whereupon flow returns to the main screen 400 for the top probe 210 at step 5032, or the bottom probe 216 at step 5034. To return to the previous screen, the temperature selection screen 6312, the user selects the back icon 6333 at step 5038, whereupon flow returns to the screen 6312 at step 5036. Once the user is satisfied with the probe temperature settings, the user selects the next icon 6330 at step 5042, whereupon flow proceeds to display a set meat weight and cooking time per pound screen, illustrated in FIG. 120 at 6036.

As shown in FIG. 120, the set weight and time screen 6036 includes a pound display window 6042, an ounce display window 6044, a cook minutes per pound display window 6046, a numeric keypad 6048, a next icon 6038, a cancel icon 6040, and a back icon 6041. Using the numeric keypad 6048, the user enters the weight of the food item being cooked, and the cooking minutes per pound. To accept these inputs, the user selects the next, icon 6038 at step 5044, whereupon flow proceeds to display a confirmation screen at step 5050. To cancel the cook now probe cooking operation, the user selects the cancel 6040 at step 5046, whereupon flow returns to the appropriate main screen 400 at step 5052 for the top probe 210 and step 5054 for the bottom probe 216. To return to the previous screen, the user selects the back icon 6041 at step 5048, whereupon flow returns to the set probe temperature screen 6328 at step 5028.

Returning to FIG. 116, upon user selection of the next icon 6014 of FIG. 119 at step 5016 for the broil, warm and defrost operations, flow proceeds to step 5018, wherein the cooking time is set for the cook now probe cooking operation. A suitable template screen 3224 for setting the cooking time is illustrated in FIG. 91. As previously discussed, the user inputs the cooking time associated with the broil, warm, and defrost cooking methods using the time input screen 3224 at step 5018, whereupon flow proceeds to step 5020. At step 5020, the cook now confirmation screen 3236, shown in FIG. 92, is displayed to the user. Accordingly, operations proceed with the cook now operation as set forth above in the Cook Now Architecture Section. It will be appreciated by those skilled in the art that the user returns to the cook now probe cooking step 4056 when the back icon 3242 is selected, or when the cook method icons 3244 or 3246 are selected for adjustment.

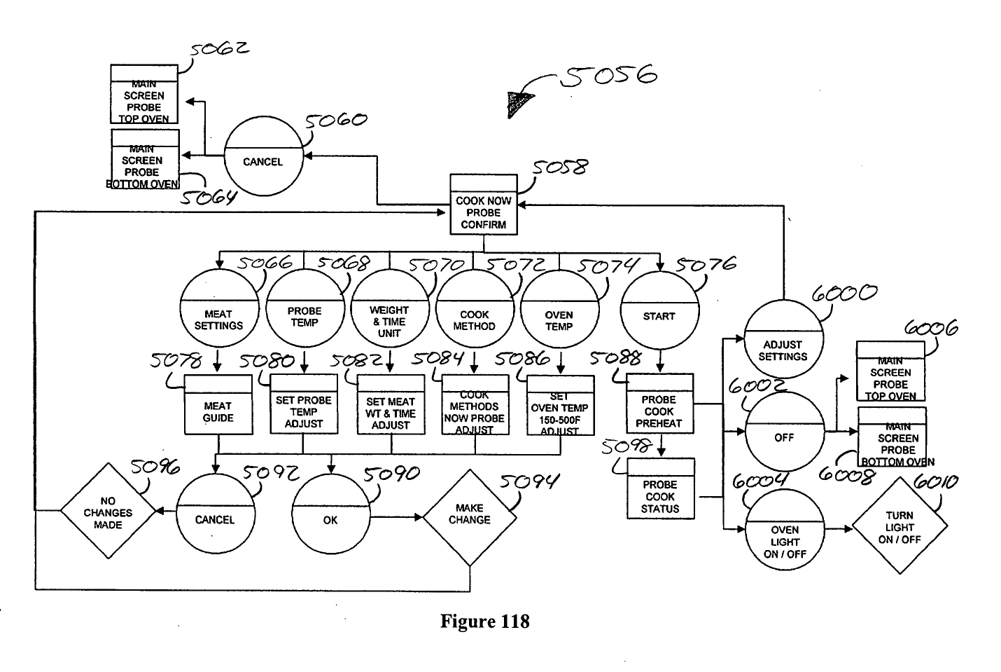

When the user has selected the meat guide icon 6034 of FIG. 119 at step 4080, flow proceeds to display, at step 4098, the meat guide screen 6304 of FIG. 129. The user then selects the meat type from the list 6310 of meats and selects the okay icon 6306 at step 5022, whereupon flow proceeds to the screen architecture 5056 of FIG. 118. When the user does not require the use of the meat guide, the user selects the cancel icon 6308 at step 5024, whereupon flow returns to the cook now probe cooking selection screen 6012 at step 4056. It will be understood by those skilled in the art that flow proceeds from steps 5022 of FIGS. 116 and 5050 of FIG. 117 to step 5058 of FIG. 118.

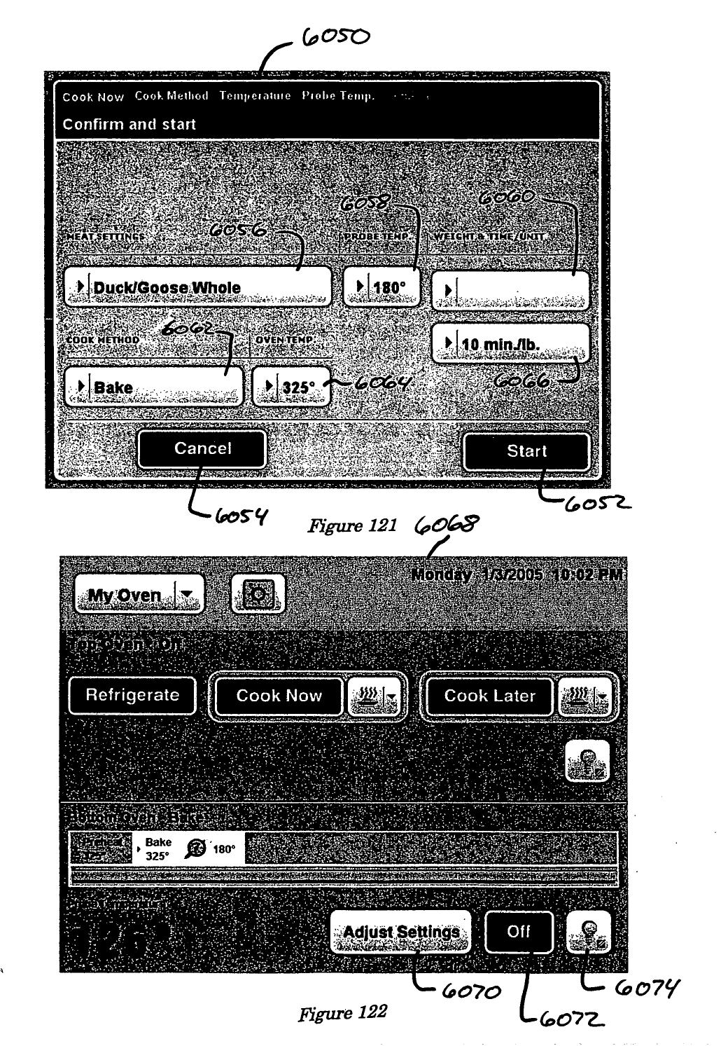

Referring now to the screen architecture 5056 of FIG. 118, at step 5058 a confirmation cook now probe cooking screen is displayed to the user. A suitable confirmation template screen is illustrated in FIG. 121. As shown in FIG. 121, the confirmation screen 6050 includes a meat settings icon 6056, a probe temperature icon 6058, a weight and time unit icon 6060, a cook method icon 6062, an oven temperature icon 6064, second weight and time unit icon 6066, a start icon 6052, and a cancel icon 6054. Operation of the confirmation screen 6050 will be explained in conjunction with the flow chart 5056 of FIG. 118. When the user desires to cancel the cook now operation, the user selects the cancel icon 6054 at step 5060, whereupon display returns to the main screen 400 at step 5062 for the top probe 210, or at step 5064 for the bottom probe 216.

When the user desires to adjust the meat settings, the user selects the meat settings icon 6056 at step 5066, whereupon the meat guide 6304 of FIG. 129 is displayed to the user at step 5078. The user then changes the meat and selects the okay icon 6306 at step 5090, whereupon the changes are made to the cook now operation at step 5094 and flow returns to the confirmation screen 6050 at step 5058. To cancel the changes, the user selects the cancel icon 6308 at step 5092, whereupon the changes are discarded at step 5096 and flow returns to the confirmation screen 6050 at step 5058. To adjust the probe temperature, the user selects the probe temperature icon 6058 at step 5068. Flow then proceeds to step 5080, whereupon the set probe temperature screen 6328 of FIG. 131 is displayed to the user. The user then makes any desired changes and selects the okay, i.e., next icon 6330 at step 5090, which saves the changes at step 5094, prompting a return to the confirmation screen 6050 at step 5058. To ignore the changes, the user selects the cancel icon 6332 at step 5092, following which the changes are deleted and flow returns to the confirmation screen 6050 at step 5058.

To adjust the weight and time unit, the user selects the weight and time unit icon 6066 at step 5070. Flow then proceeds to step 5082, whereupon the weight and time unit selection screen 6036 of FIG. 120 is displayed to the user. The user then makes any desired changes and selects the okay, i.e., next icon 6038 at step 5090, which saves the changes at step 5094, prompting a return to the confirmation screen 6050 at step 5058. To ignore the changes, the user selects the cancel icon 6040 at step 5092, following which the changes are deleted and flow returns to the confirmation screen 6050 at step 5058. To change the cooking method, the user selects the cooking method icon 6062 at step 5072. Flow then proceeds to step 5084, whereupon the cooking method selection screen 6012 of FIG. 119 is displayed to the user. The user then makes any desired changes and selects the okay, i.e., next icon 6014 at step 5090, which saves the changes at step 5094, prompting a return to the confirmation screen 6050 at step 5058. To ignore the changes, the user selects the cancel icon 6016 at step 5092, following which the changes are deleted and flow returns to the confirmation screen 6050 at step 5058. To adjust the oven temperature, the user selects the oven temperature icon 6064 at step 5074. Flow then proceeds to step 5086, whereupon the oven temperature screen 6312 of FIG. 130 is displayed to the user. The user then makes any desired changes and selects the okay, i.e., next icon 6314 at step 5090, which saves the changes at step 5094, prompting a return to the confirmation screen 6050 at step 5058. To ignore the changes, the user selects the cancel icon 6316 at step 5092, following which the changes are deleted and flow returns to the confirmation screen 6050 at step 5058.

The user then selects the start icon 6052, whereupon flow proceeds to step 5088, whereupon a preheat screen is displayed. It will be appreciated that a similar template screen 3262 is illustrated at FIG. 93. The skilled artisan will appreciate that the screen 3262, as applied to the cook now probe cooking operation, advantageously includes a probe icon, which is not shown in FIG. 93. From the preheat screen 3262, the user is able to adjust the cook now settings by selecting an adjust settings icon 3266 at step 6000, whereupon flow returns to the confirmation screen at step 5058. The probe cook now operation is capable of being canceled from the preheat screen by selecting the off icon 3268 at step 6002, whereupon flow returns to the main screen 400 associated with the probe used at step 6006 or step 6008. Furthermore, the user is able to turn on or off the oven light by selecting the oven light icon 3270 at step 6004, whereupon the state of the light of the associated chamber is turned on or off at step 6010. Once the cooking chamber associated with the cook now operation has reached the desired temperature, i.e., the preheat operation has completed, flow proceeds to display a probe cook now status screen at step 5098. A suitable status screen is illustrated in FIG. 122. From the status screen 6068 of FIG. 122, the user is able to adjust the cook now settings by selecting an adjust settings icon 6070 at step 6000, whereupon flow returns to the confirmation screen at step 5058. The probe cook now operation is capable of being canceled from the status screen 6068 by selecting the off icon 6072 at step 6002, whereupon flow returns to the main screen 400 associated with the probe used at step 6006 or step 6008. Furthermore, the user is able to turn on or off the oven light by selecting the oven light icon 6074 at step 6004, whereupon the state of the light of the associated chamber is turned on or off at step 6010.

Cook Later—Probe Architecture

Returning to FIG. 3, when the user inserts a probe 210 in the top chamber 106 or a probe 216 in the bottom chamber 108, the main screen 400 of FIG. 4 changes to indicate the presence of the probe 210 at step 352, or the presence of the probe 216 at step 358. As illustrated in the main screen 400, for example purposes only, the probe icon 432 is shown indicating that the probe 210 has been inserted in the top chamber 106. In accordance with the description above, discussion now turns to the cook later probe cooking operation. For explanation purposes only, reference will be made to the probe 210 in the top chamber 106 hereinafter, although those skilled in the art will appreciate that the methods and templates described below correspond equally to both the top probe 210 and the bottom probe 216. After insertion of the probe 210 at step 352, the user selects the cook later icon 420 at step 360, prompting display of a cook later probe cooking method selection screen at step 362.

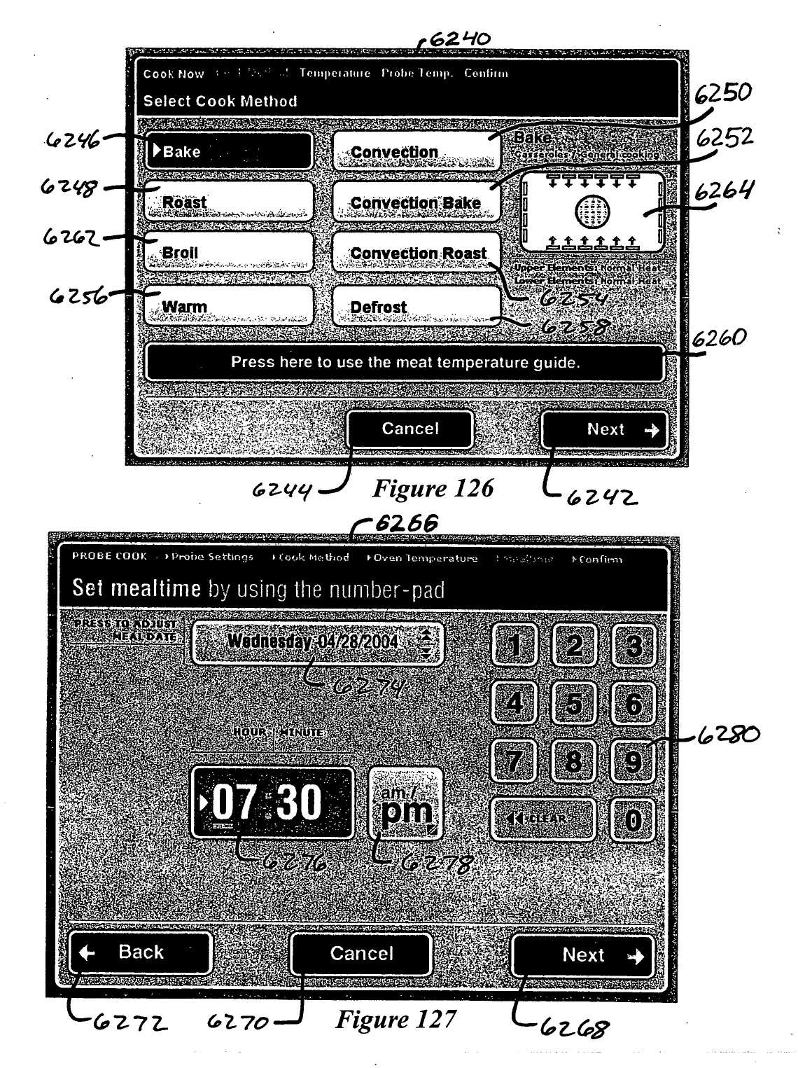

The display of the cook later probe cooking method selection screen at step 362 of FIG. 3 corresponds to the display of the cook later probe cooking method selection screen at step 6078 of FIG. 123. Thus, the skilled artisan will appreciate that flow proceeds from the screen architecture 300 of FIG. 3 to the cook later probe cooking screen architecture 6076 of FIG. 123. At step 6078, a probe cook later cooking method selection screen is displayed to the user. A suitable selection screen is illustrated in FIG. 126 as the cook later probe method selection screen 6240. As shown in FIG. 126, the method selection screen 6240 includes icons representative of several cooking options, such as, for example and without limitation, a bake icon 6246, a roast icon 6248, a convection icon 6250, a convection bake icon 6252, a convection roast icon 6254, a broil icon 6262, a warm icon 6256, a defrost icon 6258, and a meat temperature guide icon 6260. The skilled artisan will appreciate that the icons 6246-6258 are examples of cooking operations which the cooking appliance 102 is capable of performing. Other cooking operations, in addition to those operations shown, are also capable of being performed by the cooking appliance without departing from the scope of the present invention. In accordance with the reasons stated above with respect to the cook later operation without the probe, the broil operation is not included in the cook later programming.

FIG. 126 further includes a graphical illustration window 6264 suitably adapted to provide a visual indication to the user representative of the cooking or cooling operation selected. Thus, the screen 6240 illustrates that a bake operation has been selected, which is shown in the window 6264. It will be understood by those skilled in the art that each icon 6246-6258 advantageously corresponds to a different graphical representation which is capable of being shown to the user via the window 6264. The cook later probe method selection screen 6240 further includes a next icon 6242 and a cancel icon 6244, the function of which will be explained in greater detail below.

Returning to the cook later probe screen architecture 6076 at step 6078, upon user selection of the bake icon 6246 at step 6086, flow proceeds to step 6102, whereupon the window 6264 displays a graphical representation of a baking operation. When the user selects the roast icon 6248 at step 6088, flow proceeds to step 6104, which prompts the graphical window 6264 to display a roasting operation. User selection of the convection icon 6250 at step 6090 directs the window 6264 to illustrate a convection cooking operation at step 6106. In the event that the user desires to initiate a convection baking operation, the user selects the convection bake icon 6252 at step 6092, whereupon the window 6264 displays a graphical representation of a convection baking operation at step 6108. When the user elects to perform a convection roasting operation in connection with the cook later operation, the user selects the convection roast icon 6254 at step 6094, whereupon the window 6264 displays a graphical representation of a convection roasting operation at step 6110.

To program a warming operation in the cook later program, the user selects the warm icon 6256 at step 6096, whereupon the window 6264 illustrates a graphical representation of a warming operation at step 6112. In the event that the user desires to defrost a food item, the user selects the defrost icon 6258 at step 6098, whereupon the window 6264 displays a graphical representation of a defrosting operation at step 6114. When the user desires to view a meat temperature guide, the user selects the meat temperature guide icon 6260 at step 6100, whereupon flow proceeds to display a meat temperature guide screen at step 6116.

As shown in FIG. 126, the user is capable of canceling the cook later probe operation by selecting the cancel icon 6244 at step 6080. When the user selects the cancel icon 6244 at step 6080, flow proceeds to step 6082 to indicate the use of the bottom oven probe 216 or to step 6084 to indicate the use of the top oven probe 210, wherein the display is returned to the main screen 400. Following user selection of the bake icon 6246, the roast icon 6248, the convection icon 6250, the convection bake icon 6252 or the convection roast icon 6254, the user continues with programming the cook later cooking operation by selecting the next icon 6242 at step 6118, which prompts display of the temperature selection screen 6312 of FIG. 130 at step 6120. In the preferred embodiment, the temperature variations corresponding to the bake, roast, convection, convection bake, and convection roast cooking operations correlates to a range of oven temperatures from 150 degrees to 500 degrees Fahrenheit. The skilled artisan will appreciate that this temperature range is for example purposes only and the upper and lower ends of the range are capable of adjustment in either direction without departing from the scope of the present invention.

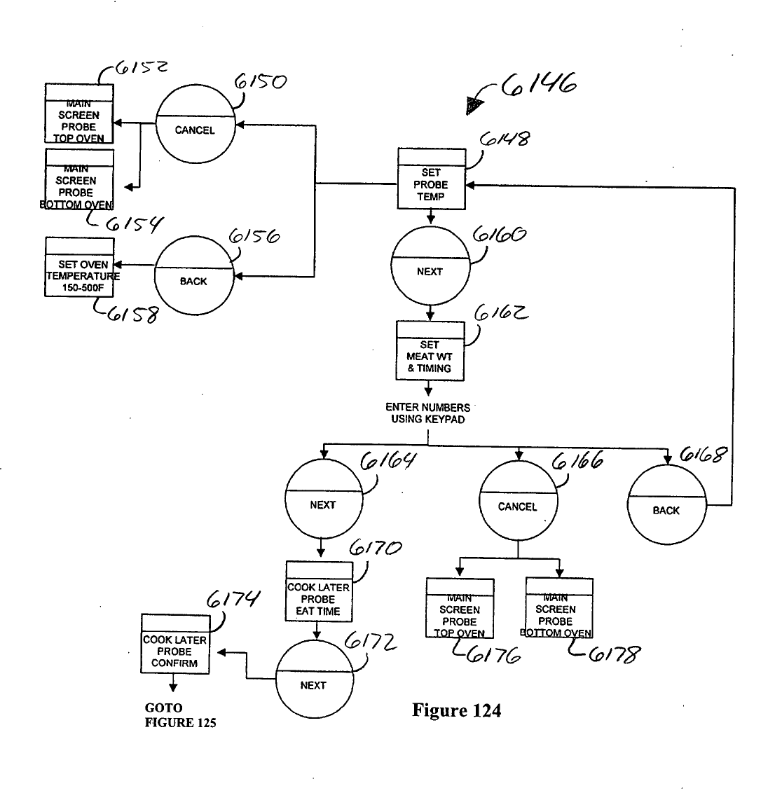

The temperature selection screen 6312 of FIG. 130 includes a graphical representation of a temperature range 6320, a sliding selector 6322, a minus five degree adjustment icon 6324, a plus five degree adjustment icon 6326, a next icon 6314, a cancel icon 6316, and a back icon 6318. Selection of the desired temperature for the cook later cooking operation is accomplished by dragging the sliding selector 6322 along the range 6320 until the desired cooking temperature is selected. To facilitate fine adjustment of the selected temperature, the user lowers the temperature in the sliding selector 6322 by selecting the minus five degree icon 6324, or raises the temperature by selecting the plus five degree icon 6326. Returning to the previous screen is accomplished when the user selects the back icon 6318 at step 6122, which returns the user to the cook later probe methods selection screen 6240 of FIG. 126. The skilled artisan will further appreciate that by selecting the cancel icon 6316 at step 6124, the user is returned to the corresponding main screen 400 at steps 6128 or 6130. After setting the desired temperature, the user selects the next icon 6314 at step 6126, which prompts the display of a set probe temperature screen at step 6132. A suitable probe temperature selection screen 6328 is illustrated in FIG. 131. Similar to the screen 6312 of FIG. 130, the probe temperature screen 6328 includes a temperature range 6334, a sliding selector 6336, a minus five degree adjustment icon 6338, a plus five degree adjustment icon 6340, a next icon 6330, a cancel icon 6332, and a back icon 6333. Selection of the desired temperature for the cook later cooking operation is accomplished by dragging the sliding selector 6336 along the range 6334 until the desired cooking temperature is selected. Explanation of the probe selection process will best be understood in conjunction with the methodology described in FIG. 124.

FIG. 124 illustrates screen architecture 6146 corresponding to the selection of the probe temperature, the weight of the meat being cooked, the cooking minutes per pound, and the eating time, i.e., the time at which the food item is to be ready for consumption. Thus, the skilled artisan will appreciate that flow proceeds from step 6132 of FIG. 123 at 6076 to step 6148 of FIG. 124 at 6146, wherein the screen 6328 of FIG. 131 is displayed to the user. At step 6148, the user selects the desired probe cooking temperature, i.e., that temperature at which the probe will issue an alarm, notification, or control signal to the computer. From the screen 6328, the user is able to cancel the cook later probe cooking operation by selecting the cancel icon 6332 at step 6150, whereupon flow returns to the main screen 400 for the top probe 210 at step 6152, or the bottom probe 216 at step 6154. To return to the previous screen, the temperature selection screen 6312, the user selects the back icon 6333 at step 6156, whereupon flow returns to the screen 6312 at step 6158. Once the user is satisfied with the probe temperature settings, the user selects the next icon 6330 at step 6160, whereupon flow proceeds to display, at step 6162, the set meat weight and cooking time per pound screen, illustrated in FIG. 120 at 6036.

As shown in FIG. 120, the set weight and time screen 6036 includes a pound display window 6042, an ounce display window 6044, a cook minutes per pound display window 6046, a numeric keypad 6048, a next icon 6038, a cancel icon 6040, and a back icon 6041. Using the numeric keypad 6048, the user enters the weight of the food item being cooked, and the cooking minutes per pound. To cancel these settings, the user selects the cancel icon 6040 at step 6166, whereupon flow returns to the main screen 400 at step 6176 or step 6178, depending on the probe used. To return to the previous screen, the user selects the back icon 6041 at step 6168, whereupon flow returns to the set probe temperature screen 6328 at step 6148. To accept these inputs, the user selects the next icon 6038 at step 6164, whereupon flow proceeds to display a set eating time screen at step 6170. A suitable template screen is illustrated in FIG. 127.

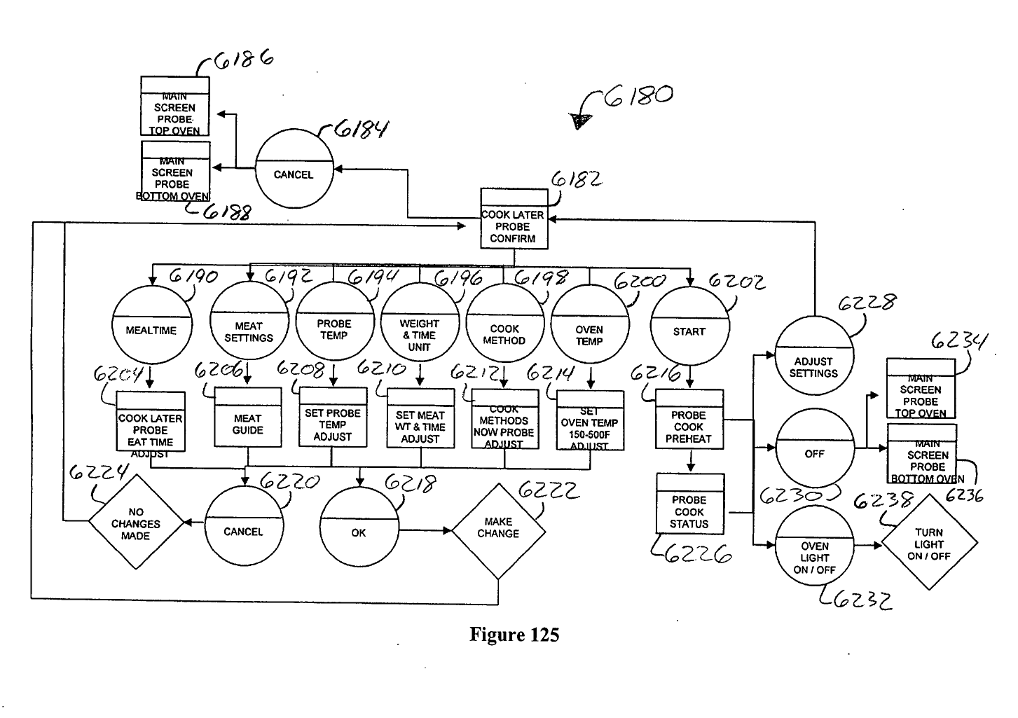

As shown in FIG. 127, the set eating time screen 6266 includes a meal date icon 6274, a time display window 6276, an AM/PM toggle icon 6278, a numeric keypad 6280, a next icon 6268, a cancel icon 6270, and a back icon 6272. The user then inputs the date and time at which the food item is to be ready, for example, Tuesday the 10th at 5:00 PM, using the numeric keypad 6280 to fill in the time, the AM/PM toggle icon 6278 to adjust the day/night component, and the meal date icon 6274, which prompts display of the calendar screen 500 of FIG. 5, to enable easy selection of the desired date. The user then cancels the changes by selecting the cancel icon 6270, which returns operations to the main screen 400, returns to the previous screen by selecting the back icon 6272, which returns operations to the set weight and time screen 6036, or accepts the changes by selecting the next icon 6268 at step 6172, whereupon flow proceeds to the cook later probe cooking confirmation screen at step 6174. The skilled artisan will appreciate that step 6174 of FIG. 124 corresponds to step 6182 of FIG. 125. Thus, flow proceeds from the screen architecture 6146 of FIG. 124 to the screen architecture 6180 of FIG. 125. As shown in FIG. 125, the screen architecture 6180 depicts the function of the confirmation process for the cook later probe cooking operation.

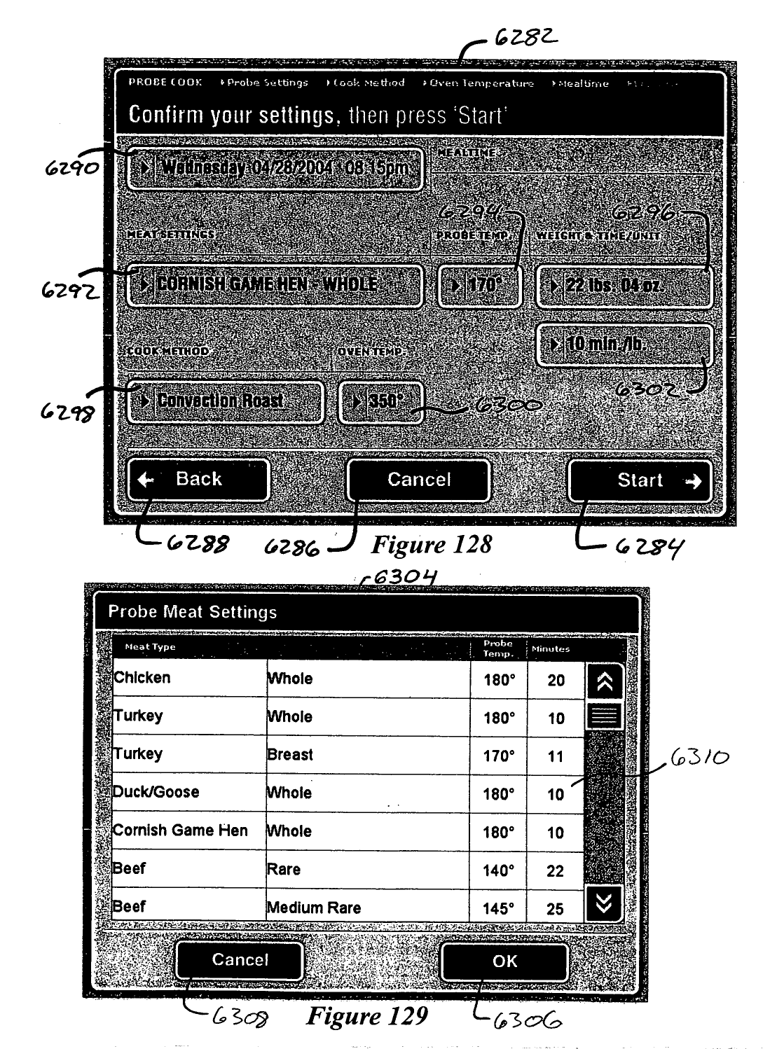

Referring now to the screen architecture 6180 of FIG. 125, at step 6182 a confirmation cook later probe cooking screen is displayed to the user. A suitable confirmation template screen is illustrated in FIG. 128. As shown in FIG. 128, the confirmation screen 6282 includes a meal time icon 6290, a meat settings icon 6292, a probe temperature icon 6294, a weight and time unit icon 6296, a cook method icon 6298, an oven temperature icon 6300, second weight and time unit icon 6302, a start icon 6284, a cancel icon 6286, and a back icon 6288. Operation of the confirmation screen 6282 will be explained in conjunction with the flow chart 6180 of FIG. 125. When the user desires to cancel the cook later operation, the user selects the cancel icon 6286 at step 6184, whereupon display returns to the main screen 400 at step 6186 for the top probe 210, or at step 6188 for the bottom probe 216.

When the user desires to adjust the meal time settings, the user selects the meal time settings icon 6290 at step 6190, whereupon the cook later probe eat time screen 6266 of FIG. 127 is displayed at step 6108. The user then makes any desired changes to the meal time settings and selects the next icon 6268 at step 6218, whereupon the changes are made to the cook later probe cooking operation at step 6222. Flow then returns to the confirmation screen 6282 at step 6182. To cancel any changes to the meal time settings, the user selects the cancel icon 6270 at step 6220, whereupon the changes are discarded at step 6224. Flow then returns to the confirmation screen 6282 at step 8182.

When the user desires to adjust the meat settings, the user selects the meat settings icon 6292 at step 6192, whereupon the meat guide 6304 is displayed to the user at step 6206. The user then changes the meat and selects the okay icon 6306 at step 6218, whereupon the changes are made to the cook later operation at step 6222 and flow returns to the confirmation screen 6282 at step 6182. To cancel the changes, the user selects the cancel icon 6308 at step 6220, whereupon the changes are discarded at step 6224 and flow returns to the confirmation screen 6282 at step 6182. To adjust the probe temperature, the user selects the probe temperature icon 6294 at step 6194. Flow then proceeds to step 6208, whereupon the set probe temperature screen 6328 of FIG. 131 is displayed to the user. The user then makes any desired changes and selects the okay, i.e., next icon 6330 at step 6218, which saves the changes at step 6222, prompting a return to the confirmation screen 6282 at step 6182. To ignore the changes, the user selects the cancel icon 6332 at step 6220, following which the changes are deleted at step 6224 and flow returns to the confirmation screen 6282 at step 6182.

To adjust the weight and time unit, the user selects the weight and time unit icon 6296 or 6302 at step 6196. Flow then proceeds to step 6210, whereupon the weight and time unit selection screen 6036 of FIG. 120 is displayed to the user. The user then makes any desired changes and selects the okay, i.e., next icon 6038 at step 6218, which saves the changes at step 6222, prompting a return to the confirmation screen 6282 at step 6182. To ignore the changes, the user selects the cancel icon 6040 at step 6220, following which the changes are deleted at step 6224 and flow returns to the confirmation screen 6282 at step 6182. To change the cooking method, the user selects the cooking method icon 6298 at step 6198. Flow then proceeds to step 6212, whereupon the cooking method selection screen 6240 of FIG. 126 is displayed to the user. The user then makes any desired changes and selects the okay, i.e., next icon 6242 at step 6218, which saves the changes at step 6222, prompting a return to the confirmation screen 6282 at step 6182. To ignore the changes, the user selects the cancel icon 6244 at step 6220, following which the changes are deleted at step 6224 and flow returns to the confirmation screen 6282 at step 6186. To adjust the oven temperature, the user selects the oven temperature icon 6300 at step 6200. Flow then proceeds to step 6214, whereupon the oven temperature screen 6312 of FIG. 130 is displayed to the user. The user then makes any desired changes and selects the okay, i.e., next icon 6314 at step 6218, which saves the changes at step 6222, prompting a return to the confirmation screen 6282 at step 6182. To ignore the changes, the user selects the cancel icon 6316 at step 6220, following which the changes are deleted at step 6224 and flow returns to the confirmation screen 6282 at step 6182.

The user then selects the start icon 6284 at step 6106, thereafter flow proceeds to step 6216, whereupon a preheat screen is displayed. It will be appreciated that a similar template screen 3262 is illustrated at FIG. 93. The skilled artisan will appreciate that the screen 3262, as applied to the cook later probe cooking operation, advantageously includes a probe icon, which is not shown in FIG. 93. From the preheat screen 3262, the user is able to adjust the cook later settings by selecting an adjust settings icon 3266 at step 6228, whereupon flow returns to the confirmation screen 6282 at step 6182. The probe cook later operation is capable of being canceled from the preheat screen by selecting the off icon 3268 at step 6230, whereupon flow returns to the main screen 400 associated with the probe used at step 6234 or step 6236. Furthermore, the user is able to turn on or off the oven light by selecting the oven light icon 3270 at step 6232, whereupon the state of the light of the associated chamber is turned on or off at step 6238. Once the cooking chamber associated with the cook later operation has reached the desired temperature, i.e., the preheat operation has completed, flow proceeds to display a probe cook later status screen at step 6226. A suitable status screen is illustrated in FIG. 122. From the status screen 6068 of FIG. 122, the user is able to adjust the cook later settings by selecting an adjust settings icon 6070 at step 6228, whereupon flow returns to the confirmation screen 6282 at step 6182. The probe cook later operation is capable of being canceled from the status screen 6068 by selecting the off icon 6072 at step 6230, whereupon flow returns to the main screen 400 associated with the probe used at step 6234 or step 6236. Furthermore, the user is able to turn on or off the oven light by selecting the oven light icon 6074 at step 6232, whereupon the state of the light of the associated chamber is turned on or off at step 6238.

The invention extends to computer programs in the form of source code, object code, code intermediate sources and object code (such as in a partially compiled form), or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed is:

1. A control interface for food preparation comprising:
means adapted for generating a display representative of at least one of date and time data, which date and time data is representative of available options for future food preparation options;
means adapted for receiving timing data, which timing data is selected from the at least one of time and date data, representative of a user-selected time for which a prepared food event is desired;
means adapted for selectively generating a display representative of at least one of available, pre-stored food preparation characteristics and user-specified food preparation characteristics;
means adapted for receiving food preparation instruction data, which food preparation instruction data is selected from the at least one of available, pre-stored food preparation characteristics and user-specified food preparation characteristics; and
means adapted for communicating the timing data and the food preparation instruction data to an associated food preparation controller unit adapted to complete a food preparation operation in accordance therewith.

2. The control interface for food preparation of claim 1 further comprising the food preparation controller inclusive of:
a refrigeration controller, which refrigeration controller includes means adapted for selectively controlling an associated refrigeration unit, which refrigeration unit functions to keep associated food at a safe storage temperature until commencement of the food preparation operation in accordance with the timing data; and
a heating unit controller, which heating unit controller includes means adapted for selectively controlling an associated heating unit, which heating unit functions to cook the associated food in accordance with the food preparation instruction data.

3. The control interface for food preparation of claim 2 further comprising:
means adapted for generating a display representative of solicited input of at least one of weight and mass of the associated food; and
means adapted for receiving quantity data, which quantity data is associated with user input of at least one of weight and mass of the associated food,
wherein the heating unit controller further includes means adapted for selectively controlling the associated heating unit in accordance with the quantity data.

4. The control interface for food preparation of claim 2 further comprising the food preparation controller inclusive of:
storage means adapted for storing received timing data and food preparation instruction data; and
means adapted for retrieving, from the storage means, timing data and food preparation instruction data in response to an initiation of a food preparation operation.

5. The control interface for food preparation of claim 4 further comprising the food preparation controller inclusive of:
communications means adapted for communicating with a distributed computing environment; and
receiving means adapted for receiving, via the distributed computing environment, food preparation instruction data and timing data.

6. The control interface for food preparation of claim 5, wherein the distributed computing environment is at least one of the group consisting of a local area network, a wide area network, a personal area network, and the Internet.

7. A method for food preparation using a control interface, comprising the steps of:
generating a display representative of at least one of date and time data, which date and time data is representative of available options for future food preparation options;
receiving timing data, which timing data is selected from the at least one of time and date data, representative of a user-selected time for which a prepared food event is desired;
generating a display representative of at least one of available, pre-stored food preparation characteristics and user-specified food preparation characteristics;
receiving food preparation instruction data, which food preparation instruction data is selected from the at least one of available, pre-stored food preparation characteristics and user-specified food preparation characteristics; and
communicating the timing data and the food preparation instruction data to an associated food preparation controller unit adapted to complete a food preparation operation in accordance therewith.

8. The method for food preparation using a control interface of claim 7, further comprising the steps of:
selectively controlling, via a refrigeration controller, an associated refrigeration unit, which refrigeration unit functions to keep associated food at a safe storage temperature until commencement of the food preparation operation in accordance with the timing data; and
selectively controlling, via a heating unit controller, an associated heating unit, which heating unit functions to cook the associated food in accordance with the food preparation instruction data.

9. The method for food preparation using a control interface of claim 8, further comprising the steps of:
generating a display representative of solicited input of at least one of weight and mass of the associated food;
receiving quantity data, which quantity data is associated with user input of at least one of weight and mass of the associated food; and
selectively controlling, via the heating unit controller, the associated heating unit in accordance with the quantity data.

10. The method for food preparation using a control interface of claim 8 further comprising the steps of:
storing, in a storage device, received timing data and food preparation instruction data; and
retrieving, from the storage device, timing data and food preparation instruction data in response to an initiation of a food preparation operation.

11. The method for food preparation using a control interface of claim 10 further comprising the steps of:
communicating with a distributed computing environment; and
receiving, via the distributed computing environment, food preparation instruction data and timing data.

12. The method for food preparation using a control interface of claim 11, wherein the distributed computing environment is at least one of the group consisting of a local area network, a wide area network, a personal area network, and the Internet.

13. A computer-implemented method for food preparation using a control interface, comprising the steps of:
generating a display representative of at least one of date and time data, which date and time data is representative of available options for future food preparation options;
receiving timing data, which timing data is selected from the at least one of time and date data, representative of a user-selected time for which a prepared food event is desired;
generating a display representative of at least one of available, pre-stored food preparation characteristics and user-specified food preparation characteristics;
receiving food preparation instruction data, which food preparation instruction data is selected from the at least one of available, pre-stored food preparation characteristics and user-specified food preparation characteristics; and
communicating the timing data and the food preparation instruction data to an associated food preparation controller unit adapted to complete a food preparation operation in accordance therewith.

14. The computer-implemented method for food preparation using a control interface of claim 13, further comprising the steps of:
selectively controlling, via a refrigeration controller, an associated refrigeration unit, which refrigeration unit functions to keep associated food at a safe storage temperature until commencement of the food preparation operation in accordance with the timing data; and
selectively controlling, via a heating unit controller, an associated heating unit, which heating unit functions to cook the associated food in accordance with the food preparation instruction data.

15. The computer-implemented method for food preparation using a control interface of claim 14, further comprising the steps of:
generating a display representative of solicited input of at least one of weight and mass of the associated food;
receiving quantity data, which quantity data is associated with user input of at least one of weight and mass of the associated food; and
selectively controlling, via the heating unit controller, the associated heating unit in accordance with the quantity data.

16. The computer-implemented method for food preparation using a control interface of claim 14 further comprising the steps of:
storing, in a storage device, received timing data and food preparation instruction data; and
retrieving, from the storage device, timing data and food preparation instruction data in response to an initiation of a food preparation operation.

17. The computer-implemented method for food preparation using a control interface of claim 16 further comprising the steps of:
communicating with a distributed computing environment; and
receiving, via the distributed computing environment, food preparation instruction data and timing data.

18. The computer-implemented method for food preparation using a control interface of claim 17, wherein the distributed computing environment is at least one of the group consisting of a local area network, a wide area network, a personal area network, and the Internet.
